(19) United States
(12) Patent Application Publication
(10) Pub. No.: US 2026/0081745 A1
(43) Pub. Date: Mar. 19, 2026

(54) EVENT DRIVEN BEAM REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/312,247

(22) Filed: Aug. 27, 2025

Related U.S. Application Data
(60) Provisional application No. 63/695,220, filed on Sep. 16, 2024.
(60) Provisional application No. 63/698,297, filed on Sep. 24, 2024.
(60) Provisional application No. 63/701,988, filed on Oct. 1, 2024.
(60) Provisional application No. 63/734,431, filed on Dec. 16, 2024.
(60) Provisional application No. 63/827,137, filed on Jun. 20, 2025.

(51) Int. Cl. H04L 5/00

(52) U.S. Cl. CPC H04L 5/0091; H04L 5/0051

(57) ABSTRACT

Methods and apparatuses event driven beam reporting. A method performed by a user equipment (UE) includes receiving, in a channel state information (CSI) report configuration for UE-initiated (UEI) reporting, information related to an event, determining, based on the information, a first reference signal (RS) resource for evaluation of the event, and monitoring transmission occasions (TOs) of the first RS resource. The method includes determining, based on measured layer-1 reference signal received powers (L1-RSRPs) of the TOs and the information, a value of a timer and a value of a counter specific to the first RS resource and determining the event based on the values of the timer and the counter. The information includes a threshold, a time window length and a number of event instance count.

### CROSS-REFERENCE TO RELATED AND CLAIM OF PRIORITY

The present application claims priority under 35 U.S.C. § 119(e) to U.S. Provisional Patent Application No. 63/695,220 filed on Sep. 16, 2024; U.S. Provisional Patent Application No. 63/698,297 filed on Sep. 24, 2024; U.S. Provisional Patent Application No. 63/701,988 filed on Oct. 1, 2024; U.S. Provisional Patent Application No. 63/734,431 filed on Dec. 16, 2024; and U.S. Provisional Patent Application No. 63/827,137 filed on Jun. 20, 2025, which are hereby incorporated by reference in their entirety.

### TECHNICAL FIELD

The present disclosure relates generally to wireless communication systems and, more specifically, the present disclosure relates to methods and apparatuses event driven beam reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to event driven beam reporting.

In one embodiment, a user equipment (UE) is provided. The UE includes a transceiver configured to receive, in a channel state information (CSI) report configuration for UE-initiated (UEI) reporting, information related to an event. The UE further includes a processor operably coupled with the transceiver. The processor is configured to determine, based on the information, a first RS (RS) resource for evaluation of the event. The transceiver is further configured to monitor transmission occasions (TOs) of the first RS resource. The processor is further configured to determine, based on measured layer-1 RS received powers (L1-RSRPs) of the TOs and the information, a value of a timer and a value of a counter specific to the first RS resource; and determine the event based on the values of the timer and the counter. The information includes a threshold, a time window length, and a number of event instance count.

In another embodiment, a base station (BS) is provided. The BS includes a processor and a transceiver operably coupled with the processor. The transceiver is configured to transmit, in a CSI report configuration for UEI reporting, information related to an event that indicates a first RS resource for evaluation of the event and transmit in one or more TOs of the first RS resource. The event is based on a value of a timer and a value of a counter specific to the first RS resource. The values of the timer and the counter are based on L1-RSRPs of TOs of the first RS resource. The information includes a threshold, a time window length, and a number of event instance count.

In yet another embodiment, a method performed by a UE is provided. The method includes receiving, in a CSI report configuration for UEI reporting, information related to an event, determining, based on the information, a first RS resource for evaluation of the event, and monitoring TOs of the first RS resource. The method includes determining, based on measured L1-RSRPs of the TOs and the information, a value of a timer and a value of a counter specific to the first RS resource and determining the event based on the values of the timer and the counter. The information includes a threshold, a time window length and a number of event instance count.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an examples of wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate examples of report format/content(s)/quantity(s) of a UE-initiated (UEI)/event-driven report according to embodiments of the present disclosure;

FIGS. 8A, 8B, and 8C illustrate examples of event evaluation procedure(s) for UEI beam reporting according to embodiments of the present disclosure;

FIG. 9 illustrates an example of determining time window(s) for event evaluation for UEI beam reporting according to embodiments of the present disclosure;

FIG. 10 illustrates example transmission occasions (TOs) of RSs according to embodiments of the present disclosure;

FIGS. 11A, 11B, and 11C illustrate examples of time window(s) according to embodiments of the present disclosure;

FIG. 12 illustrates an example of determining time window for event evaluation(s) for UEI beam reporting according to embodiments of the present disclosure; and

FIG. 13 illustrates an example method performed by a UE in a wireless communication system according to embodiments of the present disclosure.

### DETAILED DESCRIPTION

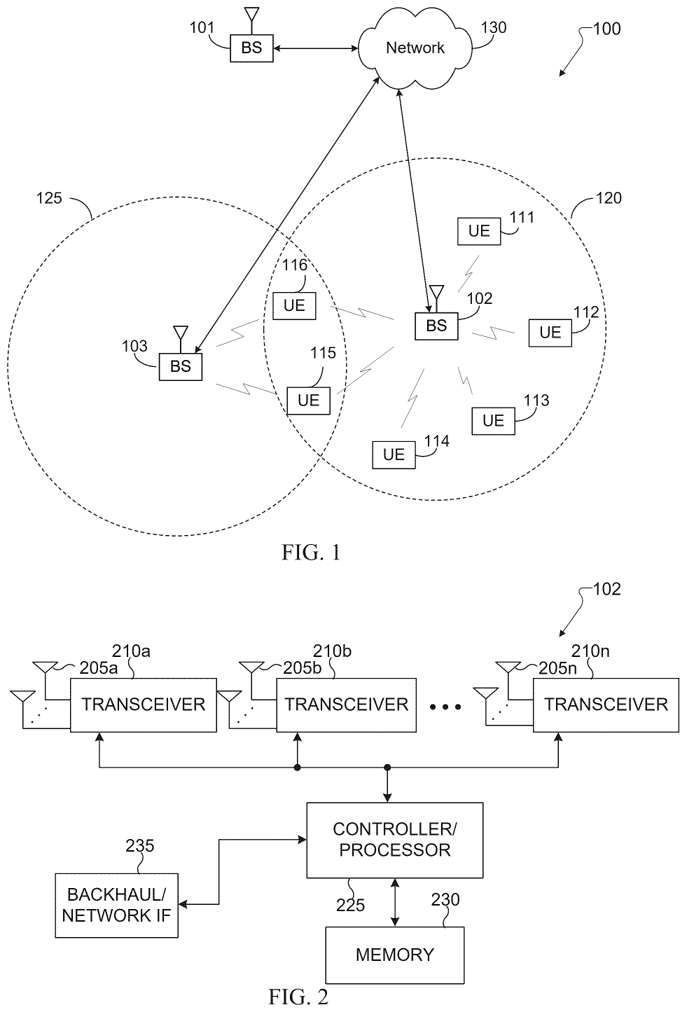

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical LayerProcedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing event driven beam reporting. In certain embodiments, one or more of the BSs 101-103 include circuitry, programing, or a combination thereof to support event driven beam reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting event driven beam reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

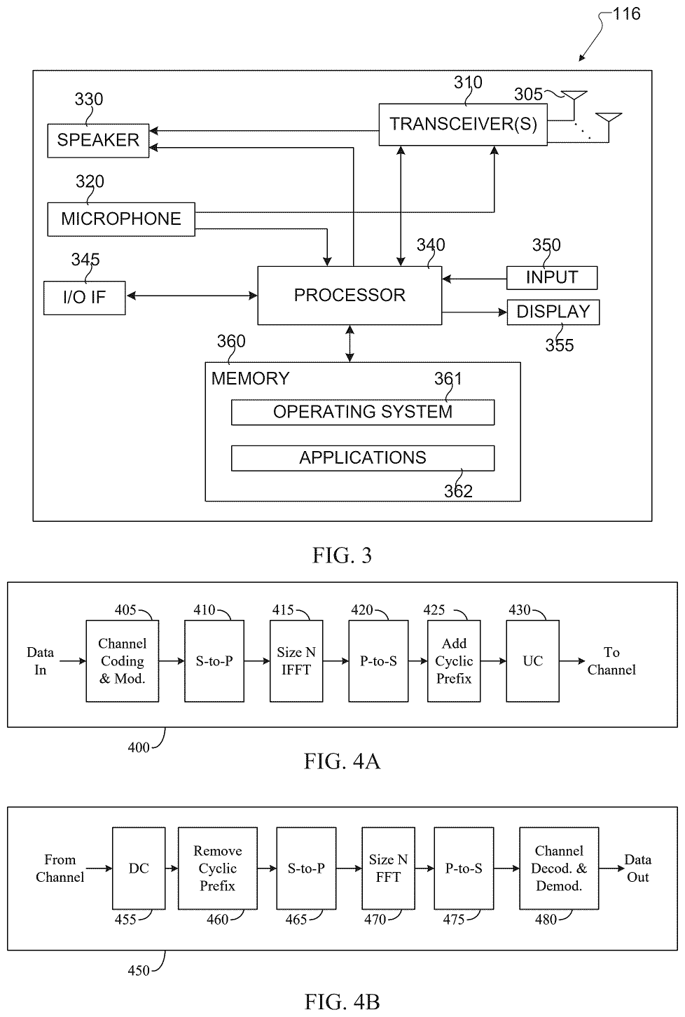

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform event driven beam reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support event driven beam reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

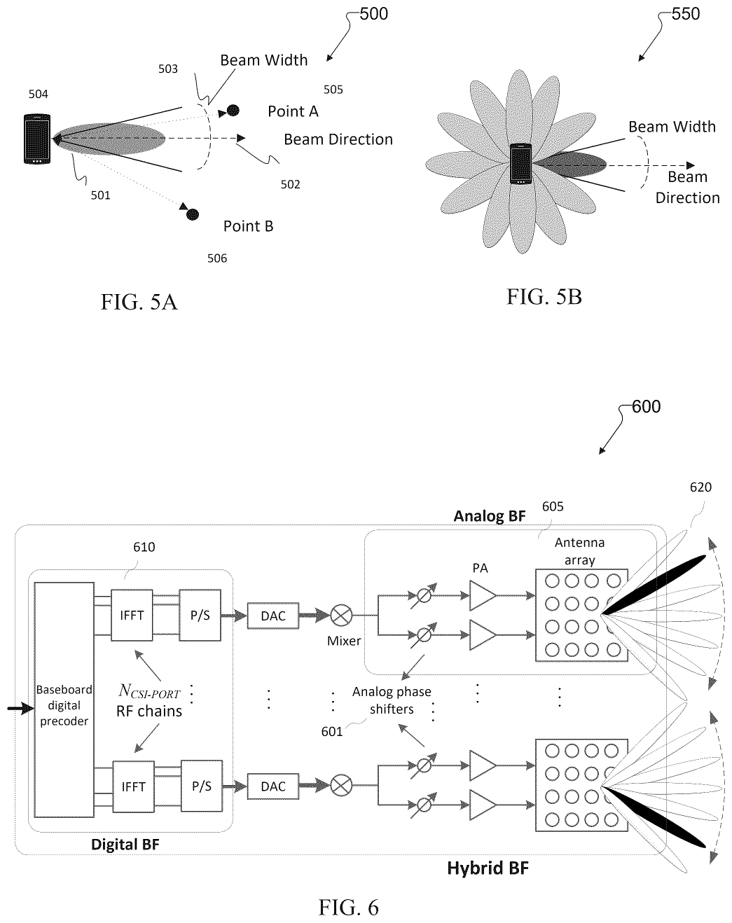

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports Ncsz-PORT. A digital beamforming unit 610 performs a linear combination across NcSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one RS for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of;
A transmission configuration indication (TCI) state, that establishes a quasi-colocation (QCL) relationship between a source RS (e.g. synchronization signal block (SSB) and/or CSI-RS) and a target RS
A spatial relation information that establishes an association to a source RS, such as SSB or CSI-RS or sounding RS (SRS).

In either case, the ID of the source RS identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Accordingly, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various report formats customized for the UE-initiated/event-driven beam reporting, and specifies different conditions or settings to apply or use different report formats. Means of detecting/declaring different events or combinations of different events, and designs of their corresponding configurations and signaling details are specified in this disclosure as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE (e.g., the UE 116) could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic downlink control information (DCI) based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB (e.g., the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CRI, SSBRI) and Jᵢ is a beam metric (e.g. L1-RS received power (RSRP)/L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 0.1 (for Joint) and Table 0.2/Table 0.3 (for separate). In these examples, the event-types and the report-types are separate (explicit). However, they can also be Joint, as shown in Table 0.4. A few examples of the autonomous UE-initiated report are shown in Table 0.5.

TABLE 0.1
event-based UE-initiated report

| Event | Report | | |
|---|---|---|---|
| type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/ | (A) | Yes (e.g. non-CSI-related event) | No |
| beam/TDCP | (B) | No | Yes |
| | (C) | Yes (e.g. non-CSI-related event) | Yes |
| 4. other (content- | (A) | Yes (no need for content) | No |
| free/less events) | | | |

TABLE 0.2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 0.3
event-based UE-initiated report

| Report-type | Trigger/pre-notification message | Content |
|---|---|---|
| (A) | Yes | No |
| (B) | No | Yes |
| (C) | Yes | Yes |

TABLE 0.4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 0.5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of CWs.
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating thatthe UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

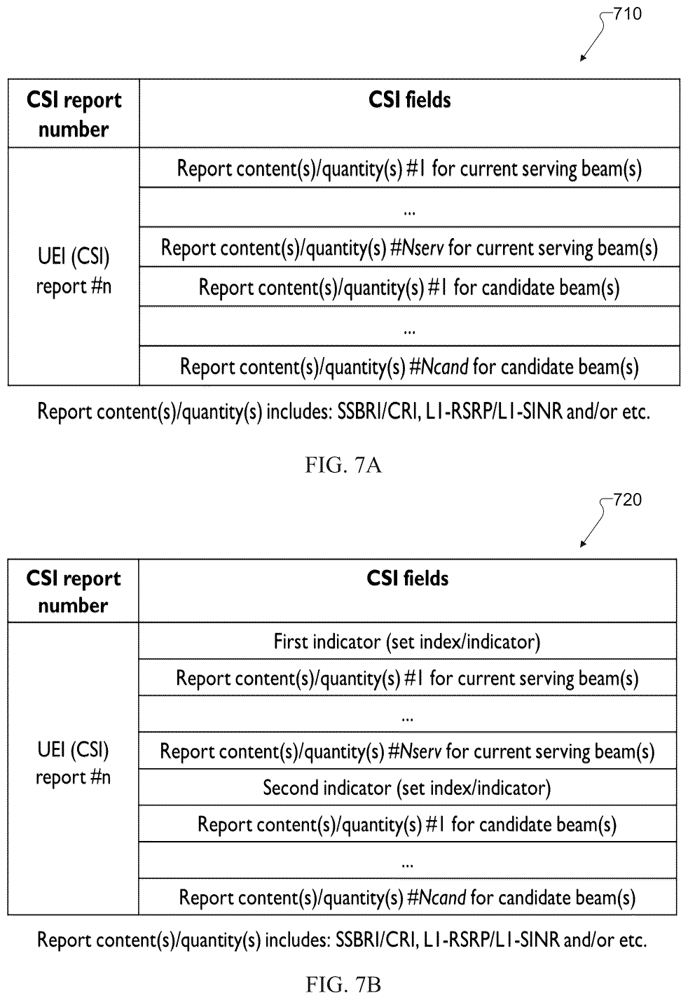

FIGS. 7A and 7B illustrate examples of report format/content(s)/quantity(s) 710 and 720 of a UE-initiated (UEI)/event-driven report according to embodiments of the present disclosure. For example, report format/content(s)/quantity(s) 710 and 720 of a UEI/event-driven report can be reported by any of the UEs 111-116 of FIG. 1. This example is for illustration only and other embodiments can be used without departing from the scope of the present disclosure.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSB resource indicator(s) (SSBRI(s))/CSI-RS resource indicator(s) (CRI(s)) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
   In one example, the UE could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
   In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
   In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
   In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format described/specified herein in the present disclosure is presented in FIG. 7A.
   In another example, for (3), a first indicator and/or a second indicator could be provided, reported, sent, comprised, included, contained or transmitted in a/the UEI report as specified herein in the present disclosure. For this design example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure. In particular, the first indicator could correspond to a set index/indicator for a serving beam(s) RS set denoted by s̅₀ according to those specified herein in the present disclosure—e.g., the set index/indicator for the serving beam(s) RS set, and therefore, the first indicator, could be ‘0’ (or ‘1’ or ‘2’); optionally or alternatively, the first indicator could correspond to a one-bit indicator (e.g., a one-bit set index/indicator) with ‘0’ (or ‘1’ or ‘2’) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure. Furthermore, the second indicator could correspond to a set index/indicator for a candidate beam(s) RS set denoted by s̅₁ according to those specified herein in the present disclosure—e.g., the set index/indicator for the candidate beam(s) RS set, and therefore, the second indicator, could be ‘1’ (or ‘0’ or ‘2’); optionally or alternatively, the second indicator could correspond to a one-bit indicator (e.g., a one-bit set index/indicator) with ‘1’ (or ‘0’ or ‘2’) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s). In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) such as SSBRI(s)/CRI(s) and/or beam metric(s) such as L1-RSRP(s)/L1-SINR(s) corresponding to the current serving (or candidate) beam(s)—in FIG. 7B, a conceptual example capturing the UEI reporting format according to those specified herein in the present disclosure is provided. Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.
   In another example, for (3), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by s̅₀ according to those specified herein in the present disclosure or a candidate beam(s) RS set denoted by s̅₁ according to those specified herein in the present disclosure—e.g., the indicator (or equivalently, the set index/indicator) could be ‘0’ (or ‘1’ or ‘2’) for the serving beam(s) RS set, and ‘1’ (or ‘0’ or ‘2’) for the candidate beam(s) RS set. For another example, the indicator could correspond to a one-bit indicator with ‘0’ (or ‘1’ or ‘2’) corresponding to/indicating the serving beam(s) RS set and/or information related to current serving beam(s), and ‘1’ (or ‘0’ or ‘2’) corresponding to/indicating the candidate beam(s) RS set and/or information related to candidate beam(s). In this case, when/if an indicator associated/corresponding/specific to a report content/quantity as specified/defined herein in the present disclosure in a UEI report is set to ‘0’ (or ‘1’ or ‘2’), the report content/quantity could be associated/corresponding/specific to the current serving beam(s), and when/if an indicator associated/corresponding/specific to a report content/quantity as specified/defined herein in the present disclosure in a UEI report is set to ‘1’ (or ‘0’ or ‘2’), the report content/quantity could be associated/corresponding/specific to the candidate beam(s).
   In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, a UE could be provided/indicated/configured by the network (e.g., the network 130), e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE (e.g., the UE 116) could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17:
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

Under the aforementioned unified TCI framework, a UE could receive a (unified) TCI state(s) activation/deactivation (MAC CE) command, used to map up to a number of activated TCI states and/or pairs of activated TCI states, with one activated TCI state for DL channels/signals and/or one activated TCI state for UL channels/signals to the codepoints of the DCI field ‘Transmission Configuration Indication’ for one or for a set of component carriers (CCs)/DL BWPs, and if applicable, for one or for a set of CCs/UL bandwidth parts (BWPs). That is, a UE could receive from the network, in/via a (unified) TCI state(s) activation/deactivation (MAC CE) command, up to a number of TCI codepoints of the DCI field ‘Transmission Configuration Indication’ for one or for a set of CCs/DL BWPs, and if applicable, for one or for a set of CCs/UL BWPs with each TCI codepoint mapped to an activated TCI state and/or a pair of activated TCI states, with one activated TCI state for DL channels/signals and/or one activated TCI state for UL channels/signals. In the present disclosure, an activated TCI state can also be referred to as an activated beam, and vice versa.

The RS(s) or RS resource(s) or RS resource index(es) of/for a current serving beam—denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking RS (TRS) is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set \vec{s}₀ of (periodic) CSI-RS resource configuration indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfg, CSI-ResourceConfig, nzp-CSI-RS-ResourceSet and/or higher layer parameter(s) UEI-ReportConfg, UEI-ResourceConfig and/or etc. dedicated/configured for the UEI reporting as specified herein in the present disclosure.
(explicit configuration example-2): a set s̅₀ of SS/PBCH block indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking RS(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to):
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-B): a set s̅₁ of SS/PBCH block indexes by CandidateBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking RS(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource index(es)—could be identified or determined according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-i): a set s̅₂ of (periodic) CSI-RS resource configuration indexes by activationBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-ii): a set s₂ of SS/PBCH block indexes by activationBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking RS(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to):
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Furthermore, the UE could identify or determine a subset of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D as the RS(s) or RS resource(s) or RS resource index(es) for the actual measurement for/of one or more candidate/new beams.
In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.
In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g. (1) fixed rule(s) in system specification(s) or per RRC (re)configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.
   For example, the first (or last) L≥1 candidate RS(s) or RS resource(s) or RS resource index(es) or the L≥1 candidate RS(s) or RS resource(s) with the lowest (or highest) resource index(es)—among the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of the K configured/determined candidate RS(s) or RS resource(s) or RS resource index(es) or the half of the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.
   For another example, the even-ordered or even-numbered or even-indexed candidate RS(s) or RS resource(s) or RS resource index(es) or the candidate RS(s) or RS resource(s) with even-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.
   For another example, the odd-ordered or odd-numbered or odd-indexed candidate RS(s) or RS resource(s) or RS resource index(es) or the candidate RS(s) or RS resource(s) with odd-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.
In another example, the UE (e.g., the UE 116) could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network (e.g., the network 130) that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set si corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.
In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when/if the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.
In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set si corresponding/associated to the 1-bit indicators provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.

For the described/specified design examples herein, when/if the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D to obtain the actual corresponding measurement result(s) for/of the one or more candidate/new beams. As specified or discussed herein in the present disclosure, a/the UE could indicate or send or transmit to the network, e.g., by/in part of their capability or capability signaling, whether or not they are capable of receiving/detecting/using/applying or support to receive/detect/use/apply the one or more indicators as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; for instance, a/the UE could indicate or send or transmit to the network, e.g., by/in part of their capability or capability signaling, whether or not they are capable of receiving/detecting/using/applying or support to receive/detect/use/apply the one or more indicators provided, contained, indicated, included, comprised or configured in the higher layer parameter TCI-State or TCI-UL-State that configures or provides the indicated TCI state as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. Optionally, when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is greater than or equal to a first threshold/number/value, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, (ii) follow those specified in the implicit determination example-A/B/C/D, and/or (iii) follow other subset based candidate RS(s)/RS resource(s)/RS resource index(es) indication/identification/determination method(s) as discussed or specified herein in the present disclosure, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is less than or equal to the first threshold/number/value, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B to obtain the actual corresponding measurement result(s) for/of the one or more candidate/new beams. In this case, the UE could determine or identify the first threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Alternatively, when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is less than or equal to a second threshold/value/number, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, and/or (ii) follow those specified in the explicit configuration example-A/B, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is greater than or equal to the second threshold/value/number, the UE could assess or evaluate the radio link/beam quality(s), e.g., by measuring the L1-RSRP(s)/L1-SINR(s), of the candidate RS(s) or RS resource(s) or RS resource index(es) determined following those specified/described in the implicit determination example-A, the implicit determination example-B, the implicit determination example-C and/or the implicit determination example-D to obtain the actual corresponding measurement result(s) for/of the one or more candidate/new beams. In this case, the UE could determine or identify the second threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Furthermore, the UE could first determine or identify, e.g., based on or according to (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure. Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/1-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking RS (TRS)—e.g., a CSI-RS configured with trs-Info, a CSI-RS configured without repetition or with repetition set to ‘off’, and etc.

A UE could determine or identify an instance of a first event or Event-1 (or a given event as specified/defined herein in the present disclosure or used throughout the present disclosure) according to or based on or corresponding to:
In one example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure.
   For example, the UE could determine or identify the one or more activated beams/TCI states or the one or more activation beam RSs/RS resource according to or based on fixed value(s) in system specification(s) and/or per RRC (re-)configuration. For instance, the one or more activated beams/TCI states could correspond to the activated beam/TCI state among the activated beams/TCI states in the (unified) TCI state(s) activation/deactivation MAC CE command that has the highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure. Alternatively, the one or more activated beams/TCI states could correspond to the activated beam/TCI state among the activated beams/TCI states in the (unified) TCI state(s) activation/deactivation MAC CE command that has the lowest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure. Optionally, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the value of m could be fixed in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M). Similarly, the one or more activation beam RSs or RS resources could have the highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Alternatively, the one or more activation beam RSs or RS resources could have the lowest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Optionally, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be fixed in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M).
   For another example, the UE could determine or identify the one or more activated beams/TCI states or the one or more activation beam RSs/RS resource according to or based on network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. For instance, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the value of m could be configured or provided or indicated by the network e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M). Similarly, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be configured or provided or indicated by the network e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M).
   For another example, the UE could determine or identify the one or more activated beams/TCI states or the one or more activation beam RSs/RS resource according to or based on UE's autonomous determination or selection, which could be further sent or transmitted to the network via/by various UL channels/signals e.g. in/by part of a CSI/beam report and/or a UE's capability signaling. For instance, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the value of m could be according to or based on UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Similarly, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be according to or based on UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M).
   For another example, the UE could determine or identify that the one or more activated beams/TCI states could correspond to the activated beams/TCI states in the (unified) TCI state(s) activation/deactivation MAC CE command, and the beam quality(s)/metric(s) of or corresponding to the one or more activated beams/TCI states could correspond to averaged and/or filtered L1-RSRP(s) of or corresponding to the activated beams/TCI states in the (unified) TCI state(s) activation/deactivation MAC CE command according to or based on (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Similarly, the UE could determine or identify that the one or more activation beam RSs or RS resources could correspond to the activation beam RSs or RS resources corresponding, specific or associated to the activated beams/TCI states in the (unified) TCI state(s) activation/deactivation MAC CE command, and the beam quality(s)/metric(s) of or corresponding to the one or more activation beam RSs or RS resources could correspond to averaged and/or filtered L1-RSRP(s) of or corresponding to the activation beam RSs or RS resources corresponding, specific or associated to the activated beams/TCI states in the (unified) TCI state(s) activation/deactivation MAC CE command according to or based on (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states could be a second threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beam/TCI state among the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a second threshold value greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states could be a second threshold value greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a second threshold value greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure, and the beam quality(s)/metric(s)—e.g., measured L1-RSRP(s)/L1-SINR(s)—of the one or more activated beams/TCI states could be a third threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beam/TCI state among the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a third threshold value greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure, and the beam quality(s)/metric(s)—e.g., measured L1-RSRP(s)/L1-SINR(s)—of the one or more activated beams/TCI states could be a third threshold value greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a third threshold value greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.

The UE (e.g., the UE 116) could determine or identify the value(s) of the first threshold and/or the second threshold and/or the third threshold according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For the described design example(s) herein, the beam quality(s)/metric(s)—e.g., measured L1-RSRP(s)/L1-SINR(s)—of the determined or identified at least one (same) candidate/new beam or candidate/new beam RS/RS resource could also be:
a fourth threshold value lower than or equal to the beam quality/metric (e.g., a measured L1-RSRP/L1-SINR) of the current serving beam or current serving beam RS/RS resource according to or following those specified herein in the present disclosure, and/or
a fifth threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beam/TCI state among the activated beams/TCI states in the (unified) TCI state(s) activation/deactivation MAC CE command—or equivalently, greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure, and/or
a sixth threshold greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure,
   wherein the UE could determine or identify the value(s) of the fourth threshold and/or the fifth threshold and/or the sixth threshold according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on corresponding UE's capability(s) or capability signaling(s), and/or (iii) UE's autonomous determination(s)/selection(s), which could be further sent to the network via various UL channels/signals and/or in part of a CSI/beam report and/or UE's capability signaling. The UE could evaluate an instance of the event (as specified/defined herein in the present disclosure) and/or detect or declare the event according to or following those specified herein in the present disclosure when/if the number of activated TCI states/pairs of TCI states or TCI codepoints in the (unified) TCI state(s) activation/deactivation MAC CE command is greater (or less) than a threshold. Here, the UE could determine or identify the threshold value according to: (i) a fixed value in system specification(s)—e.g., 4, 6 or 8, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or Event-2) according to or based on or corresponding to: the UE could determine or identify at least one (same) candidate/new beam or candidate/new beam RS/RS resource that has a beam quality/metric (e.g., a measured L1-RSRP/L1-SINR) a seventh threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the seventh threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or Event-3) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to an eighth threshold, wherein the UE could determine or identify the eighth threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-3}, the UE could indicate or send or transmit to the network that they could support or could be capable of supporting the Event-1 and Event-3 in the present disclosure:
{Event-1}
{Event-2}
{Event-3}
{Event-1, Event-2}
{Event-1, Event-3}
{Event-2, Event-3}
{Event-1, Event-2, Event-3}

Furthermore, UEs that could or would support the UE-initiated or event-driven reporting should support or indicate their support of one or more of the events—such as Event-1; i.e., the one or more of the events—such as Event-1 in the present disclosure—could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one or more than one) of the events (e.g., Event-1 and/or Event-2) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when/if the eventType is set to ‘Event-1’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-2′ or ‘second’ or 2’ or ‘2nd’ or ‘two’ or ‘disabled’ (or ‘enabled’) or 0 (or 1), the Event-2 as specified/described herein in the present disclosure is enabled. For another example, when/if the eventType is set to ‘Event-1 and Event-2’ or ‘one and second’ or ‘1 and 2’ or ‘first and second’ or ‘enabled’ (or ‘disabled’) or 1 (or 0) or ‘00’ (or ‘01’ or ‘10’ or ‘11’), both the Event-1 and Event-2 as specified/defined herein in the present disclosure are enabled. Throughout the present disclosure, discussions, descriptions, specifications and etc. for when one/an event (e.g., Event-1 or Event-2) is enabled (e.g., detection, declaration, triggering and etc. of the event) can be equally applied or extended to when more than one events (e.g., both Event-1 and Event-2) are enabled (e.g., detection, declaration, triggering and etc. of the more than one events). In another example, the UE may not expect the network to configure or enable any two or three of the {Event-1, Event-2, Event-3}—e.g., Event-1 and Event-2, at a same time.

A given event or an event or the event used throughout the present disclosure could correspond to or could be referred to as a/the first event as specified/defined herein in the present disclosure unless otherwise specified. Furthermore, an instance of a given event or an event or the event used throughout the present disclosure could correspond to or could be referred to as an instance of a/the first event as specified/defined herein in the present disclosure unless otherwise specified.

For the event discussed herein, and/or for a UE to declare the event, and/or for a UE to formulate, construct, transmit and/or send the UEI report(s) with the report content(s)/quantity(s) corresponding to the event according to or following those specified herein in the present disclosure, and/or for a UE to use/apply the event for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of the event, individually:
   2> if an indication for an instance for an event specified/defined according to those specified herein in the present disclosure has been received from lower layers:
      3> start or restart the EventInstanceDetectionTimer (higher layer configured for the event—when/if applicable);
      3> increment Event_COUNTER, secondEvent COUNTER, thirdEvent COUNTER or fourthEvent COUNTER (higher layer configured respectively for the first, second, third or fourth event—when/if applicable) by 1;
      3> if Event_COUNTER>=EventInstanceMaxCount (for the event−when/if applicable), wherein the EventInstanceMaxCount is higher layer configured for the event−when/if applicable:
         4> trigger a UEI (beam) reporting specific to the event−when/if applicable—for this Serving Cell, wherein the report content(s)/quantity(s) in the UEI report(s) could be specific to the event—when/if applicable—according to or following those specified herein in the present disclosure.
   2> if the EventInstanceDetectionTimer (for the event−when/if applicable) expires; or
   2> if the EventInstanceDetectionTimer (for the event−when/if applicable), Event_COUNTER (for the event−when/if applicable), or any of the RSRSs (and/or the corresponding configured, activated and/or indicated TCI state(s)) used for UEI reporting—e.g., including that/those specific to/for the current serving beam(s)/TCI state(s) and/or the candidate beam(s)/TCI state(s) and/or the activated beam(s)/TCI state(s) as specified or defined herein in the present disclosure specific to/for the event—is reconfigured by upper layers associated with this Serving Cell; or
   2> if the RSRS(s) associated with this Serving Cell used for detection/declaration/indication for the event as specified/defined herein in the present disclosure is changed and/or reconfigured by upper layers associated with this Serving Cell:
      3> set Event_COUNTER to 0; and/or
      3> stop the ueiReportingTimer, if configured; and/or
      3> consider the UE-initiated (UEI) reporting procedure triggered or initiated with respect to the event successfully completed, and/or cancel the UEI report(s) triggered or initiated with respect to the event for this Serving Cell.

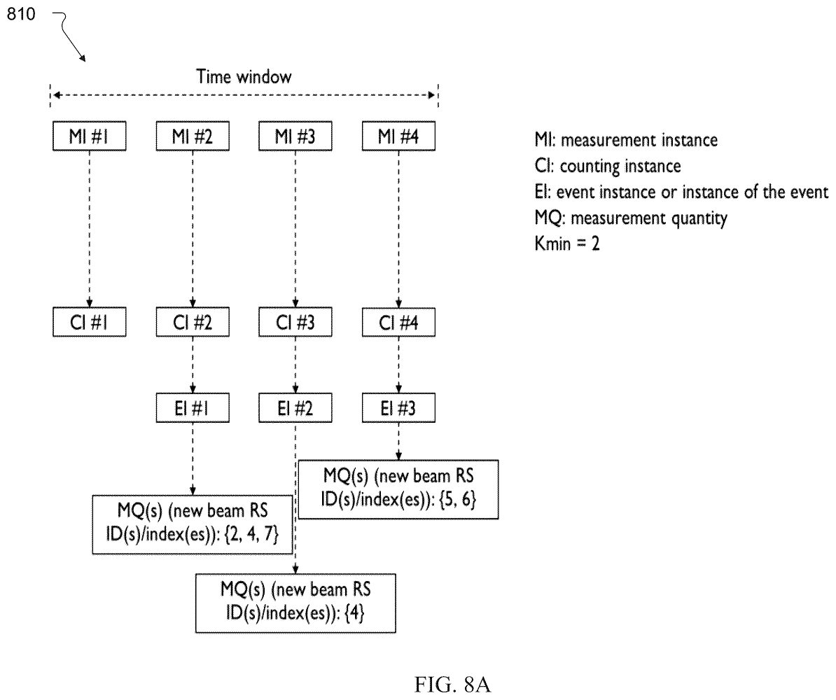

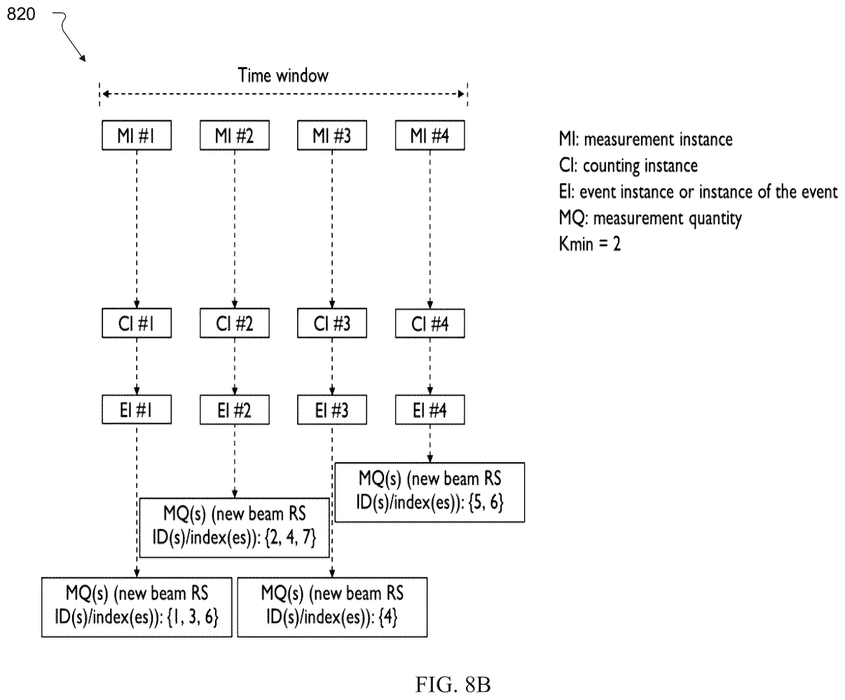

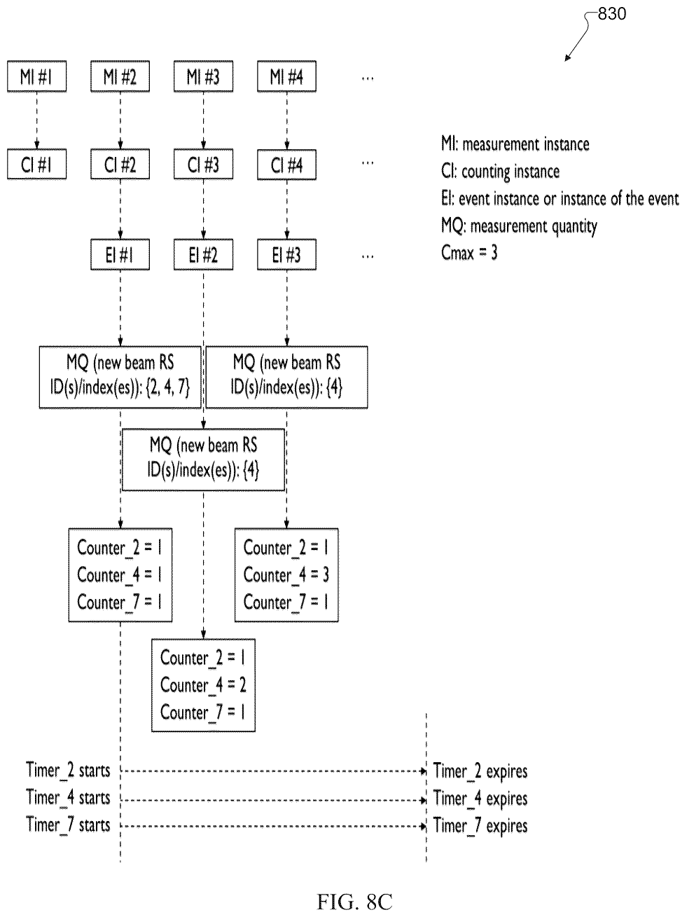

FIGS. 8A, 8B, and 8C illustrate examples of event evaluation procedure(s) for UEI beam reporting 810, 820, and 830, respectively, according to embodiments of the present disclosure. For example, examples of event evaluation procedure(s) 810, 820, and 830, respectively, can be followed by any of the UEs 111-116 of FIG. 1, such as the UE 116. This example is for illustration only and other embodiments can be used without departing from the scope of the present disclosure.

With reference to FIG. 8A, both EI #1 and EI #2 (number of counts=2) have a common MQ (i.e., new beam RS ID/index 4)) within the time window. In this case, the number of counts (2) is equal to Kmin (2). Hence, the event can be declared and the corresponding UEI beam reporting can be initiated/triggered with the new beam RS ID/index 4 as a candidate report quantity/content.

With reference to FIG. 8B, both EI #1 and EI #4 (number of counts=2) have a common MQ (i.e., new beam RS ID/index 6) within the time window. In this case, the number of counts (2) is equal to Kmin (2), and both EI #2 and EI #3 (number of counts=2) have a common MQ (i.e., new beam RS ID/index 4). In this case, the number of counts (2) is equal to Kmin (2). Hence, the event can be declared and the corresponding UEI beam reporting can be initiated/triggered with the new beam RS IDs/indexes 4 and 6 as candidate report quantity(s)/content(s).

With reference to FIG. 8C, the number of counts in Counter_4 specific/associated to new beam RS ID/index 4 (a MQ) reaches to the maximum number of counts Cmax=3 before the corresponding Timer_4 expires. Hence, the UE can declare the event, initiate/trigger a beam reporting with the new beam RS ID/index 4 as a candidate report quantity/content, reset Counter_2/Counter_4/Counter_7 to zero(s), and reset Timer_2/Timer_4/Timer_7.

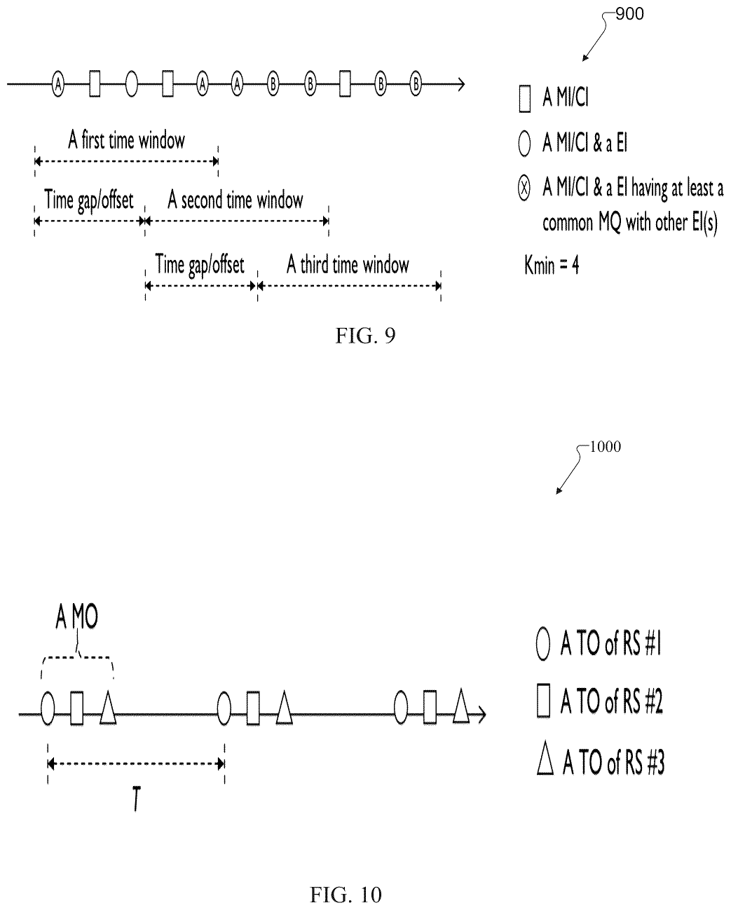

FIG. 9 illustrates an example of determining time window(s) for event evaluation 900 for UEI beam reporting according to embodiments of the present disclosure. For example, determining time window(s) for event evaluation 900 can be followed by the UE 116 of FIG. 3. This example is for illustration only and other embodiments can be used without departing from the scope of the present disclosure.

As specified herein in the present disclosure, to declare an event and to trigger the corresponding (beam) reporting, a UE would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure based on or according to or following one or more of:
In one example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. In this design example, a first counting instance (or a corresponding/associated measurement instance as specified/defined herein in the present disclosure) and a second counting instance (or a corresponding/associated measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance
denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if a/the number of instances of the event—denoted by K_1≥1 out of the total number of instances of the event, i.e., K_1≤K—that have at least one same measurement quantity (denoted by first same measurement quantity(s)) is less than (or greater than) or equal to a threshold (denoted by Kmax) or greater than (or less than) or equal to a threshold (denoted by Kmin), and/or a/the number of instances of the event—denoted by K_2≥1 out of the total number of instances of the event, i.e., K_2≤K—that have at least one same measurement quantity (denoted by second same measurement quantity(s)) is less than (or greater than) or equal to a threshold (denoted by Kmax) or greater than (or less than) or equal to a threshold (denoted by Kmin), and so on, and/or a/the number of instances of the event—denoted by K_k≥1 out of the total number of instances of the event, i.e., K_k≤K—that have at least one same measurement quantity (denoted by k-th same measurement quantity(s)) is less than (or greater than) or equal to a threshold (denoted by Kmax) or greater than (or less than) or equal to a threshold (denoted by Kmin), wherein k∈{1, 2, . . . , Btot} with Btot representing the maximum/total number of unique measurement quantities obtained/identified/determined from the K event instances, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. Two conceptual examples are presented in FIG. 8A and FIG. 8B. In FIG. 8A, the UE could determine or identify three instances of the event (denoted by event instance (EI) #1, EI #2 and EI #3) from four measurement instances (MIs)/counting instances (CIs) in the time window/period/gap/offset, and in FIG. 8B, the UE could determine or identify four instances of the event (denoted by EI #1, EI #2, EI #3 and EI #4) from four MIs/CIs within the time window/period/gap/offset. Among the three determined/identified EIs in FIG. 3, the two (equal to Kmin=2 in this design example) EI #1 and EI #2 have a/the same measurement quantity—i.e., a new beam RS ID/index 4; hence, according to those specified herein in the present disclosure, the UE could declare the event and initiate/trigger a beam reporting with the new beam RS ID/index 4 as a candidate report quantity/content. Among the four determined/identified EIs in FIG. 4, the two (equal to Kmin=2 in this design example) EI #1 and EI #4 have a/the same measurement quantity—i.e., a new beam RS ID/index 6, and the two (equal to Kmin=2 in this design example) EI #2 and EI #3 have a/the same measurement quantity—i.e., a new beam RS ID/index 4; hence, according to those specified herein in the present disclosure, the UE could declare the event and initiate/trigger a beam reporting with the new beam RS IDs/indexes 4 and 6 as candidate report quantities/contents.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if there is at least one common/same measurement quantity (e.g., in terms of new beam RS ID(s)/index(es)) among the first, second, . . . , and/or K-th measurement quantities as specified/defined herein in the present disclosure and/or the number of at least one of the common/same measurement quantities—denoted by/referred to as triggering measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or K-th measurement quantities as specified/defined herein in the present disclosure, and/or when/if a/the number of one or more same/common measurement quantities—denoted by/referred to as first same measurement quantity(s)—among the first, second, . . . and/or K-th measurement quantities as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . and/or K-th measurement quantities as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), k∈{1, 2, . . . , Btot} with Btot representing the maximum/total number of unique measurement quantities obtained/identified/determined from the K event instances, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as specified/defined herein in the present disclosure, and/or the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine an event instance counter specific/associated to the k-th instance of the event wherein k=1, . . . , K. The UE (e.g., higher layer(s) of the UE) could increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein l∈{1, . . . , K} and l≠k, that has at least one same measurement quantity, denoted by k′-th same measurement quantity(s) wherein k′∈{1, . . . , Btot} with Btot representing the maximum/total number of unique measurement quantities obtained/identified/determined from the K event instances, as that determined or identified for the k-th instance of the event. When/if a/the number of count(s) in at least one event instance counter as specified/defined herein in the present disclosure reaches to the maximum number of count(s)—denoted by Cmax, wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in each of the event instance counter(s) as specified/defined herein in the present disclosure to zero(s) when/if (1) the number of count(s) in the corresponding event instance counter has reached to Cmax, and/or (2) after, e.g., the last symbol/slot/etc. of, the K-th measurement instance or the K-th counting instance or the K-th instance of the event or out of the time window/period/gap/offset as specified/defined herein in the present disclosure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), . . . , the k′-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine an event instance counter specific/associated to the k-th instance of the event wherein k=1, . . . , K, . . . . The UE (e.g., higher layer(s) of the UE) could start a timer specific/associated to the k-th instance of the event and/or increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein l∈{1, . . . , K, . . . } and l≠k, that has at least one same measurement quantity, denoted by k′-th same measurement quantity(s) wherein k′∈{1, . . . , Btot} with Btot representing the maximum/total number of unique measurement quantities obtained/identified/determined from the event instances, as that determined or identified for the k-th instance of the event. When/if a/the number of count(s) in at least one event instance counter as specified/defined herein in the present disclosure reaches to the maximum number of count(s)—denoted by Cmax—before the corresponding timer expires (the corresponding same measurement quantity(s) specific/associated to the at least one event instance counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the event instance counter specific/associated to the k-th instance of the event as specified/defined herein in the present disclosure to zero and/or reset the timer specific/associated to the k-th instance of the event when/if (1) the number of count(s) in the event instance counter specific/associated to the k-th instance of the event has reached to Cmax, and/or (2) the timer specific/associated to the k-th instance of the event has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For a m-th measurement quantity, wherein m=1, 2, . . . , Btot with Btot representing the total/maximum number of unique measurement quantities obtained/identified/determined from the K event instances, the UE could determine or identify a/the number of event instance(s)—denoted by K_m≥1 out of the total number of instances of the event, i.e., K_m≤K—that have at least the m-th measurement quantity. In this case, when/if at least one of K_1, . . . , K_Btot is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, when/if K_k (k∈{1, . . . , Btot}) is less than (or greater than) or equal to a threshold (denoted by Kmax) or greater than (or less than) or equal to a threshold (denoted by Kmin), the k-th measurement quantity as defined/specified herein in the present disclosure could be regarded as one of candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine a measurement quantity counter specific/associated to a m-th measurement quantity, wherein m=1, . . . , Btot with Btot representing the total/maximum number of unique measurement quantities obtained/identified/determined from the K event instances. The UE (e.g., higher layer(s) of the UE) could increase the number of count(s), e.g., in the measurement quantity counter specific/associated to the m-th measurement quantity, by 1, when/if the UE has identified, determined or detected a/the same value of the m-th measurement quantity from any of the K event instances and therefore their corresponding/associated counting/measurement instances. When/if a/the number of count(s) in at least one measurement quantity counter as specified/defined herein in the present disclosure reaches to the maximum number of count(s)—denoted by Cmax (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero when/if (1) the number of count(s) in the measurement quantity counter specific/associated to the m-th measurement quantity has reached to Cmax, and/or (2) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine a measurement quantity counter specific/associated to a m-th measurement quantity, wherein m=1, 2, . . . , Btot, . . . with Btot representing the total/maximum number of unique measurement quantities obtained/identified/determined from the K event instances. The UE (e.g., higher layer(s) of the UE) could start a timer specific/associated to the m-th measurement quantity and/or increase the number of count(s), e.g., in the measurement quantity counter specific/associated to the m-th measurement quantity, by 1, when/if the UE has identified, determined or detected a/the same value of the m-th measurement quantity from any of the (K) event instances and therefore their corresponding/associated counting/measurement instances. When/if a/the number of count(s) in at least one measurement quantity counter as specified/defined herein in the present disclosure reaches to the maximum number of count(s)—denoted by Cmax—before the corresponding timer expires (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero and/or reset the timer specific/associated to the m-th measurement quantity when/if (1) the number of count(s) in the measurement quantity counter specific/associated to the m-th measurement quantity has reached to Cmax, and/or (2) the timer specific/associated to the m-th measurement quantity has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. One conceptual example characterizing the described/specified design procedures herein is provided in FIG. 8C. As can be seen from FIG. 8C, only the number of counts in the measurement quantity counter specific/associated to the measurement quantity of new beam RS ID/index 4 (denoted by Counter_4 in FIG. 8C) has reached to the maximum number of counts Cmax before the corresponding timer specific/associated to the measurement quantity of new beam RS ID/index 4 (denoted by Timer_4 in FIG. 8C) expires. In this case, the UE could declare the event and initiate/trigger a beam reporting with at least the new beam RS ID/index 4 as a candidate report quantity/content.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, wherein the first instance of the event (or the corresponding/associated first counting/measurement instance as specified/defined herein in the present disclosure), the second instance of the event (or the corresponding/associated second counting/measurement instance as specified/defined herein in the present disclosure), . . . , and the K-th instance of the event (or the corresponding/associated K-th measurement/counting instance as specified/defined herein in the present disclosure) could be within a t-th (e.g., t∈{1, . . . , T}) time window/period/gap/offset (e.g., in terms of number of symbols/slots/etc.), wherein the value(s) of T and/or the t-th time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if at least one of the second measurement quantity(s), . . . , at least one of the K-th measurement quantity(s) is identical to or the same as at least one of the first measurement quantity(s)—denoted by/as channel triggering condition(s)—within the t-th time window/period/gap/offset as specified/defined herein in the present disclosure, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting. In this design example, the UE (e.g., the UE 116) could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s), and K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event—within the t-th time window/period/gap/offset—as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event—denoted by K_1≥1 out of the total number of instances of the event within the t-th time window/period/gap/offset, i.e., K_1≤Kt—that have at least one same measurement quantity (denoted by first same measurement quantity(s)) is less than (or greater than) or equal to a threshold (denoted by Kmax) or greater than (or less than) or equal to a threshold (denoted by Kmin)—denoted by/referred to as channel triggering condition(s), and/or a/the number of instances of the event—denoted by K_2≥1 out of the total number of instances of the event within the t-th time window/period/gap/offset, i.e., K_2≤Kt—that have at least one same measurement quantity (denoted by second same measurement quantity(s)) is less than (or greater than) or equal to a threshold (denoted by Kmax) or greater than (or less than) or equal to a threshold (denoted by Kmin)—denoted by/referred to as channel triggering condition(s), and so on, and/or a/the number of instances of the event—denoted by K_k≥1 out of the total number of instances of the event within the t-th time window/period/gap/offset, i.e., K_k≤Kt—that have at least one same measurement quantity (denoted by k-th same measurement quantity(s)) is less than (or greater than) or equal to a threshold (denoted by Kmax) or greater than (or less than) or equal to a threshold (denoted by Kmin)—denoted by/referred to as channel triggering condition(s), wherein k∈{1, 2, . . . , Btot,t} with Btot,t representing the maximum/total number of unique measurement quantities obtained/identified/determined from the Kt event instances within the t-th time window/period/gap/offset, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event that have at least one same measurement quantity (denoted by triggering measurement quantity(s)) within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. A conceptual example characterizing the described design procedure(s) herein is presented in FIG. 9. As illustrated in FIG. 9, only within the third time window/period/gap/offset, the number of counts of the instances of the event that have at least one common measurement quantity (e.g., in term of new beam RS ID(s)/index(es)) is equal to Kmin (i.e., 4 in this example). Hence, the UE could declare the event and trigger/initiate a beam reporting after the third time window/period/offset/gap. Note there that there is a time gap/offset t_p between two adjacent time windows/periods/offsets/gaps in time, which can be configured/provided by the network, e.g., via higher layer RRC signaling/parameter (e.g., provided in higher layer parameter(s) such as CSI-ResourceConfig, CSI-ReportConfig, UEI-ReportConfig or UEI-ResourceConfig that provides necessary information/settings for the UEI beam reporting).
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure and/or the number of at least one of the common/same measurement quantities—denoted by/referred to as triggering measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by or referred to as channel trigging condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure, and/or when/if a/the number of one or more same/common measurement quantities—denoted by/referred to as first same measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by/referred to as channel triggering condition(s), k∈{1, 2, . . . , Btot} with Btot representing the maximum/total number of unique measurement quantities obtained/identified/determined from the Kt event instances within the t-th time window/period/gap/offset, and/or when/if the t-th time window/period/gap/offset ends the earliest in time than the other time window(s)/period(s)/gap(s)/offset(s) each having one or more same/common measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of same/common measurement quantity(s) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s)—within the t-th time window/period/gap/offset—as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among (all) the measurement quantities within at least one time window/period/offset/gap (e.g., the t-th time window/period/offset/gap), and/or when/if a/the number of at least one of the common/same measurement quantities (denoted by triggering measurement quantity(s)) among (all) the measurement quantities within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of common/same measurement quantity(s) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance −corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance −corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.

For the (described herein) design examples discussed/specified herein in the present disclosure, when/if a UE is configured/provided by the network, e.g., via higher layer RRC signaling/parameter, a parameter, the parameter could be provided in higher layer parameter(s) such as CSI-ResourceConfig, CSI-ReportConfig, UEI-ReportConfig or UEI-ResourceConfig that provides necessary information/settings for the UEI beam reporting. Furthermore, as specified herein in the present disclosure, for a measurement instance (or a counting instance), the UE could measure or assess one or more measurement RSs (for the current serving beam and/or one or more candidate/new beams as specified/defined herein in the present disclosure), obtain/determine/identify the corresponding measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs, and determine or identify an event instance (if any). In the present disclosure, the UE could identify or determine an instance of an event if the condition(s) of the event is achieved/satisfied.

As specified herein in the present disclosure, for a given event, a measurement quantity (and therefore, a corresponding candidate report content/quantity as defined/specified herein in the present disclosure) could correspond to a report content/quantity as specified herein in the present disclosure for the event. For instance, for the event as specified herein in the present disclosure, a measurement quantity and/or a triggering measurement quantity as specified/defined herein in the present disclosure (and therefore, a corresponding candidate report content/quantity as defined/specified herein in the present disclosure) could correspond to an identified candidate/new beam that satisfies the event condition, an identified candidate/new beam RS/RS resource/RS resource index (or the corresponding SSBRI/CRI) that satisfies the event condition, the current serving beam or the current serving beam RS/RS resource/RS resource index (or the corresponding SSBRI/CRI) that satisfies the event condition, an identified activation beam RS/RS resource/RS resource index (or the corresponding SSBRI/CRI) that satisfies the event condition, index/ID of a TCI codepoint—e.g., among the activated TCI codepoints in a (unified) TCI state(s) activation/deactivation MAC CE command—comprising/mapped to a TCI state associated/specific to the identified activation beam RS/RS resource/RS resource index that satisfies the event condition, index/ID of a TCI state—e.g., among the activated TCI states in a (unified) TCI state(s) activation/deactivation MAC CE command—associated/specific to the identified activation beam RS/RS resource/RS resource index that satisfies the event condition, a (measured/differential) L1-RSRP/L1-SINR value associated/specific to an identified candidate/new beam or candidate/new beam RS/RS resource/RS resource index (or the corresponding SSBRI/CRI) that satisfies the event condition, a (measured/differential) L1-RSRP/L1-SINR value associated/specific to the current serving beam or the current serving beam RS/RS resource/RS resource index (or the corresponding SSBRI/CRI) that satisfies the event condition, and a (measured/differential) L1-RSRP/L1-SINR value associated/specific to an identified activated beam/TCI state or activation beam RS/RS resource/RS resource index (or the corresponding SSBRI/CRI) that satisfies the event condition. Or, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more report contents/quantities as specified herein in the present disclosure for the event. For instance, for the Event as specified herein in the present disclosure, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams that satisfy the Event condition, one or more identified candidate/new beam RSs/RS resources/RS resource indexes (or the corresponding SSBRIs/CRIs) that satisfy the Event condition, the current serving beam or the current serving beam RS/RS resource/RS resource index (or the corresponding SSBRI/CRI) that satisfies the Event condition, one or more identified activation beam RSs/RS resources/RS resource indexes (or the corresponding SSBRIs/CRIs) that satisfy the event condition, indexes/IDs of one or more TCI codepoints—e.g., among the activated TCI codepoints in a (unified) TCI state(s) activation/deactivation MAC CE command—comprising/mapped to one or more TCI states associated/specific to the identified one or more activation beam RSs/RS resources/RS resource indexes that satisfy the event condition, indexes/IDs of one or more TCI states—e.g., among the activated TCI states in a (unified) TCI state(s) activation/deactivation MAC CE command—associated/specific to the identified one or more activation beam RSs/RS resources/RS resource indexes that satisfy the event condition, one or more (measured/differential) L1-RSRP/L1-SINR values associated/specific to the one or more identified candidate/new beams or candidate/new beam RSs/RS resources/RS resource indexes (or the corresponding SSBRIs/CRIs) that satisfy the event condition, one or more (measured/differential) L1-RSRP/L1-SINR values associated/specific to the one or more identified activated beams/TCI states or activation beam RSs/RS resources/RS resource indexes (or the corresponding SSBRIs/CRIs) that satisfy the event condition, and a (measured/differential) L1-RSRP/L1-SINR value associated/specific to the current serving beam or the current serving beam RS/RS resource/RS resource index (or the corresponding SSBRI/CRI) that satisfies the event condition. Across different measurement instances as described/specified herein in the present disclosure, the type of the measurement RS(s) for the candidate/new beam(s) could be the same/identical, e.g., CSI-RS(s) or SSB(s). Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), for a LTM event, a measurement quantity and/or a triggering measurement quantity as specified/defined herein in the present disclosure (and therefore, a corresponding candidate report content/quantity as defined/specified herein in the present disclosure) could correspond to an identified candidate/new beam—associated to a PCI other than the serving cell PCI or the serving cell PCI—that satisfies the LTM event condition, an identified candidate/new beam RS/RS resource/RS resource index (or the corresponding SSBRI/CRI)—associated to a PCI other than the serving cell PCI or the serving cell PCI—that satisfies the LTM event condition, the current serving beam or the current serving beam RS/RS resource/RS resource index (or the corresponding SSBRI/CRI)—associated to the serving cell PCI—that satisfies the LTM event condition, a (measured/differential) L1-RSRP/L1-SINR value associated/specific to an identified candidate/new beam or candidate/new beam RS/RS resource/RS resource index (or the corresponding SSBRI/CRI)—associated to a PCI other than the serving cell PCI or the serving cell PCI—that satisfies the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. In addition, for the LTM event, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams—associated to one or more PCIs other than the serving cell PCI or the serving cell PCI (and/or associated to one or more candidate cells other than the serving cell or the serving cell)—that satisfy the LTM event condition, one or more identified candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, the current serving beam or the current serving beam RS/RS resource/RS resource index (or the corresponding SSBRI/CRI)—associated to the serving cell PCI—that satisfies the LTM event condition, one or more (measured/differential) L1-RSRP/L1-SINR values associated/specific to the one or more identified candidate/new beams or candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. Across different measurement instances as described/specified herein in the present disclosure, the type of the measurement RS(s) for the candidate/new beam(s) could be the same/identical, e.g., CSI-RS(s) or SSB(s), and/or the measurement RS(s) for the candidate/new beam(s) could be associated to a/the same PCI (e.g., a PCI other than the serving cell PCI or the serving cell PCI)—or a/the same candidate cell (e.g., a candidate cell other than the serving cell or the serving cell)—or different PCIs (e.g., different PCIs other than the serving cell PCI or different PCIs comprising one or more PCIs other than the serving cell PCI and the serving cell PCI)—or different candidate cells (e.g., different candidate cells other than the serving cell or different candidate cells comprising one or more candidate cells other than the serving cell and the serving cell). Here, a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s).

After the UE has declared an event, the UE could trigger or initiate a (beam) reporting following those specified/described herein in the present disclosure, and transmit or send to the network a UEI (beam) report comprising at least one or more report contents/quantities (including resource indicator(s) such as SSBRI(s)/CRI(s) and the corresponding beam metric(s) such as L1-RSRP(s)/L1-SINR(s)) that satisfy/achieve the event condition(s), which could be determined according to one or more of:
In one example, the one or more report contents/quantities in the UEI (beam) report could comprise or could be determined/identified/selected from the candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   The first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more of the first candidate report content(s)/quantity(s), one or more of the second candidate report content(s)/quantity(s), . . . , and one or more of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more (e.g., M 1) of the first candidate report content(s)/quantity(s), one or more (e.g., M 1) of the second candidate report content(s)/quantity(s), . . . and one or more (e.g., M 1) of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same (e.g., the common, identical or same M≥1) components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of one or more of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of one or more (e.g., Q≥1) of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and Q could be greater than (or less than) or equal to a threshold value (denoted by Qmin). Here, the threshold value or value of Qmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise or could only be determined/identified/selected from one or more of the first candidate report content(s)/quantity(s) obtained, identified or determined by the UE at the very beginning during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise or could only be determined/identified/selected from one or more of the K-th candidate report content(s)/quantity(s) obtained, identified or determined by the UE at the very last/end during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more of the first same measurement quantity(s), the second same measurement quantity(s), . . . , and the k-th/k′-th same measurement quantity(s) as defined/specified herein in the present disclosure obtained, identified or determined by the UE during the process of event declaration or declaring an event according to or following those specified herein in the present disclosure (e.g., according to or following those described/specified in one or more examples herein), wherein k and/or k′∈{1, 2, . . . , Btot} with Btot representing the maximum/total number of unique measurement quantities obtained/identified/determined from the relevant (e.g., K) event instances. In this case, one or more of the following conditions could be achieved/satisfied (first):
   The first, second, . . . , and k-th/k′-th same measurement quantities as defined/specified herein in the present disclosure could be the same as/identical to each other
   At least one of the first same measurement quantity(s), at least one of the second same measurement quantity(s), . . . , and at least one of the k-th/k′-th same measurement quantity(s) as defined/specified herein in the present disclosure could be the same as/identical to each other
   One or more of the first, second, . . . , and k-th/k′-th same measurement quantities as defined/specified herein in the present disclosure could be different from each other
   One or more report contents/quantities corresponding to one or more of the first, second, . . . , and k-th/k′-th same measurement quantities as defined/specified herein in the present disclosure could be the same as/identical to each other
In another example, the one or more report contents/quantities in the UEI (beam) report could comprise or could be determined/identified/selected from one or more of the triggering measurement quantities as defined/specified herein in the present disclosure obtained, identified or determined by the UE during the process of event declaration or declaring an event according to or following those specified herein in the present disclosure (e.g., according to or following those described/specified in one or more examples herein), wherein the triggering measurement quantity(s) could or should satisfy or achieve the channel triggering condition(s) as specified/defined herein in the present disclosure. In this case, one or more of the following conditions could be achieved/satisfied (first):
   The triggering measurement quantities as defined/specified herein in the present disclosure could be the same as/identical to each other
   One or more of the triggering measurement quantities as defined/specified herein in the present disclosure could be the same as/identical to each other or different from each other
   One or more report contents/quantities corresponding to one or more of the triggering measurement quantities as defined/specified herein in the present disclosure could be the same as/identical to each other

As specified herein in the present disclosure, a UE (e.g., the UE 116) could trigger or initiate or send a UEI beam report based on or according to detection or declaration of the first event or Event-1 according to or following those specified herein in the present disclosure. In particular, the UE could detect or declare the first event or Event-1 according to:
The UE has identified or determined at least a same new beam (e.g., a same new/candidate beam RS or RS resource or RS index or RS resource configuration index or etc. as defined/specified herein in the present disclosure) that has a beam metric (e.g., a measured L1-RSRP/L1-SINR) a threshold value denoted by Th_diff—e.g., configured or provided by the network (e.g., the network 130) in higher layer parameter(s) CSI-ReportConfig and/or UEI-ReportConfig that provides or configures the corresponding CSI reporting setting(s) for the UE-initiated beam reporting—greater than or equal to that (e.g., a beam metric such as a measured L1-RSRP/L1-SINR) measured in/during a (same) corresponding measurement occasion as defined/specified herein in the present disclosure of a (same) TCI state/beam (e.g., a (same) activation beam RS or RS resource or RS index or RS resource configuration index or etc. associated/specific to the (same) TCI state/beam) activated in/by a (unified) TCI state(s) activation/deactivation MAC CE command at least a configurable number of times within a configurable time window/length/duration. Here, the (same) activated TCI state/beam could also be referred to as an activated reference TCI state/beam, mapped to a reference TCI codepoint in/of the (unified) TCI state(s) activation/deactivation MAC CE command. Furthermore, the (same) activation beam RS or RS resource or RS index or RS resource configuration index associated/specific to the activated reference TCI state/beam could correspond to:
   (Case-1) A CSI-RS resource or resource configuration (and therefore, the corresponding index) corresponding to (or having the same value(s) as) the QCL (source) RS or RS resource or RS resource configuration (and therefore, the corresponding index) provided or indicated in the higher layer parameter(s) TCI-State or UL-TCIState that provides or configures the activated reference TCI state/beam; or
   (Case-2) A SSB or SSB index that is QCL'ed with (or serves as a root QCL source RS to) the QCL (source) RS or RS resource or RS resource configuration (and therefore, the corresponding index) provided or indicated in the higher layer parameter(s) TCI-State or UL-TCIState that provides or configures the activated reference TCI state/beam.
In this case, the UE could determine the (same) activation beam RS or RS resource or RS index or RS resource configuration index associated/specific to the activated reference TCI state/beam following Case-1 and/or Case-2 based on or according to:
   Network's configuration(s)/indication(s), e.g., via higher layer RRC signaling(s)/parameter(s) and/or MAC CE command(s) and/or dynamic DCI based L1 signaling(s), according to or based on a corresponding UE's capability or capability signaling, and/or
   When/if the (same) new/candidate beam RS or RS resource or RS index or RS resource configuration index or etc. corresponds to a CSI-RS resource or CSI-RS resource configuration (and therefore, the corresponding index), the UE could determine the (same) activation beam RS or RS resource or RS index or RS resource configuration index associated/specific to the activated reference TCI state/beam following Case-1; otherwise, i.e., when/if the (same) new/candidate beam RS or RS resource or RS index or RS resource configuration index or etc. corresponds to a SSB or SSB index, the UE could determine the (same) activation beam RS or RS resource or RS index or RS resource configuration index associated/specific to the activated reference TCI state/beam following Case-2.
The activated reference TCI state/beam here (and therefore, the corresponding activation beam RS or RS resource or RS index or RS resource configuration index or etc. associated/specific to the activated reference TCI state/beam following those specified herein in the present disclosure) could correspond to a TCI state/beam (and therefore, the corresponding activation beam RS or RS resource or RS index or RS resource configuration index or etc. associated/specific to the TCI state/beam following those specified herein in the present disclosure) activated in/by the (unified) TCI state(s) activation/deactivation MAC CE command that has the m-th lowest (or highest) beam metric (e.g., the m-th lowest (or highest) measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command. The UE could determine or identify the value of m based on or according to:
   Fixed rule(s)/value(s) in system specification(s) or per RRC (re-)configuration; e.g., the value of m could be 1 corresponding to the lowest or highest measured L1-RSRP/L1-SINR
   Network's configuration(s)/indication(s) via higher layer RRC signaling(s)/parameter(s) and/or MAC CE command(s) and/or dynamic DCI based L1 signaling(s) based on or according to a corresponding UE's capability or capability signaling; for instance, the value of m could be provided or configured in the higher layer parameter(s)/signaling(s) CSI-ReportConfig and/or UEI-ReportConfig that provides or configures necessary setting(s) and/or configuration(s) for the UEI beam reporting

When evaluating, detecting or declaring instance(s) of the first event (or Event-1), and/or when evaluating, detecting, declaring or triggering the first event (or Event-1) following those specified herein in the present disclosure, the UE could identify or determine multiple (i.e., more than one) new/candidate beams (and therefore, multiple corresponding new/candidate beam RSs or RS resources or RS indexes or RS resource configuration indexes and/or etc. as specified herein in the present disclosure), and/or multiple (i.e., more than one) activated reference TCI states/beams (and therefore, multiple corresponding activation beam RSs or RS resources or RS indexes or RS resource configuration indexes and/or etc. as specified herein in the present disclosure) that satisfy or achieve condition(s) of the event. Furthermore, for a measurement occasion of evaluating the first event (or Event-1) wherein a UE could perform measurement(s) on the activation beam RS(s) corresponding to the activation beam RS resource(s) associated/specific to the TCI state(s)/beam(s) following those specified herein in the present disclosure activated in/by the (unified) TCI state(s) activation/deactivation MAC CE command, the UE could or may identify more than one (e.g., L>1) TCI states/beams (and therefore, the corresponding activation beam RSs or RS resources or RS indexes or RS resource configuration indexes or etc. associated/specific to the L>1 TCI states/beams following those specified herein in the present disclosure) activated in/by the (unified) TCI state(s) activation/deactivation MAC CE command that have the (same or identical) m-th lowest (or highest) beam metric (e.g., the same or identical m-th lowest (or highest) measured L1-RSRP/L1-SINR) among the beam metrics measured in/during the (same) corresponding measurement occasion as defined/specified herein in the present disclosure of the TCI states/beams—and therefore, the corresponding activation beam RSs or RS resources or RS indexes or RS resource configuration indexes or etc. associated/specific to the TCI states/beams following those specified herein in the present disclosure—activated by/in the (unified) TCI state(s) activation/deactivation MAC CE command. In addition, for a measurement occasion of evaluating the first event (or Event-1) wherein a UE could perform measurement(s) on the activation beam RS(s) corresponding to the activation beam RS resource(s) associated/specific to the TCI state(s)/beam(s) following those specified herein in the present disclosure activated in/by the (unified) TCI state(s) activation/deactivation MAC CE command, the UE could or may identify more than one (e.g., L>1) TCI states/beams (and therefore, the corresponding activation beam RSs or RS resources or RS indexes or RS resource configuration indexes or etc. associated/specific to the L>1 TCI states/beams following those specified herein in the present disclosure) activated in/by the (unified) TCI state(s) activation/deactivation MAC CE command, wherein the difference(s) between/among the beam metrics of the L>1 activated TCI states/beams could be within an offset/threshold value, and one or more of the beam metrics of the L>1 activated TCI states/beams could have the (same or identical) m-th lowest (or highest) beam metric (e.g., the same or identical m-th lowest (or highest) measured L1-RSRP/L1-SINR) among the beam metrics measured in/during the (same) corresponding measurement occasion as defined/specified herein in the present disclosure of the TCI states/beams—and therefore, the corresponding activation beam RSs or RS resources or RS indexes or RS resource configuration indexes or etc. associated/specific to the TCI states/beams following those specified herein in the present disclosure—activated by/in the (unified) TCI state(s) activation/deactivation MAC CE command; here, the UE could determine or identify the offset/threshold value according to or based on (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For the aforementioned design cases/examples, the UE could determine or identify which of the L>1 activated TCI states/beams as an activated reference TCI state/beam (and therefore, the corresponding activation beam RS or RS resource or RS index or RS resource configuration index or etc. associated/specific to the activated reference TCI state/beam following those specified herein in the present disclosure) according to or based on one or more of:
Fixed rule(s)/value(s) in system specification(s) and/or per RRC (re-)configuration: for example, the TCI state/beam with the lowest (or highest) ID/index—among the L>1 activated TCI states/beams—could correspond to the activated reference TCI state/beam; for another example, the TCI state/beam mapped to a TCI codepoint with the lowest (or highest) codepoint index/ID—among the TCI codepoints mapped to the L>1 activated TCI states/beams—could correspond to the activated reference TCI state/beam
Network's configuration(s)/indication(s) via higher layer RRC signaling(s)/parameter(s) and/or MAC CE command(s) and/or dynamic DCI based L1 signaling(s) according to or based on a corresponding UE's capability or capability signaling
UE's autonomous determination/selection, which could be further sent to the network via various UL channels/signals and/or in part of a CSI/beam report and/or UE's capability signaling

As specified herein in the present disclosure, a UE could trigger or initiate or send or transmit a UEI beam report according to or based on detection or declaration of the first event or Event-1 according to or following those specified herein in the present disclosure—i.e., when/if the UE has detected or declared the first event or Event-1. Furthermore, the UEI beam report triggered or initiated based on or according to detection or declaration of the first event or Event-1 could comprise one or more of:
Index(es) of one or more reference TCI codepoints—among the TCI codepoint(s) activated by/in the (unified) TCI state(s) activation/deactivation MAC CE command—each comprising or mapped to an activated (reference) TCI state/beam (and therefore, the corresponding activation beam RS or RS resource or RS index or RS resource configuration index or etc. associated/specific to the activated (reference) TCI state/beam following those specified herein in the present disclosure) activated in/by the (unified) TCI state(s) activation/deactivation MAC CE command that has the m-th lowest (or highest) beam metric (e.g., the m-th lowest (or highest) measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command.
   In one example, the UE could determine or identify whether or not to report in the UEI beam report the index(es) of the one or more reference TCI codepoints according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter referenceTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es) of the one or more reference TCI codepoints.
      Otherwise, i.e., when/if the higher layer parameter referenceTCICpInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter referenceTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es) of the reference TCI codepoint(s). Alternatively, the UE may or may not report in the corresponding UEI beam report the index(es) of the reference TCI codepoint(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es) of the reference TCI codepoint(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index of a reference TCI codepoint and ‘0’(s) indicating otherwise.
   In another example, when/if the number of TCI codepoint(s)/TCI state(s) activated by/in the (unified) TCI state(s) activation/deactivation MAC CE command is one (or less than or greater than or equal to a threshold), the UE may not need to report or indicate, in the corresponding UEI beam report, the index(es) of the reference TCI codepoint(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es) of the one or more reference TCI codepoints.
Index(es) of one or more activated reference TCI states (and therefore, the corresponding activation beam RS(s) or RS resource(s) or RS index(es) or RS resource configuration index(es) or etc. associated/specific to the one or more activated reference TCI states/beams following those specified herein in the present disclosure)—among the TCI states activated by/in the (unified) TCI state(s) activation/deactivation MAC CE command, and/or ID(s) of one or more activated reference TCI states (and therefore, the corresponding activation beam RS(s) or RS resource(s) or RS index(es) or RS resource configuration index(es) or etc. associated/specific to the one or more activated reference TCI states/beams following those specified herein in the present disclosure)—among the TCI states configured or provided in a higher layer configured list of TCI states/TCI state IDs e.g. provided by dl-OrJointTCI-StateL1st or ul-TCI-StateL1st, each having the m-th lowest (or highest) beam metric (e.g., the m-th lowest (or highest) measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command.
   In one example, the UE could determine or identify whether or not to report in the UEI beam report the index(es)/ID(s) of the one or more activated reference TCI states according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter referenceTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more activated reference TCI states.
      Otherwise, i.e., when/if the higher layer parameter referenceTCIStateInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter referenceTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the activated reference TCI state(s). Alternatively, the UE may or may not report in the corresponding UEI beam report the index(es)/ID(s) of the activated reference TCI state(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the activated reference TCI state(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of an activated reference TCI state and ‘0’(s) indicating otherwise.
   In another example, when/if the number of TCI codepoint(s)/TCI state(s) activated by/in the (unified) TCI state(s) activation/deactivation MAC CE command is one (or greater than or less than or equal to a threshold), the UE may not need to report or indicate, in the corresponding UEI beam report, the index(es)/ID(s) of the activated reference TCI state(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more activated reference TCI states.
Index(es)/ID(s) of one or more activation beam RSs or RS resources or RS resource configurations—e.g., in terms/form of the corresponding resource indicator(s) including SSBRI(s)/CRI(s)—associated/specific to one or more activated reference TCI states following those specified herein in the present disclosure, each having the m-th lowest (or highest) beam metric (e.g., the m-th lowest (or highest) measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command.
   In one example, the UE could determine or identify whether or not to report in the UEI beam report the index(es)/ID(s) of the one or more activation beam RSs or RS resources or RS resource configurations—e.g., in terms/form of the corresponding resource indicator(s) including SSBRI(s)/CRI(s)—according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter activationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more activation beam RSs or RS resources or RS resource configurations—e.g., in form/terms of the corresponding resource indicator(s) including SSBRI(s)/CRI(s).
      Otherwise, i.e., when/if the higher layer parameter activationBeamRsInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter activationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the activation beam RS(s) or RS resource(s) or RS resource configuration(s). Alternatively, the UE may or may not report in the corresponding UEI beam report the index(es)/ID(s) of the activation beam RS(s)/RS resource(s)/RS resource configuration(s)—e.g., in terms or form of the corresponding resource indicator(s) including SSBRI(s)/CRI(s)—according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the activation beam RS(s)/RS resource(s)/RS resource configuration(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of an activation beam RS/RS resource/RS resource configuration (e.g., in terms or form of the corresponding resource indicator such as SSBRI/CRI) and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the index(es)/ID(s) of the activation beam RS(s)/RS resource(s)/RS resource configuration(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more activation beam RSs or RS resources or RS resource configurations—e.g., in terms/form of the corresponding resource indicator(s) including SSBRI(s)/CRI(s)—associated/specific to the one or more activated reference TCI states.
First beam metric(s) including (measured) L1-RSRP(s)/L1-SINR(s) of/corresponding/specific to one or more activated reference TCI states/beams (and therefore, the corresponding activation beam RS(s) or RS resource(s) or RS resource configuration(s) as specified/defined herein in the present disclosure)
   In one example, the UE could determine or identify whether or not to report in the UEI beam report the first beam metric(s) according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter firstBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the first beam metric(s).
      Otherwise, i.e., when/if the higher layer parameter firstBeamMetricInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter firstBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the first beam metric(s). Alternatively, the UE may or may not report in the corresponding UEI beam report the first beam metric(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the first beam metric(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to a first beam metric and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the first beam metric(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
Index(es) of one or more TCI codepoints—among the TCI codepoint(s) activated by/in the (unified) TCI state(s) activation/deactivation MAC CE command—each comprising or mapped to an activated TCI state/beam (and therefore, the corresponding activation beam RS or RS resource or RS index or RS resource configuration index or etc. associated/specific to the activated TCI state/beam following those specified herein in the present disclosure) activated in/by the (unified) TCI state(s) activation/deactivation MAC CE command that has the highest/best beam metric (e.g., the highest/best measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command. The aforementioned one or more TCI codepoints could also be referred to as best TCI codepoint(s).
   In one example, the UE could determine or identify whether or not to report in the UEI beam report the index(es) of the aforementioned one or more best TCI codepoints according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter bestTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es) of the aforementioned one or more best TCI codepoints.
      Otherwise, i.e., when/if the higher layer parameter bestTCICpInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter bestTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es) of the aforementioned best TCI codepoint(s). Alternatively, the UE may or may not report in the corresponding UEI beam report the index(es) of the aforementioned best TCI codepoint(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es) of the aforementioned best TCI codepoint(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index of an aforementioned best TCI codepoint and ‘0’(s) indicating otherwise.
   In another example, when/if the number of TCI codepoint(s)/TCI state(s) activated by/in the (unified) TCI state(s) activation/deactivation MAC CE command is one (or greater than or lower than or equal to a threshold), the UE may not need to report or indicate, in the corresponding UEI beam report, the index(es) of the aforementioned best TCI codepoint(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es) of the one or more best TCI codepoints as specified/defined herein in the present disclosure.
Index(es) of one or more activated TCI states (and therefore, the corresponding activation beam RS(s) or RS resource(s) or RS index(es) or RS resource configuration index(es) or etc. associated/specific to the one or more activated TCI states/beams following those specified herein in the present disclosure)—among the TCI states activated by/in the (unified) TCI state(s) activation/deactivation MAC CE command, and/or ID(s) of one or more activated TCI states (and therefore, the corresponding activation beam RS(s) or RS resource(s) or RS index(es) or RS resource configuration index(es) or etc. associated/specific to the one or more activated TCI states/beams following those specified herein in the present disclosure)—among the TCI states configured or provided in a higher layer configured list of TCI states/TCI state IDs e.g. provided by dl-OrJointTCI-StateL1st or ul-TCI-StateL1st, each having the highest/best beam metric (e.g., the highest/best measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command. The aforementioned one or more activated TCI states could also be referred to as activated best TCI state(s).
   In one example, the UE could determine or identify whether or not to report in the UEI beam report the index(es)/ID(s) of the one or more activated best TCI states according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter bestTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more activated best TCI states.
      Otherwise, i.e., when/if the higher layer parameter bestTCIStateInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter bestTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the activated best TCI state(s). Alternatively, the UE may or may not report in the corresponding UEI beam report the index(es)/ID(s) of the activated best TCI state(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the activated best TCI state(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of an activated best TCI state and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE (e.g., the UE 116) may not need to report or indicate, in the corresponding UEI beam report, the index(es)/ID(s) of the activated best TCI state(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more activated best TCI states as specified/defined herein in the present disclosure.
Index(es)/ID(s) of one or more activation beam RSs or RS resources or RS resource configurations—e.g., in terms/form of the corresponding resource indicator(s) including SSBRI(s)/CRI(s)—associated/specific to one or more activated best TCI states following those specified herein in the present disclosure, each having the highest/best beam metric (e.g., the highest/best measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command. The aforementioned one or more activation beam RSs or RS resources or RS resource configurations could also be referred to as best activation beam RS(s) or RS resource(s) or RS resource configuration(s).
   In one example, the UE could determine or identify whether or not to report in the UEI beam report the index(es)/ID(s) of the one or more best activation beam RSs or RS resources or RS resource configurations—e.g., in terms/form of the corresponding resource indicator(s) including SSBRI(s)/CRI(s)—according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter bestActivationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more best activation beam RSs or RS resources or RS resource configurations—e.g., in form/terms of the corresponding resource indicator(s) including SSBRI(s)/CRI(s).
      Otherwise, i.e., when/if the higher layer parameter bestActivationBeamRsInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter bestActivationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the best activation beam RS(s) or RS resource(s) or RS resource configuration(s). Alternatively, the UE may or may not report in the corresponding UEI beam report the index(es)/ID(s) of the best activation beam RS(s)/RS resource(s)/RS resource configuration(s)—e.g., in terms or form of the corresponding resource indicator(s) including SSBRI(s)/CRI(s)—according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the best activation beam RS(s)/RS resource(s)/RS resource configuration(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of a best activation beam RS/RS resource/RS resource configuration (e.g., in terms or form of the corresponding resource indicator such as SSBRI/CRI) and ‘0’(s) indicating otherwise.
   In another example, when/if the number of TCI codepoint(s)/TCI state(s) activated by/in the (unified) TCI state(s) activation/deactivation MAC CE command is one (or greater than or less than or equal to a threshold), the UE may not need to report or indicate, in the corresponding UEI beam report, the index(es)/ID(s) of the best activation beam RS(s)/RS resource(s)/RS resource configuration(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more best activation beam RSs or RS resources or RS resource configurations as specified/defined herein in the present disclosure—e.g., in terms/form of the corresponding resource indicator(s) including SSBRI(s)/CRI(s)—associated/specific to the one or more activated best TCI states as specified/defined herein in the present disclosure.
Second beam metric(s) including (measured) L1-RSRP(s)/L1-SINR(s) of/corresponding/specific to one or more activated best TCI states/beams as specified/defined herein in the present disclosure (and therefore, the corresponding best activation beam RS(s) or RS resource(s) or RS resource configuration(s) as specified/defined herein in the present disclosure)
   In one example, the UE could determine or identify whether or not to report in the UEI beam report the second beam metric(s) according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter secondBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the second beam metric(s).
      Otherwise, i.e., when/if the higher layer parameter secondBeamMetricInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter secondBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the second beam metric(s). Alternatively, the UE may or may not report in the corresponding UEI beam report the second beam metric(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the second beam metric(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to a second beam metric and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the second beam metric(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
Index(es) of one or more TCI codepoints—among the TCI codepoint(s) activated by/in the (unified) TCI state(s) activation/deactivation MAC CE command—each comprising or mapped to an activated TCI state/beam (and therefore, the corresponding activation beam RS or RS resource or RS index or RS resource configuration index or etc. associated/specific to the activated TCI state/beam following those specified herein in the present disclosure) activated in/by the (unified) TCI state(s) activation/deactivation MAC CE command that has the lowest/worst beam metric (e.g., the lowest/worst measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command. The aforementioned one or more TCI codepoints could also be referred to as worst TCI codepoint(s).
   In one example, the UE could determine or identify whether or not to report in the UEI beam report the index(es) of the aforementioned one or more worst TCI codepoints according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter worstTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es) of the aforementioned one or more worst TCI codepoints.
      Otherwise, i.e., when/if the higher layer parameter worstTCICpInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter worstTCICpInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es) of the aforementioned worst TCI codepoint(s). Alternatively, the UE may or may not report in the corresponding UEI beam report the index(es) of the aforementioned worst TCI codepoint(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es) of the aforementioned worst TCI codepoint(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index of an aforementioned worst TCI codepoint and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the index(es) of the aforementioned worst TCI codepoint(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es) of the one or more worst TCI codepoints as specified/defined herein in the present disclosure.
Index(es) of one or more activated TCI states (and therefore, the corresponding activation beam RS(s) or RS resource(s) or RS index(es) or RS resource configuration index(es) or etc. associated/specific to the one or more activated TCI states/beams following those specified herein in the present disclosure)—among the TCI states activated by/in the (unified) TCI state(s) activation/deactivation MAC CE command, and/or ID(s) of one or more activated TCI states (and therefore, the corresponding activation beam RS(s) or RS resource(s) or RS index(es) or RS resource configuration index(es) or etc. associated/specific to the one or more activated TCI states/beams following those specified herein in the present disclosure)—among the TCI states configured or provided in a higher layer configured list of TCI states/TCI state IDs e.g. provided by dl-OrJointTCI-StateL1st or ul-TCI-StateL1st, each having the lowest/worst beam metric (e.g., the lowest/worst measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command. The aforementioned one or more activated TCI states could also be referred to as activated worst TCI state(s).
   In one example, the UE could determine or identify whether or not to report in the UEI beam report the index(es)/ID(s) of the one or more activated worst TCI states according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter worstTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more activated worst TCI states.
      Otherwise, i.e., when/if the higher layer parameter worstTCIStateInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter worstTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the activated worst TCI state(s). Alternatively, the UE may or may not report in the corresponding UEI beam report the index(es)/ID(s) of the activated worst TCI state(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the activated worst TCI state(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of an activated worst TCI state and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the index(es)/ID(s) of the activated worst TCI state(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more activated worst TCI states as specified/defined herein in the present disclosure.
Index(es)/ID(s) of one or more activation beam RSs or RS resources or RS resource configurations—e.g., in terms/form of the corresponding resource indicator(s) including SSBRI(s)/CRI(s)—associated/specific to one or more activated worst TCI states following those specified herein in the present disclosure, each having the lowest/worst beam metric (e.g., the lowest/worst measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command. The aforementioned one or more activation beam RSs or RS resources or RS resource configurations could also be referred to as worst activation beam RS(s) or RS resource(s) or RS resource configuration(s).
   In one example, the UE could determine or identify whether or not to report in the UEI beam report the index(es)/ID(s) of the one or more worst activation beam RSs or RS resources or RS resource configurations—e.g., in terms/form of the corresponding resource indicator(s) including SSBRI(s)/CRI(s)—according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter worstActivationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more worst activation beam RSs or RS resources or RS resource configurations—e.g., in form/terms of the corresponding resource indicator(s) including SSBRI(s)/CRI(s).
      Otherwise, i.e., when/if the higher layer parameter worstActivationBeamRsInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter worstActivationBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the worst activation beam RS(s) or RS resource(s) or RS resource configuration(s). Alternatively, the UE may or may not report in the corresponding UEI beam report the index(es)/ID(s) of the worst activation beam RS(s)/RS resource(s)/RS resource configuration(s)—e.g., in terms or form of the corresponding resource indicator(s) including SSBRI(s)/CRI(s)—according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the worst activation beam RS(s)/RS resource(s)/RS resource configuration(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of a worst activation beam RS/RS resource/RS resource configuration (e.g., in terms or form of the corresponding resource indicator such as SSBRI/CRI) and ‘0’(s) indicating otherwise.
   In another example, when/if the number of TCI codepoint(s)/TCI state(s) activated by/in the (unified) TCI state(s) activation/deactivation MAC CE command is one (or greater than or lower than or equal to a threshold), the UE may not need to report or indicate, in the corresponding UEI beam report, the index(es)/ID(s) of the worst activation beam RS(s)/RS resource(s)/RS resource configuration(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more worst activation beam RSs or RS resources or RS resource configurations as specified/defined herein in the present disclosure—e.g., in terms/form of the corresponding resource indicator(s) including SSBRI(s)/CRI(s)—associated/specific to the one or more activated worst TCI states as specified/defined herein in the present disclosure.
Third beam metric(s) including (measured) L1-RSRP(s)/L1-SINR(s) of/corresponding/specific to one or more activated worst TCI states/beams as specified/defined herein in the present disclosure (and therefore, the corresponding worst activation beam RS(s) or RS resource(s) or RS resource configuration(s) as specified/defined herein in the present disclosure)
   In one example, the UE could determine or identify whether or not to report in the UEI beam report the third beam metric(s) according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter thirdBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the third beam metric(s).
      Otherwise, i.e., when/if the higher layer parameter thirdBeamMetricInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter thirdBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the third beam metric(s). Alternatively, the UE may or may not report in the corresponding UEI beam report the third beam metric(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the third beam metric(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to a third beam metric and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the third beam metric(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
Index(es) of one or more indicated TCI states (and therefore, the corresponding current serving beam RS(s) or RS resource(s) or RS index(es) or RS resource configuration index(es) or etc. associated/specific to the one or more indicated TCI states/beams following those specified herein in the present disclosure)—e.g. among the TCI states activated by/in the (unified) TCI state(s) activation/deactivation MAC CE command, and/or ID(s) of one or more indicated TCI states (and therefore, the corresponding current serving beam RS(s) or RS resource(s) or RS index(es) or RS resource configuration index(es) or etc. associated/specific to the one or more indicated TCI states/beams following those specified herein in the present disclosure)—among the TCI states configured or provided in a higher layer configured list of TCI states/TCI state IDs e.g. provided by dl-OrJointTCI-StateL1st or ul-TCI-StateL1st.
   In one example, the UE could determine or identify whether or not to report in the UEI beam report the index(es)/ID(s) of the one or more indicated TCI states according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter currentTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more indicated TCI states.
      Otherwise, i.e., when/if the higher layer parameter currentTCIStateInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentTCIStateInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the indicated TCI state(s). Alternatively, the UE may or may not report in the corresponding UEI beam report the index(es)/ID(s) of the indicated TCI state(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the indicated TCI state(s). Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of an indicated TCI state and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the index(es)/ID(s) of the indicated TCI state(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more indicated TCI states as specified/defined herein in the present disclosure.
Index(es)/ID(s) of one or more current serving beam RSs or RS resources or RS resource configurations—e.g., in terms/form of the corresponding resource indicator(s) including SSBRI(s)/CRI(s)—associated/specific to one or more indicated TCI states following those specified herein in the present disclosure.
   In one example, the UE could determine or identify whether or not to report in the UEI beam report the index(es)/ID(s) of the one or more current serving beam RSs or RS resources or RS resource configurations—e.g., in terms/form of the corresponding resource indicator(s) including SSBRI(s)/CRI(s)—according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter currentBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the index(es)/ID(s) of the one or more current serving beam RSs or RS resources or RS resource configurations—e.g., in form/terms of the corresponding resource indicator(s) including SSBRI(s)/CRI(s).
      Otherwise, i.e., when/if the higher layer parameter currentBeamRsInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamRsInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the index(es)/ID(s) of the current serving beam RS(s) or RS resource(s) or RS resource configuration(s). Alternatively, the UE may or may not report in the corresponding UEI beam report the index(es)/ID(s) of the current serving beam RS(s)/RS resource(s)/RS resource configuration(s)—e.g., in terms or form of the corresponding resource indicator(s) including SSBRI(s)/CRI(s)—according to or based on their autonomous determination; in this case, the UE could also report or indicate in the corresponding UEI beam report presence/absence (e.g., via a one-bit indicator with ‘1’ indicating presence and ‘0’ indicating absence) of each of the index(es)/ID(s) of the current serving beam RS(s)/RS resource(s)/RS resource configuration(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to an index/ID of a current serving beam RS/RS resource/RS resource configuration (e.g., in terms or form of the corresponding resource indicator such as SSBRI/CRI) and ‘0’(s) indicating otherwise.
   In another example, when/if the number of TCI codepoint(s)/TCI state(s) activated by/in the (unified) TCI state(s) activation/deactivation MAC CE command is one (or greater than or less than or equal to a threshold), the UE may not need to report or indicate, in the corresponding UEI beam report, the index(es)/ID(s) of the current serving beam RS(s)/RS resource(s)/RS resource configuration(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s).
A/the number of the index(es)/ID(s) of the one or more current serving beam RSs or RS resources or RS resource configurations as specified/defined herein in the present disclosure—e.g., in terms/form of the corresponding resource indicator(s) including SSBRI(s)/CRI(s)—associated/specific to the one or more indicated TCI states as specified/defined herein in the present disclosure.
Fourth beam metric(s) including (measured) L1-RSRP(s)/L1-SINR(s) of/corresponding/specific to one or more indicated TCI states/beams as specified/defined herein in the present disclosure (and therefore, the corresponding current serving beam RS(s) or RS resource(s) or RS resource configuration(s) as specified/defined herein in the present disclosure)
   In one example, the UE (e.g., the UE 116) could determine or identify whether or not to report in the UEI beam report the fourth beam metric(s) according to or based on network's configuration(s)/indication(s) e.g. via higher layer RRC signaling(s)/parameter(s) and/or MAC CE command(s) and/or dynamic DCI based L1 signaling(s) according to or based on a corresponding UE's capability or capability signaling. For instance,
      When/if a higher layer parameter fourthBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in the UEI beam report the fourth beam metric(s).
      Otherwise, i.e., when/if the higher layer parameter fourthBeamMetricInReport is absent or is not present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter fourthBeamMetricInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but is set to ‘disabled’, the UE is not expected to report in the corresponding UEI beam report the fourth beam metric(s). Alternatively, the UE may or may not report in the corresponding UEI beam report the fourth beam metric(s) according to or based on their autonomous determination; in this case, the UE could also report or indicate in the corresponding UEI beam report presence/absence (e.g., via a one-bit indicator with ‘1’ indicating presence and ‘0’ indicating absence) of each of the fourth beam metric(s) as defined herein in the present disclosure. Furthermore, the UE could in addition report or indicate in the corresponding UEI beam report one or more indicators each associated/specific to a report quantity; in this case, the indicator(s) could be one-bit indicator(s) with ‘1’(s) indicating that the associated report quantity(s) corresponds to a fourth beam metric and ‘0’(s) indicating otherwise.
   In another example, when/if the number of TCI codepoint(s)/TCI state(s) activated by/in the (unified) TCI state(s) activation/deactivation MAC CE command is one (or lower than or greater than or equal to a threshold), the UE may not need to report or indicate, in the corresponding UEI beam report, the fourth beam metric(s). In this case, the UE could determine or identify the threshold value according to/based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
One or more first beam metric (e.g., measured L1-RSRP/L1-SINR) differences: a first beam metric difference denoted by firstBmDiff corresponds to a difference between a beam metric (e.g., a measured L1-RSRP/L1-SINR) denoted by newBm of an identified or determined new/candidate beam (and therefore, the corresponding new/candidate beam RS or RS resource or RS resource configuration as specified herein in the present disclosure) and a beam metric (e.g., a measured L1-RSRP/L1-SINR) denoted by refBm of an activated reference TCI state/beam (and therefore, the corresponding activation beam RS or RS resource or RS resource configuration as specified herein in the present disclosure) measured, obtained and/or evaluated in a (same) measurement occasion as specified or defined herein in the present disclosure. In this case, firstBmDiff=newBm−refBm or firstBmDiff=refBm−newBm or firstBmDiff=|newBm−refBm|. For firstBmDiff=|newBm−refBm|, a sign indicator denoted by sign(firstBmDiff)—with ‘1’ indicating positive and ‘0’ indicating negative—for a first beam metric difference could also be included in the UEI beam report associated to the corresponding first beam metric difference.
One or more second beam metric (e.g., measured L1-RSRP/L1-SINR) differences: a second beam metric difference denoted by secondBmDiff corresponds to a difference between a beam metric (e.g., a measured L1-RSRP/L1-SINR) denoted by newBm of an identified or determined new/candidate beam (and therefore, the corresponding new/candidate beam RS or RS resource or RS resource configuration as specified herein in the present disclosure) and a beam metric (e.g., a measured L1-RSRP/L1-SINR) denoted by currentBm of a/the current serving beam RS(s) or RS resource(s) or RS resource configuration(s) as specified/defined herein in the present disclosure measured, obtained and/or evaluated in a (same) measurement occasion as specified or defined herein in the present disclosure. In this case, secondBmDiff=newBm−currentBm or secondBmDiff=currentBm−newBm or secondBmDiff=|newBm−currentBm|. For secondBmDiff=|newBm−currentBm|, a sign indicator denoted by sign(secondBmDiff)—with ‘1’ indicating positive and ‘0’ indicating negative—for a second beam metric difference could also be included in the UEI beam report associated to the corresponding second beam metric difference.
One or more third beam metric (e.g., measured L1-RSRP/L1-SINR) differences: a third beam metric difference denoted by thirdBmDiff corresponds to a difference between a beam metric (e.g., a measured L1-RSRP/L1-SINR) denoted by newBm of an identified or determined new/candidate beam (and therefore, the corresponding new/candidate beam RS or RS resource or RS resource configuration as specified herein in the present disclosure) and a beam metric (e.g., a measured L1-RSRP/L1-SINR) denoted by bestBm of a TCI state/beam (and therefore, the corresponding activation beam RS or RS resource or RS index or RS resource configuration index or etc. associated/specific to the TCI state/beam following those specified herein in the present disclosure) activated in/by the (unified) TCI state(s) activation/deactivation MAC CE command that has the highest/best beam metric (e.g., the highest/best measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command measured, obtained and/or evaluated in a (same) measurement occasion as specified or defined herein in the present disclosure. In this case, thirdBmDiff=newBm−bestBm or thirdBmDiff=bestBm−newBm or thirdBmDiff=|newBm−bestBm|. For thirdBmDiff=|newBm−bestBm|, a sign indicator denoted by sign(thirdBmDiff)—with ‘1’ indicating positive and ‘0’ indicating negative—for a third beam metric difference could also be included in the UEI beam report associated to the corresponding third beam metric difference.
One or more fourth beam metric (e.g., measured L1-RSRP/L1-SINR) differences: a fourth beam metric difference denoted by fourthBmDiff corresponds to a difference between a beam metric (e.g., a measured L1-RSRP/L1-SINR) denoted by newBm of an identified or determined new/candidate beam (and therefore, the corresponding new/candidate beam RS or RS resource or RS resource configuration as specified herein in the present disclosure) and a beam metric (e.g., a measured L1-RSRP/L1-SINR) denoted by worstBm of a TCI state/beam (and therefore, the corresponding activation beam RS or RS resource or RS index or RS resource configuration index or etc. associated/specific to the TCI state/beam following those specified herein in the present disclosure) activated in/by the (unified) TCI state(s) activation/deactivation MAC CE command that has the lowest/worst beam metric among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command measured, obtained and/or evaluated in a (same) measurement occasion as specified or defined herein in the present disclosure. In this case, fourthBmDiff=newBm−worstBm or fourthBmDiff=worstBm−newBm or fourthBmDiff=|newBm−worstBm|. For fourthBmDiff=newBm−|worstBm|, a sign indicator denoted by sign(fourthBmDiff)—with ‘1’ indicating positive and ‘0’ indicating negative—for a fourth beam metric difference could also be included in the UEI beam report associated to the corresponding fourth beam metric difference.
One or more fifth beam metric (e.g., measured L1-RSRP/L1-SINR) differences: a fifth beam metric difference denoted by fifthBmDiff corresponds to a difference between a beam metric (e.g., a measured L1-RSRP/L1-SINR) denoted by refBm of an activated reference TCI state/beam (and therefore, the corresponding activation beam RS or RS resource or RS resource configuration as specified herein in the present disclosure) and a beam metric (e.g., a measured L1-RSRP/L1-SINR) denoted by currentBm of a/the current serving beam RS(s) or RS resource(s) or RS resource configuration(s) as specified/defined herein in the present disclosure measured, obtained and/or evaluated in a (same) measurement occasion as specified or defined herein in the present disclosure. In this case, fifthBmDiff=currentBm−refBm or fifthBmDiff=refBm−currentBm or fifthBmDiff=|currentBm−refBm|. For fifthBmDiff=|currentBm−refBm|, a sign indicator denoted by sign(fifthBmDiff)—with ‘1’ indicating positive and ‘0’ indicating negative—for a fifth beam metric difference could also be included in the UEI beam report associated to the corresponding fifth beam metric difference.
One or more sixth beam metric (e.g., measured L1-RSRP/L1-SINR) differences: a sixth beam metric difference denoted by sixthBmDiff corresponds to a difference between a beam metric (e.g., a measured L1-RSRP/L1-SINR) denoted by refBm of an activated reference TCI state/beam (and therefore, the corresponding activation beam RS or RS resource or RS resource configuration as specified herein in the present disclosure) and a beam metric (e.g., a measured L1-RSRP/L1-SINR) denoted by bestBm of a TCI state/beam (and therefore, the corresponding activation beam RS or RS resource or RS index or RS resource configuration index or etc. associated/specific to the TCI state/beam following those specified herein in the present disclosure) activated in/by the (unified) TCI state(s) activation/deactivation MAC CE command that has the highest/best beam metric (e.g., the highest/best measured L1-RSRP/L1-SINR) among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command measured, obtained and/or evaluated in a (same) measurement occasion as specified or defined herein in the present disclosure. In this case, sixthBmDiff=bestBm−refBm or sixthBmDiff=refBm−bestBm or sixthBmDiff=|bestBm−refBm|. For sixthBmDiff=|bestBm−refBm|, a sign indicator denoted by sign(sixthBmDiff)—with ‘1’ indicating positive and ‘0’ indicating negative—for a sixth beam metric difference could also be included in the UEI beam report associated to the corresponding sixth beam metric difference.
One or more seventh beam metric (e.g., measured L1-RSRP/L1-SINR) differences: a seventh beam metric difference denoted by seventhBmDiff corresponds to a difference between a beam metric (e.g., a measured L1-RSRP/L1-SINR) denoted by refBm of an activated reference TCI state/beam (and therefore, the corresponding activation beam RS or RS resource or RS resource configuration as specified herein in the present disclosure) and a beam metric (e.g., a measured L1-RSRP/L1-SINR) denoted by worstBm of a TCI state/beam (and therefore, the corresponding activation beam RS or RS resource or RS index or RS resource configuration index or etc. associated/specific to the TCI state/beam following those specified herein in the present disclosure) activated in/by the (unified) TCI state(s) activation/deactivation MAC CE command that has the lowest/worst beam metric among the beam metric(s) measured in/during a (same) corresponding measurement occasion as defined/specified herein in the present disclosure of the TCI state(s)/beam(s)—and therefore, the corresponding activation beam RS(s) or RS resource(s) or RS index(es) or RS resource configuration index(es) or etc. associated/specific to the TCI state(s)/beam(s) following those specified herein in the present disclosure—activated by/in the (unified) TCI state(s) activation/deactivation MAC CE command measured, obtained and/or evaluated in a (same) measurement occasion as specified or defined herein in the present disclosure. In this case, seventhBmDiff=worstBm−refBm or seventhBmDiff=refBm−worstBm or seventhBmDiff=|worstBm−refBm|. For seventhBmDiff=|worstBm−refBm|, a sign indicator denoted by sign(seventhBmDiff)—with ‘1’ indicating positive and ‘0’ indicating negative—for a seventh beam metric difference could also be included in the UEI beam report associated to the corresponding seventh beam metric difference.
One or more eighth beam metric (e.g., measured L1-RSRP/L1-SINR) differences: an eighth beam metric difference denoted by eighthBmDiff corresponds to a difference between a first beam metric difference denoted by firstBmDiff as specified/defined herein in the present disclosure and the configurable threshold value denoted by Th_diff as specified or defined herein in the present disclosure for evaluating the first event (or Event-1). In this case, eighthBmDiff=firstBmDiff−Th_diff or eighthBmDiff=Th_diff−firstBmDiff or eighthBmDiff=|firstBmDiff−Th_diff|. For eighthBmDiff=|firstBmDiff−Th_diff|, a sign indicator denoted by sign(eighthBmDiff)—with ‘1’ indicating positive and ‘0’ indicating negative—for an eighth beam metric difference could also be included in the UEI beam report associated to the corresponding eighth beam metric difference.

The UE could determine or identify which one or more of the aforementioned report quantities could be sent in a UEI beam report according to or based on one or more of
Fixed rule(s) in system specification(s) and/or RRC (re-)configuration.
Network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. For instance, a higher layer parameter could be provided in higher layer parameter(s) CSI-ReportConfig and/or UEI-ReportConfig and/or etc. that configures or provides necessary information/setting(s) for the UEI beam reporting to enable/disable reporting in a UEI beam report one or more report quantities (e.g., the first beam metric(s)) as specified/defined herein in the present disclosure. In this case, when/if the higher layer parameter is provided or present or configured and/or set to ‘enabled’, the UE could report the corresponding report quantity(s) (e.g., the first beam metric(s)) in the UEI beam report; otherwise, i.e., when/if the higher layer parameter is not provided or present or configured and/or is absent and/or is provided or present or configured but set to ‘disabled’, the UE may not report the corresponding report quantity(s) (e.g., the first beam metric(s)) in the UEI beam report, or the UE could autonomously determine whether or not to report the corresponding report quantity(s) (e.g., the first beam metric(s)) in the UEI beam report—in this case, the UE could also send or indicate, in the UEI beam report, whether or not the UE has sent or transmitted or indicated in the (same) UEI beam report, the corresponding report quantity(s) and/or which of the CSI field(s) in the (same) UEI beam report carries the corresponding report quantity(s).
UE's autonomous determination—in this case, the UE could send or indicate, in the UEI beam report, one or more indicators to indicate which one or more of the aforementioned report quantities has been included in the UEI beam report, and/or which of the CSI field(s) in the (same) UEI beam report carries the corresponding report quantity(s).

A first beam metric, a second beam metric, a third beam metric and/or a fourth beam metric as specified/defined herein in the present disclosure could correspond to a L1-RSRP. In particular, when/if the first beam metric(s), the second beam metric(s), the third beam metric(s) and/or the fourth beam metric(s) as specified/defined herein in the present disclosure is/are reported in a/the UEI beam report, and/or when/if differential L1-RSRP based reporting is enabled/configured,
When/if a reported first beam metric, second beam metric, third beam metric or fourth beam metric corresponds to the largest measured value of L1-RSRP, it is quantized to a 7-bit value in the range [−140, −44] dBm with 1 dB step size.
Else, it corresponds to a differential L1-RSRP value quantized to a 4-bit value and computed with 2 dB step with a reference to the largest measured L1-RSRP value which is part of the same L1-RSRP reporting instance, and/or with a reference to a first reference value which is part of the same L1-RSRP reporting instance.

Furthermore, when/if the first beam metric(s), the second beam metric(s), the third beam metric(s) and/or the fourth beam metric(s) as specified/defined herein in the present disclosure is/are reported in a/the UEI beam report, and/or when/if differential L1-SINR based reporting is enabled/configured,
When/if a reported first beam metric, second beam metric, third beam metric or fourth beam metric corresponds to the largest measured value of L1-SINR, it is quantized to a 7-bit value in the range [−23, −40] dB with 0.5 dB step size.
Else, it corresponds to a differential L1-SINR value quantized to a 4-bit value and computed with 1 dB step with a reference to the largest measured L1-SINR value which is part of the same L1-SINR reporting instance, and/or with a reference to a second reference value which is part of the same L1-SINR reporting instance.

In particular, the UE could determine or identify the corresponding first/second reference value according to one or more of:
The largest/highest value or the smallest/lowest value among the first beam metric(s)—e.g., when/if the first/second reference value is for a first beam metric
The largest/highest value or the smallest/lowest value among the second beam metric(s)—e.g., when/if the first/second reference value is for a second beam metric
The largest/highest value or the smallest/lowest value among the third beam metric(s)—e.g., when/if the first/second reference value is for a third beam metric
The largest/highest value or the smallest/lowest value among the fourth beam metric(s)—e.g., when/if the first/second reference value is for a fourth beam metric
The largest/highest value or the smallest/lowest value among the first and second beam metrics—e.g., when/if the first/second reference value is for a first beam metric and/or a second beam metric
The largest/highest value or the smallest/lowest value among the first and third beam metrics—e.g., when/if the first/second reference value is for a first beam metric and/or a third beam metric
The largest/highest value or the smallest/lowest value among the first and fourth beam metrics—e.g., when/if the first/second reference value is for a first beam metric and/or a fourth beam metric
The largest/highest value or the smallest/lowest value among the second and third beam metrics—e.g., when/if the first/second reference value is for a second beam metric and/or a third beam metric
The largest/highest value or the smallest/lowest value among the second and fourth beam metrics—e.g., when/if the first/second reference value is for a second beam metric and/or a fourth beam metric
The largest/highest value or the smallest/lowest value among the third and fourth beam metrics—e.g., when/if the first/second reference value is for a third beam metric and/or a fourth beam metric
The largest/highest value or the smallest/lowest value between a first beam metric and a second beam metric (denoted by the first largest/highest value or the first smallest/lowest value in the present disclosure) when/if the first beam metric and the second beam metric are used to determine or identify a reported beam metric difference as specified/defined herein in the present disclosure—e.g., when/if the first/second reference value is for a first beam metric and/or a second beam metric
The largest/highest value or the smallest/lowest value between a first beam metric and a third beam metric (denoted by the second largest/highest value or the second smallest/lowest value in the present disclosure) when/if the first beam metric and the third beam metric are used to determine or identify a reported beam metric difference as specified/defined herein in the present disclosure—e.g., when/if the first/second reference value is for a first beam metric and/or a third beam metric
The largest/highest value or the smallest/lowest value between a first beam metric and a fourth beam metric (denoted by the third largest/highest value or the third smallest/lowest value in the present disclosure) when/if the first beam metric and the fourth beam metric are used to determine or identify a reported beam metric difference as specified/defined herein in the present disclosure—e.g., when/if the first/second reference value is for a first beam metric and/or a fourth beam metric
The largest/highest value or the smallest/lowest value between a second beam metric and a third beam metric (denoted by the fourth largest/highest value or the fourth smallest/lowest value in the present disclosure) when/if the second beam metric and the third beam metric are used to determine or identify a reported beam metric difference as specified/defined herein in the present disclosure—e.g., when/if the first/second reference value is for a second beam metric and/or a third beam metric
The largest/highest value or the smallest/lowest value between a second beam metric and a fourth beam metric (denoted by the fifth largest/highest value or the fifth smallest/lowest value in the present disclosure) when/if the second beam metric and the fourth beam metric are used to determine or identify a reported beam metric difference as specified/defined herein in the present disclosure—e.g., when/if the first/second reference value is for a second beam metric and/or a fourth beam metric
The largest/highest value or the smallest/lowest value between a third beam metric and a fourth beam metric (denoted by the sixth largest/highest value or the sixth smallest/lowest value in the present disclosure) when/if the third beam metric and the fourth beam metric are used to determine or identify a reported beam metric difference as specified/defined herein in the present disclosure—e.g., when/if the first/second reference value is for a third beam metric and/or a fourth beam metric
The largest/highest value or the smallest/lowest value among the first largest/highest value(s) or the first smallest/lowest value(s) as specified/defined herein in the present disclosure
The largest/highest value or the smallest/lowest value among the second largest/highest value(s) or the second smallest/lowest value(s) as specified/defined herein in the present disclosure
The largest/highest value or the smallest/lowest value among the third largest/highest value(s) or the third smallest/lowest value(s) as specified/defined herein in the present disclosure
The largest/highest value or the smallest/lowest value among the fourth largest/highest value(s) or the fourth smallest/lowest value(s) as specified/defined herein in the present disclosure
The largest/highest value or the smallest/lowest value among the fifth largest/highest value(s) or the fifth smallest/lowest value(s) as specified/defined herein in the present disclosure
The largest/highest value or the smallest/lowest value among the sixth largest/highest value(s) or the sixth smallest/lowest value(s) as specified/defined herein in the present disclosure

A first beam metric difference, a second beam metric difference, a third beam metric difference, a fourth beam metric difference, a fifth beam metric difference, a sixth beam metric difference, a seventh beam metric difference and/or an eighth beam metric difference as specified/defined herein in the present disclosure could be based on L1-RSRP/L1-SINR. In particular, when/if the first beam metric difference(s), the second beam metric difference(s), the third beam metric difference(s), the fourth beam metric difference(s), the fifth beam metric difference(s), the sixth beam metric difference(s), the seventh beam metric difference(s) and/or the eighth beam metric difference(s) as specified/defined herein in the present disclosure is/are reported in a/the UEI beam report, and/or when/if differential L1-RSRP/L1-SINR based reporting is enabled/configured,
In one example, a reported first beam metric difference, second beam metric difference, third beam metric difference, fourth beam metric difference, fifth beam metric difference, sixth beam metric difference, seventh beam metric difference and/or eighth beam metric difference as specified/defined herein in the present disclosure could be quantized to a x_0-bit value in the range [x_1, x_2] dB with x_3 dB step size. The UE could determine or identify the value(s) of x_0, x_1, x_2 and/or x_3 according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Optionally, the value(s) of x_0, x_1, x_2 and/or x_3 could be the same/identical for or different between the first beam metric difference(s), the second beam metric difference(s), the third beam metric difference(s), the fourth beam metric difference(s), the fifth beam metric difference(s), the sixth beam metric difference(s), the seventh beam metric difference(s) and/or the eighth beam metric difference(s) as specified/defined herein in the present disclosure.
In another example, a reported first beam metric difference, second beam metric difference, third beam metric difference, fourth beam metric difference, fifth beam metric difference, sixth beam metric difference, seventh beam metric difference and/or eighth beam metric difference as specified/defined herein in the present disclosure could be quantized to a x_4-bit value and computed with x_5 dB step with a reference to a reference value which is part of the same L1-RSRP/L1-SINR reporting instance. The UE could determine or identify the value(s) of x_4, x_5 and/or the reference value according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Optionally, the value(s) of x_4, x_5 and/or the reference value could be the same/identical for or different between the first beam metric difference(s), the second beam metric difference(s), the third beam metric difference(s), the fourth beam metric difference(s), the fifth beam metric difference(s), the sixth beam metric difference(s), the seventh beam metric difference(s) and/or the eighth beam metric difference(s) as specified/defined herein in the present disclosure.
   For example, for a reported first beam metric difference and for the L1-RSRP/L1-SINR based reporting, the UE could determine or identify the corresponding reference value according to the largest/highest or smallest/lowest first beam metric difference among the reported first beam metric difference(s) in the same L1-RSRP/L1-SINR reporting instance.
   For another example, for a reported second beam metric difference and for the L1-RSRP/L1-SINR based reporting, the UE could determine or identify the corresponding reference value according to the largest/highest or smallest/lowest second beam metric difference among the reported second beam metric difference(s) in the same L1-RSRP/L1-SINR reporting instance.
   For another example, for a reported third beam metric difference and for the L1-RSRP/L1-SINR based reporting, the UE could determine or identify the corresponding reference value according to the largest/highest or smallest/lowest third beam metric difference among the reported third beam metric difference(s) in the same L1-RSRP/L1-SINR reporting instance.
   For another example, for a reported fourth beam metric difference and for the L1-RSRP/L1-SINR based reporting, the UE could determine or identify the corresponding reference value according to the largest/highest or smallest/lowest fourth beam metric difference among the reported fourth beam metric difference(s) in the same L1-RSRP/L1-SINR reporting instance.
   For another example, for a reported fifth beam metric difference and for the L1-RSRP/L1-SINR based reporting, the UE could determine or identify the corresponding reference value according to the largest/highest or smallest/lowest fifth beam metric difference among the reported fifth beam metric difference(s) in the same L1-RSRP/L1-SINR reporting instance.
   For another example, for a reported sixth beam metric difference and for the L1-RSRP/L1-SINR based reporting, the UE could determine or identify the corresponding reference value according to the largest/highest or smallest/lowest sixth beam metric difference among the reported sixth beam metric difference(s) in the same L1-RSRP/L1-SINR reporting instance.
   For another example, for a reported seventh beam metric difference and for the L1-RSRP/L1-SINR based reporting, the UE could determine or identify the corresponding reference value according to the largest/highest or smallest/lowest seventh beam metric difference among the reported seventh beam metric difference(s) in the same L1-RSRP/L1-SINR reporting instance.
   For another example, for a reported eighth beam metric difference and for the L1-RSRP/L1-SINR based reporting, the UE could determine or identify the corresponding reference value according to the largest/highest or smallest/lowest eighth beam metric difference among the reported eighth beam metric difference(s) in the same L1-RSRP/L1-SINR reporting instance.
   For another example, for a reported first beam metric difference, second beam metric difference, third beam metric difference, fourth beam metric difference, fifth beam metric difference, sixth beam metric difference, seventh beam metric difference and/or eighth beam metric difference as specified/defined herein in the present disclosure and for the L1-RSRP/L1-SINR based reporting, the UE could determine or identify the corresponding reference value according to the largest/highest or smallest/lowest value among the reported first beam metric difference(s), second beam metric difference(s), third beam metric difference(s), fourth beam metric difference(s), fifth beam metric difference(s), sixth beam metric difference(s), seventh beam metric difference(s) and/or eighth beam metric difference(s) as specified/defined herein in the present disclosure in the same L1-RSRP/L1-SINR reporting instance.
In another example, when/if the first beam metric(s), the second beam metric(s), the third beam metric(s) and/or the fourth bema metric(s) is/are in the UEI report:
   For example, in the UEI beam report, when/if two beam metrics are reported in/by two adjacent CSI fields and they are of different types (e.g., a first beam metric and a second beam metric are of different types), they can be used to determine, calculate or compute a corresponding beam metric difference as defined/specified herein in the present disclosure.
   For another example, in the UEI beam report, when/if the ordinal positions/indexes of the CSI fields that carry two beam metrics of different types are the same/identical among the CSI fields that carry their respective type of beam metric(s), the two beam metrics can be used to determine, calculate or compute a corresponding beam metric difference as defined/specified herein in the present disclosure. For instance, when/if a first beam metric is reported or carried by/in the 1^{st} CSI field or the CSI field with the lowest index among the CSI fields that carry the first beam metric(s), and when/if a fourth beam metric is reported or carried by/in the 1^{st} CSI field or the CSI field with the lowest index among the CSI fields that carry the fourth beam metric(s), the first beam metric and the fourth beam metric can be used to determine, calculate or compute a corresponding fifth beam metric difference as specified/defined herein in the present disclosure.
   For another example, the UE could send in the UEI beam report one or more indicators to indicate which of the reported first beam metric(s), and/or which of the reported second beam metric(s), and/or which of the reported third beam metric(s), and/or which of the reported fourth beam metric(s) can be used to determine, calculate or compute corresponding beam metric difference(s) as specified/defined herein in the present disclosure. For instance, each of the one or more indicators could be associated/corresponding to a reported first, second, third or fourth beam metric; in this case, when/if two indicators associated/corresponding to two reported beam metrics of different types have the same/identical value(s), the two reported beam metrics can be used to determine, calculate or compute a corresponding beam metric difference as specified/defined herein in the present disclosure. Alternatively, the one or more indicators could correspond to a bitmap with each entry/bit position of the bitmap corresponding to a reported first beam metric, second beam metric, third beam metric and/or fourth beam metric; in this case, when/if an entry/bit position of the bitmap is set to ‘1’ (or ‘0’), the first beam metric, second beam metric, third beam metric, and/or fourth beam metric associated/corresponding to the entry/bit position can be used to determine, compute or calculate the corresponding beam metric difference(s) as specified/defined herein in the present disclosure.

According to or following those specified herein in the present disclosure, the UE could identify or determine the (first/second) reference value(s) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

The first, second, third and/or fourth beam metric(s) as specified/defined herein in the present disclosure could be present or absent in a UEI beam report.
In one example, (position(s)/index(es)/ordering(s)) of the CSI field(s) in a UEI beam report to carry the first beam metric(s), (position(s)/index(es)/ordering(s)) of the CSI field(s) in a UEI beam report to carry the second beam metric(s), (position(s)/index(es)/ordering(s)) of the CSI field(s) in a UEI beam report to carry the third beam metric(s), and/or (position(s)/index(es)/ordering(s)) of the CSI field(s) in a UEI beam report to carry the fourth beam metric(s) could be fixed (e.g., per RRC (re-)configuration). For this design example, a CSI field that is supposed to carry a first, second, third or fourth beam metric could be empty, or could carry a zero, or may not carry a beam metric as defined herein in the present disclosure. When/if the CSI field(s) that is supposed to carry the first (second, third or fourth) beam metric(s) is empty, or carry/pad zero(s), or does not carry any beam metric(s), the corresponding first (second, third, fourth) beam metric(s) could be absent or may not be present in the corresponding UEI beam report.
In another example, the UE could indicate to the network, e.g., by sending, transmitting or indicating one or more indicators in a UEI beam report, whether the first beam metric(s), second beam metric(s), third beam metric(s) and/or fourth beam metric(s) is/are absent or present in a UEI beam report. For example, each of the one or more indicators could be a one-bit indicator corresponding to a type of beam metric(s)—e.g., the first beam metric(s) as specified/defined herein in the present disclosure; when/if a one-bit indicator is set to ‘1’ (or ‘0’), the corresponding type of beam metric(s)—e.g., the first beam metric(s)—could be present in the UEI beam report; otherwise, i.e., when/if the one-bit indicator is set to ‘0’ (or ‘1’), the corresponding type of beam metric(s)—e.g., the first beam metric(s)—could be absent in the UEI beam report. For another example, the one or more indicators could correspond to a bitmap with each entry/bit position of the bitmap corresponding to a type of beam metric(s)—e.g., the first beam metric(s) as specified/defined herein in the present disclosure; for this design example, when/if an entry/bit position of the bitmap is set to ‘1’ (or ‘0’), the corresponding type of beam metric(s)—e.g., the first beam metric(s)—associated to the entry/bit position could be present in the UEI beam report; otherwise, i.e., when/if an entry/bit position of the bitmap is set to ‘0’ (or ‘1’), the corresponding type of beam metric(s)—e.g., the first beam metric(s)—associated to the entry/bit position could be absent in the UEI beam report.

Furthermore, the UE could indicate, transmit or send in a/the UEI beam report a/the number of the reported first beam metric(s) in the UEI beam report, a/the number of the reported second beam metric(s) in the UEI beam report, a/the number of the reported third beam metric(s) in the UEI beam report, and/or a/the number of the reported fourth beam metric(s) in the UEI beam report.

The first, second, third, fourth, fifth, sixth, seventh and/or eighth beam metric difference(s) as specified/defined herein in the present disclosure could be present or absent in a UEI beam report.
In one example, (position(s)/index(es)/ordering(s)) of the CSI field(s) in a UEI beam report to carry the first (second, third, fourth, fifth, sixth, seventh and/or eighth) beam metric difference(s), could be fixed (e.g., per RRC (re-)configuration). For this design example, a CSI field that is supposed to carry a first (second, third, fourth, fifth, sixth, seventh and/or eighth) beam metric difference could be empty, or could carry a zero, or may not carry a beam metric difference as defined herein in the present disclosure. When/if the CSI field(s) that is supposed to carry the first (second, third, fourth, fifth, sixth, seventh and/or eighth) beam metric difference(s) is empty, or carry/pad zero(s), or does not carry any beam metric difference(s), the corresponding first (second, third, fourth, fifth, sixth, seventh and/or eighth) beam metric difference(s) could be absent or may not be present in the corresponding UEI beam report.
In another example, the UE (e.g., the UE 116) could indicate to the network (e.g., the network 130), e.g., by sending, transmitting or indicating one or more indicators in a UEI beam report, whether the first (second, third, fourth, fifth, sixth, seventh and/or eighth) beam metric difference(s) is/are absent or present in a UEI beam report. For example, each of the one or more indicators could be a one-bit indicator corresponding to a type of beam metric difference(s)—e.g., the first beam metric difference(s) as specified/defined herein in the present disclosure; when/if a one-bit indicator is set to ‘1’ (or ‘0’), the corresponding type of beam metric difference(s)—e.g., the first beam metric difference(s)—could be present in the UEI beam report; otherwise, i.e., when/if the one-bit indicator is set to ‘0’ (or ‘1’), the corresponding type of beam metric difference(s)—e.g., the first beam metric difference(s)—could be absent in the UEI beam report. For another example, the one or more indicators could correspond to a bitmap with each entry/bit position of the bitmap corresponding to a type of beam metric difference(s)—e.g., the first beam metric difference(s) as specified/defined herein in the present disclosure; for this design example, when/if an entry/bit position of the bitmap is set to ‘1’ (or ‘0’), the corresponding type of beam metric difference(s)—e.g., the first beam metric difference(s)—associated to the entry/bit position could be present in the UEI beam report; otherwise, i.e., when/if an entry/bit position of the bitmap is set to ‘0’ (or ‘1’), the corresponding type of beam metric difference(s)—e.g., the first beam metric difference(s)—associated to the entry/bit position could be absent in the UEI beam report.

Furthermore, the UE could indicate, transmit or send in a/the UEI beam report a/the number of the reported first (second, third, fourth, fifth, sixth, seventh and/or eighth) beam metric difference(s) in the UEI beam report.

During/in the process of evaluating, detecting or declaring the first event (or Event-1) as specified/defined herein in the present disclosure, and/or triggering, initiating, sending or transmitting a UEI beam report based on or according to evaluation, detection or declaration of the first event or Event-1 according to or following those specified herein in the present disclosure, for a/the same identified/determined new/candidate beam (and therefore, the corresponding new/candidate beam RS or RS resource or RS index or RS resource configuration index and/or etc. as specified herein in the present disclosure), and/or for a/the same identified/determined activated reference TCI state/beam (and therefore, the corresponding activation beam RS or RS resource or RS index or RS resource configuration index and/or etc. as specified herein in the present disclosure), and/or for a/the same indicated TCI state (and therefore, the corresponding current serving beam RS or RS resource or RS resource configuration associated/specific to the indicated TCI state as specified herein in the present disclosure), and/or for a/the same identified/determined activated TCI state/beam with the best/highest/largest beam metric denoted by bestBm (and therefore, the corresponding activation beam RS or RS resource or RS index or RS resource configuration index and/or etc. as specified herein in the present disclosure), and/or for a/the same identified/determined activated TCI state/beam with the worst/lowest/smallest beam metric denoted by worstBm (and therefore, the corresponding activation beam RS or RS resource or RS index or RS resource configuration index and/or etc. as specified herein in the present disclosure), when/if the first (second, third or fourth) beam metric(s) is to be reported in a UEI beam report according to or following those specified herein in the present disclosure, and/or when/if the UE has determined or identified more than one (e.g., Q>1) first (second, third or fourth) beam metrics across or among one or more of the measurement occasions during/in the process of evaluating, detecting or declaring the first event (or Event-1) as specified/defined herein in the present disclosure, and/or triggering, initiating, sending or transmitting a UEI beam report based on or according to evaluation, detection or declaration of the first event or Event-1 according to or following those specified herein in the present disclosure, the UE could determine or identify which of the determined or identified Q>1 first (second, third or fourth) beam metrics to report in the corresponding UEI beam report according to or based on one or more of:
Fixed rule(s)/value(s) in system specification(s) and/or per RRC (re-)configuration: for example, the UE could include, indicate, transmit, send or report in the corresponding UEI beam report the first (second, third or fourth) beam metric(s) with the highest/largest value(s)—among the determined/identified Q>1 first (second, third or fourth) beam metrics; for another example, the UE could include, indicate, transmit, send or report in the corresponding UEI beam report the first (second, third or fourth) beam metric(s) determined, identified or measured the latest in time—among the determined/identified Q>1 first (second, third or fourth) beam metrics; for another example, the UE could include, indicate, transmit, send or report in the corresponding UEI beam report the first (second, third or fourth) beam metric(s) determined, identified or measured the earliest in time—among the determined/identified Q>1 first (second, third or fourth) beam metrics; for another example, the UE could include, indicate, transmit, send or report in the corresponding UEI beam report an average value of the determined/identified Q>1 first (second, third or fourth) beam metrics.
Network's configuration(s)/indication(s) via higher layer RRC signaling(s)/parameter(s) and/or MAC CE command(s) and/or dynamic DCI based L1 signaling(s) according to or based on a corresponding UE's capability or capability signaling. For example, the UE could be indicated/configured by the network, e.g., via higher layer RRC signaling(s)/parameter(s) and/or MAC CE command(s) and/or dynamic DCI based L1 signaling(s) to include, indicate, transmit, send or report in the corresponding UEI beam report the first (second, third or fourth) beam metric(s) with the n-th highest/largest value(s)—among the determined/identified Q>1 first (second, third or fourth) beam metrics, wherein the UE could determine or identify the value(s) of n according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
UE's autonomous determination/selection, which could be further sent to the network via various UL channels/signals and/or in part of a CSI/beam report and/or UE's capability signaling.

During/in the process of evaluating, detecting or declaring the first event (or Event-1) as specified/defined herein in the present disclosure, and/or triggering, initiating, sending or transmitting a UEI beam report based on or according to evaluation, detection or declaration of the first event or Event-1 according to or following those specified herein in the present disclosure, for a/the same identified/determined new/candidate beam (and therefore, the corresponding new/candidate beam RS or RS resource or RS index or RS resource configuration index and/or etc. as specified herein in the present disclosure), and/or for a/the same identified/determined activated reference TCI state/beam (and therefore, the corresponding activation beam RS or RS resource or RS index or RS resource configuration index and/or etc. as specified herein in the present disclosure), and/or for a/the same indicated TCI state (and therefore, the corresponding current serving beam RS or RS resource or RS resource configuration associated/specific to the indicated TCI state as specified herein in the present disclosure), and/or for a/the same identified/determined activated TCI state/beam with the best/highest/largest beam metric denoted by bestBm (and therefore, the corresponding activation beam RS or RS resource or RS index or RS resource configuration index and/or etc. as specified herein in the present disclosure), and/or for a/the same identified/determined activated TCI state/beam with the worst/lowest/smallest beam metric denoted by worstBm (and therefore, the corresponding activation beam RS or RS resource or RS index or RS resource configuration index and/or etc. as specified herein in the present disclosure), when/if the first (second, third, fourth, fifth, sixth, seventh or eighth) beam metric difference(s) is to be reported in a UEI beam report according to or following those specified herein in the present disclosure, and/or when/if the UE has determined or identified more than one (e.g., R>1) first (second, third, fourth, fifth, sixth, seventh or eighth) beam metric differences across or among one or more of the measurement occasions during/in the process of evaluating, detecting or declaring the first event (or Event-1) as specified/defined herein in the present disclosure, and/or triggering, initiating, sending or transmitting a UEI beam report based on or according to evaluation, detection or declaration of the first event or Event-1 according to or following those specified herein in the present disclosure, the UE could determine or identify which of the determined or identified R>1 first (second, third, fourth, fifth, sixth, seventh or eighth) beam metric differences to report in the corresponding UEI beam report according to or based on one or more of
Fixed rule(s)/value(s) in system specification(s) and/or per RRC (re-)configuration: for example, the UE could include, indicate, transmit, send or report in the corresponding UEI beam report the first (second, third, fourth, fifth, sixth, seventh or eighth) beam metric difference(s) with the highest/largest (or lowest/smallest) value(s)—among the determined/identified R>1 first (second, third, fourth, fifth, sixth, seventh or eighth) beam metric differences; for another example, the UE could include, indicate, transmit, send or report in the corresponding UEI beam report the first (second, third, fourth, fifth, sixth, seventh or eighth) beam metric difference(s) determined, identified or measured the latest in time—among the determined/identified R>1 first (second, third, fourth, fifth, sixth, seventh or eighth) beam metric differences; for another example, the UE could include, indicate, transmit, send or report in the corresponding UEI beam report the first (second, third, fourth, fifth, sixth, seventh or eighth) beam metric difference(s) determined, identified or measured the earliest in time—among the determined/identified R>1 first (second, third, fourth, fifth, sixth, seventh or eighth) beam metric differences; for another example, the UE could include, indicate, transmit, send or report in the corresponding UEI beam report an average value of the determined/identified R>1 first (second, third, fourth, fifth, sixth, seventh or eighth) beam metric differences.
Network's configuration(s)/indication(s) via higher layer RRC signaling(s)/parameter(s) and/or MAC CE command(s) and/or dynamic DCI based L1 signaling(s) according to or based on a corresponding UE's capability or capability signaling. For example, the UE could be indicated/configured by the network, e.g., via higher layer RRC signaling(s)/parameter(s) and/or MAC CE command(s) and/or dynamic DCI based L1 signaling(s) to include, indicate, transmit, send or report in the corresponding UEI beam report the first (second, third, fourth, fifth, sixth, seventh or eighth) beam metric difference(s) with the n′-th highest/largest (or lowest/smallest) value(s)—among the determined/identified R>1 first (second, third, fourth, fifth, sixth, seventh or eighth) beam metric differences, wherein the UE could determine or identify the value(s) of n′ according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
UE's autonomous determination/selection, which could be further sent to the network via various UL channels/signals and/or in part of a CSI/beam report and/or UE's capability signaling.

When/if a UE is configured or provided by the network, e.g., via higher layer RRC signaling(s)/parameter(s) and/or MAC CE command(s) and/or dynamic DCI based L1 signaling(s) based on or according to a corresponding UE's capability or capability signaling, that the first event (or Event-1) as defined herein in the present disclosure is enabled, e.g., when/if a higher layer parameter eventType provided or configured in higher layer parameter(s) CSI-ReportConfig and/or UEI-ReportConfig that provides or configures necessary information and/or setting(s) for the UEI beam reporting is set to ‘firstEvent’, ‘event-1’ and/or a corresponding/relevant value, the UE could evaluate, detect or declare the first event (or Event-1)—and therefore, the corresponding instance(s) of the first event (or Event-1)—as specified/defined herein in the present disclosure, and/or trigger, initiate, send or transmit a UEI beam report based on or according to evaluation, detection or declaration of the first event or Event-1 when/if one or more of the following conditions/requirements are satisfied or achieved:
The number of TCI codepoint(s) activated/provided/indicated in the corresponding (unified) TCI state(s) activation/deactivation (MAC CE) command is greater/larger (or lower/smaller) than or equal to a first value/number, wherein the UE could determine or identify the first value/number according to or based on: (i) fixed value(s) in system specification(s) and/or per RRC (re-)configuration—e.g., the first value/number could be 1, 2, 3, 4, 6, 7, 8 or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)). That is, when/if the number of TCI codepoint(s) activated/provided/indicated in the corresponding (unified) TCI state(s) activation/deactivation (MAC CE) command is lower/smaller (or greater/larger) than or equal to a second value/number, the UE may not or is not expected to perform evaluating, detecting or declaring the first event (or Event-1)—and therefore, the corresponding instance(s) of the first event (or Event-1)—as specified/defined herein in the present disclosure, and/or triggering, initiating, sending or transmitting a UEI beam report based on or according to evaluation, detection or declaration of the first event or Event-1, wherein the UE could determine or identify the second value/number according to or based on: (i) fixed value(s) in system specification(s) and/or per RRC (re-)configuration—e.g., the second value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
The number of TCI state(s)/beam(s)—and therefore, the number of beam activation RS(s) or RS resource(s) or RS index(es) or RS resource configuration index(es) associated/specific to the TCI state(s)/beam(s) according to or following those specified/defined herein in the present disclosure—activated/provided/indicated in the corresponding (unified) TCI state(s) activation/deactivation (MAC CE) command is greater/larger (or lower/smaller) than or equal to a first value/number, wherein the UE could determine or identify the first value/number according to or based on: (i) fixed value(s) in system specification(s) and/or per RRC (re-)configuration—e.g., the first value/number could be 1, 2, 3, 4, 6, 7, 8 or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)). That is, when/if the number of TCI state(s)/beam(s)—and therefore, the number of beam activation RS(s) or RS resource(s) or RS index(es) or RS resource configuration index(es) associated/specific to the TCI state(s)/beam(s) according to or following those specified/defined herein in the present disclosure—activated/provided/indicated in the corresponding (unified) TCI state(s) activation/deactivation (MAC CE) command is lower/smaller (or greater/larger) than or equal to a second value/number, the UE may not or is not expected to perform evaluating, detecting or declaring the first event (or Event-1)—and therefore, the corresponding instance(s) of the first event (or Event-1)—as specified/defined herein in the present disclosure, and/or triggering, initiating, sending or transmitting a UEI beam report based on or according to evaluation, detection or declaration of the first event or Event-1, wherein the UE could determine or identify the second value/number according to or based on: (i) fixed value(s) in system specification(s) and/or per RRC (re-)configuration—e.g., the second value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined second beam metric difference as specified/defined herein in the present disclosure is greater/larger (or lower/smaller) than or equal to a first threshold, and/or the number of identified/determined second beam metric difference(s) as defined/specified herein in the present disclosure greater/larger (or lower/smaller) than or equal to the first threshold is greater/larger (or lower/smaller) than or equal to a first value/number, wherein the UE could determine or identify the first threshold and/or the first value/number here according to or based on: (i) fixed value(s) in system specification(s) and/or per RRC (re-)configuration—e.g., the first value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the first threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined third beam metric difference as specified/defined herein in the present disclosure is greater/larger (or lower/smaller) than or equal to a second threshold, and/or the number of identified/determined third beam metric difference(s) as defined/specified herein in the present disclosure greater/larger (or lower/smaller) than or equal to the second threshold is greater/larger (or lower/smaller) than or equal to a second value/number, wherein the UE could determine or identify the second threshold and/or the second value/number here according to or based on: (i) fixed value(s) in system specification(s) and/or per RRC (re-)configuration—e.g., the second value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the second threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined fourth beam metric difference as specified/defined herein in the present disclosure is greater/larger (or lower/smaller) than or equal to a third threshold, and/or the number of identified/determined fourth beam metric difference(s) as defined/specified herein in the present disclosure greater/larger (or lower/smaller) than or equal to the third threshold is greater/larger (or lower/smaller) than or equal to a third value/number, wherein the UE could determine or identify the third threshold and/or the third value/number here according to or based on: (i) fixed value(s) in system specification(s) and/or per RRC (re-)configuration—e.g., the third value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the third threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined fifth beam metric difference as specified/defined herein in the present disclosure is greater/larger (or lower/smaller) than or equal to a fourth threshold, and/or the number of identified/determined fourth beam metric difference(s) as defined/specified herein in the present disclosure greater/larger (or lower/smaller) than or equal to the fourth threshold is greater/larger (or lower/smaller) than or equal to a fourth value/number, wherein the UE could determine or identify the fourth threshold and/or the fourth value/number here according to or based on: (i) fixed value(s) in system specification(s) and/or per RRC (re-)configuration—e.g., the fourth value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the fourth threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined sixth beam metric difference as specified/defined herein in the present disclosure is greater/larger (or lower/smaller) than or equal to a fifth threshold, and/or the number of identified/determined sixth beam metric difference(s) as defined/specified herein in the present disclosure greater/larger (or lower/smaller) than or equal to the fifth threshold is greater/larger (or lower/smaller) than or equal to a fifth value/number, wherein the UE could determine or identify the fifth threshold and/or the fifth value/number here according to or based on: (i) fixed value(s) in system specification(s) and/or per RRC (re-)configuration—e.g., the fifth value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the fifth threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined seventh beam metric difference as specified/defined herein in the present disclosure is greater/larger (or lower/smaller) than or equal to a sixth threshold, and/or the number of identified/determined seventh beam metric difference(s) as defined/specified herein in the present disclosure greater/larger (or lower/smaller) than or equal to the sixth threshold is greater/larger (or lower/smaller) than or equal to a sixth value/number, wherein the UE could determine or identify the sixth threshold and/or the sixth value/number here according to or based on: (i) fixed value(s) in system specification(s) and/or per RRC (re-)configuration—e.g., the sixth value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the sixth threshold here could correspond to Th_diff as defined herein in the present disclosure, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).
At least one identified or determined eighth beam metric difference as specified/defined herein in the present disclosure is greater/larger (or lower/smaller) than or equal to a seventh threshold, and/or the number of identified/determined eighth beam metric difference(s) as defined/specified herein in the present disclosure greater/larger (or lower/smaller) than or equal to the seventh threshold is greater/larger (or lower/smaller) than or equal to a seventh value/number, wherein the UE could determine or identify the seventh threshold and/or the seventh value/number here according to or based on: (i) fixed value(s) in system specification(s) and/or per RRC (re-)configuration—e.g., the seventh value/number could be 1, 2, 3, 4, or etc.; (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)).

According to or following those specified herein in the present disclosure,
In one example, for a measurement occasion of evaluating, assessing, detecting or declaring the first event (or Event-1) as specified/defined herein in the present disclosure—and therefore, the corresponding instance(s) of the first event (or Event-1), the UE could measure, evaluate or assess the radio link/beam quality(s)—e.g., L1-RSRP(s)/L1-SINR(s)—of one or more RSs corresponding to or comprising the beam activation RS(s), RS resource(s), RS resource configuration(s), RS index(es) or RS resource configuration index(es) associated/specific to the TCI state(s)/beam(s) according to or following those specified herein in the present disclosure activated/provided/indicated in/by a/the (unified) TCI state(s) activation/deactivation (MAC CE) command, and/or compare the measured, evaluated or assessed radio link/beam quality(s) of the one or more RSs with measured, evaluated or assessed radio link/beam quality(s)—e.g., L1-RSRP(s)/L1-SINR(s)—of a (same) reference activated TCI state/beam as specified/defined herein in the present disclosure (and therefore, the corresponding activation beam RS or RS resource or RS index or RS resource configuration index associated/specific to the reference activated TCI state/beam according to or following those specified herein in the present disclosure).
In another example, for a measurement occasion of evaluating, assessing, detecting or declaring the first event (or Event-1) as specified/defined herein in the present disclosure—and therefore, the corresponding instance(s) of the first event (or Event-1), the UE could measure, evaluate or assess the radio link/beam quality(s)—e.g., L1-RSRP(s)/L1-SINR(s)—of one or more RSs each corresponding to a beam activation RS, RS resource, RS resource configuration, RS index or RS resource configuration index associated/specific to a TCI state/beam according to or following those specified herein in the present disclosure activated/provided/indicated in/by a/the (unified) TCI state(s) activation/deactivation (MAC CE) command, wherein the one or more RSs could comprise the beam activation RS(s), RS resource(s), RS resource configuration(s), RS index(es) or RS resource configuration index(es) associated/specific to the TCI state(s)/beam(s) according to or following those specified herein in the present disclosure activated/provided/indicated in/by a/the (unified) TCI state(s) activation/deactivation (MAC CE) command, and/or compare the measured, evaluated or assessed radio link/beam quality(s) of the one or more RSs with measured, evaluated or assessed radio link/beam quality(s)—e.g., L1-RSRP(s)/L1-SINR(s)—of a (same) reference activated TCI state/beam as specified/defined herein in the present disclosure (and therefore, the corresponding activation beam RS or RS resource or RS index or RS resource configuration index associated/specific to the reference activated TCI state/beam according to or following those specified herein in the present disclosure).
In another example, for a measurement occasion of evaluating, assessing, detecting or declaring the first event (or Event-1) as specified/defined herein in the present disclosure—and therefore, the corresponding instance(s) of the first event (or Event-1), the UE could measure, evaluate or assess the radio link/beam quality(s) of one or more RSs each corresponding to a beam activation RS, RS resource, RS resource configuration, RS index or RS resource configuration index associated/specific to a different TCI state/beam according to or following those specified herein in the present disclosure activated/provided/indicated in/by a/the (unified) TCI state(s) activation/deactivation (MAC CE) command, and/or compare the measured, evaluated or assessed radio link/beam quality(s) of the one or more RSs with measured, evaluated or assessed radio link/beam quality(s)—e.g., L1-RSRP(s)/L1-SINR(s)—of a (same) reference activated TCI state/beam as specified/defined herein in the present disclosure (and therefore, the corresponding activation beam RS or RS resource or RS index or RS resource configuration index associated/specific to the reference activated TCI state/beam according to or following those specified herein in the present disclosure).
In another example, a measurement occasion could comprise at least one RS corresponding to a beam activation RS, RS resource, RS resource configuration, RS index or RS resource configuration index associated/specific to each of the TCI state(s)/beam(s) according to or following those specified herein in the present disclosure activated/provided/indicated by/in a/the (unified) TCI state(s) activation/deactivation (MAC CE) command.

When/if a UE is configured or provided by the network, e.g., via higher layer RRC signaling(s)/parameter(s) and/or MAC CE command(s) and/or dynamic DCI based L1 signaling(s) based on or according to a corresponding UE's capability or capability signaling, that the first event (or Event-1) as defined herein in the present disclosure is enabled, e.g., when/if a higher layer parameter eventType provided or configured in higher layer parameter(s) CSI-ReportConfig and/or UEI-ReportConfig that provides or configures necessary information and/or setting(s) for the UEI beam reporting is set to ‘firstEvent’, ‘event-1’ and/or a corresponding/relevant value, the UE could be configured or provided by the network, e.g., via higher layer RRC signaling(s)/parameter(s) and/or MAC CE command(s) and/or dynamic DCI based L1 signaling(s) based on or according to a corresponding UE's capability or capability signaling, a/the number (denoted by nrofReportedRS-UEIBR) of resource indicator(s) including SSBRI(s) and/or CRI(s)—and therefore, a/the corresponding number of beam metric(s) including L1-RSRP(s)/L1-SINR(s)—that the UE could report in a single report/reporting instance for each report setting for the UE-initiated beam reporting.
The reported nrofReportedRS-UEIBR (higher layer configured) resource indicator(s) in a single report/reporting instance for each report setting for the UE-initiated beam reporting could comprise at least one resource indicator e.g. a SSBRI or a CRI (and therefore, a corresponding beam metric including L1-RSRP/L1-SINR) corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the following conditions (or condition(s) of the first event or Event-1 as specified/defined herein in the present disclosure):
   The beam metric (e.g., a measured L1-RSRP/L1-SINR) of the new beam RS or RS resource is a threshold value denoted by Th_diff_0—e.g., configured or provided by the network in higher layer parameter(s) CSI-ReportConfig and/or UEI-ReportConfig that provides or configures the corresponding CSI reporting setting(s) for the UE-initiated beam reporting—greater than or equal to that (e.g., a beam metric such as a measured L1-RSRP/L1-SINR) measured in/during a (same) corresponding measurement occasion as defined/specified herein in the present disclosure of a (same) reference activated TCI state/beam (and therefore, a/the corresponding (same) activation beam RS or RS resource or RS index or RS resource configuration index or etc. associated/specific to the (same) reference activated TCI state/beam) activated in/by a (unified) TCI state(s) activation/deactivation MAC CE command at least a configurable number of times (M_0) within a configurable time window/length/duration (T_0).
   A UE could identify an instance of the first event (or Event-1) based on or according to: the beam metric (e.g., a measured L1-RSRP/L1-SINR) of the new beam RS or RS resource is a threshold value denoted by Th_diff_0—e.g., configured or provided by the network in higher layer parameter(s) CSI-ReportConfig and/or UEI-ReportConfig that provides or configures the corresponding CSI reporting setting(s) for the UE-initiated beam reporting—greater than or equal to that (e.g., a beam metric such as a measured L1-RSRP/L1-SINR) measured in/during a (same) corresponding measurement occasion as defined/specified herein in the present disclosure of a reference activated TCI state/beam (and therefore, a/the corresponding activation beam RS or RS resource or RS index or RS resource configuration index or etc. associated/specific to the reference activated TCI state/beam) activated in/by a (unified) TCI state(s) activation/deactivation MAC CE command, and the UE has identified such instance(s) of the first event (or Event-1) at least a configurable number of times (M_O) within a configurable time window/length/duration (T_0), wherein the identified or determined reference activated TCI state(s)/beam(s)—and therefore, the corresponding activation beam RS(s), RS resource(s), RS index(es), RS resource configuration index(es) and/or etc. associated/specific to the identified/determined reference activated TCI state(s)/beam(s)—across, within or during the identified instance(s) of the first event (or Event-1) could be different.
   The beam metric (e.g., a measured L1-RSRP/L1-SINR) of the new beam RS or RS resource is a threshold value denoted by Th_diff_1—e.g., configured or provided by the network in higher layer parameter(s) CSI-ReportConfig and/or UEI-ReportConfig that provides or configures the corresponding CSI reporting setting(s) for the UE-initiated beam reporting—greater than or equal to that (e.g., a beam metric such as a measured L1-RSRP/L1-SINR) measured in/during a (same) corresponding measurement occasion as defined/specified herein in the present disclosure of a (same) worst activation beam RS or RS resource associated/specific to a (same) TCI state/beam having the lowest/worst beam metric (e.g., the lowest/worst measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command at least a configurable number of times (M_1) within a configurable time window/length/duration (T_1).
   A UE could identify an instance of the first event (or Event-1) based on or according to: the beam metric (e.g., a measured L1-RSRP/L1-SINR) of the new beam RS or RS resource is a threshold value denoted by Th_diff_1—e.g., configured or provided by the network in higher layer parameter(s) CSI-ReportConfig and/or UEI-ReportConfig that provides or configures the corresponding CSI reporting setting(s) for the UE-initiated beam reporting—greater than or equal to that (e.g., a beam metric such as a measured L1-RSRP/L1-SINR) measured in/during a (same) corresponding measurement occasion as defined/specified herein in the present disclosure of a worst activation beam RS or RS resource associated/specific to an activated TCI state/beam having the lowest/worst beam metric (e.g., the lowest/worst measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command, and the UE has identified such instance(s) of the first event (or Event-1) at least a configurable number of times (M_1) within a configurable time window/length/duration (T_1), wherein the identified or determined activated TCI state(s)/beam(s)—and therefore, the corresponding worst activation beam RS(s), RS resource(s), RS index(es), RS resource configuration index(es) and/or etc. associated/specific to the identified/determined activated TCI state(s)/beam(s)—across, within or during the identified instance(s) of the first event (or Event-1) could be different.
   The beam metric (e.g., a measured L1-RSRP/L1-SINR) of the new beam RS or RS resource is a threshold value denoted by Th_diff_2—e.g., configured or provided by the network in higher layer parameter(s) CSI-ReportConfig and/or UEI-ReportConfig that provides or configures the corresponding CSI reporting setting(s) for the UE-initiated beam reporting—lower than or equal to that (e.g., a beam metric such as a measured L1-RSRP/L1-SINR) measured in/during a (same) corresponding measurement occasion as defined/specified herein in the present disclosure of a (same) best activation beam RS or RS resource associated/specific to a (same) TCI state/beam having the highest/best beam metric (e.g., the highest/best measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command at least a configurable number of times (M_2) within a configurable time window/length/duration (T_2).
   A UE could identify an instance of the first event (or Event-1) based on or according to: the beam metric (e.g., a measured L1-RSRP/L1-SINR) of the new beam RS or RS resource is a threshold value denoted by Th_diff_2—e.g., configured or provided by the network (e.g., the network 130) in higher layer parameter(s) CSI-ReportConfig and/or UEI-ReportConfig that provides or configures the corresponding CSI reporting setting(s) for the UE-initiated beam reporting—lower than or equal to that (e.g., a beam metric such as a measured L1-RSRP/L1-SINR) measured in/during a (same) corresponding measurement occasion as defined/specified herein in the present disclosure of a best activation beam RS or RS resource associated/specific to an activated TCI state/beam having the highest/best beam metric (e.g., the highest/best measured L1-RSRP/L1-SINR) among the beam metric(s) measured in/during a (same) corresponding measurement occasion as defined/specified herein in the present disclosure for/of the activation beam RS(s) or RS resource(s) or RS index(es) or RS resource configuration index(es) or etc. associated/specific to the TCI state(s)/beam(s) following those specified herein in the present disclosure activated by/in the (unified) TCI state(s) activation/deactivation MAC CE command, and the UE has identified such instance(s) of the first event (or Event-1) at least a configurable number of times (M_2) within a configurable time window/length/duration (T_2), wherein the identified or determined activated TCI state(s)/beam(s)—and therefore, the corresponding best activation beam RS(s), RS resource(s), RS index(es), RS resource configuration index(es) and/or etc. associated/specific to the identified/determined activated TCI state(s)/beam(s)—across, within or during the identified instance(s) of the first event (or Event-1) could be different.
When/if (1) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter refActivationBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE (e.g., the UE 116) could report in a single report/reporting instance for each report setting for the UE-initiated beam reporting, (a) nrofReportedRS-UEIBR (higher layer configured) resource indicator(s) including SSBRI(s)/CRI(s), and/or (b) nrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s), and/or (c) a resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure)—e.g., carried in the CSI field with the lowest/highest index/value among the CSI field(s) or the CSI field(s) that carries resource indicator(s) or the CSI field(s) that carries the nrofReportedRS-UEIBR resource indicator(s) in the UEI beam report, and/or (d) a beam metric such as a L1-RSRP/L1-SINR (e.g., a differential L1-RSRP/L1-SINR value carried in the CSI field with the lowest/highest index/value among the CSI field(s) or the CSI field(s) that carries beam metric(s) or the CSI field(s) that carries the nrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure).
   For (a), for example, the nrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure—for this design example, the nrofReportedRS-UEIBR resource indicator(s) may not include or comprise or contain any resource indicator(s) corresponding/specific to activation beam RS(s) or RS resource(s) associated/specific to reference activated TCI state(s)/beam(s) as specified/defined herein in the present disclosure. For another example, the nrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and one resource indicator e.g. a SSBRI or a CRI corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries resource indicator(s) or the CSI field(s) that carries the nrofReportedRS-UEIBR resource indicator(s) in the UEI beam report. For another example, the nrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and one or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the nrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).
   For (b), for example, the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure—for this design example, the nrofReportedBM-UEIBR beam metric(s) may not include or comprise or contain any beam metric(s) corresponding/specific to activation beam RS(s) or RS resource(s)—and therefore, the corresponding resource indicator(s) including SSBRI(s)/CRI(s), if reported—associated/specific to reference activated TCI state(s)/beam(s) as specified/defined herein in the present disclosure. For another example, the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and one beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the nrofReportedBM-UEIBR beam metric(s) in the UEI beam report. For another example, the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and one or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the nrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).
When/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE could report in a single report/reporting instance for each report setting for the UE-initiated beam reporting, (a) nrofReportedRS-UEIBR (higher layer configured) resource indicator(s) including SSBRI(s)/CRI(s), and/or (b) nrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s), and/or component (c) and/or component (d), wherein the component (c) here could correspond to or comprise one or more of:
   A resource indicator such as a SSBRI/CRI or corresponding/specific to an activation beam RS or RS resource associated/specific to a reference activated TCI state/beam as specified/defined herein in the present disclosure)—e.g., carried in the CSI field with the lowest/highest index/value among the CSI field(s) or the CSI field(s) that carries resource indicator(s) or the CSI field(s) that carries the nrofReportedRS-UEIBR resource indicator(s) in the UEI beam report.
   One or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the nrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).

Furthermore, the component (d) here could correspond to or comprise one or more of:
A beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the nrofReportedBM-UEIBR beam metric(s) in the UEI beam report.
One or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the nrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).

In addition,
For (a), for example, the nrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure—for this design example, the nrofReportedRS-UEIBR resource indicator(s) may not include or comprise or contain any resource indicator(s) such as SSBRI(s)/CRI(s) or any RS index(es)/RS resource configuration index(es) or any TCI state ID(s)/index(es) or any TCI codepoint index(es) corresponding to a/the indicated TCI state (and therefore, the corresponding current serving beam RS(s) or RS resource(s) or RS index(es) or RS resource configuration index(es) as specified/defined herein in the present disclosure). For another example, the nrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and a resource indicator e.g. a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure)—e.g., e.g., carried in the CSI field with the lowest/highest index/value among the CSI field(s) or the CSI field(s) that carries resource indicator(s) or the CSI field(s) that carries the nrofReportedRS-UEIBR resource indicator(s) in the UEI beam report.
For (b), for example, the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure—for this design example, the nrofReportedBM-UEIBR beam metric(s) may not include or comprise or contain any beam metric(s) corresponding/specific to a/the indicated TCI state (and therefore, the corresponding current serving beam RS(s) or RS resource(s) or RS index(es) or RS resource configuration index(es) as specified/defined herein in the present disclosure). For another example, the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and one beam metric e.g. a L1-RSRP or a L1-SINR corresponding/specific to a/the indicated TCI state (and therefore, the corresponding current serving beam RS(s) or RS resource(s) or RS index(es) or RS resource configuration index(es) as specified/defined herein in the present disclosure)—e.g., carried in the CSI field with the lowest/highest index/value among the CSI field(s) or the CSI field(s) that carries beam metric(s) or the CSI field(s) that carries the nrofReportedBM-UEIBR beam metric(s) in the UEI beam report.
When/if (1) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter refActivationBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE could report in a single report/reporting instance for each report setting for the UE-initiated beam reporting, (a) totalnrofReportedRS-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) resource indicator(s) including SSBRI(s)/CRI(s), and/or (b) totalnrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s).
For (a), the totalnrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and a resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure)—e.g., carried in the CSI field with the lowest/highest index/value among the CSI field(s) or the CSI field(s) that carries resource indicator(s) or the CSI field(s) that carries the totalnrofReportedRS-UEIBR resource indicator(s) in the UEI beam report. In this case, the totalnrofReportedRS-UEIBR (higher layer configured) resource indicator(s) may or may not comprise resource indicator(s) corresponding/specific to activation beam RS(s) or RS resource(s) associated/specific to reference activated TCI state(s)/beam(s) as specified/defined herein in the present disclosure.
   For example, the totalnrofReportedRS-UEIBR (higher layer configured) resource indicator(s) may not comprise any resource indicator(s) corresponding/specific to activation beam RS(s) or RS resource(s) associated/specific to reference activated TCI state(s)/beam(s) as specified/defined herein in the present disclosure.
   For another example, the totalnrofReportedRS-UEIBR (higher layer configured) resource indicator(s) could comprise one resource indicator e.g. a SSBRI or a CRI corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries resource indicator(s) or the CSI field(s) that carries the totalnrofReportedRS-UEIBR resource indicator(s) in the UEI beam report.
   For another example, the totalnrofReportedRS-UEIBR (higher layer configured) resource indicator(s) could comprise one or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the totalnrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).
For (b), the totalnrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and a beam metric such as a L1-RSRP/L1-SINR (e.g., a differential L1-RSRP/L1-SINR value carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure). In this case, the totalnrofReportedBM-UEIBR (higher layer configured) beam metric(s) may or may not comprise beam metric(s) corresponding/specific to activation beam RS(s) or RS resource(s) associated/specific to reference activated TCI state(s)/beam(s) as specified/defined herein in the present disclosure.
   For example, the totalnrofReportedBM-UEIBR beam metric(s) may not include or comprise or contain any beam metric(s) corresponding/specific to activation beam RS(s) or RS resource(s)—and therefore, the corresponding resource indicator(s) including SSBRI(s)/CRI(s), if reported—associated/specific to reference activated TCI state(s)/beam(s) as specified/defined herein in the present disclosure.
   For another example, the totalnrofReportedBM-UEIBR beam metric(s) could comprise one beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report.
   For another example, the totalnrofReportedBM-UEIBR beam metric(s) could comprise one or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the totalnrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) ofNref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).
When/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE could report in a single report/reporting instance for each report setting for the UE-initiated beam reporting, (a) totalnrofReportedRS-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) resource indicator(s) including SSBRI(s)/CRI(s), and/or (b) totalnrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s).
For (a), the totalnrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and (1) one resource indicator e.g. a SSBRI or a CRI corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries resource indicator(s) or the CSI field(s) that carries the totalnrofReportedRS-UEIBR resource indicator(s) in the UEI beam report and/or (2) one or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the totalnrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s). In this case, the totalnrofReportedRS-UEIBR (higher layer configured) resource indicator(s) may or may not comprise resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure).
   For example, the totalnrofReportedRS-UEIBR (higher layer configured) resource indicator(s) may not comprise any resource indicator(s) such as SSBRI(s)/CRI(s) or any RS index(es)/RS resource configuration index(es) or any TCI state ID(s)/index(es) or any TCI codepoint index(es) corresponding to a/the indicated TCI state (and therefore, the corresponding current serving beam RS(s) or RS resource(s) or RS index(es) or RS resource configuration index(es) as specified/defined herein in the present disclosure).
   For another example, the totalnrofReportedRS-UEIBR (higher layer configured) resource indicator(s) could comprise a resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure).
For (b), the totalnrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, and (1) one beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report, and/or (2) one or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the totalnrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s). In this case, the totalnrofReportedBM-UEIBR (higher layer configured) beam metric(s) may or may not comprise beam metric(s) corresponding/specific to a/the indicated TCI state (and therefore, the corresponding current serving beam RS(s) or RS resource(s) or RS index(es) or RS resource configuration index(es) as specified/defined herein in the present disclosure).
   For example, the totalnrofReportedBM-UEIBR (higher layer configured) beam metric(s) may not comprise any beam metric(s) corresponding/specific to a/the indicated TCI state (and therefore, the corresponding current serving beam RS(s) or RS resource(s) or RS index(es) or RS resource configuration index(es) as specified/defined herein in the present disclosure).
   For another example, the totalnrofReportedBM-UEIBR (higher layer configured) beam metric(s) could comprise a beam metric such as a L1-RSRP/L1-SINR (e.g., a differential L1-RSRP/L1-SINR value carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure).
When/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE (e.g., the UE 116) could report in a single report/reporting instance for each report setting for the UE-initiated beam reporting, (a) nrofReportedRS-UEIBR (higher layer configured) resource indicator(s) including SSBRI(s)/CRI(s), and/or (b) nrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s), and/or component (c1) and/or component (c2) and/or component (d1) and/or component (d2), wherein the component (c1) here could correspond to or comprise one or more of:
A resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure).

The component (c2) here could correspond to or comprise one or more of:
A resource indicator such as a SSBRI/CRI or corresponding/specific to an activation beam RS or RS resource associated/specific to a reference activated TCI state/beam as specified/defined herein in the present disclosure)—e.g., carried in the CSI field with the lowest/highest index/value among the CSI field(s) or the CSI field(s) that carries resource indicator(s) or the CSI field(s) that carries the nrofReportedRS-UEIBR resource indicator(s) in the UEI beam report.
One or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the nrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).

Furthermore, the component (dl) here could correspond to or comprise one or more of:
A beam metric such as a L1-RSRP/L1-SINR (e.g., a differential L1-RSRP/L1-SINR value carried in the CSI field with the lowest/highest index/value among the CSI field(s) or the CSI field(s) that carries beam metric(s) or the CSI field(s) that carries the nrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure).

The component (d2) here could correspond to or comprise one or more of:
A beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the nrofReportedBM-UEIBR beam metric(s) in the UEI beam report.
One or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the nrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported nrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).

In addition,
For (a), the nrofReportedRS-UEIBR (higher layer configured) resource indicator(s) may not comprise any resource indicator(s) such as SSBRI(s)/CRI(s) or any RS index(es)/RS resource configuration index(es) or any TCI state ID(s)/index(es) or any TCI codepoint index(es) corresponding to a/the indicated TCI state (and therefore, the corresponding current serving beam RS(s) or RS resource(s) or RS index(es) or RS resource configuration index(es) as specified/defined herein in the present disclosure), and/or the nrofReportedRS-UEIBR (higher layer configured) resource indicator(s) may not comprise any resource indicator(s) corresponding/specific to activation beam RS(s) or RS resource(s) associated/specific to reference activated TCI state(s)/beam(s) as specified/defined herein in the present disclosure.
For (b), the nrofReportedBM-UEIBR (higher layer configured) beam metric(s) may not comprise any beam metric(s) corresponding/specific to a/the indicated TCI state (and therefore, the corresponding current serving beam RS(s) or RS resource(s) or RS index(es) or RS resource configuration index(es) as specified/defined herein in the present disclosure), and/or the nrofReportedBM-UEIBR (higher layer configured) beam metric(s) may not comprise any beam metric(s) corresponding/specific to activation beam RS(s) or RS resource(s)—and therefore, the corresponding resource indicator(s) including SSBRI(s)/CRI(s), if reported—associated/specific to reference activated TCI state(s)/beam(s) as specified/defined herein in the present disclosure.
When/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, the UE could report in a single report/reporting instance for each report setting for the UE-initiated beam reporting, (a) totalnrofReportedRS-UEIBR (higher layer configured) resource indicator(s) including SSBRI(s)/CRI(s), and/or (b) totalnrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s).
For (a), the totalnrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, a resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure), and (1) one resource indicator e.g. a SSBRI or a CRI corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries resource indicator(s) or the CSI field(s) that carries the totalnrofReportedRS-UEIBR resource indicator(s) in the UEI beam report and/or (2) one or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the totalnrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).
For (b), the totalnrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure, a beam metric such as a L1-RSRP/L1-SINR (e.g., a differential L1-RSRP/L1-SINR value carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure), and (1) one beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the totalnrofReportedBM-UEIBR beam metric(s) in the UEI beam report, and/or (2) one or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the totalnrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).
When/if (1) a higher layer parameter refActivationBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, and (2) a higher layer parameter currentBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE could report in a single report/reporting instance for each report setting for the UE-initiated beam reporting, (a) nrofReportedRS-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) resource indicator(s) including SSBRI(s)/CRI(s), and/or (b) nrofReportedBM-UEIBR (higher layer configured, e.g., in the higher layer parameter(s) CSI-ReportConfig and/or UEI-ReportConfig that provides or configures necessary information and/or setting(s) for the UEI beam reporting, based on or according to a corresponding UE's capability or capability signaling) beam metric(s) including L1-RSRP(s)/L1-SINR(s).
   For (a), the totalnrofReportedRS-UEIBR (higher layer configured) resource indicator(s) could comprise at least one resource indicator e.g. a SSBRI or a CRI corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure. In this case, the nrofReportedRS-UEIBR (higher layer configured) resource indicator(s) may or may not comprise resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure).
      For example, the nrofReportedRS-UEIBR (higher layer configured) resource indicator(s) may not comprise any resource indicator(s) such as SSBRI(s)/CRI(s) or any RS index(es)/RS resource configuration index(es) or any TCI state ID(s)/index(es) or any TCI codepoint index(es) corresponding to a/the indicated TCI state (and therefore, the corresponding current serving beam RS(s) or RS resource(s) or RS index(es) or RS resource configuration index(es) as specified/defined herein in the present disclosure).
      For another example, the nrofReportedRS-UEIBR (higher layer configured) resource indicator(s) could comprise a resource indicator such as a SSBRI/CRI or a RS index/RS resource configuration index or a TCI state ID/index or a TCI codepoint index corresponding to a/the indicated TCI state (and therefore, the corresponding current serving beam RS(s) or RS resource(s) or RS index(es) or RS resource configuration index(es) as specified/defined herein in the present disclosure).

Additionally, the nrofReportedRS-UEIBR (higher layer configured) resource indicator(s) may or may not comprise resource indicator(s) corresponding/specific to activation beam RS(s) or RS resource(s) associated/specific to reference activated TCI state(s)/beam(s) as specified/defined herein in the present disclosure.
For example, the nrofReportedRS-UEIBR (higher layer configured) resource indicator(s) may not comprise any resource indicator(s) corresponding/specific to activation beam RS(s) or RS resource(s) associated/specific to reference activated TCI state(s)/beam(s) as specified/defined herein in the present disclosure.
For another example, the nrofReportedRS-UEIBR (higher layer configured) resource indicator(s) could comprise one resource indicator e.g. a SSBRI or a CRI corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries resource indicator(s) or the CSI field(s) that carries the totalnrofReportedRS-UEIBR resource indicator(s) in the UEI beam report.
For another example, the nrofReportedRS-UEIBR (higher layer configured) resource indicator(s) could comprise one or more (e.g., Nref≥1) resource indicators e.g. one or more SSBRIs or CRIs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries resource indicator(s) or the CSI field(s) that carries the nrofReportedRS-UEIBR resource indicator(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedRS-UEIBR resource indicator(s)—e.g., in terms/form position(s), ordering(s), index(es), ID(s) and/or etc. of the corresponding CSI field(s) in the UEI beam report—corresponding to the Nref resource indicator(s).
   For (b), the nrofReportedBM-UEIBR (higher layer configured) beam metric(s) could comprise at least one beam metric e.g. a L1-RSRP or a L1-SINR corresponding to a resource indicator e.g. a SSBRI or a CRI in the UEI beam report corresponding to/selecting a new beam RS or RS resource (a SSB or a CSI-RS) from the (set of) new beam RS(s) or RS resource(s) or RS index(es) or RS resource configuration index(es) as specified/defined herein in the present disclosure that satisfies or achieves one or more of the aforementioned conditions or conditions of the first event or Event-1 as specified/defined herein in the present disclosure. In this case, the nrofReportedBM-UEIBR (higher layer configured) beam metric(s) may or may not comprise beam metric(s) corresponding/specific to a/the indicated TCI state (and therefore, the corresponding current serving beam RS(s) or RS resource(s) or RS index(es) or RS resource configuration index(es) as specified/defined herein in the present disclosure).
      For example, the nrofReportedBM-UEIBR (higher layer configured) beam metric(s) may not comprise any beam metric(s) corresponding/specific to a/the indicated TCI state (and therefore, the corresponding current serving beam RS(s) or RS resource(s) or RS index(es) or RS resource configuration index(es) as specified/defined herein in the present disclosure).
      For another example, the nrofReportedBM-UEIBR (higher layer configured) beam metric(s) could comprise a beam metric such as a L1-RSRP/L1-SINR (e.g., a differential L1-RSRP/L1-SINRvalue carried in the CSI field with the lowest/highest index/value among the CSI field(s) or the CSI field(s) that carries beam metric(s) or the CSI field(s) that carries the nrofReportedBM-UEIBR beam metric(s) in the UEI beam report) of/for a/the indicated TCI state (and therefore, the corresponding current serving beam RS(s) or RS resource(s) or RS index(es) or RS resource configuration index(es) as specified/defined herein in the present disclosure).

Additionally, the nrofReportedBM-UEIBR (higher layer configured) beam metric(s) may or may not comprise beam metric(s) corresponding/specific to activation beam RS(s) or RS resource(s) associated/specific to reference activated TCI state(s)/beam(s) as specified/defined herein in the present disclosure.
For example, the nrofReportedBM-UEIBR beam metric(s) may not include or comprise or contain any beam metric(s) corresponding/specific to activation beam RS(s) or RS resource(s)—and therefore, the corresponding resource indicator(s) including SSBRI(s)/CRI(s), if reported—associated/specific to reference activated TCI state(s)/beam(s) as specified/defined herein in the present disclosure.
For another example, the nrofReportedBM-UEIBR beam metric(s) could comprise one beam metric e.g. a L1-RSRP or a L1-SINR corresponding/specific to an activation beam RS or RS resource associated/specific to a reference activated TCI state/beam as specified/defined herein in the present disclosure—e.g., carried in the CSI field with the lowest/highest index/value among the CSI field(s) or the CSI field(s) that carries beam metric(s) or the CSI field(s) that carries the nrofReportedBM-UEIBR beam metric(s) in the UEI beam report.
For another example, the nrofReportedBM-UEIBR beam metric(s) could comprise one or more (e.g., Nref≥1) beam metrics e.g. one or more L1-RSRPs or L1-SINRs corresponding/specific to one or more activation beam RSs or RS resources associated/specific to one or more reference activated TCI states/beams as specified/defined herein in the present disclosure—e.g., carried in the CSI field(s) with the (e.g., Nref) lowest/highest index(es)/value(s) among the CSI field(s) or the CSI field(s) that carries beam metric(s) or the CSI field(s) that carries the nrofReportedBM-UEIBR beam metric(s) in the UEI beam report—for this design example, the UE could determine or identify the value(s) of Nref according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling—e.g., the value(s) of Nref could be provided or configured in higher layer parameter(s) CSI-ReportConfig and/or UEI-ReportConfig that provides or configures necessary information and/or setting(s) for the UEI beam reporting, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s); furthermore, the UE could send or transmit, in the corresponding UEI beam report, one or more indicators (e.g., in terms/form of bitmap(s) and/or one-bit indicator(s)) to indicate which of the reported totalnrofReportedBM-UEIBR beam metric(s)—e.g., in terms/form position(s), ordering(s), index(es), ID(s) and/or etc. of the corresponding CSI field(s) in the UEI beam report—corresponding to the Nref beam metric(s).
According to those specified/defined herein in the present disclosure, the UE could determine or identify the threshold value(s)—e.g., Th_diff, Th_diff_0, Th_diff_1 and/or Th_diff_2, and/or the number of time(s)—e.g., M_0, M_1 and/or M_2, and/or the time window/length/duration—e.g., T_0, T_1 and/or T_2, according to or based on (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). In the (aforementioned) design examples specified/defined herein in the present disclosure and according to or following those specified/defined herein in the present disclosure, the value of totalnrofReportedBM-UEIBR could be identical to/same as or different/separate from the value of totalnrofReportedRS-UEIBR, and the value of nrofReportedBM-UEIBR could be identical to/same as or different/separate from the value of nrofReportedRS-UEIBR. Furthermore, when/if one or more of the following conditions is/are satisfied or achieved, the differential L1-RSRP/L1-SINR based reporting for the first event (or Event-1) as specified/defined herein in the present disclosure could be enabled/used (by the UE) for the UE-initiated beam reporting: The value of nrofReportedRS-UEIBR is greater than one
The value of nrofReportedBM-UEIBR is greater than one
The value of totalnrofReportedRS-UEIBR is greater than one
The value of totalnrofReportedBM-UEIBR is greater than one
The higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’
The higher layer parameter currentBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’
The higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’
The higher layer parameter refActivationBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’

Throughout the present disclosure, a resource indicator (e.g., a SSBRI or a CRI) is said to be specific or associated to a RS or RS resource or RS resource configuration (e.g., a SSB or a CSI-RS/CSI-RS resource/CSI-RS resource configuration) could be referred to as or equivalent to selecting a RS or RS resource or RS resource configuration (e.g., a SSB or a CSI-RS/CSI-RS resource/CSI-RS resource configuration) from a corresponding set of RS(s) or RS resource(s) or RS resource configuration(s)—e.g., a SSB resource set or a nonzero power (NZP) CSI-RS resource set. Furthermore, throughout the present disclosure, a reported beam metric e.g. a reported L1-RSRP or a reported L1-SINR in a UEI beam report corresponding/specific to a RS or RS resource (e.g., an activation beam RS or RS resource) could also be associated to a resource indicator, if reported in the UEI beam report, corresponding to the RS or RS resource (e.g., the activation beam RS or RS resource as aforementioned).

Bitwidth of a resource indicator including a SSBRI or a CRI, e.g., when/if reported in a UEI beam report, for an activation beam RS or RS resource or RS index or RS resource configuration index as specified/defined herein in the present disclosure could be determined or identified according to or following one or more of:
When/if the N_0≥1 activation beam RS(s) or RS resource(s) or RS index(es) or RS resource configuration index(es) defined/specified herein in the present disclosure and the N_1≥1 new/candidate beam RS(s) or RS resource(s) or RS index(es) or RS resource configuration index(es) defined/specified herein in the present disclosure are provided or configured in a/the (same) set of RS(s) or RS resource(s) or RS resource configuration index(es), the bitwidth for the resource indicator of the activation beam RS or RS resource or RS index or RS resource configuration index could be ┌ log₂(N_0+N_1)┐—e.g., at least when/if a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb and N_1=N_1_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure, and N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure.
   For CRI, N_0=N_0_csirs and N_1=N_1_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure, and N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure.
When/if the N_0≥1 activation beam RS(s) or RS resource(s) or RS index(es) or RS resource configuration index(es) defined/specified herein in the present disclosure and the (one) current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the activation beam RS or RS resource or RS index or RS resource configuration index could be ┌ log₂(N_0+1)┐—e.g., at least when/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s), and the SSBRI(s), if reported, for the N_0_ssb≥1 activation beam RS(s) or RS resource(s) or RS index(es) or RS resource configuration index(es) could correspond to other value(s) of SSBRI(s) than the lowest or highest value among possible value(s) of SSBRI(s), wherein the bitwidth for each of the SSBRI(s) is ┌ log₂(N_0_ssb+1)┐.
   For CRI, N_0=N_0_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s), and the CRI(s), if reported, for the N_0_csirs≥1 activation beam RS(s) or RS resource(s) or RS index(es) or RS resource configuration index(es) could correspond to other value(s) of CRI(s) than the lowest or highest value among possible value(s) of CRI(s), wherein the bitwidth for each of the CRI(s) is ┌ log₂(N_0_csirs+1)┐.
When/if the N_0≥1 activation beam RS(s) or RS resource(s) or RS index(es) or RS resource configuration index(es) defined/specified herein in the present disclosure, the N_1≥1 new/candidate beam RS(s) or RS resource(s) or RS index(es) or RS resource configuration index(es) defined/specified herein in the present disclosure and the (one) current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the activation beam RS or RS resource or RS index or RS resource configuration index could be ┌ log₂(N_0+N_1+1)┐—e.g., at least when/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb and N_1=N_1_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure, and N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s), and the SSBRI(s), if reported, for the N_0_ssb≥1 activation beam RS(s) or RS resource(s) or RS index(es) or RS resource configuration index(es) could correspond to other value(s) of SSBRI(s) than (1) the lowest or highest value among possible value(s) of SSBRI(s) and (2) the (value(s) of) SSBRI(s), if reported, for the N_1_ssb≥1 new/candidate beam RS(s) or RS resource(s) or RS index(es) or RS resource configuration index(es), wherein the bitwidth for each of the SSBRI(s) is ┌ log₂(N_0_ssb+N_1_ssb+1)┐.
   For CRI, N_0=N_0_csirs and N_1=N_1_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure, and N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s), and the CRI(s), if reported, for the N_0_csirs≥1 activation beam RS(s) or RS resource(s) or RS index(es) or RS resource configuration index(es) could correspond to other value(s) of CRI(s) than (1) the lowest or highest value among possible value(s) of CRI(s) and (2) the (value(s) of) CRI(s), if reported, for the N_1_csirs≥1 new/candidate beam RS(s) or RS resource(s) or RS index(es) or RS resource configuration index(es), wherein the bitwidth for each of the CRI(s) is ┌ log₂(N_0_csirs+N_1_csirs+1)┐.
When/if the N_0≥1 activation beam RS(s) or RS resource(s) or RS index(es) or RS resource configuration index(es) defined/specified herein in the present disclosure is/are provided or configured in a different or separate set of RS(s) or RS resource(s) or RS resource configuration index(es) from a/the set of RS(s) or RS resource(s) or RS resource configuration index(es) comprising the N_1≥1 new/candidate beam RS(s) or RS resource(s) or RS index(es) or RS resource configuration index(es) defined/specified herein in the present disclosure, and/or a/the set of RS(s) or RS resource(s) or RS resource configuration index(es) comprising the current serving beam RS or RS resource or RS index or RS resource configuration index, the bitwidth for the resource indicator of the activation beam RS or RS resource or RS index or RS resource configuration index could be ┌ log₂(N_0)┐—e.g., at least when/if a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure.
   For CRI, N_0=N_0_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure.

Bitwidth of a resource indicator including a SSBRI or a CRI, e.g., when/if reported in a UEI beam report, for a new/candidate beam RS or RS resource or RS index or RS resource configuration index as specified/defined herein in the present disclosure could be determined or identified according to or following one or more of:
When/if the N_1≥1 new/candidate beam RS(s) or RS resource(s) or RS index(es) or RS resource configuration index(es) defined/specified herein in the present disclosure and the N_0≥1 activation beam RS(s) or RS resource(s) or RS index(es) or RS resource configuration index(es) defined/specified herein in the present disclosure are provided or configured in a/the (same) set of RS(s) or RS resource(s) or RS resource configuration index(es), the bitwidth for the resource indicator of the new/candidate beam RS or RS resource or RS index or RS resource configuration index could be ┌ log₂(N_0+N_1)┐—e.g., at least when/if a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb and N_1=N_1_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure, and N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure.
   For CRI, N_0=N_0_csirs and N_1=N_1_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure, and N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure.
When/if the N_1≥1 new/candidate beam RS(s) or RS resource(s) or RS index(es) or RS resource configuration index(es) defined/specified herein in the present disclosure and the (one) current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the new/candidate beam RS or RS resource or RS index or RS resource configuration index could be ┌ log₂(N_1+1)┐—e.g., at least when/if a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_1=N_1_ssb, wherein N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s), and the SSBRI(s), if reported, for the N_1_ssb≥1 new/candidate beam RS(s) or RS resource(s) or RS index(es) or RS resource configuration index(es) could correspond to other value(s) of SSBRI(s) than the lowest or highest value among possible value(s) of SSBRI(s), wherein the bitwidth for each of the SSBRI(s) is ┌ log₂(N_1_ssb+1)┐.
   For CRI, N_1=N_1_csirs, wherein N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s), and the CRI(s), if reported, for the N_1_csirs≥1 new/candidate beam RS(s) or RS resource(s) or RS index(es) or RS resource configuration index(es) could correspond to other value(s) of CRI(s) than the lowest or highest value among possible value(s) of CRI(s), wherein the bitwidth for each of the CRI(s) is ┌ log₂(N_1_csirs+1)┐.
When/if the N_0≥1 activation beam RS(s) or RS resource(s) or RS index(es) or RS resource configuration index(es) defined/specified herein in the present disclosure, the N_1≥1 new/candidate beam RS(s) or RS resource(s) or RS index(es) or RS resource configuration index(es) defined/specified herein in the present disclosure and the (one) current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the new/candidate beam RS or RS resource or RS index or RS resource configuration index could be ┌ log₂(N_0+N_1+1)┐—e.g., at least when/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb and N_1=N_1_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure, and N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s), and the SSBRI(s), if reported, for the N_1_ssb≥1 new/candidate beam RS(s) or RS resource(s) or RS index(es) or RS resource configuration index(es) could correspond to other value(s) of SSBRI(s) than (1) the lowest or highest value among possible value(s) of SSBRI(s) and (2) the (value(s) of) SSBRI(s), if reported, for the N_0_ssb≥1 activation beam RS(s) or RS resource(s) or RS index(es) or RS resource configuration index(es), wherein the bitwidth for each of the SSBRI(s) is ┌ log₂(N_0_ssb+N_1_ssb+1)┐.
   For CRI, N_0=N_0_csirs and N_1=N_1_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure, and N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s), and the CRI(s), if reported, for the N_1_csirs≥1 new/candidate beam RS(s) or RS resource(s) or RS index(es) or RS resource configuration index(es) could correspond to other value(s) of CRI(s) than (1) the lowest or highest value among possible value(s) of CRI(s) and (2) the (value(s) of) CRI(s), if reported, for the N_0_csirs≥1 activation beam RS(s) or RS resource(s) or RS index(es) or RS resource configuration index(es), wherein the bitwidth for each of the CRI(s) is ┌ log₂(N_0_csirs+N_1_csirs+1)┐.
When/if the N_1≥1 new/candidate beam RS(s) or RS resource(s) or RS index(es) or RS resource configuration index(es) defined/specified herein in the present disclosure is/are provided or configured in a different or separate set of RS(s) or RS resource(s) or RS resource configuration index(es) from a/the set of RS(s) or RS resource(s) or RS resource configuration index(es) comprising the N_0≥1 activation beam RS(s) or RS resource(s) or RS index(es) or RS resource configuration index(es) defined/specified herein in the present disclosure, and/or a/the set of RS(s) or RS resource(s) or RS resource configuration index(es) comprising the current serving beam RS or RS resource or RS index or RS resource configuration index, the bitwidth for the resource indicator of the new/candidate beam RS or RS resource or RS index or RS resource configuration index could be ┌ log₂(N_1)┐.
   For SSBRI, N_1=N_1_ssb, wherein N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure.
   For CRI, N_1=N_1_csirs, wherein N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure.

of a resource indicator including a SSBRI or a CRI, e.g., when/if reported in a UEI beam report, for the current serving beam RS or RS resource or RS index or RS resource configuration index as specified/defined herein in the present disclosure could be determined or identified according to or following one or more of:
When/if the N_0≥1 activation beam RS(s) or RS resource(s) or RS index(es) or RS resource configuration index(es) defined/specified herein in the present disclosure and the current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the current serving beam RS or RS resource or RS index or RS resource configuration index could be ┌ log₂(N_0+1)┐—e.g., at least when/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s).
   For CRI, N_0=N_0_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s).
When/if the N_1≥1 new/candidate beam RS(s) or RS resource(s) or RS index(es) or RS resource configuration index(es) defined/specified herein in the present disclosure and the current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the current serving beam RS or RS resource or RS index or RS resource configuration index could be ┌ log₂(N_1+1)┐—e.g., at least when/if a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_1=N_1_ssb, wherein N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s).
   For CRI, N_1=N_1_csirs, wherein N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s).
When/if the N_0≥1 activation beam RS(s) or RS resource(s) or RS index(es) or RS resource configuration index(es) defined/specified herein in the present disclosure, the N_1≥1 new/candidate beam RS(s) or RS resource(s) or RS index(es) or RS resource configuration index(es) defined/specified herein in the present disclosure and the (one) current serving beam RS or RS resource or RS index or RS resource configuration index defined/specified herein in the present disclosure are provided or configured in a/the (same) set of RS(s) or RS resource(s) or RS resource configuration index(es), the bitwidth for the resource indicator of the current serving beam RS or RS resource or RS index or RS resource configuration index could be ┌ log₂(N_0+N_1+1)┐—e.g., at least when/if (1) a higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’, and (2) a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled’.
   For SSBRI, N_0=N_0_ssb and N_1=N_1_ssb, wherein N_0_ssb represents the number of activation beam RS(s) or RS resource(s) or RS index(es) or RS resource configuration index(es) as SSB(s) in the corresponding resource set (e.g., a SSB resource set) according to or following those defined/specified herein in the present disclosure, and N_1_ssb represents the number of new/candidate beam RS(s) or RS resource(s) or RS index(es) or RS resource configuration index(es) as SSB(s) in the corresponding resource set (e.g., a SSB resource set) according to or following those defined/specified herein in the present disclosure. In this case, for example, the SSBRI, if reported, for the current serving beam RS or RS resource or RS index or RS resource configuration index could correspond to the lowest or highest value among possible value(s) of SSBRI(s).
   For CRI, N_0=N_0_csirs and N_1=N_1_csirs, wherein N_0_csirs represents the number of activation beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure, and N_1_csirs represents the number of new/candidate beam RS(s) or RS resource(s) or RS index(es) or RS resource configuration index(es) as NZP CSI-RS(s)/CSI-RS resource(s)/CSI-RS resource configuration(s) in the corresponding resource set (e.g., a NZP CSI-RS resource set) according to or following those defined/specified herein in the present disclosure. In this case, for example, the CRI, if reported, for the current serving beam RS or RS resource or RS index or RS resource configuration index could correspond to the lowest or highest value among possible value(s) of CRI(s).
When/if the current serving beam RS or RS resource or RS index or RS resource configuration index is provided or configured in a different or separate set of RS(s) or RS resource(s) or RS resource configuration index(es) from a/the set of RS(s) or RS resource(s) or RS resource configuration index(es) comprising the N_0≥1 activation beam RS(s) or RS resource(s) or RS index(es) or RS resource configuration index(es) defined/specified herein in the present disclosure, and/or a/the set of RS(s) or RS resource(s) or RS resource configuration index(es) comprising the N_11 new/candidate beam RS(s) or RS resource(s) or RS index(es) or RS resource configuration index(es) defined/specified herein in the present disclosure, the bitwidth for the resource indicator of the current serving beam RS or RS resource or RS index or RS resource configuration index could be ┌ log₂(N_tot)┐, where N_tot represents a/the total number of RS(s), RS resource(s), RS index(es) and/or RS resource configuration index(es) associated/specific to the configured/provided joint/DL TCI state(s), e.g., in a list of joint/DL TCI state(s) provided by DLorJointTCI-State. Alternatively, the SSBRI/CRI, if reported in the UEI beam report, for the current serving beam RS or RS resource or RS index or RS resource configuration index could correspond to a value ‘0’ or ‘1’. Optionally, the SSBRI/CRI, if reported in the UEI beam report, for the current serving beam RS or RS resource or RS index or RS resource configuration index could correspond to a special value (e.g., value ‘X’ or value ‘S’) or the exact ID/index of the current serving beam RS or RS resource—e.g., among/out of the RS(s), RS resource(s), RS index(es) and/or RS resource configuration index(es) associated/specific to the configured/provided joint/DL TCI state(s), e.g., in a list of joint/DL TCI state(s) provided by DLorJointTCI-State, and/or associated/specific to the activated joint/DL TCI state(s), e.g., in a (unified) TCI state(s) activation/deactivation MAC CE command. Herein, this applies, e.g., at least when/if a higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or is set to ‘enabled.’

According to or following those specified herein in the present disclosure, when/if the current serving beam RS or RS resource or RS index or RS resource configuration index, the N_0≥1 activation beam RS(s) or RS resource(s) or RS index(es) or RS resource configuration index(es) defined/specified herein in the present disclosure, and/or the N_1≥1 new/candidate beam RS(s) or RS resource(s) or RS index(es) or RS resource configuration index(es) defined/specified herein in the present disclosure are provided or configured in different or separate sets of RS(s) or RS resource(s) or RS resource configuration index(es),
In one example, the bitwidth of a resource indicator including a SSBRI or a CRI, e.g., when/if reported in a UEI beam report, for an activation beam RS or RS resource or RS index or RS resource configuration index as specified/defined herein in the present disclosure could be ┌ log₂(N_0)┐—denoted by/referred to as a first bitwidth. Optionally, the bitwidth a resource indicator including a SSBRI or a CRI, e.g., when/if reported in a UEI beam report, for an activation beam RS or RS resource or RS index or RS resource configuration index as specified/defined herein in the present disclosure could be 1—denoted by/referred to as a first bitwidth: for example, the SSBRI/CRI, if reported in the UEI beam report, for an activation beam RS or RS resource or RS index or RS resource configuration index as specified/defined herein in the present disclosure could correspond to the exact ID/index of the activation beam RS or RS resource or RS index or RS resource configuration index as specified/defined herein in the present disclosure—e.g., among/out of the RS(s), RS resource(s), RS index(es) and/or RS resource configuration index(es) in the corresponding resource set, and/or associated/specific to the configured/provided joint/DL TCI state(s), e.g., in a list of joint/DL TCI state(s) provided by DLorJointTCI-State, and/or associated/specific to the activated joint/DL TCI state(s), e.g., in a (unified) TCI state(s) activation/deactivation MAC CE command.
In another example, the bitwidth of a resource indicator including a SSBRI or a CRI, e.g., when/if reported in a UEI beam report, for a new/candidate beam RS or RS resource or RS index or RS resource configuration index as specified/defined herein in the present disclosure could be ┌ log₂(N_1)┐—denoted by/referred to as a second bitwidth. Optionally, the bitwidth a resource indicator including a SSBRI or a CRI, e.g., when/if reported in a UEI beam report, for a new/candidate beam RS or RS resource or RS index or RS resource configuration index as specified/defined herein in the present disclosure could be 1—denoted by/referred to as a second bitwidth: for example, the SSBRI/CRI, if reported in the UEI beam report, for a new/candidate beam RS or RS resource or RS index or RS resource configuration index as specified/defined herein in the present disclosure could correspond to the exact ID/index of the new/candidate beam RS or RS resource or RS index or RS resource configuration index as specified/defined herein in the present disclosure—e.g., among/out of the RS(s), RS resource(s), RS index(es) and/or RS resource configuration index(es) in the corresponding resource set, and/or associated/specific to the configured/provided joint/DL TCI state(s), e.g., in a list of joint/DL TCI state(s) provided by DLorJointTCI-State, and/or associated/specific to the activated joint/DL TCI state(s), e.g., in a (unified) TCI state(s) activation/deactivation MAC CE command.
In another example, the bitwidth for the resource indicator including a SSBRI or a CRI of the current serving beam RS or RS resource or RS index or RS resource configuration index could be 1—denoted by/referred to as a third bitwidth: for example, the SSBRI/CRI, if reported in the UEI beam report, for the current serving beam RS or RS resource or RS index or RS resource configuration index could correspond to a value ‘0’ or ‘1’; for another example, the SSBRI/CRI, if reported in the UEI beam report, for the current serving beam RS or RS resource or RS index or RS resource configuration index could correspond to a special value (e.g., value ‘X’ or value ‘S’) or the exact ID/index of the current serving beam RS or RS resource—e.g., among/out of the RS(s), RS resource(s), RS index(es) and/or RS resource configuration index(es) associated/specific to the configured/provided joint/DL TCI state(s), e.g., in a list of joint/DL TCI state(s) provided by DLorJointTCI-State. Or, the bitwidth for the resource indicator of the current serving beam RS or RS resource or RS index or RS resource configuration index could be ┌ log₂(N_tot)┐—denoted by/referred to as a third bitwidth, where N_tot represents a/the total number of RS(s), RS resource(s), RS index(es) and/or RS resource configuration index(es) associated/specific to the configured/provided joint/DL TCI state(s), e.g., in a list of joint/DL TCI state(s) provided by DLorJointTCI-State, and/or associated/specific to the activated joint/DL TCI state(s), e.g., in a (unified) TCI state(s) activation/deactivation MAC CE command.

In this case, the actual number of bits or bitwidth (denoted by a fourth bitwidth) of a CSI field in a/the UEI beam report used to indicate, carry, send or transmit a resource indicator—e.g., for a new/candidate beam RS/RS resource/RS index/RS resource configuration index, an activation beam RS/RS resource/RS index/RS resource configuration index, or a current serving beam RS/RS resource/RS index/RS resource configuration index as specified/defined herein in the present disclosure—could be determined or identified as a/the maximum among the first bitwidth, the second bitwidth and the third bitwidth as specified/defined herein in the present disclosure, i.e., the fourth bitwidth=max{the first bitwidth, the second bitwidth, the third bitwidth}. Optionally, the fourth bitwidth=the first bitwidth+the second bitwidth+the third bitwidth. Alternatively, the fourth bitwidth=┌ log₂(N_0+N_1+1)┐, wherein N_0≥1 represents a/the number of activation beam RS(s) or RS resource(s) or RS index(es) or RS resource configuration index(es) defined/specified herein in the present disclosure—e.g., in a corresponding resource set and/or associated/specific to the TCI state(s) activated by/in a/the (unified) TCI state(s) activation/deactivation MAC CE command, and N_1≥1 represents a/the number of new/candidate beam RS(s) or RS resource(s) or RS index(es) or RS resource configuration index(es) defined/specified herein in the present disclosure, e.g., in a corresponding resource set of RS(s) or RS resource(s) or RS resource configuration index(es).
When/if the first bitwidth is less than or equal to the fourth bitwidth, the SSBRI/CRI, if reported in a/the corresponding UEI beam report, for an activation beam RS or RS resource or RS index or RS resource configuration index determined or identified according to or following those specified/defined herein in the present disclosure could be padded with a number of (e.g., the fourth bitwidth—the first bitwidth) zero(s)/0's or one(s)/1's or special value(s) e.g. ‘X’s, ‘S’s and/or etc. in the LSB(s) or the MSB(s) of the corresponding CSI field in the corresponding UEI beam report.
When/if the second bitwidth is less than or equal to the fourth bitwidth, the SSBRI/CRI, if reported in a/the corresponding UEI beam report, for a new/candidate beam RS or RS resource or RS index or RS resource configuration index determined or identified according to or following those specified/defined herein in the present disclosure could be padded with a number of (e.g., the fourth bitwidth—the second bitwidth) zero(s)/0's or one(s)/1's or special value(s) e.g. ‘X’s, ‘S’s and/or etc. in the LSB(s) or the MSB(s) of the corresponding CSI field in the corresponding UEI beam report.
When/if the third bitwidth is less than or equal to the fourth bitwidth, the SSBRI/CRI, if reported in a/the corresponding UEI beam report, for the current serving beam RS or RS resource or RS index or RS resource configuration index determined or identified according to or following those specified/defined herein in the present disclosure could be padded with a number of (e.g., the fourth bitwidth—the third bitwidth) zero(s)/0's or one(s)/1's or special value(s) e.g. ‘X’s, ‘S’s and/or etc. in the LSB(s) or the MSB(s) of the corresponding CSI field in the corresponding UEI beam report.

In addition to or other than the padding method(s)/design(s) as specified/defined herein in the present disclosure (e.g., as aforementioned),
In one example, the UE could also indicate, provide, send or transmit in a/the UEI beam report one or more indicators associated/specific to a CSI field. For example, the one or more indicators could be a one-bit (flag) indicator; for this design example, when/if the one-bit (flag) indicator is set to ‘1’ (or ‘0’), the CSI field associated/specific to the one-bit (flag) indicator could be used to carry, convey or indicate the SSBRI/CRI (and/or the corresponding beam metric such as L1-RSRP/L1-SINR), if reported in a/the corresponding UEI beam report, for an activation beam RS or RS resource or RS index or RS resource configuration index determined or identified according to or following those specified/defined herein in the present disclosure. For another example, the one or more indicators could be a two-bit indicator; for this design example, when/if the two-bit indicator is set to ‘00’ (‘01’, ‘10’ or ‘11’), the CSI field associated/specific to the two-bit indicator could be used to carry, convey or indicate the SSBRI/CRI (and/or the corresponding beam metric such as L1-RSRP/L1-SINR), if reported in a/the corresponding UEI beam report, for an activation beam RS or RS resource or RS index or RS resource configuration index determined or identified according to or following those specified/defined herein in the present disclosure.
In another example, the UE could also indicate, provide, send or transmit in a/the UEI beam report one or more indicators associated/specific to a CSI field. For example, the one or more indicators could be a one-bit (flag) indicator; forthis design example, when/if the one-bit (flag) indicator is set to ‘1’ (or ‘0’), the CSI field associated/specific to the one-bit (flag) indicator could be used to carry, convey or indicate the SSBRI/CRI (and/or the corresponding beam metric such as L1-RSRP/L1-SINR), if reported in a/the corresponding UEI beam report, for a new/candidate beam RS or RS resource or RS index or RS resource configuration index determined or identified according to or following those specified/defined herein in the present disclosure. For another example, the one or more indicators could be a two-bit indicator; for this design example, when/if the two-bit indicator is set to ‘01’ (‘00’, ‘10’ or ‘11’), the CSI field associated/specific to the two-bit indicator could be used to carry, convey or indicate the SSBRI/CRI (and/or the corresponding beam metric such as L1-RSRP/L1-SINR), if reported in a/the corresponding UEI beam report, for a new/candidate beam RS or RS resource or RS index or RS resource configuration index determined or identified according to or following those specified/defined herein in the present disclosure.
In another example, the UE could also indicate, provide, send or transmit in a/the UEI beam report one or more indicators associated/specific to a CSI field. For example, the one or more indicators could be a one-bit (flag) indicator; for this design example, when/if the one-bit (flag) indicator is set to ‘1’ (or ‘0’), the CSI field associated/specific to the one-bit (flag) indicator could be used to carry, convey or indicate the SSBRI/CRI (and/or the corresponding beam metric such as L1-RSRP/L1-SINR), if reported in a/the corresponding UEI beam report, for the current serving beam RS or RS resource or RS index or RS resource configuration index determined or identified according to or following those specified/defined herein in the present disclosure. For another example, the one or more indicators could be a two-bit indicator; for this design example, when/if the two-bit indicator is set to ‘01’ (‘00’, ‘10’ or ‘11’), the CSI field associated/specific to the two-bit indicator could be used to carry, convey or indicate the SSBRI/CRI (and/or the corresponding beam metric such as L1-RSRP/L1-SINR), if reported in a/the corresponding UEI beam report, for the current serving beam RS or RS resource or RS index or RS resource configuration index determined or identified according to or following those specified/defined herein in the present disclosure.

According to or following those specified herein in the present disclosure, when/if a higher layer parameter refActivationBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter refActivationBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE may or may not report, in a/the UEI beam report, resource indicator(s)—and/or the corresponding beam metric(s)—corresponding/specific to activation beam RS(s) or RS resource(s) associated/specific to reference activated TCI state(s)/beam(s) as specified/defined herein in the present disclosure. In this case, when/if the activation beam RS(s) or RS resource(s) or RS index(es) or RS resource configuration index(es) defined/specified herein in the present disclosure is/are provided or configured in a/the (same) set of RS(s) or RS resource(s) or RS index(es) or RS resource configuration index(es) comprising the new/candidate beam RS(s) or RS resource(s) or RS index(es) or RS resource configuration index(es) defined/specified herein in the present disclosure and/or the current serving beam RS or RS resource or RS index or RS resource configuration index defined/specified herein in the present disclosure, the UE could report, in a/the UEI beam report, resource indicator(s) e.g. SSBRI(s) and/or CRI(s)—and/or the corresponding beam metric(s) e.g. L1-RSRP(s) and/or L1-SINR(s)—corresponding/specific to activation beam RS(s) or RS resource(s) associated/specific to reference activated TCI state(s)/beam(s) as specified/defined herein in the present disclosure—or equivalently, the totalnrofReportedRS-UEIBR (higher layer configured) resource indicator(s) could comprise one or more resource indicators e.g. one or more SSBRIs and/or CRIs corresponding/specific to one or more activation beam RSs or RS resources associated/specific to one or more reference activated TCI states/beams according to or following those specified/defined herein in the present disclosure, and/or the totalnrofReportedBM-UEIBR (higher layer configured) beam metric(s) could comprise one or more beam metrics e.g. one or more L1-RSRPs and/or L1-SINRs corresponding/specific to one or more activation beam RSs or RS resources associated/specific to one or more reference activated TCI states/beams according to or following those specified/defined herein in the present disclosure; otherwise, the UE may not report, in a/the UEI beam report, any resource indicator(s) e.g. SSBRI(s) and/or CRI(s)—and/or any beam metric(s) e.g. L1-RSRP(s) and/or L1-SINR(s)—corresponding/specific to activation beam RS(s) or RS resource(s) associated/specific to reference activated TCI state(s)/beam(s) as specified/defined herein in the present disclosure—or equivalently, the totalnrofReportedRS-UEIBR (higher layer configured) resource indicator(s) may not comprise any resource indicator(s) e.g. SSBRI(s) and/or CRI(s) corresponding/specific to activation beam RS(s) or RS resource(s) associated/specific to reference activated TCI state(s)/beam(s) according to or following those specified/defined herein in the present disclosure, and/or the totalnrofReportedBM-UEIBR (higher layer configured) beam metric(s) may not comprise any beam metric(s) e.g. L1-RSRP(s) and/or L1-SINR(s) corresponding/specific to activation beam RS(s) or RS resource(s) associated/specific to reference activated TCI state(s)/beam(s) according to or following those specified/defined herein in the present disclosure.

According to or following those specified herein in the present disclosure, when/if a higher layer parameter currentBeamInReport is not present or provided or configured or is absent in the higher layer parameter(s) e.g. CSI-ReportConfig and/or UEI-ReportConfig that provides or configures necessary information or setting(s) or configuration(s) for the UEI beam reporting as specified/defined herein in the present disclosure, and/or the higher layer parameter currentBeamInReport is present or provided or configured in the higher layer parameter(s) e.g. CSI-ReportConfig and/or UEI-ReportConfig that provides or configures necessary information or setting(s) or configuration(s) for the UEI beam reporting as specified/defined herein in the present disclosure but set to ‘disabled’, the UE (e.g., the UE 116) may or may not report, in a/the UEI beam report, the resource indicator (and/or the TCI state/TCI codepoint index/ID)—and/or the corresponding beam metric—corresponding/specific to the current serving beam RS or RS resource associated/specific to the indicated joint/DL TCI state/beam as specified/defined herein in the present disclosure. In this case, when/if the current serving beam RS or RS resource or RS index or RS resource configuration index defined/specified herein in the present disclosure is provided or configured in a/the (same) set of RS(s) or RS resource(s) or RS index(es) or RS resource configuration index(es) comprising the new/candidate beam RS(s) or RS resource(s) or RS index(es) or RS resource configuration index(es) defined/specified herein in the present disclosure and/or the activation beam RS(s) or RS resource(s) or RS index(es) or RS resource configuration index(es) defined/specified herein in the present disclosure, the UE could report, in a/the UEI beam report, the resource indicator e.g. the SSBRI and/or CRI (and/or the TCI state/TCI codepoint ID/index)—and/or the corresponding beam metric e.g. L1-RSRP and/or L1-SINR—corresponding/specific to the current serving beam RS or RS resource associated/specific to the indicated joint/DL TCI state/beam as specified/defined herein in the present disclosure—or equivalently, the totalnrofReportedRS-UEIBR (higher layer configured) resource indicator(s) could comprise the resource indicator e.g. the SSBRI and/or CRI (and/or the TCI state/TCI codepoint ID/index) corresponding/specific to the current serving beam RS or RS resource associated/specific to the indicated joint/DL TCI state/beam according to or following those specified/defined herein in the present disclosure, and/or the totalnrofReportedBM-UEIBR (higher layer configured) beam metric(s) could comprise the beam metric e.g. the L1-RSRP and/or L1-SINR corresponding/specific to the current serving beam RS or RS resource associated/specific to the indicated joint/DL TCI state/beam according to or following those specified/defined herein in the present disclosure; otherwise, the UE may not report, in a/the UEI beam report, the resource indicator e.g. the SSBRI and/or CRI (and/or the TCI state/TCI codepoint index/ID)—and/or the corresponding beam metric e.g. the L1-RSRP and/or L1-SINR— corresponding/specific to the current serving beam RS or RS resource associated/specific to the indicated joint/DL TCI state/beam as specified/defined herein in the present disclosure—or equivalently, the totalnrofReportedRS-UEIBR (higher layer configured) resource indicator(s) may not comprise the resource indicator e.g. the SSBRI and/or CRI corresponding/specific to the current serving beam RS or RS resource associated/specific to the indicated joint/DL TCI state/beam according to or following those specified/defined herein in the present disclosure, and/or the totalnrofReportedBM-UEIBR (higher layer configured) beam metric(s) may not comprise any beam metric(s) e.g. L1-RSRP(s) and/or L1-SINR(s) corresponding/specific to the current serving beam RS or RS resource associated/specific to the indicated joint/DL TCI state/beam according to or following those specified/defined herein in the present disclosure.

All of the report content(s)/quantity(s) in/of a UEI beam report as specified/defined herein in the present disclosure can be sent, transmitted, carried or conveyed in a MAC CE. In this case, a bit or a bit position or a CSI field that is used to carry, convey or indicate a report quantity (e.g., a resource indicator including a SSBRI or a CRI, or a beam metric including a L1-RSRP or a L1-SINR) could correspond to a field in the MAC CE command.

Throughout the present disclosure, in addition to or instead of or other than or rather than reporting, in a/the UEI beam report, resource indicator(s) including SSBRI(s) or CRI(s)—and/or the corresponding beam metric(s) including L1-RSRP(s)/L1-SINR(s)—for the activation beam RS(s) or RS resource(s) associated/specific to the determined/identified reference activated TCI state(s)/beam(s) according to or following those specified herein in the present disclosure, the UE could report, in a/the UEI beam report, index(es)/ID(s) of TCI state(s)/TCI codepoint(s) associated/specific to the determined/identified reference activated TCI state(s)/beam(s).

A UE could indicate or send ortransmitto the network (e.g., the network 130) a capability signaling indicating whether or not the UE can or would like to support one or more of the herein described/specified processes and/or procedures of declaring an event or event declaration (including the event counter—e.g., with a candidate value of maximum number of counts as zero, event instance detection timer—e.g., with a candidate value of zero, those described/specified in the one or more design examples herein in the present disclosure and/or etc.). Furthermore, UEs that could or would support the UE-initiated or event-driven reporting should or could support or indicate their support of a candidate value of zero of the maximum number of counts for the event counter(s) and/or a candidate value of 0 of the event instance detection timer(s); i.e., supporting of a candidate value of zero of the maximum number of counts for the event counter and/or a candidate value of 0 of the event instance detection timer(s) could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more of the herein described/specified processes or procedures of declaring an event or event declaration (including the event counter, event instance detection timer, those described/specified in one or more examples herein in the present disclosure and/or etc.) could be enabled. For instance, a higher layer parameter eventDeclaration could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting. For instance, when/if the eventDeclaration is present/configured/provided and/or set to ‘on’ or ‘enabled’ or 1, the event counter(s), the event instance detection timer(s), etc. and the corresponding MAC procedures as specified/described herein could be enabled for the UE for declaring the event(s). Otherwise, i.e., when/if the eventDeclaration is set to ‘off’ or ‘disabled’ or 0 or absent or not present/configured/provided, the event counter(s), the event instance detection timer(s), etc. and the corresponding MAC procedures as specified/described herein could be disabled or not used/applied by the UE for declaring the event(s).

According to or following those specified herein in the present disclosure, a UE could determine or identify one or more candidate/new beam RSs or RS resources to measure, assess or evaluate (e.g., to obtain the corresponding measurement result(s) including L1-RSRP(s)/L1-SINR(s)), e.g., for evaluating instance(s) of an event or evaluating or declaring an event according to or following those specified herein in the present disclosure, according to or based on one or more of:
In one example, the one or more candidate/new beam RS resources could be provided or configured in a CSI resource set in a CSI resource setting associated/linked to a CSI reporting setting, wherein the CSI resource set, the CSI resource setting and/or the CSI reporting setting could be provided or configured for the UE-initiated/event-driven beam reporting as specified/defined herein in the present disclosure.
   For example, the one or more candidate/new beam RS resources—corresponding to SSBs—could be provided or configured in a SSB resource set configured for reporting ‘ssb-Index-RSRP’/‘ssb-Index-RSRP’and provided by CSI-SSB-ResourceSet in the CSI resource setting associated/linked to the CSI reporting setting.
   For another example, the one or more candidate/new beam RS resources—corresponding to NZP CSI-RS resources—could be provided or configured in a NZP CSI-RS resource set configured for reporting ‘cri-RSRP’/‘cri-RSRP’ and provided by NZP-CSI-RS-ResourceSet in the CSI resource setting associated/linked to the CSI reporting setting.
In another example, the one or more candidate/new beam RS resources could be associated to a joint/DL/UL TCI state configured, activated or indicated for at least UE-dedicated transmission(s) and/or reception(s) of various DL and/or UL channels/signals. For instance, information related to the one or more candidate/new beam RS resources could be provided or configured in a higher layer parameter TCI-State or UL-TCIState that provides or configures a joint/DL/UL TCI state, wherein the one or more candidate/new beam RS resources could be associated/linked/specific to a CSI reporting setting or configuration, e.g., provided by CSI-ReportConfig, configured for CSI/beam and/or UEI CSI/beam measurement and/or reporting. For this design example, the information could correspond to or comprise or include or contain or provide one or more of:
   Index(es)/ID(s) of the one or more candidate/new beam RS resources, wherein bitwidth of the index(es)/ID(s) of the one or more candidate/new beam RS resources could be ┌ log₂ L┐, where L here is the number of RS resources in a list/set/pool of RS resources (higher layer) configured/provided to the UE for candidate/new beam RS(s) measurement and/or reporting.
   Index(es)/ID(s) of the one or more candidate/new beam RS resources, wherein bitwidth of the index(es)/ID(s) of the one or more candidate/new beam RS resources could be ┌ log₂ M┐, where Mhere is the number of RS resources in a CSI resource set in a CSI resource setting associated/linked to a CSI reporting setting, wherein the CSI resource set, the CSI resource setting and/or the CSI reporting setting could be provided or configured for the UE-initiated/event-driven beam reporting as specified/defined herein in the present disclosure.
   Index(es)/ID(s) of one or more CSI resource sets—e.g., among the CSI resource sets provided/configured in a CSI resource setting associated/linked to a CSI reporting setting, wherein the CSI resource set(s), the CSI resource setting and/or the CSI reporting setting could be provided or configured for the UE-initiated/event-driven beam reporting as specified/defined herein in the present disclosure; in this case, the one or more candidate/new beam RS resources could correspond to the RS resource(s) in the one or more CSI resource sets.

Optionally, a higher layer parameter TCI-State or UL-TCIState that provides or configures a joint/DL/UL TCI state could comprise, provide, contain, include or configure first information related to one or more SSBs as first candidate/new beam RS resource(s), wherein the first candidate/new beam RS resource(s)—i.e., the one or more SSBs—could be associated/linked/specific to a CSI reporting setting or configuration, e.g., provided by CSI-ReportConfig, configured for CSI/beam and/or UEI CSI/beam measurement and/or reporting, and second information related to one or more NZP CSI-RS resources as second candidate/new beam RS resource(s), wherein the second candidate/new beam RS resource(s)—i.e., the one or more NZP CSI-RS resources—could be associated/linked/specific to a CSI reporting setting or configuration, e.g., provided by CSI-ReportConfig, configured for CSI/beam and/or UEI CSI/beam measurement and/or reporting. In this case, the first information could correspond to or comprise or include or contain or provide one or more of:
Index(es)/ID(s) of the SSBs (i.e., index(es)/ID(s) of the one or more first candidate/new beam RS resources), wherein bitwidth of the index(es)/ID(s) of the SSBs could be ┌ log₂ L1┐, where Lᵢ here is the number of SSBs in a list/set/pool of SSBs (higher layer) configured/provided to the UE for candidate/new beam RS(s) measurement and/or reporting.
Index(es)/ID(s) of the SSBs (i.e., index(es)/ID(s) of the one or more first candidate/new beam RS resources), wherein bitwidth of the index(es)/ID(s) of the SSBs could be ┌ log₂ L2┐, where L₂ here is the number of SSBs in a SSB resource set—e.g., provided by CSI-SSB-ResourceSet—in a CSI resource setting associated/linked to a CSI reporting setting, wherein the SSB resource set, the CSI resource setting and/or the CSI reporting setting could be provided or configured for the UE-initiated/event-driven beam reporting as specified/defined herein in the present disclosure.
Index(es)/ID(s) of one or more SSB resource sets—e.g., among the SSB resource sets provided/configured in a CSI resource setting associated/linked to a CSI reporting setting, wherein the SSB resource set(s), the CSI resource setting and/or the CSI reporting setting could be provided or configured for the UE-initiated/event-driven beam reporting as specified/defined herein in the present disclosure; in this case, the one or more SSBs (and therefore, the one or more first candidate/new beam RS resources) could correspond to the SSB(s) in the one or more SSB resource sets.

The second information could correspond to or comprise or include or contain or provide one or more of:
Index(es)/ID(s) of the NZP CSI-RS resources (i.e., index(es)/ID(s) of the one or more second candidate/new beam RS resources), wherein bitwidth of the index(es)/ID(s) of the NZP CSI-RS resources could be ┌ log₂ L2┐, where L₂ here is the number ofNZP CSI-RS resources in a list/set/pool ofNZP CSI-RS resources (higher layer) configured/provided to the UE for candidate/new beam RS(s) measurement and/or reporting.
Index(es)/ID(s) of the NZP CSI-RS resources (i.e., index(es)/ID(s) of the one or more second candidate/new beam RS resources), wherein bitwidth of the index(es)/ID(s) of the NZP CSI-RS resources could be ┌ log₂ L2┐, where L₂ here is the number of NZP CSI-RS resources in a NZP CSI-RS resource set—e.g., provided by NZP-CSI-RS-ResourceSet—in a CSI resource setting associated/linked to a CSI reporting setting, wherein the NZP CSI-RS resource set, the CSI resource setting and/or the CSI reporting setting could be provided or configured for the UE-initiated/event-driven beam reporting as specified/defined herein in the present disclosure.
Index(es)/ID(s) of one or more NZP CSI-RS resource sets—e.g., among the NZP CSI-RS resource sets provided/configured in a CSI resource setting associated/linked to a CSI reporting setting, wherein the NZP CSI-RS resource set(s), the CSI resource setting and/or the CSI reporting setting could be provided or configured for the UE-initiated/event-driven beam reporting as specified/defined herein in the present disclosure; in this case, the one or more NZP CSI-RS resources (and therefore, the one or more second candidate/new beam RS resources) could correspond to the NZP CSI-RS resource(s) in the one or more NZP CSI-RS resource sets.

In this case, to evaluate an instance of an event or to evaluate or declare or detect an event (e.g., the event could be the second event or Event-2 as defined/specified herein in the present disclosure), when/if the UE has determined or identified (e.g., based on network's configuration(s)/indication(s) via/by higher layer RRC signaling(s)/parameter(s) and/or MAC CE command(s) and/or dynamic DCI based L1 signaling(s) based on or according to a corresponding UE's capability signaling) that the current (serving) beam RS or RS resource corresponds to a SSB associated/specific to the indicated TCI state according to or following those specified herein in the present disclosure, the UE could determine or identify that candidate beam RS(s) or RS resource(s) could correspond to the first candidate/new beam RS(s)/RS resource(s)—i.e., SSBs—provided or configured by/via the first information provided, configured or comprised in the higher layer parameter TCI-State or UL-TCIState that provides or configures the indicated TCI state. Additionally, when/if the UE has determined or identified (e.g., based on network's configuration(s)/indication(s) via/by higher layer RRC signaling(s)/parameter(s) and/or MAC CE command(s) and/or dynamic DCI based L1 signaling(s) based on or according to a corresponding UE's capability signaling) that the current (serving) beam RS or RS resource corresponds to a NZP CSI-RS resource associated/specific to the indicated TCI state according to or following those specified herein in the present disclosure, the UE could determine or identify that candidate beam RS(s) or RS resource(s) could correspond to the second candidate/new beam RS(s)/RS resource(s)—i.e., NZP CSI-RS resources—provided or configured by/via the second information provided, configured or comprised in the higher layer parameter TCI-State or UL-TCIState that provides or configures the indicated TCI state.

According to those specified herein in the present disclosure, when/if a UE is indicated by the network, e.g., via a beam activation and/or indication MAC CE or DCI (e.g., via a TCI codepoint of a TCI field in the corresponding beam indication DCI format(s) 11/1_2 with or without DL assignment), one or more TCI states, and/or when/if the higher layer parameter(s) TCI-State(s) and/or UL-TCIState(s) that provides or configures the one or more TCI states does not comprise, configure, provide, contain or include any information related to candidate/new beam RS(s)/RS resource(s) following or according to those specified herein in the present disclosure, and/or when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s) for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure.

According to those specified herein in the present disclosure, when/if a UE is indicated or provided by the network a (unified) TCI state(s) activation/deactivation MAC CE command comprising or indicating or providing or activating one or more TCI states or TCI codepoints each mapped to one or more TCI states, and/or when/if the number of (activated) TCI state(s)/TCI codepoint(s) in the (unified) TCI state(s) activation/deactivation MAC CE command is greater (or lower) than or equal to a threshold (the UE could determine or identify the threshold value according to or based on: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)), and/or when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s) for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated by the network, e.g., via a beam activation and/or indication MAC CE or DCI (e.g., via a TCI codepoint of a TCI field in the corresponding beam indication DCI format(s) 11/1_2 with or without DL assignment), one or more TCI states, and/or when/if the higher layer parameter(s) TCI-State(s) and/or UL-TCIState(s) that provides or configures the one or more TCI states comprises, configures, provides, contains or includes information related to second candidate/new beam RS(s)/RS resource(s) following or according to those specified herein in the present disclosure, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated by the network, e.g., via a beam activation and/or indication MAC CE or DCI (e.g., via a TCI codepoint of a TCI field in the corresponding beam indication DCI format(s) 1_1/1_2 with or without DL assignment), one or more TCI states, and/or when/if the higher layer parameter(s) TCI-State(s) and/or UL-TCIState(s) that provides or configures the one or more TCI states comprises, configures, provides, contains or includes information related to second candidate/new beam RS(s)/RS resource(s) following or according to those specified herein in the present disclosure, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure, when/if one or more of the following conditions are satisfied/achieved:
In one example, the UE could be provided or configured or indicated by the network, e.g., in/by higher layer parameter(s)/signaling(s) that provides necessary information and/or configurations and/or setting(s) for the UE-initiated/event-driven beam reporting, an indicator to enable the UE to use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.
   For example, the indicator could correspond to a higher layer parameter provided by ‘enable2ndCandidateBeamRS’; in this case, when/if ‘enable2ndCandidateBeamRS’ is provided/configured and/or set to ‘enabled’ or ‘on’, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if ‘enable2ndCandidateBeamRS’ is not provided/configured/present or is absent or is provided/configured/present but set to ‘disabled’ or ‘off’, the UE could (only) use/apply the first candidate/new beam RS(s)/RS resource(s) to evaluate/declare instance(s) of the event and/or evaluate, detect or declare the event according to or following those specified herein in the present disclosure.
   For another example, the indicator could correspond to a one-bit flag indicator; in this case, when/if the one-bit flag indicator is provided/configured and/or set to ‘1’ (or 0″), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the one-bit flag indicator is not provided/configured/present or is absent or is provided/configured/present but set to ‘0’ (or ‘1’), the UE could (only) use/apply the first candidate/new beam RS(s)/RS resource(s) to evaluate/declare instance(s) of the event and/or evaluate, detect or declare the event according to or following those specified herein in the present disclosure.

In this design example, the higher layer parameter(s)/signaling(s) TCI-State and/or UL-TCIState that configures or provides the indicated TCI state according to or following those specified herein in the present disclosure could provide or configure or comprise the indicator.
In another example, when/if the number of the first candidate/new beam RS resource(s) in the CSI resource set is greater (or lower) than or equal to a threshold, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of the first candidate/new beam RS resource(s) in the CSI resource set is lower (or greater) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure. The threshold value defined herein could be determined or identified based on or according to: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated or provided by the network a (unified) TCI state(s) activation/deactivation MAC CE command comprising or indicating or providing or activating one or more TCI states or TCI codepoints each mapped to one or more TCI states, the UE could first identify or determine one or more second candidate/beam RSs or RS resources according to one or more of:
The second candidate/new beam RS(s) or RS resource(s) could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to the RS(s) in one or more (or all) of the (activated) TCI-State(s) or UL-TCIState(s) activated or indicated or provided by/in the (unified) TCI state(s) activation/deactivation MAC CE command. In this case, the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s).

The second candidate/new beam RS(s) or RS resource(s) could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)
each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to one or more (or all) of the SSB(s) that could be QCL'ed with the RS(s) in one or more (or all) of the (activated) TCI-State(s) or UL-TCIState(s) activated or indicated or provided by/in a/the (unified) TCI state(s) activation/deactivation MAC CE command. In this case, the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s). The UE could then use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated or provided by the network a (unified) TCI state(s) activation/deactivation MAC CE command comprising or indicating or providing or activating one or more TCI states or TCI codepoints each mapped to one or more TCI states, the UE could first identify or determine one or more second candidate/beam RSs or RS resources according to one or more of:
The second candidate/new beam RS(s) or RS resource(s) could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to the RS(s) in one or more (or all) of the (activated) TCI-State(s) or UL-TCIState(s) activated or indicated or provided by/in the (unified) TCI state(s) activation/deactivation MAC CE command. In this case, the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s).

The second candidate/new beam RS(s) or RS resource(s) could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to one or more (or all) of the SSB(s) that could be QCL'ed with the RS(s) in one or more (or all) of the (activated) TCI-State(s) or UL-TCIState(s) activated or indicated or provided by/in a/the (unified) TCI state(s) activation/deactivation MAC CE command. In this case, the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s). The UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure, when/if one or more of the following conditions are satisfied/achieved:
In one example, the UE could be provided or configured or indicated by the network, e.g., in/by higher layer parameter(s)/signaling(s) that provides necessary information and/or configurations and/or setting(s) for the UE-initiated/event-driven beam reporting, an indicator to enable the UE to use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.
   For example, the indicator could correspond to a higher layer parameter provided by ‘enable2ndCandidateBeamRS’; in this case, when/if ‘enable2ndCandidateBeamRS’ is provided/configured and/or set to ‘enabled’ or ‘on’, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if ‘enable2ndCandidateBeamRS’ is not provided/configured/present or is absent or is provided/configured/present but set to ‘disabled’ or ‘off’, the UE could (only) use/apply the first candidate/new beam RS(s)/RS resource(s) to evaluate/declare instance(s) of the event and/or evaluate, detect or declare the event according to or following those specified herein in the present disclosure.
   For another example, the indicator could correspond to a one-bit flag indicator; in this case, when/if the one-bit flag indicator is provided/configured and/or set to ‘1’ (or 0″), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the one-bit flag indicator is not provided/configured/present or is absent or is provided/configured/present but set to ‘0’ (or ‘1’), the UE could (only) use/apply the first candidate/new beam RS(s)/RS resource(s) to evaluate/declare instance(s) of the event and/or evaluate, detect or declare the event according to or following those specified herein in the present disclosure.

In this design example, the (unified) TCI state(s) activation/deactivation MAC CE command could indicate or provide or configure or comprise the indicator (e.g., via a new field or by (repurposing) an existing, e.g., an ‘R’, field).
In another example, when/if the number of the first candidate/new beam RS resource(s) in the CSI resource set is greater (or lower) than or equal to a threshold, the UE (e.g., the UE 116) could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of the first candidate/new beam RS resource(s) in the CSI resource set is lower (or greater) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure. The threshold value defined herein could be determined or identified based on or according to: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s).
In another example, when/if the number of (activated) TCI state(s)/TCI codepoint(s) in the (unified) TCI state(s) activation/deactivation MAC CE command is lower (or greater) than or equal to a threshold (the UE could determine or identify the threshold value according to or based on: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of (activated) TCI state(s)/TCI codepoint(s) in the (unified) TCI state(s) activation/deactivation MAC CE command is greater (or lower) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure.

The second candidate/new beam RS(s) or RS resource(s) specified/defined herein in the present disclosure could also be associated, specific or linked to a/the CSI reporting setting provided or configured for the UE-initiated/event-driven beam reporting as specified/defined herein in the present disclosure.

According to those specified herein in the present disclosure, a UE could transmit or send to the network a first capability signaling to indicate whether or not they could support using/applying RS resource(s) provided or configured in a CSI resource set in a CSI resource setting associated/linked to a CSI reporting setting to evaluate/declare instance(s) of the event and/or evaluate, detect or declare the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. Additionally, a UE could transmit or send to the network a second capability signaling to indicate whether or not they could support using/applying candidate/new beam RS(s)/RS resource(s) provided or configured or comprised or included or contained in/by the higher layer parameter(s) TCI-State(s) and/or UL-TCIState(s) that provides or configures one or more indicated TCI states following or according to those specified herein in the present disclosure to evaluate/declare instance(s) of the event and/or evaluate, detect or declare the event according to or following those specified herein in the present disclosure. Here, the first capability signaling could be different or separate from the second capability signaling, or optionally, the first capability signaling could be identical to or same as the second capability signaling. Furthermore, a UE's basic feature (i.e., the feature that the UE has to support) could comprise one or more of:
Support of using/applying RS resource(s) provided or configured in a CSI resource set in a CSI resource setting associated/linked to a CSI reporting setting to evaluate/declare instance(s) of the event and/or evaluate, detect or declare the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure
Support of using/applying candidate/new beam RS(s)/RS resource(s) provided or configured or comprised or included or contained in/by the higher layer parameter(s) TCI-State(s) and/or UL-TCIState(s) that provides or configures one or more indicated TCI states following or according to those specified herein in the present disclosure to evaluate/declare instance(s) of the event and/or evaluate, detect or declare the event according to or following those specified herein in the present disclosure

When a UE is indicated by the network, e.g., via a beam activation and/or indication MAC CE or DCI (e.g., via a TCI codepoint of a TCI field in the corresponding beam indication DCI format(s) 11/1_2 with or without DL assignment), one or more TCI states, the UE could expect that the higher layer parameter(s) TCI-State(s) and/or UL-TCIState(s) that provides or configures the one or more TCI states could comprise, configure, provide, contain or include information related to candidate/new beam RS(s)/RS resource(s) following or according to those specified herein in the present disclosure, and/or the UE could expect to use/apply the candidate/new beam RS(s)/RS resource(s) to evaluate/declare instance(s) of the event and/or evaluate, detect or declare the event according to or following those specified herein in the present disclosure if one or more of the following conditions are satisfied or achieved or held:
The UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, a specific or particular event (e.g., the second event or Event-2) for the UE-initiated/event-driven beam reporting.
The UE has indicated or sent to the network, e.g., in/via a capability signaling, their support of at least an event counter and/or an event timer/time window as specified/defined herein in the present disclosure.
The UE has indicated or sent to the network, e.g., in/via a capability signaling, their support of the maximum number of event instance(s), e.g., that can be higher layer configured/provided in a CSI/beam resource setting or a CSI/beam resource set for the UE-initiated/event-driven beam reporting associated/linked/specific to a CSI/beam reporting setting or configuration e.g. higher layer configured/provided for the UE-initiated/event-driven beam reporting, that the UE could use/apply, e.g., in an event counter, for evaluating or declaring the event (e.g., the second event or Event-2 or the third event or Event-3 as specified/defined herein in the present disclosure), being greater than (or less than or equal to) a threshold, wherein the threshold value could be determined or identified based on or according to: (i) fixed value(s), e.g., greater than 1, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
The UE has indicated or sent to the network, e.g., in/via a capability signaling, their support of the length/duration of the event timer(s)/time window(s), e.g., that can be higher layer configured/provided in a CSI/beam resource setting or a CSI/beam resource set for the UE-initiated/event-driven beam reporting associated/linked/specific to a CSI/beam reporting setting or configuration e.g. higher layer configured/provided for the UE-initiated/event-driven beam reporting, that the UE could use/apply, e.g., for evaluating instance(s) of the event (e.g., the second event or Event-2 or the third event or Event-3 as specified/defined herein in the present disclosure), being greater than (or less than or equal to) a threshold, wherein the threshold value could be determined or identified based on or according to: (i) fixed value(s), e.g., greater than 1 symbol/slot, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
The number of RS resource(s)—or the candidate/new beam RS resource(s) as specified/defined herein in the present disclosure—provided or configured in a CSI resource set in a CSI resource setting associated/linked to a CSI reporting setting for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure, is greater than (or less than or equal to) a threshold, wherein the threshold value could be determined or identified based on or according to: (i) fixed value(s), e.g., greater than 1 symbol/slot, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

According to or following those specified herein in the present disclosure, a UE could determine or identify a first set of one or more candidate/new beam RSs or RS resources to measure, assess or evaluate (e.g., to obtain the corresponding measurement result(s) including L1-RSRP(s)/L1-SINR(s)), e.g., for evaluating instance(s) of an event or evaluating or declaring an event according to or following those specified herein in the present disclosure, wherein the first set could correspond to a CSI resource set in a CSI resource setting associated/linked to a CSI reporting setting, and the CSI resource set, the CSI resource setting and/or the CSI reporting setting could be provided or configured for the UE-initiated/event-driven beam reporting as specified/defined herein in the present disclosure. In this case, to evaluate instance(s) of an event or to evaluate or declare an event according to or following those specified herein in the present disclosure, the UE could determine, identify or obtain the measurement result(s) including L1-RSRP(s)/L1-SINR(s) for candidate/new beam(s) by measuring, assessing or evaluating the beam qualities including L1-RSRP(s)/L1-SINR(s) of one or more of the one or more candidate/new beam RSs or RS resources in the first set having same value(s)—e.g., in terms of their RS or RS resource index(es) in their respective sets or their RS or RS resource ID(s)—as one or more of RS(s) or RS resource(s) in a second set, and/or quasi co-located (i.e., QCL'ed) with one or more of RS(s) or RS resource(s) in a second set. The UE could determine or identify the second set of one or more candidate/new beam RSs or RS resources according to or following one or more of:
In one example, the second set of RS(s) or RS resource(s) could be provided or configured or indicated to the UE, e.g., via higher layer RRC signaling(s)/parameter(s) and/or MAC CE command(s) and/or dynamic DCI based L1 signaling(s).
   For example, the second set of RS(s) or RS resource(s)—e.g., in terms/form of the corresponding RS/RS resource index(es) in the set and/or RS/RS resource ID(s)—could be provided or configured or indicated in higher layer parameter(s)/signaling(s) that provides necessary information and/or configurations and/or setting(s) for the UE-initiated/event-driven beam reporting. For instance, the higher layer parameter(s)/signaling(s) could correspond to TCI-State and/or UL-TCIState that configures or provides the indicated TCI state according to or following those specified herein in the present disclosure, wherein as specified/defined herein in the present disclosure the current beam RS(s) or RS resource(s) could be associated/specific to the indicated TCI state.
   For another example, the second set of RS(s) or RS resource(s)—e.g., in terms/form of the corresponding RS/RS resource index(es) in the set and/or RS/RS resource ID(s)—could be activated or updated or indicated or sub-selected by/in a MAC CE activation/deactivation or sub-selection or indication command. For instance, the MAC CE command could provide or indicate RS/RS resource index(es) and/or RS/RS resource ID(s) corresponding to the RS(s) or RS resource(s) in the second set. The MAC CE command herein could be a new MAC CE command or an existing MAC CE command, wherein the MAC CE command could correspond to or could be similarly designed according to the beam failure detection (BFD)-RS Indication MAC CE, SP CSI-RS/CSI-IM Resource Set Activation/Deactivation MAC CE, Aperiodic CSI Trigger State Subselection MAC CE and/or etc.
In another example, the second set of RS(s) or RS resource(s)—e.g., in terms/form of the corresponding RS/RS resource index(es) in the set and/or RS/RS resource ID(s)—could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to the RS(s) in one or more (or all) of the (activated) TCI-State(s) or UL-TCIState(s) activated or indicated or provided by/in a/the (unified) TCI state(s) activation/deactivation MAC CE command.
In another example, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the RS(s) in one or more (or all) of the (activated) TCI-State(s) or UL-TCIState(s) activated or indicated or provided by/in a/the (unified) TCI state(s) activation/deactivation MAC CE command.

The UE could determine or identify whether the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set—expecting that the UE has already determined or identified the second set following or according to those specified herein in the present disclosure—according to or following those specified/defined herein in one or more examples herein according to or based on: (1) fixed rule(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent or transmitted to the network via various UL channels/signals, e.g., by/in part of the CSI/beam report and/or UE's capability signaling(s).
In one example, the UE could be provided or configured or indicated by the network, e.g., in/by higher layer parameter(s)/signaling(s) that provides necessary information and/or configurations and/or setting(s) for the UE-initiated/event-driven beam reporting, an indicator to indicate to the UE whether the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein to evaluate instance(s) of an event or evaluate or declare an event according to or following those specified herein in the present disclosure.
   For example, the indicator could correspond to a higher layer parameter provided by ‘enableCandidateBeamRSSubset’; in this case, when/if ‘enableCandidateBeamRSSubset’ is provided/configured and/or set to ‘enabled’ or ‘on’, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein; otherwise, i.e., when/if ‘enableCandidateBeamRSSubset’ is not provided/configured/present or is absent or is provided/configured/present but set to ‘disabled’ or ‘off’, the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure.
   For another example, the indicator could correspond to a one-bit flag indicator; in this case, when/if the one-bit flag indicator is provided/configured and/or set to ‘1’ (or ‘0’), the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein one or more examples herein; otherwise, i.e., when/if the one-bit flag indicator is not provided/configured/present or is absent or is provided/configured/present but set to ‘0’ (or ‘1’), the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure.

For the design example as specified/defined herein in the present disclosure, the higher layer parameter(s)/signaling(s) TCI-State and/or UL-TCIState that configures or provides the indicated TCI state according to or following those specified herein in the present disclosure could provide or configure or comprise the indicator, wherein as specified/defined herein in the present disclosure the current beam RS(s) or RS resource(s) could be associated/specific to the indicated TCI state. For one or more examples herein, the corresponding MAC CE activation, deactivation, indication or sub-selection command(s) could indicate, provide, comprise, include or contain the indicator (e.g., via a new field or by (repurposing) an existing field, e.g., an ‘R’ field).
In another example, when/if the number of activated TCI state(s)/TCI codepoint(s) in the (unified) TCI state(s) activation/deactivation MAC CE command is greater (or lower) than or equal to a threshold, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein; otherwise, i.e., when/if the number of activated TCI state(s)/TCI codepoint(s) in the (unified) TCI state(s) activation/deactivation MAC CE command is lower (or greater) than or equal to the threshold, (i) the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure, or (ii) the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein (i.e., rather than those specified/defined herein in one or more examples herein). The herein could be based on or according to network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. The value of the threshold defined herein could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
In another example, when/if the number of candidate/new beam RS(s) or RS resource(s) in the first set is greater (or lower) than or equal to a threshold, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein; otherwise, i.e., when/if the number of candidate/new beam RS(s) or RS resource(s) in the first set is lower (or greater) than or equal to the threshold, the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure. The herein could be based on or according to network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. The threshold value defined herein could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

In particular, when/if the UE has determined or identified that the UE could assess or evaluate or measure beam qualities including L1-RSRP(s)/LI-SINR(s) of one or more of the one or more candidate/new beam RSs or RS resources in the first set according to one or more of the one or more candidate/new beam RSs or RS resources in the second set—expecting that the UE has already determined or identified the second set following or according to those specified herein in the present disclosure—according to or following those specified/defined herein in one or more examples herein according to or following those specified herein in the present disclosure,
When/if the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s), the UE could determine, identify or obtain the measurement result(s) including L1-RSRP(s)/LI-SINR(s) for candidate/new beam(s) by measuring, assessing or evaluating the beam qualities including L1-RSRP(s)/LI-SINR(s) of one or more of the one or more candidate/new beam RSs or RS resources in the first set that has/have same value(s)—e.g., in terms of their RS or RS resource index(es) in their respective sets or their RS or RS resource ID(s)—as one or more of the one or more candidate/new beam RSs or RS resources in the second set, and/or that is/are quasi co-located (i.e., QCL'ed) with one or more of the one or more candidate/new beam RSs or RS resources in the second set, to evaluate instance(s) of an event or evaluate, detect or declare an event according to or following those specified herein in the present disclosure, wherein the second set of RS(s) or RS resource(s)—e.g., in terms/form of the corresponding RS/RS resource index(es) in the set and/or RS/RS resource ID(s)—could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to the RS(s) in one or more (or all) of the (activated) TCI-State(s) or UL-TCIState(s) activated or indicated or provided by/in a/the (unified) TCI state(s) activation/deactivation MAC CE command (i.e., following those specified in one or more examples herein).
When/if the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s), the UE could determine, identify or obtain the measurement result(s) including L1-RSRP(s)/L1-SINR(s) for candidate/new beam(s) by measuring, assessing or evaluating the beam qualities including L1-RSRP(s)/L1-SINR(s) of one or more of the one or more candidate/new beam RSs or RS resources in the first set that has/have same value(s)—e.g., in terms of their RS or RS resource index(es) in their respective sets or their RS or RS resource ID(s)—as one or more of the one or more candidate/new beam RSs or RS resources in the second set, and/or that is/are quasi co-located (i.e., QCL'ed) with one or more of the one or more candidate/new beam RSs or RS resources in the second set, to evaluate instance(s) of an event or evaluate, detect or declare an event according to or following those specified herein in the present disclosure, wherein the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the RS(s) in one or more (or all) of the (activated) TCI-State(s) or UL-TCIState(s) activated or indicated or provided by/in a/the (unified) TCI state(s) activation/deactivation MAC CE command (i.e., following those specified in one or more examples herein).

For a UE configured with a CSI-ReportConfig with eventType for periodic RSs with the same periodicity configured by the newBeamResourceSet, without eventDetectionTimeWindowLength, and with dl-OrJointTCU-StateL1st, when an event instance is determined (as described in the following sections/paragraphs in the present disclosure),
for a RS configured by the newBeamResourceSet, if eventType is set to ‘event2’ or ‘event7’, or
for the RS in the indicated TCI state or the SS/PBCH block which is QCLed with the RS in the indicated TCI, if eventType is set to ‘event1’,
   the UE transmits UEIRI on a PUCCH format 0 or format 1 in the PUCCH resource (in the CC provided by pucchCell, if configured, in the CSI-ReportConfig) configured by PUCCHResource in the CSI-ReportConfig. As default/basic capability(s)/feature(s), for instance, the aforementioned UE may not indicate their support (e.g., in part of their capability(s) and/or capability signalling(s)) of configuration(s) of eventDetectionTimeWindowLength and/or eventInstanceCount, and/or the aforementioned UE could indicate their support (e.g., in part of their capability(s) and/or capability signalling(s)) of configuration(s) of eventDetectionTimeWindowLength=0 and/or eventInstanceCount=1 (i.e., UE-initiated/event-driven beam report/reporting based on one event instance as specified/described herein in the present disclosure), and/or the aforementioned UE could indicate their support of UE-initiated/event-driven beam report/reporting based on one event instance as specified/described herein in the present disclosure. Such/the aforementioned UE could indicate their support (e.g., in part of their capability(s) and/or capability signalling(s)) of reporting, including or comprising condition met indicator(s) in a/the CSI report to indicate whether RS(s) indicated by reported CRI(s) or SSBRI(s), in a/the (same) CSI report, trigger(s) the UEIRI transmission. Here, such/the aforementioned UE may not be provided or configured eventDetectionTimeWindowLength (i.e, without eventDetectionTimeWindowLength) but such/the aforementioned UE could expect to be or could be configured or provided PresenceOfConditionMetIndicator (e.g., set to ‘enabled’).

For a UE configured with a CSI-ReportConfig with eventType for periodic RSs with the same periodicity configured by the newBeamResourceSet, with eventDetectionTimeWindowLength, and with dl-OrJointTCU-StateL1st, when an event instance is determined (as described in the following sections/paragraphs in the present disclosure),
for a RS configured by the newBeamResourceSet, if eventType is set to ‘event2’ or ‘event7’, or
for the RS in the indicated TCI state or the SS/PBCH block which is QCLed with the RS in the indicated TCI, if eventType is set to ‘event1’, the UE
starts a timer for such RS from the initial value equal to the time window length provided by eventDetectionTimeWindowLength and sets the counter to 1, if the timer for such RS is not running; or
increments the counter for such RS by 1, if the timer for such RS is running.

If the number of event instances determined by the counter for such RS is greater than or equal to eventInstanceCount, the UE transmits UEIRI on a PUCCH format 0 or format 1 in the PUCCH resource (in the CC provided by pucchCell, if configured, in the CSI-ReportConfig) configured by PUCCHResource in the CSI-ReportConfig.

The counter of the event instances for such RS is reset, e.g., when/if the UE is configured with a CSI-ReportConfig with the higher layer parameter eventType set to ‘event1’, ‘event2’ and/or ‘event7’ as specified/defined herein in the present disclosure:
if the RS in the indicated TCI state is updated when/if newBeamResourceSet is a NZP-CSI-RS-ResourceSet configured with repetition, or/else
if the SS/PBCH block which is QCLed with the RS in the indicated TCI state is updated when/if newBeamResourceSet is a CSI-SSB-ResourceSet.

The UE does not expect that a CSI trigger state associated with CSI report configuration(s) configured with the higher layer parameter eventType is further associated with other CSI report configurations that are not configured with the higher layer parameter eventType.

For a UE configured with a CSI-ReportConfig with the higher layer parameter eventType set to ‘event2’, an event instance is determined for a RS configured by the newBeamResourceSet if the L1-RSRP value determined for a transmission occasion of such RS is an eventThreshold greater than the L1-RSRP value determined for a transmission occasion of:
the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a NZP-CSI-RS-ResourceSet configured with repetition, else
the SS/PBCH block which is QCLed with the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet
if CCofIndicatedTCI is not configured, or to the CC indicated by CCofIndicatedTCI in the CSI-ReportConfig), if newBeamResourceSet is a CSI-SSB-ResourceSet.

After transmitting UEIRI, the UE reports, as defined in Clause 6.3.2.1.2 of [5, [REF 2]], in a single reporting instance nrofReportedRS-UEIBR CRIs or SSBRIs corresponding to RSs provided by the newBeamResourceSet that comprise at least one RS that triggers the UEIRI transmission. For each CRI or SSBRI, the CSI report includes the absolute L1-RSRP or differential L1-RSRP and, when PresenceOfConditionMetIndicator is configured (with or without eventDetectionTimeWindowLength being configured/provided or when eventDetectionTimeWindowLength is configured), a condition met indicator indicating whether the RS indicated by reported CRI or SSBRI triggers the UEIRI transmission, and, when enabledCurrentBeamReport is configured, the absolute L1-RSRP or differential L1-RSRP corresponding to the RS in the indicated TCI state, or to the SS/PBCH block which is QCLed with the RS in the indicated TCI state. The UE (e.g., the UE 116) sends the CSI report
on a PUSCH indicated by the DCI format 0_1/0_2 in a PDCCH reception if reportTransmissionMode is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS in the indicated TCI state is the RS w.r.t. QCL-TypeD, if there are two QCL RSs in the indicated TCI state.
In one example, when enabledCurrentBeamReport is not configured, the aforementioned CSI report may not include any (absolute/differential) L1-RSRP corresponding to the RS in the indicated TCI state, or to the SS/PBCH block which is QCLed with the RS in the indicated TCI state. For this design example, the absolute L1-RSRP could correspond to the largest measured value of L1-RSRP quantized to a 7-bit value in the range of [−140, −44] dBm with 1 dB step size, and a/the differential L1-RSRP is quantized to a 4-bit value, computed with 2 dB step size with a reference to the largest measured L1-RSRP value which is part of the same L1-RSRP reporting instance (i.e., the CSI report).
In another example, when enabledCurrentBeamReport is configured, according to or following those specified or described herein in the present disclosure, the aforementioned CSI report could include the absolute or differential L1-RSRP corresponding to the RS in the indicated TCI state, or to the SS/PBCH block which is QCLed with the RS in the indicated TCI state. For this design example,
   In one example, when/if the measured value of L1-RSRP corresponding to the RS in the indicated TCI state, or to the SS/PBCH block which is QCLed with the RS in the indicated TCI state is the largest among the measured values of L1-RSRPs including the measured L1-RSRPs each corresponding to a CRI or SSBRI reported in the (same) CSI report, the absolute L1-RSRP—i.e., quantized to a 7-bit value in the range of [−140, −44] dBm with 1 dB step size—could be reported for the RS in the indicated TCI state, or to the SS/PBCH block which is QCLed with the RS in the indicated TCI state, and a/the differential L1-RSRP—i.e., quantized to a 4-bit value and computed with 2 dB step size with a reference to the largest measured L1-RSRP value (in this case, this value corresponds to the RS in the indicated TCI state, or to the SS/PBCH block which is QCLed with the RS in the indicated TCI state) which is part of the same L1-RSRP reporting instance (i.e., the CSI report)—could be reported for a CRI or SSBRI in the same L1-RSRP reporting instance/CSI report.
   In another example, when/if the measured value of L1-RSRP corresponding to the RS in the indicated TCI state, or to the SS/PBCH block which is QCLed with the RS in the indicated TCI state is not the largest among the measured values of L1-RSRPs including the measured L1-RSRPs each corresponding to a CRI or SSBRI reported in the (same) CSI report, the differential L1-RSRP—i.e., quantized to a 4-bit value and computed with 2 dB step size with a reference to the largest measured L1-RSRP value which is part of the same L1-RSRP reporting instance (i.e., the CSI report)—could be reported for the RS in the indicated TCI state, or to the SS/PBCH block which is QCLed with the RS in the indicated TCI state. In this case, the largest measured value of L1-RSRP—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP—corresponding to CRI(s) or SSBRI(s) other than the first CRI or SSBRI reported in the CSI report—could be quantized to a 4-bit value and computed with 2 dB step size with a reference to the largest measured L1-RSRP value which is part of the same L1-RSRP reporting instance (i.e., the CSI report).
   In another example, the largest measured value of L1-RSRP among the measured values of L1-RSRPs including the measured L1-RSRPs each corresponding to a CRI or SSBRI reported in the (same) CSI report and excluding the measured value of L1-RSRP corresponding to the RS in the indicated TCI state, or to the SS/PBCH block which is QCLed with the RS in the indicated TCI state—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report). Furthermore, when/if the measured value of L1-RSRP corresponding to the RS in the indicated TCI state, or to the SS/PBCH block which is QCLed with the RS in the indicated TCI state is greater than (or equal to) the largest measured value of L1-RSRP as defined in the present example, the absolute L1-RSRP—i.e., quantized to a 7-bit value in the range of [−140, −44] dBm with idB step size—could be reported for the RS in the indicated TCI state, or to the SS/PBCH block which is QCLed with the RS in the indicated TCI state; otherwise, i.e., when/if the measured value of L1-RSRP corresponding to the RS in the indicated TCI state, or to the SS/PBCH block which is QCLed with the RS in the indicated TCI state is greater than (or equal to) the largest measured value of L1-RSRP as defined in the present example, a/the differential L1-RSRP—i.e., quantized to a 4-bit value and computed with 2 dB step size with a reference to the largest measured L1-RSRP value as defined in the present example—could be reported for the RS in the indicated TCI state, or to the SS/PBCH block which is QCLed with the RS in the indicated TCI state.
In another example, when enabledCurrentBeamReport is configured, according to or following those specified or described herein in the present disclosure, the aforementioned CSI report could include the absolute L1-RSRP corresponding to the RS in the indicated TCI state, or to the SS/PBCH block which is QCLed with the RS in the indicated TCI state, wherein the absolute L1-RSRP could be quantized to a 7-bit value in the range of [−140, −44] dBm with 1 dB step size. For this design example,
   In one example, the largest measured value of L1-RSRP among the measured values of L1-RSRPs including the measured L1-RSRPs each corresponding to a CRI or SSBRI reported in the (same) CSI report and excluding the measured value of L1-RSRP corresponding to the RS in the indicated TCI state, or to the SS/PBCH block which is QCLed with the RS in the indicated TCI state—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report).
   In another example, when/if the measured value of L1-RSRP corresponding to the RS in the indicated TCI state, or to the SS/PBCH block which is QCLed with the RS in the indicated TCI state is the largest among the measured values of L1-RSRPs including the measured L1-RSRPs each corresponding to a CRI or SSBRI reported in the (same) CSI report, a/the differential L1-RSRP—i.e., quantized to a 4-bit value and computed with 2 dB step size with a reference to the largest measured L1-RSRP value (in this case, this value corresponds to the RS in the indicated TCI state, or to the SS/PBCH block which is QCLed with the RS in the indicated TCI state) which is part of the same L1-RSRP reporting instance (i.e., the CSI report)—could be reported for a CRI or SSBRI in the same L1-RSRP reporting instance/CSI report.
   In another example, when/if the measured value of L1-RSRP corresponding to the RS in the indicated TCI state, or to the SS/PBCH block which is QCLed with the RS in the indicated TCI state is not the largest among the measured values of L1-RSRPs including the measured L1-RSRPs each corresponding to a CRI or SSBRI reported in the (same) CSI report, the largest measured value of L1-RSRP—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined herein in the present example
corresponding to CRI(s) or SSBRI(s) other than the first CRI or SSBRI reported in the CSI report—could be quantized to a 4-bit value and computed with 2 dB step size with a reference to the largest measured L1-RSRP value as defined herein in the present example which is part of the same L1-RSRP reporting instance (i.e., the CSI report).

The mapping order of the CSI field of one report for the absolute or differential L1-RSRP corresponding to the RS in the indicated TCI state, or to the SS/PBCH block which is QCLed with the RS in the indicated TCI state could follow or could be based on or according to that/those presented or provided in Table 2 in the present disclosure.

For a UE configured with a CSI-ReportConfig with the higher layer parameter eventType set to ‘event2’, an event instance is determined for a RS configured by the newBeamResourceSet if the L1-RSRP value determined for a transmission occasion of such RS is an eventThreshold greater than the L1-RSRP value determined for a transmission occasion of
the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a NZP-CSI-RS-ResourceSet configured with repetition which could or may comprise the RS e.g. the corresponding RS ID/index of NZP CSI-RS resource ID/index provided by NZP-CSI-RS-ResourceId, else
the SS/PBCH block which is QCLed with the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet
if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block e.g. the corresponding SSB ID/index provided by SSB-Index.

In this case, for instance, after transmitting UEIRI, the UE reports, as defined in Clause 6.3.2.1.2 of [5, [REF 2]], in a single reporting instance nrofReportedRS-UEIBR CRIs or SSBRIs corresponding to RSs provided by the newBeamResourceSet that comprise at least one RS that triggers the UEIRI transmission. For each CRI or SSBRI, the CSI report includes the absolute L1-RSRP or differential L1-RSRP and, when PresenceOfConditionMetIndicator is configured (with or without eventDetectionTimeWindowLength being configured/provided or when eventDetectionTimeWindowLength is configured), a condition met indicator indicating whether the RS indicated by reported CRI or SSBRI triggers the UEIRI transmission, and, when enabledCurrentBeamReport is configured, the absolute L1-RSRP or differential L1-RSRP corresponding to the RS in the indicated TCI state, or to the SS/PBCH block which is QCLed with the RS in the indicated TCI state. In particular, a/the absolute L1-RSRP could correspond to the largest measured value of L1-RSRP quantized to a 7-bit value in the range of [−140, −44] dBm with 1 dB step size, and a/the differential L1-RSRP is quantized to a 4-bit value, computed with 2 dB step size with a reference to the largest measured L1-RSRP value which is part of the same L1-RSRP reporting instance (i.e., the CSI report). Furthermore,
In one example, when enabledCurrentBeamReport is configured, the CSI report could comprise or include a/the CRI or SSBRI—denoted by a/the current serving CRI or SSBRI—corresponding to the RS in the indicated TCI state, or to the SS/PBCH block which is QCLed with the RS in the indicated TCI state. For this design example, the UE could determine or identify that a/the reported absolute/differential L1-RSRP corresponding or associated to the current serving CRI or SSBRI could correspond to the RS in the indicated TCI state, or to the SS/PBCH block which is QCLed with the RS in the indicated TCI state. When PresenceOfConditionMetIndicator is configured (with or without eventDetectionTimeWindowLength being configured/provided or when eventDetectionTimeWindowLength is configured), (1) the reported current serving CRI or SSBRI (and/or the corresponding/associated absolute/differential L1-RSRP) is not associated or linked or mapped or corresponding to any condition met indicator, and/or (2) a/the condition met indication associated or linked or mapped or corresponding to the reported current serving CRI or SSBRI (and/or the corresponding/associated absolute/differential L1-RSRP) is set to ‘0’.
In another example, when enabledCurrentBeamReport is configured, the CSI report would not comprise or include any CRI or SSBRI corresponding to the RS in the indicated TCI state, or to the SS/PBCH block which is QCLed with the RS in the indicated TCI state. For this design example,
   For example, each reported absolute/differential L1-RSRP could be associated with a one-bit indicator; when/if a one-bit indicator is set to ‘1’ (or ‘0’), UE could determine or identify that the absolute/differential L1-RSRP associated with the one-bit indicator could correspond to the RS in the indicated TCI state, or to the SS/PBCH block which is QCLed with the RS in the indicated TCI state.
   For another example, the CSI report could include or comprise a bitmap with each entry/bit position of the bitmap associated with a reported absolute/differential L1-RSRP; when/if an entry/bit position of the bitmap is set to ‘1’ (or ‘0’), UE could determine or identify that the absolute/differential L1-RSRP associated with the entry/bit position of the bitmap could correspond to the RS in the indicated TCI state, or to the SS/PBCH block which is QCLed with the RS in the indicated TCI state.
   For another example, when/if a reported absolute/differential L1-RSRP is associated with an indicator used for indicating (whether or not) a reported absolute/differential L1-RSRP corresponds to the RS in the indicated TCI state, or to the SS/PBCH block which is QCLed with the RS in the indicated TCI state, the reported absolute/differential L1-RSRP could correspond to the RS in the indicated TCI state, or to the SS/PBCH block which is QCLed with the RS in the indicated TCI state. The indicator could be a one-bit indicator set to ‘1’ (or ‘0’); alternatively, when/if the indicator is present (e.g., regardless of the value of the indicator) and associated with a reported absolute/differential L1-RSRP, the UE could determine or identify that the absolute/differential L1-RSRP associated with the indicator could correspond to the RS in the indicated TCI state, or to the SS/PBCH block which is QCLed with the RS in the indicated TCI state.

The UE sends the CSI report
on a PUSCH indicated by the DCI format 0_1/0_2 in a PDCCH reception if reportTransmissionMode is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOjModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS in the indicated TCI state is the RS w.r.t. QCL-TypeD, if there are two QCL RSs in the indicated TCI state.

If the newBeamResourceSet is a NZP-CSI-RS-ResourceSet configured with repetition, the UE could determine or identify whether (or not) the newBeamResourceSet could comprise the RS, e.g. the corresponding RS ID/index of NZP CSI-RS resource ID/index provided by NZP-CSI-RS-ResourceId, in the indicated TCI state according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network via/by/in various UL channels/signals including CSI/beam report(s) and/or UE's capability signalling(s). If the newBeamResourceSet is a CSI-SSB-ResourceSet, the UE could determine or identify whether (or not) the newBeamResourceSet could comprise the SS/PBCH block e.g. the corresponding SSB ID/index provided by SSB-Index which is QCLed with the RS in the indicated TCI state according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network (e.g., the network 130) via/by/in various UL channels/signals including CSI/beam report(s) and/or UE's capability signalling(s). For instance,
the UE could indicate to the network, e.g., in part of their capability(s) and/or capability report(s)/signaling(s), whether (or not) they are capable of supporting or they could support that
   if the newBeamResourceSet is a NZP-CSI-RS-ResourceSet configured with repetition, the newBeamResourceSet could comprise the RS, e.g. the corresponding RS ID/index of NZP CSI-RS resource ID/index provided by NZP-CSI-RS-ResourceId, in the indicated TCI state, and/or
   if the newBeamResourceSet is a CSI-SSB-ResourceSet, the newBeamResourceSet could comprise the SS/PBCH block e.g. the corresponding SSB ID/index provided by SSB-Index which is QCLed with the RS in the indicated TCI state, and/or
when/if a higher layer parameter denoted by enableCurrentBeamRSinNewBeamSet provided in the CSI-ReportConfig is present/configured and/or set to ‘enabled’,
   if the newBeamResourceSet is a NZP-CSI-RS-ResourceSet configured with repetition, the UE could determine or identify that the newBeamResourceSet could comprise the RS, e.g. the corresponding RS ID/index of NZP CSI-RS resource ID/index provided by NZP-CSI-RS-ResourceId, in the indicated TCI state, and/or
   if the newBeamResourceSet is a CSI-SSB-ResourceSet, the UE could determine or identify that the newBeamResourceSet could comprise the SS/PBCH block e.g. the corresponding SSB ID/index provided by SSB-Index which is QCLed with the RS in the indicated TCI state.

The UE does not expect that the RS in the indicated TCI state or the SS/PBCH block which is QCLed with the RS in the indicated TCI state is in a different CC from the RSs configured by newBeamResourceSet, wherein the UE could determine a target CC for the SS/PBCH block according to or based on a target TCI state having (1) the SS/PBCH block as/corresponding to the referenceSignal (i.e., the QCL source RS) configured therein and (2) the RS in the indicated TCI state as a/the QCL target RS,
when/if the higher layer parameter(s) cell/servingCellId is present in TCI-State/QCL-Info that provides the target TCI state, the UE could determine the target CC as or according to or based on the value(s) of cell/servingCellId,
otherwise, i.e., when/if the higher layer parameter(s) cell/servingCellId is absent in/from TCI-State/QCL-Info that provides the target TCI state, the UE could determine the target CC as or according to or based on the CC in which the target TCI state is applied by the UE.

For a UE configured with a CSI-ReportConfig with the higher layer parameter eventType set to ‘event1’, an event instance is determined if the L1-RSRP value determined for a transmission occasion of
the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfg), if newBeamResourceSet is a NZP-CSI-RS-ResourceSet configured with repetition, else
the SS/PBCH block which is QCLed with the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet
if CCofIndicatedTCI is not configured, or to the CC indicated by CCofIndicatedTCI in the CSI-ReportConfig), if newBeamResourceSet is a CSI-SSB-ResourceSet, is lower than eventThreshold-Event1.

After transmitting UEIRI, the UE reports, as defined in Clause 6.3.2.1.2 of [5, [REF 2]], in a single reporting instance nrofReportedRS-UEIBR CRIs or SSBRIs corresponding to RSs provided by the newBeamResourceSet. For each CRI or SSBRI, the CSI report includes the absolute L1-RSRP or differential L1-RSRP, and, when enabledCurrentBeamReport is configured, the absolute L1-RSRP or differential L1-RSRP corresponding to the RS in the indicated TCI state, or to the SS/PBCH block which is QCLed with the RS in the indicated TCI state. The UE sends the CSI report
on a PUSCH indicated by the DCI format 0_1/0_2 in a PDCCH reception if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS in the indicated TCI state is the RS w.r.t. QCL-TypeD, if there are two QCL RSs in the indicated TCI state.
In one example, when enabledCurrentBeamReport is not configured, the aforementioned CSI report may not include any (absolute/differential) L1-RSRP corresponding to the RS in the indicated TCI state, or to the SS/PBCH block which is QCLed with the RS in the indicated TCI state. For this design example, the absolute L1-RSRP could correspond to the largest measured value of L1-RSRP quantized to a 7-bit value in the range of [−140, −44] dBm with 1 dB step size, and a/the differential L1-RSRP is quantized to a 4-bit value, computed with 2 dB step size with a reference to the largest measured L1-RSRP value which is part of the same L1-RSRP reporting instance (i.e., the CSI report).
In another example, when enabledCurrentBeamReport is configured, according to or following those specified or described herein in the present disclosure, the aforementioned CSI report could include the absolute or differential L1-RSRP corresponding to the RS in the indicated TCI state, or to the SS/PBCH block which is QCLed with the RS in the indicated TCI state. For this design example,
   In one example, when/if the measured value of L1-RSRP corresponding to the RS in the indicated TCI state, or to the SS/PBCH block which is QCLed with the RS in the indicated TCI state is the largest among the measured values of L1-RSRPs including the measured L1-RSRPs each corresponding to a CRI or SSBRI reported in the (same) CSI report, the absolute L1-RSRP—i.e., quantized to a 7-bit value in the range of [−140, −44] dBm with 1 dB step size—could be reported for the RS in the indicated TCI state, or to the SS/PBCH block which is QCLed with the RS in the indicated TCI state, and a/the differential L1-RSRP—i.e., quantized to a 4-bit value and computed with 2 dB step size with a reference to the largest measured L1-RSRP value (in this case, this value corresponds to the RS in the indicated TCI state, or to the SS/PBCH block which is QCLed with the RS in the indicated TCI state) which is part of the same L1-RSRP reporting instance (i.e., the CSI report)—could be reported for a CRI or SSBRI in the same L1-RSRP reporting instance/CSI report.
   In another example, when/if the measured value of L1-RSRP corresponding to the RS in the indicated TCI state, or to the SS/PBCH block which is QCLed with the RS in the indicated TCI state is not the largest among the measured values of L1-RSRPs including the measured L1-RSRPs each corresponding to a CRI or SSBRI reported in the (same) CSI report, the differential L1-RSRP—i.e., quantized to a 4-bit value and computed with 2 dB step size with a reference to the largest measured L1-RSRP value which is part of the same L1-RSRP reporting instance (i.e., the CSI report)—could be reported for the RS in the indicated TCI state, or to the SS/PBCH block which is QCLed with the RS in the indicated TCI state. In this case, the largest measured value of L1-RSRP—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP—corresponding to CRI(s) or SSBRI(s) other than the first CRI or SSBRI reported in the CSI report—could be quantized to a 4-bit value and computed with 2 dB step size with a reference to the largest measured L1-RSRP value which is part of the same L1-RSRP reporting instance (i.e., the CSI report).
   In another example, the largest measured value of L1-RSRP among the measured values of L1-RSRPs including the measured L1-RSRPs each corresponding to a CRI or SSBRI reported in the (same) CSI report and excluding the measured value of L1-RSRP corresponding to the RS in the indicated TCI state, or to the SS/PBCH block which is QCLed with the RS in the indicated TCI state—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report). Furthermore, when/if the measured value of L1-RSRP corresponding to the RS in the indicated TCI state, or to the SS/PBCH block which is QCLed with the RS in the indicated TCI state is greater than (or equal to) the largest measured value of L1-RSRP as defined in the present example, the absolute L1-RSRP—i.e., quantized to a 7-bit value in the range of [−140, −44] dBm with idB step size—could be reported for the RS in the indicated TCI state, or to the SS/PBCH block which is QCLed with the RS in the indicated TCI state; otherwise, i.e., when/if the measured value of L1-RSRP corresponding to the RS in the indicated TCI state, or to the SS/PBCH block which is QCLed with the RS in the indicated TCI state is greater than (or equal to) the largest measured value of L1-RSRP as defined in the present example, a/the differential L1-RSRP—i.e., quantized to a 4-bit value and computed with 2 dB step size with a reference to the largest measured L1-RSRP value as defined in the present example
could be reported for the RS in the indicated TCI state, or to the SS/PBCH block which is QCLed with the RS in the indicated TCI state.
In another example, when enabledCurrentBeamReport is configured, according to or following those specified or described herein in the present disclosure, the aforementioned CSI report could include the absolute L1-RSRP corresponding to the RS in the indicated TCI state, or to the SS/PBCH block which is QCLed with the RS in the indicated TCI state, wherein the absolute L1-RSRP could be quantized to a 7-bit value in the range of [−140, −44] dBm with 1 dB step size. For this design example,
   In one example, the largest measured value of L1-RSRP among the measured values of L1-RSRPs including the measured L1-RSRPs each corresponding to a CRI or SSBRI reported in the (same) CSI report and excluding the measured value of L1-RSRP corresponding to the RS in the indicated TCI state, or to the SS/PBCH block which is QCLed with the RS in the indicated TCI state—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report).
   In another example, when/if the measured value of L1-RSRP corresponding to the RS in the indicated TCI state, or to the SS/PBCH block which is QCLed with the RS in the indicated TCI state is the largest among the measured values of L1-RSRPs including the measured L1-RSRPs each corresponding to a CRI or SSBRI reported in the (same) CSI report, a/the differential L1-RSRP—i.e., quantized to a 4-bit value and computed with 2 dB step size with a reference to the largest measured L1-RSRP value (in this case, this value corresponds to the RS in the indicated TCI state, or to the SS/PBCH block which is QCLed with the RS in the indicated TCI state) which is part of the same L1-RSRP reporting instance (i.e., the CSI report)—could be reported for a CRI or SSBRI in the same L1-RSRP reporting instance/CSI report.
   In another example, when/if the measured value of L1-RSRP corresponding to the RS in the indicated TCI state, or to the SS/PBCH block which is QCLed with the RS in the indicated TCI state is not the largest among the measured values of L1-RSRPs including the measured L1-RSRPs each corresponding to a CRI or SSBRI reported in the (same) CSI report, the largest measured value of L1-RSRP—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined herein in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined herein in the present example which is part of the same L1-RSRP reporting instance (i.e., the CSI report).

The mapping order of the CSI field of one report for the absolute or differential L1-RSRP corresponding to the RS in the indicated TCI state, or to the SS/PBCH block which is QCLed with the RS in the indicated TCI state could follow or could be based on or according to that/those presented or provided in Table 2 in the present disclosure.

For a UE configured with a CSI-ReportConfig with the higher layer parameter eventType set to ‘event1’, an event instance is determined if the L1-RSRP value determined for a transmission occasion of
the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a NZP-CSI-RS-ResourceSet configured with repetition which could or may comprise the RS e.g. the corresponding RS ID/index of NZP CSI-RS resource ID/index provided by NZP-CSI-RS-ResourceId, else
the SS/PBCH block which is QCLed with the RS in the indicated TCI state (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet
if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block e.g. the corresponding SSB ID/index provided by SSB-Index,
   is lower than eventThreshold-Event1. In this case, for instance, after transmitting UEIRI, the UE reports, as defined in Clause 6.3.2.1.2 of [5, TS [REF 2]], in a single reporting instance nrofReportedRS-UEIBR CRIs or SSBRIs corresponding to RSs provided by the newBeamResourceSet. For each CRI or SSBRI, the CSI report includes the absolute L1-RSRP or differential L1-RSRP, and, when enabledCurrentBeamReport is configured, the absolute L1-RSRP or differential L1-RSRP corresponding to the RS in the indicated TCI state, or to the SS/PBCH block which is QCLed with the RS in the indicated TCI state. In particular, a/the absolute L1-RSRP could correspond to the largest measured value of L1-RSRP quantized to a 7-bit value in the range of [−140, −44] dBm with 1 dB step size, and a/the differential L1-RSRP is quantized to a 4-bit value, computed with 2 dB step size with a reference to the largest measured L1-RSRP value which is part of the same L1-RSRP reporting instance (i.e., the CSI report). Furthermore,
In one example, when enabledCurrentBeamReport is configured, the CSI report could comprise or include a/the CRI or SSBRI—denoted by a/the current serving CRI or SSBRI—corresponding to the RS in the indicated TCI state, or to the SS/PBCH block which is QCLed with the RS in the indicated TCI state. For this design example, the UE could determine or identify that a/the reported absolute/differential L1-RSRP corresponding or associated to the current serving CRI or SSBRI could correspond to the RS in the indicated TCI state, or to the SS/PBCH block which is QCLed with the RS in the indicated TCI state.
In another example, when enabledCurrentBeamReport is configured, the CSI report would not comprise or include any CRI or SSBRI corresponding to the RS in the indicated TCI state, or to the SS/PBCH block which is QCLed with the RS in the indicated TCI state. For this design example,
   For example, each reported absolute/differential L1-RSRP could be associated with a one-bit indicator; when/if a one-bit indicator is set to ‘1’ (or ‘0’), UE could determine or identify that the absolute/differential L1-RSRP associated with the one-bit indicator could correspond to the RS in the indicated TCI state, or to the SS/PBCH block which is QCLed with the RS in the indicated TCI state.
   For another example, the CSI report could include or comprise a bitmap with each entry/bit position of the bitmap associated with a reported absolute/differential L1-RSRP; when/if an entry/bit position of the bitmap is set to ‘1’ (or ‘0’), UE could determine or identify that the absolute/differential L1-RSRP associated with the entry/bit position of the bitmap could correspond to the RS in the indicated TCI state, or to the SS/PBCH block which is QCLed with the RS in the indicated TCI state.
   For another example, when/if a reported absolute/differential L1-RSRP is associated with an indicator used for indicating (whether or not) a reported absolute/differential L1-RSRP corresponds to the RS in the indicated TCI state, or to the SS/PBCH block which is QCLed with the RS in the indicated TCI state, the reported absolute/differential L1-RSRP could correspond to the RS in the indicated TCI state, or to the SS/PBCH block which is QCLed with the RS in the indicated TCI state. The indicator could be a one-bit indicator set to ‘1’ (or ‘0’); alternatively, when/if the indicator is present (e.g., regardless of the value of the indicator) and associated with a reported absolute/differential L1-RSRP, the UE could determine or identify that the absolute/differential L1-RSRP associated with the indicator could correspond to the RS in the indicated TCI state, or to the SS/PBCH block which is QCLed with the RS in the indicated TCI state.

The UE sends the CSI report
on a PUSCH indicated by the DCI format 0_1/0_2 in a PDCCH reception if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS in the indicated TCI state is the RS w.r.t. QCL-TypeD, if there are two QCL RSs in the indicated TCI state.

If the newBeamResourceSetis a NZP-CSI-RS-ResourceSet configured with repetition, the UE (e.g., the UE 116) could determine or identify whether (or not) the newBeamResourceSet could comprise the RS, e.g. the corresponding RS ID/index of NZP CSI-RS resource ID/index provided by NZP-CSI-RS-ResourceId, in the indicated TCI state according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network via/by/in various UL channels/signals including CSI/beam report(s) and/or UE's capability signalling(s). If the newBeamResourceSet is a CSI-SSB-ResourceSet, the UE could determine or identify whether (or not) the newBeamResourceSet could comprise the SS/PBCH block e.g. the corresponding SSB ID/index provided by SSB-Index which is QCLed with the RS in the indicated TCI state according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network via/by/in various UL channels/signals including CSI/beam report(s) and/or UE's capability signalling(s). For instance,
the UE could indicate to the network, e.g., in part of their capability(s) and/or capability report(s)/signaling(s), whether (or not) they are capable of supporting or they could support that
   if the newBeamResourceSet is a NZP-CSI-RS-ResourceSet configured with repetition, the newBeamResourceSet could comprise the RS, e.g. the corresponding RS ID/index of NZP CSI-RS resource ID/index provided by NZP-CSI-RS-ResourceId, in the indicated TCI state, and/or
   if the newBeamResourceSet is a CSI-SSB-ResourceSet, the newBeamResourceSet could comprise the SS/PBCH block e.g. the corresponding SSB ID/index provided by SSB-Index which is QCLed with the RS in the indicated TCI state, and/or
when/if a higher layer parameter denoted by enableCurrentBeamRSinNewBeamSet provided in the CSI-ReportConfig is present/configured and/or set to ‘enabled’,
   if the newBeamResourceSet is a NZP-CSI-RS-ResourceSet configured with repetition, the UE could determine or identify that the newBeamResourceSet could comprise the RS, e.g. the corresponding RS ID/index of NZP CSI-RS resource ID/index provided by NZP-CSI-RS-ResourceId, in the indicated TCI state, and/or
   if the newBeamResourceSet is a CSI-SSB-ResourceSet, the UE could determine or identify that the newBeamResourceSet could comprise the SS/PBCH block e.g. the corresponding SSB ID/index provided by SSB-Index which is QCLed with the RS in the indicated TCI state.

The UE does not expect that the RS in the indicated TCI state or the SS/PBCH block which is QCLed with the RS in the indicated TCI state is in a different CC from the RSs configured by newBeamResourceSet, wherein the UE could determine a target CC for the SS/PBCH block according to or based on a target TCI state having (1) the SS/PBCH block as/corresponding to the referenceSignal (i.e., the QCL source RS) configured therein and (2) the RS in the indicated TCI state as a/the QCL target RS,
when/if the higher layer parameter(s) cell/servingCellId is present in TCI-State/QCL-Info that provides the target TCI state, the UE could determine the target CC as or according to or based on the value(s) of cell/servingCellId,
otherwise, i.e., when/if the higher layer parameter(s) cell/servingCellId is absent in/from TCI-State/QCL-Info that provides the target TCI state, the UE could determine the target CC as or according to or based on the CC in which the target TCI state is applied by the UE.

In one design example, for a UE configured with a CSI-ReportConfig with the higher layer parameter eventType set to ‘event7’, e.g., with or without eventDetectionTimeWindowLength being configured/provided, an event instance is determined for a RS configured by the newBeamResourceSet if the L1-RSRP value determined for a transmission occasion of such RS is an eventThreshold greater than the L1-RSRP value determined for a transmission occasion of
a/the RS with the valueOfQ-th highest L1-RSRP—denoted by a/the current serving NZP CSI-RS resource in the present disclosure—out of the RSs among the activated TCI states e.g. having or with their respective TOs within a (same) measurement occasion (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a NZP-CSI-RS-ResourceSet configured with repetition which could or may comprise the RS (or the current serving NZP CSI-RS resource) e.g. the corresponding RS ID/index of NZP CSI-RS resource ID/index provided by NZP-CSI-RS-ResourceId and/or the RSs e.g. the corresponding RS IDs/indexes of NZP CSI-RS resource IDs/indexes each provided by by NZP-CSI-RS-ResourceId in the activated TCI states, else
a/the SS/PBCH block—denoted by a/the current serving SS/PBCH block in the present disclosure
   with the valueOfQ-th highest L1-RSRP out of the SS/PBCH blocks QCLed with the RSs among the activated TCI states e.g. having or with their respective TOs within a (same) measurement occasion (applied to the same CC of CSI-ReportConfg if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block (or the current serving SS/PBCH block) e.g. the corresponding SSB ID/index provided by SSB-Index and/or the SS/PBCH blocks e.g. the corresponding SSB IDs/indexes each provided by SSB-Index, QCLed with the RSs in the activated TCI states; for this case, valueofQ could be in the range of or the value range for valueofQ could be [1, . . . , maxvalueofQ], where maxvalueofQ could correspond to the maximum number of SS/PBCH blocks that are QCLed with the RSs among the activated TCI states wherein maxvalueofQ could be higher layer configured and/or belong to {1, 2, 3, 4, 5, 6, 7, 8} subject or according to a corresponding UE's capability or capability signaling, and/or
   QCLed with the RS with/having the valueOfQ-th highest L1-RSRP (denoted by a/the current serving QCLed RS in the present disclosure) out of the RSs among the activated TCI states e.g. having or with their respective TOs within a (same) measurement occasion (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block (or the current serving SS/PBCH block) e.g. the corresponding SSB ID/index provided by SSB-Index and/or the SS/PBCH blocks e.g. the corresponding SSB IDs/indexes each provided by SSB-Index, QCLed with the RSs in the activated TCI states; for this case, valueofQ could be in the range of or the value range for valueofQ could be [1, 2, 3, 4, 5, 6, 7, 8].

In another design example, for a UE configured with a CSI-ReportConfig with the higher layer parameter eventType set to ‘event7’, e.g., with or without eventDetectionTimeWindowLength being configured/provided, an event instance is determined for a RS configured by the newBeamResourceSet if the L1-RSRP value determined for a transmission occasion of such RS is an eventThreshold greater than the L1-RSRP value determined for a transmission occasion (TO) of a/the (same) RS—denoted by a/the (same) reference RSRS in the present disclosure—determined as or according to or based on
the RS with the valueOfQ-th highest L1-RSRP (denoted by a/the current serving NZP CSI-RS resource in the present disclosure)—determined at or by or until or up to a reference point of time or a reference TO of such RS/the (same) reference RSRS—out of the RSs among the activated TCI states e.g. having or with their respective TOs within a (same) measurement occasion (applied to the same CC of CSI-ReportConfig if CCofIndicatedTCI is not configured and/or carrier indicating the CC for the RSs configured by newBeamResourceSet is not configured in the CSI-ReportConfig, or to the CC indicated by carrier in the CSI-ReportConfig—indicating the CC for the RSs configured by newBeamResourceSet—if CCofIndicatedTCI is not configured, or to the CC indicated by CCofIndicatedTCI in the CSI-ReportConfig), if newBeamResourceSet is a NZP-CSI-RS-ResourceSet configured with repetition which could or may comprise the RS (or the current serving NZP CSI-RS resource) e.g. the corresponding RS ID/index of NZP CSI-RS resource ID/index provided by NZP-CSI-RS-ResourceId and/or the RSs e.g. the corresponding RS IDs/indexes of NZP CSI-RS resource IDs/indexes each provided by by NZP-CSI-RS-ResourceId in the activated TCI states, else
the SS/PBCH block—denoted by a/the current serving SS/PBCH block in the present disclosure
   with the valueOfQ-th highest L1-RSRP—determined at or by or until or up to a reference point of time or a reference TO of such RS/the (same) reference RSRS—out of the SS/PBCH blocks QCLed with the RSRSs among the activated TCI states e.g. having or with their respective TOs within a (same) measurement occasion (applied to the same CC of CSI-ReportConfig if CCofIndicatedTCI is not configured and/or carrier indicating the CC for the RSRSs configured by newBeamResourceSet is not configured in the CSI-ReportConfig, or to the CC indicated by carrier in the CSI-ReportConfig—indicating the CC for the RSRSs configured by newBeamResourceSet—if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block (or the current serving SS/PBCH block) e.g. the corresponding SSB ID/index provided by SSB-Index and/or the SS/PBCH blocks e.g. the corresponding SSB IDs/indexes each provided by SSB-Index, QCLed with the RSRSs in the activated TCI states; for this case, valueofQ could be in the range of or the value range for valueofQ could be [1, . . . , maxvalueofQ], where maxvalueofQ could correspond to the maximum number of SS/PBCH blocks that are QCLed with the RSRSs among the activated TCI states wherein maxvalueofQ could be higher layer configured and/or belong to {1, 2, 3, 4, 5, 6, 7, 8} subject or according to a corresponding UE's capability or capability signaling, and/or
   QCLed with the RSRS with/having the valueOfQ-th highest L1-RSRP (denoted by a/the current serving QCLed RSRS in the present disclosure)—determined at or by or until or up to a reference point of time or a reference TO of such RSRS/the (same) reference RSRS—out of the RSRSs among the activated TCI states e.g. having or with their respective TOs within a (same) measurement occasion (applied to the same CC of CSI-ReportConfig if CCofIndicatedTCI is not configured and/or carrier indicating the CC for the RSRSs configured by newBeamResourceSet is not configured in the CSI-ReportConfig, or to the CC indicated by carrier in the CSI-ReportConfig—indicating the CC for the RSRSs configured by newBeamResourceSet—if CCofIndicatedTCI is not configured, or to the CC indicated by CCofIndicatedTCI in the CSI-ReportConfig), if newBeamResourceSet is a CSI-SSB-ResourceSet which could or may comprise the SS/PBCH block e.g. the corresponding SSB ID/index provided by SSB-Index and/or the SS/PBCH blocks e.g. the corresponding SSB IDs/indexes each provided by SSB-Index, QCLed with the RSRSs in the activated TCI states; for this case, valueofQ could be in the range of or the value range for valueofQ could be [1, 2, 3, 4, 5, 6, 7, 8].

For this design example, the UE could determine or identify the (same) reference RSRS (and therefore the corresponding reference point of time or the reference TO of such RSRS/the (same) reference RSRS) according to or based on or following: (i) fixed rule(s)/value(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For instance, the UE could determine or identify the (same) reference RSRS (and therefore the corresponding reference point of time or the reference TO of such RSRS/the (same) reference RSRS) according to or based on or following UE's own implementation(s); alternatively, the UE could determine or identify the reference point of time or the reference TO of such RSRS/the (same) reference RSRS as
when an event instance is determined, and/or
when the UE starts a timer for such RSRS from the initial value equal to the time window length provided by eventDetectionTimeWindowLength, and/or
when the UE starts a timer for such RSRS, at the start (or end) of a TO of such RSRS/the (same) reference RSRS for which an event instance is determined, from the initial value equal to the time window length provided by eventDetectionTimeWindowLength, and/or
when the UE starts a timer for such RSRS, at the k-th symbol/slot/etc. of a TO of such RSRS/the (same) reference RSRS for which an event instance is determined, from the initial value equal to the time window length provided by eventDetectionTimeWindowLength, and/or
when the timer is running, at the start (or end) of a TO of such RS/the (same) reference RS for which an event instance is determined when the value of the timer equals to the time window length provided by eventDetectionTimeWindowLength or eventDetectionTimeWindowLength−1, and/or
when the timer is running, at the k-th symbol/slot/etc. of a TO of such RS/the (same) reference RS for which an event instance is determined when the value of the timer equals to the time window length provided by eventDetectionTimeWindowLength or eventDetectionTimeWindowLength−1, and/or
when the timer is running, at the start (or end) of a TO of such RS/the (same) reference RS for which an event instance is determined when the value of the timer equals to 1 or 0, and/or
when the timer is running, at the k-th symbol/slot/etc. of a TO of such RS/the (same) reference RS for which an event instance is determined when the value of the timer equals to 1 or 0, and/or
when the timer is running, at the start (or end) of a TO of such RS/the (same) reference RS for which an event instance is determined when the counter for such RS or the number of event instance(s) determined by the counter for such RS is 0 or 1, and/or
when the timer is running, at the k-th symbol/slot/etc. of a TO of such RS/the (same) reference RS for which an event instance is determined when the counter for such RS or the number of event instance(s) determined by the counter for such RS is 0 or 1, and/or
when the timer is running, at the start (or end) of a TO of such RS/the (same) reference RS for which an event instance is determined when the counter for such RS or the number of event instance(s) determined by the counter for such RS is eventInstanceCount or eventInstanceCount−1 or eventInstanceCount+1, and/or
when the timer is running, at the k-th symbol/slot/etc. of a TO of such RS/the (same) reference RS for which an event instance is determined when the counter for such RS or the number of event instance(s) determined by the counter for such RS is eventInstanceCount or eventInstanceCount−1 or eventInstanceCount+1, and/or
when the timer is running, at the start (or end) of a TO of such RS/the (same) reference RS for which an event instance is determined when the counter for such RS or the number of event instance(s) determined by the counter for such RS is incremented by 1 for the last time before the timer expires or stops (e.g., the value of the timer equals to 0 or 1), and/or
when the timer is running, at the k-th symbol/slot/etc. of a TO of such RS/the (same) reference RS for which an event instance is determined when the counter for such RS or the number of event instance(s) determined by the counter for such RS is incremented by 1 for the last time before the timer expires or stops (e.g., the value of the timer equals to 0 or 1), and/or
at the start (or end) of a TO of such RS/the (same) reference RS for which an event instance is determined when the L1-RSRP value determined for a/the corresponding TO of the (same) RS is the largest or greatest among the L1-RSRP values determined for their corresponding or respective TOs of the (same) RS during when the timer is running, and/or
at the k-th symbol/slot/etc. of a TO of such RS/the (same) reference RS for which an event instance is determined when the L1-RSRP value determined for a/the corresponding TO of the (same) RS is the largest or greatest among the L1-RSRP values determined for their corresponding or respective TOs of the (same) RS during when the timer is running, and/or
at the start (or end) of a TO of such RS/the (same) reference RS for which an event instance is determined when the L1-RSRP value determined for a/the corresponding TO of the (same) RS is the smallest or lowest among the L1-RSRP values determined for their corresponding or respective TOs of the (same) RS during when the timer is running, and/or
at the k-th symbol/slot/etc. of a TO of such RS/the (same) reference RS for which an event instance is determined when the L1-RSRP value determined for a/the corresponding TO of the (same) RS is the smallest or lowest among the L1-RSRP values determined for their corresponding or respective TOs of the (same) RS during when the timer is running, and/or
at the start (or end) of a TO of such RS/the (same) reference RS for which an event instance is determined when the L1-RSRP value determined for a/the corresponding TO of the (same) RS is the p-th largest/greatest (or the p-th smallest/lowest) among the L1-RSRP values determined for their corresponding or respective TOs of the (same) RS during when the timer is running, and/or
at the k-th symbol/slot/etc. of a TO of such RS/the (same) reference RS for which an event instance is determined when the L1-RSRP value determined for a/the corresponding TO of the (same) RS is the p-th largest/greatest (or the p-th smallest/lowest) among the L1-RSRP values determined for their corresponding or respective TOs of the (same) RS during when the timer is running.

The UE could determine or identify the value(s) of k and/or p according to or based on or following: (1) fixed value(s) in system specification(s) and/or per RRC (re-)configuration, (2) network's configuration(s)/indication(s) e.g. via higher layer RRC signalling(s)/parameter(s) e.g. in the corresponding CSI-ReportConfig for the UEI reporting and/or MAC CE command(s) and/or dynamic DCI based L1 signaling(s) according to or based on or subject to corresponding UE's capability signalling(s), and/or (3) UE's autonomous determination, selection or decision, which could be further sent or transmitted or indicate the network (e.g., the network 130) via various UL channels/signals including UE's capability signalling(s), PUCCH(s), PUSCH(s) and/or CSI/beam report(s).

FIG. 10 illustrates example TOs of RSs 1000 according to embodiments of the present disclosure. For example, TOs of RSs 1000 can be utilized by any of the UEs 111-116 of FIG. 1, such as the UE 115. This example is for illustration only and other embodiments can be used without departing from the scope of the present disclosure.

In FIG. 10, a conceptual example of TO(s) of RS(s) specific to the activated TCI state(s), the corresponding MO(s) and/or etc. is provided. As illustrated in FIG. 10, there are three activated TCI states specific to RS #1, RS #2 and RS #3 respectively, where T represents the periodicity configured for the RSs specific to the activated TCI states. A measurement occasion (MO) here could comprise TOs of the corresponding RSs (RS #1, RS #2 and RS #3 in this example) wherein time gap or interval or offset between any or each two of the TOs within the MO could be less than or equal to T. Furthermore, time interval or gap or offset between two TOs of the same RS (e.g., RS #1) respectively within two neighboring MOs could be equal to T.

In one case (Case-1), for a UE configured with a CSI-ReportConfig with eventType for periodic RSs with the same periodicity configured by the newBeamResourceSet, with eventDetectionTimeWindowLength, and with dl-OrJointTCI-StateL1st, when an event instance is determined, for a RS configured by the newBeamResourceSet, if eventType is set to ‘event7’, the UE
starts a timer for such RS from the initial value equal to the time window length provided by eventDetectionTimeWindowLength and sets a/the counter for such RS to 1, if the timer for such RS is not running; or
increments the counter for such RS by 1, if the timer for such RS is running.

If the number of event instances determined by the counter for such RS is greater than or equal to eventInstanceCount, the UE transmits UEIRI on a PUCCH format 0 or format 1 in the PUCCH resource (in the CC provided by pucchCell, if configured, in the CSI-ReportConfg) configured by PUCCHResource in the CSI-ReportConfig—in this Case-1, such RS triggers the UEIRI transmission. For the aforementioned Case-1, the counter of the event instances for such RS is reset:
if any of the current serving NZP CSI-RS resource(s) as specified/defined herein in the present disclosure in the corresponding activated TCI state(s)—e.g., used for determining the corresponding event instance(s)—is updated when/if newBeamResourceSet is a NZP-CSI-RS-ResourceSet configured with repetition, or/else
if any of the current serving SS/PBCH block(s) as specified/defined herein in the present disclosure QCLed with the corresponding RS(s) in the corresponding activated TCI state(s)—e.g., used for determining the corresponding event instance(s)—is updated when/if newBeamResourceSet is a CSI-SSB-ResourceSet.

In another case (Case-2), for a UE configured with a CSI-ReportConfig with eventType for periodic RSs with the same periodicity configured by the newBeamResourceSet, with eventDetectionTimeWindowLength, and with dl-OrJointTCI-StateL1st, when an event instance is determined for (a pair of) a RS configured by the newBeamResourceSet and a current serving NZP CSI-RS resource or a current serving SS/PBCH block as specified/defined herein in the present disclosure, if eventType is set to ‘event7’, the UE
starts a timer for such RS from the initial value equal to the time window length provided by eventDetectionTimeWindowLength and sets a/the counter for (the pair of) such RS and the current serving NZP CSI-RS resource or the current serving SS/PBCH block to 1, if the timer for such RS is not running; or
if the timer for such RS is running, increments the counter for (the pair of) such RS and the current serving NZP CSI-RS resource or the current serving SS/PBCH block by 1.

If the number of event instances determined by a/the counter for (a/the (same) pair of) such RS and a/the (same) current serving NZP CSI-RS resource or a/the (same) current serving SS/PBCH block is greater than or equal to eventInstanceCount, the UE transmits UEIRI on a PUCCH format 0 or format 1 in the PUCCH resource (in the CC provided by pucchCell, if configured, in the CSI-ReportConfig) configured by PUCCHResource in the CSI-ReportConfig—in this Case-2, (a/the (same) pair of) such RS and a/the (same) current serving NZP CSI-RS resource or a/the (same) current serving SS/PBCH block trigger the UEIRI transmission. For the aforementioned Case-2, the counter of the event instances for (a/the (same) pair of) such RS and a/the (same) current serving NZP CSI-RS resource or a/the (same) current serving SS/PBCH block is reset:
if a/the aforementioned current serving NZP CSI-RS resource as specified/defined herein in the present disclosure in the corresponding activated TCI state is updated when/if newBeamResourceSet is a NZP-CSI-RS-ResourceSet configured with repetition, or/else
if a/the aforementioned current serving SS/PBCH block as specified/defined herein in the present disclosure QCLed with a RS in the corresponding activated TCI state is updated when/if newBeamResourceSet is a CSI-SSB-ResourceSet.

In another case (Case-3), for a UE configured with a CSI-ReportConfg with eventType for periodic RSs with the same periodicity configured by the newBeamResourceSet, with eventDetectionTimeWindowLength, and with dl-OrJointTCI-StateL1st, when an event instance is determined for a RS configured by the newBeamResourceSet (according to or based on a reference RS as specified/defined herein in the present disclosure), if eventType is set to ‘event7’, the UE
starts a timer for such RS from the initial value equal to the time window length provided by eventDetectionTimeWindowLength and sets a/the counter for such RS (together/along with the (same) reference RS) to 1, if the timer for such RS is not running; or
increments the counter for such RS (together/along with the (same) reference RS) by 1, if the timer for such RS is running.

If the number of event instances determined by the counter for such RS (together/along with the (same) reference RS) is greater than or equal to eventInstanceCount, the UE transmits UEIRI on a PUCCH format 0 or format 1 in the PUCCH resource (in the CC provided by pucchCell, if configured, in the CSI-ReportConfig) configured by PUCCHResource in the CSI-ReportConfig—in this Case-3, such RS (together/along with the (same) reference RS) triggers the UEIRI transmission. For the aforementioned Case-3, the counter of the event instances for such RS (together/along with the (same) reference RS) is reset:
if the aforementioned (same) reference RS corresponding to a current serving NZP CSI-RS resource in the corresponding activated TCI state as specified/defined herein in the present disclosure is updated when/if newBeamResourceSet is a NZP-CSI-RS-ResourceSet configured with repetition, or/else
if the aforementioned (same) reference RS corresponding to a current serving SS/PBCH block QCLed with a RS in the corresponding activated TCI state as specified/defined herein in the present disclosure is updated when/if newBeamResourceSet is a CSI-SSB-ResourceSet.

The UE could determine or identify which of Case-1, Case-2 and Case-3 as specified/defined herein in the present disclosure to follow or use or apply to determine event instance(s) hence when (or condition(s)) to trigger transmission of a UEIRI according to or based on or following: (1) fixed rule(s)/value(s) in system specification(s) and/or per RRC (re-)configuration, (2) network's configuration(s)/indication(s) e.g. via higher layer RRC signalling(s)/parameter(s) e.g. in the corresponding CSI-ReportConfig for the UEI reporting and/or MAC CE command(s) and/or dynamic DCI based L1 signaling(s) according to or based on or subject to corresponding UE's capability signalling(s), and/or (3) UE's autonomous determination, selection or decision, which could be further sent or transmitted or indicate the network via various UL channels/signals including UE's capability signalling(s), PUCCH(s), PUSCH(s) and/or CSI/beam report(s). For instance, the UE could send or transmit to the network, e.g., a bitmap via their capability signalling(s)/report(s), to indicate their support of one or more of:
Case-1 for determining event instance(s) hence when (or condition(s)) to trigger transmission of a UEIRI, and
Case-2 for determining event instance(s) hence when (or condition(s)) to trigger transmission of a UEIRI, and
Case-3 for determining event instance(s) hence when (or condition(s)) to trigger transmission of a UEIRI.

In one example, one or more of Case-1, Case-2 and Case-3 for determining event instance(s) hence when (or condition(s)) to trigger transmission of a UEIRI could be default or basic feature(s) or capability(s) for a UE; for instance, when/if Case-3 for determining event instance(s) hence when (or condition(s)) to trigger transmission of a UEIRI is the default or basic feature or capability for the UE, the UE could send or transmit to the network, in part of the their capability(s) or capability signalling(s), a bitmap having value(s) of [0 0], [0 1], [1 0] or [1 1] to indicate
that they do not support neither Case-1 nor Case-2,
their support of Case-2 only,
their support of Case-1 only, or
their support of both Case-1 and Case-2,
   respectively. In addition,
in one example, when/if a higher layer parameter eventTriggerType (e.g., provided or configured in the CSI-ReportConfig) is set to ‘case-1’, the UE could determine or identify Case-1 as specified/defined herein in the present disclosure to follow or use or apply to determine event instance(s) hence when (or condition(s)) to trigger transmission of a UEIRI; when/if the higher layer parameter eventTriggerType is set to ‘case-2’, the UE could determine or identify Case-2 as specified/defined herein in the present disclosure to follow or use or apply to determine event instance(s) hence when (or condition(s)) to trigger transmission of a UEIRI; when/if the higher layer parameter eventTriggerType is set to ‘case-3’, the UE could determine or identify Case-3 as specified/defined herein in the present disclosure to follow or use or apply to determine event instance(s) hence when (or condition(s)) to trigger transmission of a UEIRI;
in another example, the UE could receive from or could be indicated/configured/provided by the network a bitmap (e.g. via/in/by higher layer RRC signalling(s)/parameter(s) e.g. in the corresponding CSI-ReportConfig for the UEI reporting and/or MAC CE command(s) and/or dynamic DCI based L1 signaling(s) according to or based on or subject to corresponding UE's capability signalling(s)/report(s)) with each entry/bit position of the bitmap corresponding to Case-1, Case-2 or Case-3; for this design example, when/if an entry/bit position is set to ‘1’ (or ‘0’), the UE could determine or identify Case-1, Case-2 or Case-3 corresponding to the entry/bit position as specified/defined herein in the present disclosure to follow or use or apply to determine event instance(s) hence when (or condition(s)) to trigger transmission of a UEIRI;
in another example, the UE could receive from or could be indicated/configured/provided by the network a multi-bit (e.g., a 2-bit) indicator (e.g. via/in/by higher layer RRC signalling(s)/parameter(s) e.g. in the corresponding CSI-ReportConfig for the UEI reporting and/or MAC CE command(s) and/or dynamic DCI based L1 signaling(s) according to or based on or subject to corresponding UE's capability signalling(s)/report(s)) with each codepoint of the multi-bit indicator corresponding to Case-1, Case-2 or Case-3; for this design example, when/if the multi-bit indicator indicates a codepoint, the UE could determine or identify Case-1, Case-2 or Case-3 corresponding to the indicated codepoint as specified/defined herein in the present disclosure to follow or use or apply to determine event instance(s) hence when (or condition(s)) to trigger transmission of a UEIRI.

As specified/defined herein in the present disclosure, one or more of Case-1, Case-2 and Case-3 for determining event instance(s) hence when (or condition(s)) to trigger transmission of a UEIRI could be default or basic feature(s) or capability(s) for a UE; for instance, when/if Case-3 for determining event instance(s) hence when (or condition(s)) to trigger transmission of a UEIRI is the default or basic feature or capability for the UE, and/or when/if the UE does not receive from the network any configuration(s)/indication(s) as specified/defined herein in the present disclosure to indicate, configure, provide or enable one or more of Case-1 and Case-2 for the UE to determine event instance(s) hence when (or condition(s)) to trigger transmission of a UEIRI or the configuration(s)/indication(s) that indicates, configures, provides or enables one or more of Case-1 and Case-2 for the UE to determine event instance(s) hence when (or condition(s)) to trigger transmission of a UEIRI as specified/defined herein in the present disclosure is absent or is not present from/in the corresponding signalling(s) e.g. the CSI-ReportConfig, the UE could follow their default or basic feature or capability, i.e., Case-3 in this case, to determine event instance(s) hence when (or condition(s)) to trigger transmission of a UEIRI.

The counter of the event instances for such RS is reset, e.g., when/if the UE is configured with a CSI-ReportConfig with the higher layer parameter eventType set to ‘event1’, ‘event2’ and/or ‘event7’ as specified/defined herein in the present disclosure:
if the RS in the indicated TCI state is updated when/if newBeamResourceSet is a NZP-CSI-RS-ResourceSet configured with repetition, or/else
if the SS/PBCH block which is QCLed with the RS in the indicated TCI state is updated when/if newBeamResourceSet is a CSI-SSB-ResourceSet.

The UE could expect that valueofQ equals to 1, i.e., (1) the value of valueofQ could be fixed in system specification(s) and/or per RRC (re-)configuration, i.e., valueofQ=1, and/or (2) the UE could expect to be configured or provided by the network or assume from network's configuration(s)/indication(s) that valueofQ=1.

After transmitting UEIRI, the UE (e.g., the UE 116) reports, as defined in Clause 6.3.2.1.2 of [5, [REF 2]] in a single reporting instance nrofReportedRS-UEIBR CRIs or SSBRIs corresponding to RSs provided by the newBeamResourceSet that comprise at least one RS that triggers the UEIRI transmission. For each CRI or SSBRI, the CSI report includes the absolute L1-RSRP or differential L1-RSRP and, when PresenceOfConditionMetIndicator is configured (with or without eventDetectionTimeWindowLength being configured/provided when eventDetectionTimeWindowLength is configured), a condition met indicator indicating whether the RS indicated by reported CRI or SSBRI triggers the UEIRI transmission and, when enabledCurrentBeamReport is configured, one or more (e.g., K≥1 with K having a fixed value, e.g., K=1, in system specification(s)/per RRC (re-)configuration or higher layer configured in the CSI-ReportConfig subject to a corresponding UE's capability or capability signaling—e.g., K=1, 2, 3, 4 or K is up to nrofReportedRS-UEIBR) absolute L1-RSRPs or differential L1-RSRPs each corresponding to a current serving NZP CSI-RS resource, or to a current serving SS/PBCH block, or to a/the reference RS (e.g., for this case, K=1) as specified/defined herein in the present disclosure; for instance, supporting K=1 could be a default or basic feature/capability for a UE supporting the higher layer parameter eventType set to ‘event7’; the UE could send or transmit or indicate to the network, e.g., via/in part of their capability signaling(s)/report(s), their supported value(s) of K, e.g., 2, 3 and/or 4; furthermore, when/if a UE is not configured or provided any value(s) of K (e.g., the corresponding higher layer parameter that configures or provides value(s) of K is absent or not present) and/or is configured or provided K=0 or 1, the UE could apply K=1; in addition, for Case-3 and/or when/if Case-3 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) K=1, and for Case-1/Case-2 and/or when/if Case-1/Case-2 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) 1≤K≤nrofReportedRS-UEIBR (e.g., 4); optionally, i.e., when/if the UE is provided or configured by the network a corresponding higher layer signalling/parameter, e.g., in the CSI-ReportConfig, set to ‘enabled’ subject or according to a corresponding UE's capability and/or capability signalling/report, and/or when/if the UE autonomously determines the value of K, the UE could report, in the single reporting instance/CSI report, the value of K which could be in form of a k-bit field with k=┌ log₂(nrofR eportedRS—UEIBR)┐ (for nrofReportedRS-UEIBR=4, k=2). The UE sends the CSI report
on a PUSCH indicated by the DCI format 0_1/0_2 in a PDCCH reception if reportTransmissionMode is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS with the valueOfQ-r19-th highest L1-RSRP out of the corresponding activated TCI state RSs e.g. having or with their respective TOs within a (same) measurement occasion (MO) is the RS w.r.t. QCL-TypeD, if there are two QCL RSs in such activated TCI state.
In one example, when enabledCurrentBeamReport is not configured, the aforementioned CSI report may not include any (absolute/differential) L1-RSRP(s) corresponding to any current serving NZP CSI-RS resource(s), or to any current serving SS/PBCH block(s), or to any reference RS(s) as specified/defined herein in the present disclosure. For this design example, the absolute L1-RSRP could correspond to the largest measured value of L1-RSRP quantized to a 7-bit value in the range of [−140, −44] dBm with 1 dB step size, and a/the differential L1-RSRP is quantized to a 4-bit value, computed with 2 dB step size with a reference to the largest measured L1-RSRP value which is part of the same L1-RSRP reporting instance (i.e., the CSI report).
In another example, when enabledCurrentBeamReport is configured, according to or following those specified or described herein in the present disclosure, the aforementioned CSI report could include one or more absolute or differential L1-RSRPs each corresponding to a current serving NZP CSI-RS resource, or to a current serving SS/PBCH block, or to a reference RS as specified/defined herein in the present disclosure. For this design example,
   In one example, when/if a measured value of L1-RSRP corresponding to a current serving NZP CSI-RS resource, or to a current serving SS/PBCH block, or to a reference RS as specified/defined herein in the present disclosure is the largest among the measured values of L1-RSRPs including the measured L1-RSRPs each corresponding to a CRI or SSBRI reported in the (same) CSI report, the absolute L1-RSRP—i.e., quantized to a 7-bit value in the range of [−140, −44] dBm with 1 dB step size—could be reported for the aforementioned current serving NZP CSI-RS resource, or to the aforementioned current serving SS/PBCH block, or to the aforementioned reference RS as specified/defined herein in the present disclosure, and a/the differential L1-RSRP—i.e., quantized to a 4-bit value and computed with 2 dB step size with a reference to the largest measured L1-RSRP value (in this case, this value corresponds to the aforementioned current serving NZP CSI-RS resource, or to the aforementioned current serving SS/PBCH block, or to the aforementioned reference RS as specified/defined herein in the present disclosure) which is part of the same L1-RSRP reporting instance (i.e., the CSI report)—could be reported for a CRI or SSBRI in the same L1-RSRP reporting instance/CSI report, and/or for another current serving NZP CSI-RS resource or another current serving SS/PBCH block or another reference RS as specified/defined herein in the present disclosure different from or other than the aforementioned current serving NZP CSI-RS resource or the aforementioned current serving SS/PBCH block or the aforementioned reference RS as specified/defined herein in the present disclosure.
   In another example, when/if the measured value(s) of L1-RSRP(s) corresponding to any of the current serving NZP CSI-RS resource(s), or to any of the current serving SS/PBCH block(s), or to any of the reference RS(s) as specified/defined herein in the present disclosure is not the largest among the measured values of L1-RSRPs including the measured L1-RSRPs each corresponding to a CRI or SSBRI reported in the (same) CSI report, a differential L1-RSRP—i.e., quantized to a 4-bit value and computed with 2 dB step size with a reference to the largest measured L1-RSRP value which is part of the same L1-RSRP reporting instance (i.e., the CSI report)—could be reported for each of the current serving NZP CSI-RS resource(s) or the current serving SS/PBCH block(s) or the reference RS(s) as specified/defined herein in the present disclosure. In this case, the largest measured value of L1-RSRP
corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP—corresponding to CRI(s) or SSBRI(s) other than the first CRI or SSBRI reported in the CSI report—could be quantized to a 4-bit value and computed with 2 dB step size with a reference to the largest measured L1-RSRP value which is part of the same L1-RSRP reporting instance (i.e., the CSI report).
   In another example, the largest measured value of L1-RSRP among the measured values of L1-RSRPs including the measured L1-RSRPs each corresponding to a CRI or SSBRI reported in the (same) CSI report and excluding the measured value(s) of L1-RSRP(s) corresponding to the current serving NZP CSI-RS resource(s), or to the current serving SS/PBCH block(s), or to the reference RS(s) as specified/defined herein in the present disclosure—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report). Furthermore, when/if the measured value of L1-RSRP corresponding to a current serving NZP CSI-RS resource, or to a current serving SS/PBCH block, or to a reference RS as specified/defined herein in the present disclosure is greater than (or equal to) the largest measured value of L1-RSRP as defined in the present example, the absolute L1-RSRP—i.e., quantized to a 7-bit value in the range of [−140, −44] dBm with 1 dB step size—could be reported for the aforementioned current serving NZP CSI-RS resource or the aforementioned current serving SS/PBCH block or the aforementioned reference RS as specified/defined herein in the present disclosure; otherwise, i.e., when/if the measured value of L1-RSRP corresponding to a current serving NZP CSI-RS resource, or to a current serving SS/PBCH block, or to a reference RS as specified/defined herein in the present disclosure is smaller than (or equal to) the largest measured value of L1-RSRP as defined in the present example, a/the differential L1-RSRP—i.e., quantized to a 4-bit value and computed with 2 dB step size with a reference to the largest measured L1-RSRP value as defined in the present example—could be reported for the aforementioned current serving NZP CSI-RS resource or the aforementioned current serving SS/PBCH block or the aforementioned reference RS as specified/defined herein in the present disclosure.
   In another example, when/if a/the measured value of L1-RSRP corresponding to a current serving NZP CSI-RS resource or a current serving SS/PBCH block or to a reference RS as specified/defined herein in the present disclosure (denoted by a first current serving NZP CSI-RS resource or a first current serving SS/PBCH block or to a first reference RS here) is determined or reported as an absolute L1-RSRP—i.e., quantized to a 7-bit value in the range of [−140, −44] dBm with 1 dB step size, and when/if the aforementioned measured value of L1-RSRP is the largest at least among the measured value(s) of L1-RSRP(s) corresponding to the current serving NZP CSI-RS resource(s), or to the current serving SS/PBCH block(s), or to the reference RS(s) as specified/defined herein in the present disclosure that would be included in the CSI report, each of the measured value(s) of L1-RSRP(s) corresponding to the current serving NZP CSI-RS resource(s), or to the current serving SS/PBCH block(s), or to the reference RS(s) other than the first current serving NZP CSI-RS resource(s), or the first current serving SS/PBCH block, or the first reference RS here could be determined or reported as a differential L1-RSRP—i.e., quantized to a 4-bit value and computed with 2 dB step size with a reference to the aforementioned measured value of L1-RSRP corresponding to the first current serving NZP CSI-RS resource or the first current serving SS/PBCH block or the first reference RS as specified/defined here in a/the (same) reporting instance/CSI report.
In another example, when enabledCurrentBeamReport is configured, according to or following those specified or described herein in the present disclosure, the aforementioned CSI report could include one or more absolute L1-RSRPs each corresponding to a current serving NZP CSI-RS resource or a current serving SS/PBCH block or a reference RS as specified/defined herein in the present disclosure, wherein each of the one or more absolute L1-RSRPs could be quantized to a 7-bit value in the range of [−140, −44] dBm with 1 dB step size. For this design example,
   In one example, the largest measured value of L1-RSRP among the measured values of L1-RSRPs including the measured L1-RSRPs each corresponding to a CRI or SSBRI reported in the (same) CSI report and excluding the measured value(s) of L1-RSRP(s) corresponding to the current serving NZP CSI-RS resource(s), or to the current serving SS/PBCH block(s), or to the reference RS(s) as specified/defined herein in the present disclosure—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined in the present example which is part of the same L1-RSRP reporting instance (i.e., the CSI report).
   In another example, when/if a measured value of L1-RSRP corresponding to a current serving NZP CSI-RS resource, or to a current serving SS/PBCH block, or to a reference RS as specified/defined herein in the present disclosure is the largest among the measured values of L1-RSRPs including the measured L1-RSRPs each corresponding to a CRI or SSBRI reported in the (same) CSI report, a/the differential L1-RSRP—i.e., quantized to a 4-bit value and computed with 2 dB step size with a reference to the largest measured L1-RSRP value (in this case, this value corresponds to the aforementioned current serving NZP CSI-RS resource, or to the aforementioned current serving SS/PBCH block, or to the aforementioned reference RS as specified/defined herein in the present disclosure) which is part of the same L1-RSRP reporting instance (i.e., the CSI report)—could be reported for a CRI or SSBRI in the same L1-RSRP reporting instance/CSI report.
   In another example, when/if the measured value(s) of L1-RSRP(s) corresponding to any of the current serving NZP CSI-RS resource(s), or to any of the current serving SS/PBCH block(s), or to any of the reference RS(s) as specified/defined herein in the present disclosure is not the largest among the measured values of L1-RSRPs including the measured L1-RSRPs each corresponding to a CRI or SSBRI reported in the (same) CSI report, the largest measured value of L1-RSRP—corresponding to a first CRI or SSBRI reported in the CSI report—could be quantized to a 7-bit value in the range of [−140, −44] dBm with 1 dB step size, and measured value(s) of L1-RSRP(s) other or smaller than the largest measured value of L1-RSRP as defined herein in the present example—corresponding to CRI(s) or SSBRI(s) other than the first CRI or SSBRI reported in the CSI report—could be quantized to a 4-bit value and computed with 2 dB step size with a reference to the largest measured L1-RSRP value as defined herein in the present example which is part of the same L1-RSRP reporting instance (i.e., the CSI report).

The mapping order of the CSI field of one report for the absolute or differential L1-RSRP(s) corresponding to the current serving NZP CSI-RS resource(s), or to the current serving SS/PBCH block(s), or to the reference RS(s) as specified/defined herein in the present disclosure could follow or could be based on or according to that/those presented or provided in Table 2 in the present disclosure. For the design example(s) described or specified herein in the present disclosure, for K=1, the UE could determine or identify the corresponding current serving NZP CSI-RS resource or current serving SS/PBCH block (e.g., out of the corresponding current serving NZP CSI-RS resource(s) or current serving SS/PBCH block(s)), and therefore the corresponding or associated absolute/differential L1-RSRP to be included in the CSI report
according to or based on (i) fixed rule(s)/value(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination subject to UE's own implementation(s), which could be further sent to the network via/in part of various UL channels/signals and/or CSI/beam report(s) and/or UE's capability signaling(s), and/or
according to or based on or as a/the reference RS determined or identified according to or following those specified/defined herein in the present disclosure.

For the design example(s)/case(s) of,
(case-i) the newBeamResourceSet is a NZP-CSI-RS-ResourceSet configured with repetition which comprises the current serving NZP CSI-RS resource(s), e.g. the corresponding RS ID(s)/index(es) of NZP CSI-RS resource ID(s)/index(es) each provided by NZP-CSI-RS-ResourceId, as specified/defined herein in the present disclosure, and/or
(case-ii) the newBeamResourceSet is a NZP-CSI-RS-ResourceSet configured with repetition which comprises the RSs, e.g. the corresponding RS IDs/indexes of NZP CSI-RS resource IDs/indexes each provided by NZP-CSI-RS-ResourceId, in the activated TCI states, and/or
(case-iii) the newBeamResourceSet is a CSI-SSB-ResourceSet which comprises the current serving SS/PBCH block(s) as specified/defined herein in the present disclosure e.g. the corresponding SSB ID(s)/index(es) each provided by SSB-Index, and/or
(case-iv) the newBeamResourceSet is a CSI-SSB-ResourceSet which comprises the SS/PBCH blocks e.g. the corresponding SSB IDs/indexes each provided by SSB-Index, QCLed with the RSs in the activated TCI states, and/or
(case-v) the newBeamResourceSet is a NZP-CSI-RS-ResourceSet configured with repetition or a CSI-SSB-ResourceSet which comprises the reference RS(s), e.g. the corresponding RS ID(s)/index(es) of NZP CSI-RS resource ID(s)/index(es) each provided by NZP-CSI-RS-ResourceId, or of SSB ID(s)/index(es) each provided by SSB-Index as specified/defined herein in the present disclosure,
   for instance, after transmitting UEIRI, the UE reports, as defined in Clause 6.3.2.1.2 of [5, [REF 2]], in a single reporting instance nrofReportedRS-UEIBR CRIs or SSBRIs corresponding to RSs provided by the newBeamResourceSet that comprise at least one RS that triggers the UEIRI transmission. For each CRI or SSBRI, the CSI report includes the absolute L1-RSRP or differential L1-RSRP and, when PresenceOfConditionMetIndicator is configured (with or without eventDetectionTimeWindowLength being configured/provided or when eventDetectionTimeWindowLength is configured), a condition met indicator indicating whether the RS indicated by reported CRI or SSBRI triggers the UEIRI transmission, and, when enabledCurrentBeamReport is configured, one or more (e.g., K≥1 with K having a fixed value, e.g., K=1, in system specification(s)/per RRC (re-)configuration or higher layer configured in the CSI-ReportConfig subject to a corresponding UE's capability or capability signaling—e.g., K=1, 2, 3, 4 or K is up to nrofReportedRS-UEIBR) absolute L1-RSRPs or differential L1-RSRPs each corresponding to a current serving NZP CSI-RS resource, or to a current serving SS/PBCH block, or to a/the reference RS (e.g., for this case, K=1) as specified/defined herein in the present disclosure, according to or following those specified/defined herein in the present disclosure. Furthermore,
In one example, when enabledCurrentBeamReport is configured, the CSI report could comprise or include one or more (e.g., K≥1 with K having a fixed value, e.g., K=1, in system specification(s)/per RRC (re-)configuration or higher layer configured in the CSI-ReportConfig subject to a correponding UE's capability or capability signaling—e.g., K=1, 2, 3, 4 or K is up to nrofReportedRS-UEIBR) CRIs or SSBRIs—denoted by current serving CRI(s) or SSBRI(s)—each corresponding to a current serving NZP CSI-RS resource, or to a current serving SS/PBCH block, or to a/the reference RS (e.g., for this case, K=1) as specified/defined herein in the present disclosure. According to or following those specified/defined herein in the present disclosure, supporting K=1 could be a default or basic feature/capability for a UE supporting the higher layer parameter eventType set to ‘event7’; the UE could send or transmit or indicate to the network, e.g., via/in part of their capability signaling(s)/report(s), their supported value(s) of K, e.g., 2, 3 and/or 4; furthermore, when/if a UE is not configured or provided any value(s) of K (e.g., the corresponding higher layer parameter that configures or provides value(s) of K is absent or not present) and/or is configured or provided K=0 or 1, the UE could apply K=1; in addition, for Case-3 and/or when/if Case-3 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) K=1, and for Case-1/Case-2 and/or when/if Case-1/Case-2 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) 1≤K≤nrofReportedRS-UEIBR (e.g., 4); optionally, i.e., when/if the UE is provided or configured by the network a corresponding higher layer signalling/parameter, e.g., in the CSI-ReportConfig, set to ‘enabled’ subject or according to a corresponding UE's capability and/or capability signalling/report, and/or when/if the UE autonomously determines the value of K, the UE could report, in the single reporting instance/CSI report, the value of K which could be in form of a k-bit field with k=┌ log₂(nrofReportedRS−UEIBR)┐(for nrofReportedRS-UEIBR=4, k=2). For this design example, the UE could determine or identify that a/the reported absolute/differential L1-RSRP(s) corresponding or associated to the current serving CRI(s) or SSBRI(s) could correspond to the current serving NZP CSI-RS resource(s), or to the current serving SS/PBCH block(s), or to the reference RS(s) as specified/defined herein in the present disclosure. When PresenceOfConditionMetIndicator is configured (with or without eventDetectionTimeWindowLength being configured/provided or when eventDetectionTimeWindowLength is configured), (1) the reported current serving CRI(s) or SSBRI(s) (and/or the corresponding/associated absolute/differential L1-RSRP(s)) is not associated or linked or mapped or corresponding to any condition met indicator(s), and/or (2) a/the condition met indicator(s) associated or linked or mapped or corresponding to a reported current serving CRI or SSBRI (and/or the corresponding/associated absolute/differential L1-RSRP) is set to ‘0’.
In another example, when enabledCurrentBeamReport is configured, the CSI report would not comprise or include any CRI(s) or SSBRI(s) corresponding to the current serving NZP CSI-RS resource(s), or to the current serving SS/PBCH block(s), or to the reference RS(s) as specified/defined herein in the present disclosure. For this design example,
   For example, each reported absolute/differential L1-RSRP could be associated with a one-bit indicator; when/if a one-bit indicator is set to ‘1’ (or ‘0’), UE could determine or identify that the absolute/differential L1-RSRP associated with the one-bit indicator could correspond to a current serving NZP CSI-RS resource, or to a current serving SS/PBCH block, or to a/the reference RS as specified/defined herein in the present disclosure.
   For another example, the CSI report could include or comprise a bitmap with each entry/bit position of the bitmap associated with a reported absolute/differential L1-RSRP; when/if an entry/bit position of the bitmap is set to ‘1’ (or ‘0’), UE could determine or identify that the absolute/differential L1-RSRP associated with the entry/bit position of the bitmap could correspond to a current serving NZP CSI-RS resource, or to a current serving SS/PBCH block, or to a/the reference RS as specified/defined herein in the present disclosure.
   For another example, when/if a reported absolute/differential L1-RSRP is associated with an indicator used for indicating (whether or not) a reported absolute/differential L1-RSRP corresponds to a current serving NZP CSI-RS resource, or to a current serving SS/PBCH block, or to a/the reference RS as specified/defined herein in the present disclosure, the reported absolute/differential L1-RSRP could correspond to a current serving NZP CSI-RS resource, or to a current serving SS/PBCH block, or to a/the reference RS as specified/defined herein in the present disclosure. The indicator could be a one-bit indicator set to ‘1’ (or ‘0’); alternatively, when/if the indicator is present (e.g., regardless of the value of the indicator) and associated with a reported absolute/differential L1-RSRP, the UE could determine or identify that the absolute/differential L1-RSRP associated with the indicator could correspond to a current serving NZP CSI-RS resource, or to a current serving SS/PBCH block, or to a/the reference RS as specified/defined herein in the present disclosure.

The UE sends the CSI report
on a PUSCH indicated by the DCI format 0_1/0_2 in a PDCCH reception if reportTransmissionMode is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOjModeB in the same CC as the corresponding CSI-ReportConfig, on the first available transmission occasion numOfSymbols-ModeB symbols after the end of the transmitted PUCCH if reportTransmissionMode is configured as ‘ModeB’, where the periodicity of the PUCCH resource and type 1 CG-PUSCH resource is the same, numOfSymbols-ModeB is based on the numerology of the PUCCH resource with UEIRI transmitted, and the CG-PUSCH does not carry UL-SCH.

The RS with the valueOfQ-r19-th highest L1-RSRP out of the corresponding activated TCI state RSs is the RS w.r.t. QCL-TypeD, if there are two QCL RSs in such activated TCI state.

If the newBeamResourceSet is a NZP-CSI-RS-ResourceSet configured with repetition, the UE could determine or identify whether or not the newBeamResourceSet could comprise (1) the current serving NZP CSI-RS resource(s) and/or the reference RS(s)—in form of the current serving NZP CSI-RS resource(s) here, e.g. the corresponding RS ID(s)/index(es) of NZP CSI-RS resource ID(s)/index(es) each provided by NZP-CSI-RS-ResourceId, as specified/defined herein in the present disclosure and/or (2) the RSs, e.g. the corresponding RS IDs/indexes of NZP CSI-RS resource IDs/indexes each provided by NZP-CSI-RS-ResourceId, in the activated TCI states according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network via/by/in various UL channels/signals including CSI/beam report(s) and/or UE's capability signalling(s). If the newBeamResourceSet is a CSI-SSB-ResourceSet, the UE could determine or identify whether or not the newBeamResourceSet could comprise (1) the current serving SS/PBCH block(s) and/or the reference RS(s)—in form of the current serving SS/PBCH block(s) here as specified/defined herein in the present disclosure, e.g. the corresponding SSB ID(s)/index(es) each provided by SSB-Index and/or (2) the SS/PBCH blocks e.g. the corresponding SSB IDs/indexes each provided by SSB-Index, QCLed with the RSs in the activated TCI states, according to or based on: (i) fixed value(s)/rule(s) in system specification(s) and/or per RRC (re-)configuration, (ii) network's configuration(s)/indication(s) e.g., via/by/in higher layer RRC signalling(s)/parameter(s) and/or MAC CE command(s) and/or dynamic DCI based L1 signaling(s) according to or based on corresponding UE's capability(s) or capability signalling(s), and/or (iii) UE's autonomous determination, selection or decision which could be further sent or transmitted or indicated to the network via/by/in various UL channels/signals including CSI/beam report(s) and/or UE's capability signalling(s). For instance,
the UE could indicate to the network, e.g., in part of their capability(s) and/or capability report(s)/signaling(s), whether (or not) they are capable of supporting or they could support that
   if the newBeamResourceSet is a NZP-CSI-RS-ResourceSet configured with repetition, the newBeamResourceSet could comprise (1) the current serving NZP CSI-RS resource(s) and/or the reference RS(s)—in form of the current serving NZP CSI-RS resource(s) here, e.g. the corresponding RS ID(s)/index(es) of NZP CSI-RS resource ID(s)/index(es) each provided by NZP-CSI-RS-ResourceId, as specified/defined herein in the present disclosure and/or (2) the RSs, e.g. the corresponding RS IDs/indexes of NZP CSI-RS resource IDs/indexes each provided by NZP-CSI-RS-ResourceId, in the activated TCI states, and/or
   if the newBeamResourceSet is a CSI-SSB-ResourceSet, the newBeamResourceSet could comprise (1) the current serving SS/PBCH block(s) and/or the reference RS(s)—in form of the current serving SS/PBCH block(s) here as specified/defined herein in the present disclosure, e.g. the corresponding SSB ID(s)/index(es) each provided by SSB-Index and/or (2) the SS/PBCH blocks e.g. the corresponding SSB IDs/indexes each provided by SSB-Index, QCLed with the RSs in the activated TCI states, and/or
when/if a higher layer parameter denoted by enableCurrentBeamRSinNewBeamSet provided in the CSI-ReportConfig is present/configured and/or set to ‘enabled’,
   (condition-i) if the newBeamResourceSet is a NZP-CSI-RS-ResourceSet configured with repetition, the UE could determine or identify that the newBeamResourceSet could comprise (1) the current serving NZP CSI-RS resource(s) and/or the reference RS(s)—in form of the current serving NZP CSI-RS resource(s) here, e.g. the corresponding RS ID(s)/index(es) of NZP CSI-RS resource ID(s)/index(es) each provided by NZP-CSI-RS-ResourceId, as specified/defined herein in the present disclosure and/or (2) the RSs, e.g. the corresponding RS IDs/indexes of NZP CSI-RS resource IDs/indexes each provided by NZP-CSI-RS-ResourceId, in the activated TCI states, and/or
   (condition-ii) if the newBeamResourceSet is a CSI-SSB-ResourceSet, the UE could determine or identify that the newBeamResourceSet could comprise (1) the current serving SS/PBCH block(s) and/or the reference RS(s)—in form of the current serving SS/PBCH block(s) here as specified/defined herein in the present disclosure, e.g. the corresponding SSB ID(s)/index(es) each provided by SSB-Index and/or (2) the SS/PBCH blocks e.g. the corresponding SSB IDs/indexes each provided by SSB-Index, QCLed with the RSs in the activated TCI states.

The UE does not expect that a current serving NZP CSI-RS resource or a/the reference RS (when corresponding to a current serving NZP CSI-RS resource) as specified/defined herein in the present disclosure is in a different CC from the RSs configured by newBeamResourceSet, and/or the UE may not expect that a current serving SS/PBCH block (QCLed with a target RS in an activated TCI state according to or following those specified/defined herein in the present disclosure) or a/the reference RS (when corresponding to a current serving SS/PBCH block) as specified/defined herein in the present disclosure is in a target CC different from the CC the RSs configured by newBeamResourceSet are in, wherein the UE could determine the target CC for the current serving SS/PBCH block/reference RS according to or based on a target TCI state having (1) the current serving SS/PBCH block/reference RS as/corresponding to the referenceSignal (i.e., the QCL source RS) configured therein and (2) the target RS as a/the QCL target RS,
when/if the higher layer parameter(s) cell/servingCellId is present in TCI-State/QCL-Info that provides the target TCI state, the UE could determine the target CC as or according to or based on the value(s) of cell/servingCellId,
otherwise, i.e., when/if the higher layer parameter(s) cell/servingCellId is absent in/from TCI-State/QCL-Info that provides the target TCI state, the UE could determine the target CC as or according to or based on the CC in which the target TCI state is applied by the UE.

According to those specified/defined herein in the present disclosure, when/if an activated TCI state is specific or corresponding or associated to a reference RS,
when/if the reference RS corresponds to an NZP CSI-RS resource, the reference RS could correspond to the RS in the activated TCI state, and/or
when/if the reference RS corresponds to a SS/PBCH block, the reference RS could correspond to the SS/PBCH block QCLed with the RS in the activated TCI state, the activated TCI state could also be referred to as a reference activated TCI state. In addition, a TCI codepoint mapped or mapping to the reference activated TCI state can also be referred to as a reference TCI codepoint.

Furthermore, for a UE configured with a CSI-ReportConfig with the higher layer parameter eventType set to ‘event7’, after transmitting a/the UEIRI, the UE could report, as defined in Clause 6.3.2.1.2 of [5, [REF 2]] in a/the single reporting instance, when enableQthBestTciReport is configured (subject to or according to or based on a corresponding UE's capability or capability signaling/report, with or without eventDetectionTimeWindowLength being configured/provided or only when eventDetectionTimeWindowLength is configured), TCI information comprising one or more (e.g., K≥1 with K having a fixed value, e.g., K=1, in system specification(s)/per RRC (re-)configuration or higher layer configured in the CSI-ReportConfig subject to a corresponding UE's capability or capability signaling—e.g., K=1, 2, 3, 4 or K is up to nrofReportedRS-UEIBR) index/ID values each corresponding to a current serving NZP CSI-RS resource (denoted by a first current serving NZP CSI-RS resource here), or to a current serving SS/PBCH block (denoted by a first current serving SS/PBCH block here), or to a/the reference RS (e.g., for this case, K=1) as specified/defined herein in the present disclosure, that could be used or applied for determining the event instance(s)—e.g., for or of a/the (same) counter during when a/the (same) timer is running—and/or transmission of a/the UEIRI; for instance, supporting K=1 could be a default or basic feature/capability for a UE supporting the higher layer parameter eventType set to ‘event7’; the UE could send or transmit or indicate to the network (e.g., the network 130), e.g., via/in part of their capability signaling(s)/report(s), their supported value(s) of K, e.g., 2, 3 and/or 4; furthermore, when/if a UE is not configured or provided any value(s) of K (e.g., the corresponding higher layer parameter that configures or provides value(s) of K is absent or not present) and/or is configured or provided K=0 or 1, the UE could apply K=1; in addition, for Case-3 and/or when/if Case-3 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) K=1, and for Case-1/Case-2 and/or when/if Case-1/Case-2 is provided or configured or enabled for a UE to determine event instance(s) hence when (or condition(s)) to trigger transmission of a UEIRI according to or following those specified/defined herein in the present disclosure, the UE could apply or expect or assume (to be configured or provided with) 1≤K≤nrofReportedRS-UEIBR (e.g., 4); optionally, i.e., when/if the UE is provided or configured by the network a corresponding higher layer signalling/parameter, e.g., in the CSI-ReportConfig, set to ‘enabled’ subject or according to a corresponding UE's capability and/or capability signalling/report, and/or when/if the UE autonomously determines the value of K, the UE could report, in the single reporting instance/CSI report, the value of K which could be in form of a k-bit field with k=┌ log₂(nrofR eportedRS−UEIBR)┐ (for nrofReportedRS-UEIBR=4, k=2), wherein
in one example, e.g., with or without eventDetectionTimeWindowLength being configured/provided, and/or for Case-3 and/or when/if Case-3 is provided or configured or enabled for the UE to determine event instance(s) hence when (or condition(s)) to trigger transmission of a UEIRI according to or following those specified/defined herein in the present disclosure, and/or for Case-1/Case-2 and/or when/if Case-1/Case-2 is provided or configured or enabled for a UE to determine event instance(s) hence when (or condition(s)) to trigger transmission of a UEIRI according to or following those specified/defined herein in the present disclosure with K=1, the TCI information could comprise (only) one ID/index value (i.e., K=1) corresponding to (only) one first current serving NZP CSI-RS resource, or to (only) one first current serving SS/PBCH block as specified/defined herein in the present disclosure, or to the reference RS as specified/defined herein in the present disclosure; in particular, the (only) one ID/index value comprised in the TCI information could correspond to
   a/the index/ID of a/the TCI codepoint—among the TCI codepoint index(es)/ID(s) mapped/mapping to the activated TCI state(s)—mapped/mapping to a/the activated TCI state specific or corresponding or associated to the one first current serving NZP CSI-RS resource or the one first current serving SS/PBCH block or the reference RS as specified/defined herein in the present disclosure; in this case, the bitwidth for indicating a/the index/ID of a/the TCI codepoint could be ┌ log₂ S┐, where S is the maximum/total number of TCI codepoint(s) mapped/mapping to the TCI state(s) that can be/are/is activated for/in a given indication/activation instance—e.g., in a/the (enhanced) TCI state(s)/unified TCI state(s) activation/deactivation MAC CE (for instance, when/if S=4, the bitwidth here is 2, and when/if S=8, the bitwidth here is 3); and/or
   a/the index/ID of a/the TCI state—among the activated TCI state(s)—specific or corresponding or associated to the one first current serving NZP CSI-RS resource or the one first current serving SS/PBCH block or the reference RS as specified/defined herein in the present disclosure; in this case, the bitwidth for indicating a/the index/ID of a/the (activated) TCI state could be ┌ log₂ U┐, where U is the maximum/total number of TCI state(s) that can be/are/is activated for/in a given indication/activation instance—e.g., in a/the (enhanced) TCI state(s)/unified TCI state(s) activation/deactivation MAC CE (for instance, when/if U=4, the bitwidth here is 2, and when/if U=8, the bitwidth here is 3); and/or
   a/the index/ID (e.g., in terms/form of CRI or SSBRI) of the one first current serving NZP CSI-RS resource (for case-i and/or case-ii as specified/defined herein in the present disclosure and/or when/if condition-i as specified/defined herein in the present disclosure is satisfied, achieved or held) or the one first current serving SS/PBCH block—and/or its QCLed RS (for case-iii and/or case-iv as specified/defined herein in the present disclosure and/or when/if condition-ii as specified/defined herein in the present disclosure is satisfied, achieved or held) or the reference RS (for case-v as specified/defined herein in the present disclosure and/or when/if condition-i and/or condition-ii as specified/defined herein in the present disclosure are/is satisfied, achieved or held) as specified/defined herein in the present disclosure, e.g., among the RS(s) hence the corresponding RS ID(s)/index(es) in the newBeamResourceSet,
      for the one first current serving NZP CSI-RS resource or the reference RS (e.g., when/if the reference RS corresponds to a current serving NZP CSI-RS resource), the bitwidth for indicating a/the corresponding resource index/ID (e.g., in terms of CRI) could be ┌ log₂R┐, where: for example, R is the maximum/total number of NZP CSI-RS resource(s) in the corresponding resource set, e.g., newBeamResourceSet; for another example, R is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE (for these design examples, when/if R=4, the bitwidth here is 2, and when/if R=8, the bitwidth here is 3); and/or
      for the one first current serving SS/PBCH block or the reference RS (e.g., when/if the reference RS corresponds to a current serving SS/PBCH block), the bitwidth for indicating a/the corresponding resource index/ID (e.g., in terms of SSBRI) could be ┌ log₂ T┐, where: for example, T is the maximum/total number of SS/PBCH block(s) in the corresponding resource set, e.g., newBeamResourceSet; for another example, T is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE (for these design examples, when/if T=4, the bitwidth here is 2, and when/if T=8, the bitwidth here is 3); and/or
      for the one first current serving SS/PBCH block or the reference RS (e.g., when/if the reference RS corresponds to a current serving SS/PBCH block), the TCI information could comprise a/the first (resource) index/ID (e.g., in terms of CRI) of the current serving QCLed RS as specified/defined herein in the present disclosure in the activated TCI state that is QCLed with the one first current serving SS/PBCH block; in this case, the bitwidth for indicating a/the first resource index/ID (e.g., in terms of CRI) could be ┌ log₂V1┐, where: for example, V1 is the maximum/total number of NZP CSI-RS resource(s) in the corresponding resource set, e.g., newBeamResourceSet; for another example, V1 is the maximum/total number of NZP CSI-RS resource(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V1 is the maximum/total number of NZP CSI-RS resource(s) QCLed with the one first current serving SS/PBCH block or the reference RS; for another example, V1 is the maximum/total number of NZP CSI-RS resource(s) QCLed with the one first current serving SS/PBCH block or the reference RS and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V1=4, the bitwidth here is 2, and when/if V1=8, the bitwidth here is 3). The TCI information could additionally comprise a/the second index/ID (e.g., in terms of SSBRI) of the one first current serving SS/PBCH block; in this case, the bitwidth for indicating a/the second resource index/ID (e.g., in terms of SSBRI) could be ┌ log₂V2┐, where: for example, V2 is the maximum/total number of SS/PBCH block(s) in the corresponding resource set, e.g., newBeamResourceSet; for another example, V2 is the maximum/total number of SS/PBCH block(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V2 is the maximum/total number of SS/PBCH block(s) QCLed with the aforementioned current serving QCLed RS in the activated TCI state; for another example, V2 is the maximum/total number of SS/PBCH block(s) QCLed with the aforementioned current serving QCLed RS in the activated TCI state and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V2=4, the bitwidth here is 2, and when/if V2=8, the bitwidth here is 3),
wherein the UE could determine or identify value(s) of U, S, R, T, V1 and/or V2 according to or based on (i) fixed value(s) in system specification(s) and/or per RRC (re-)configuration(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling/report, and/or (iii) UE's autonomous determination/selection e.g. subject to their implementations( ), which could be further sent or transmitted or indicated to the network via various UL channels/signals including PUCCH(s), PUSCH(s), PRACH(s), and/or etc., e.g., in part of a CSI/beam report and/or UE's capability signaling(s), and the UE (e.g., the UE 116) could determine or identify the one first current serving NZP CSI-RS resource—out of the RSs with the valueOfQ-th highest L1-RSRPs out of the corresponding activated TCI state RSs (denoted by second current serving NZP CSI-RS resources here) such that a second current serving NZP CSI-RS resource could be with the valueOfQ-th highest L1-RSRP out of the corresponding activated TCI state RSs with/having their respective TOs in a (same) MO, wherein e.g. every or any two of the TOs respective to the activated TCI state RSs in a/the (same) MO comprising a/the (same) corresponding second current serving NZP CSI-RS resource could be separated by a number of symbol(s)/slot(s)/etc. smaller than or equal to the periodicity/offset configured for the RSs in the activated TCI states (the TOs respective to the activated TCI state RSs in a MO e.g. comprising a second current serving NZP CSI-RS resource and the TOs respective to the activated TCI state RSs in another different MO e.g. comprising another different second current serving NZP CSI-RS resource could be separated by a number of symbol(s)/slot(s)/etc. larger than or equal to the periodicity/offset configured for the RSs in the activated TCI states), or the one first current serving SS/PBCH block—out of the current serving SS/PBCH blocks denoted by second current serving SS/PBCH blocks as specified/defined herein in the present disclosure such that
   a second current serving SS/PBCH block could be with the valueOfQ-th highest L1-RSRP—e.g., determined at or by or until or up to a reference point of time or a reference TO of such RS/the (same) reference RS as specified/defined herein in the present disclosure—out of the SS/PBCH blocks QCLed with the RSs among the activated TCI states with/having their respective TOs in a/the (same) MO, wherein e.g. every or any two of the TOs respective to the activated TCI state RSs in a/the (same) MO or every or any two of the TOs respective to the SS/PBCH blocks—e.g. comprising a/the (same) corresponding second current serving SS/PBCH block—QCLed with the RSs among the activated TCI states with/having their respective TOs in a/the (same) MO are separated by a number of symbol(s)/slot(s)/etc. smaller than or equal to the periodicity/offset configured for the RSs in the activated TCI states or SS/PBCH blocks QCLed with the RSs among the activated TCI states (the TOs respective to the activated TCI state RSs in a MO and the TOs respective to the activated TCI state RSs in another different MO could be separated by a number of symbol(s)/slot(s)/etc. larger than or equal to the periodicity/offset configured for the RSs in the activated TCI states, and/or the TOs respective to the SS/PBCH blocks—e.g. comprising a second current serving SS/PBCH block—QCLed with the RSs among the activated TCI states with/having their respective TOs in a MO and the TOs respective to the SS/PBCH blocks—e.g. comprising another different second current serving SS/PBCH block—QCLed with the RSs among the activated TCI states with/having their respective TOs in another different MO could be separated by a number of symbol(s)/slot(s)/etc. larger than or equal to the periodicity/offset configured for the SS/PBCH blocks QCLed with the RSs among the activated TCI states), and/or
   a second current serving SS/PBCH block could be QCLed with the RS with/having the valueOfQ-th highest L1-RSRP (denoted by a/the second current serving QCLed RS in the present disclosure)—determined at or by or until or up to a reference point of time or a reference TO of such RS/the (same) reference RS as specified/defined herein in the present disclosure—out of the RSs among the activated TCI states with/having their respective TOs in a/the (same) MO, wherein e.g. every or any two of the TOs respective to the activated TCI state RSs in a/the (same) MO or every or any two of the TOs respective to the SS/PBCH blocks—e.g. comprising a/the (same) corresponding second current serving SS/PBCH block—QCLed with the RSs among the activated TCI states with/having their respective TOs in a/the (same) MO are separated by a number of symbol(s)/slot(s)/etc. smaller than or equal to the periodicity/offset configured for the RSs in the activated TCI states or SS/PBCH blocks QCLed with the RSs among the activated TCI states (the TOs respective to the activated TCI state RSs in a MO and the TOs respective to the activated TCI state RSs in another different MO could be separated by a number of symbol(s)/slot(s)/etc. larger than or equal to the periodicity/offset configured for the RSs in the activated TCI states, and/or the TOs respective to the SS/PBCH blocks—e.g. comprising a second current serving SS/PBCH block—QCLed with the RSs among the activated TCI states with/having their respective TOs in a MO and the TOs respective to the SS/PBCH blocks—e.g. comprising another different second current serving SS/PBCH block—QCLed with the RSs among the activated TCI states with/having their respective TOs in another different MO could be separated by a number of symbol(s)/slot(s)/etc. larger than or equal to the periodicity/offset configured for the SS/PBCH blocks QCLed with the RSs among the activated TCI states),
that could be used or applied for determining the event instance(s)—e.g., for or of a/the (same) counter during when a/the (same) timer for such RS is running—and/or transmission of a/the UEIRI, according to or based on or following: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s);
   for example, a TO of the one first current serving NZP CSI-RS resource, e.g., used or applied to determine an event instance (e.g., for or of a/the (same) counter during when a/the (same) timer for such RS is running), could have the highest (or lowest) L1-RSRP among the TOs of the second current serving NZP CSI-RS resources, e.g., used or applied to determine the event instances (e.g., for or of a/the (same) counter during when a/the (same) timer for such RS is running) and/or transmission of a/the UEIRI; and/or a TO of the one first current serving SS/PBCH block, e.g., used or applied to determine an event instance (e.g., for or of a/the (same) counter during when a/the (same) timer for such RS is running), could have the highest (or lowest) L1-RSRP among the TOs of the second current serving SS/PBCH blocks, e.g., used or applied to determine the event instances (e.g., for or of a/the (same) counter during when a/the (same) timer for such RS is running) and/or transmission of a/the UEIRI
   for another example, e.g., for Case-3 and/or when/if Case-3 is provided or configured or enabled for a UE to determine event instance(s) hence when (or condition(s)) to trigger transmission of a UEIRI according to or following those specified/defined herein in the present disclosure, the UE could determine or identify the one first current serving NZP CSI-RS resource or the one first current serving SS/PBCH block as specified/defined herein in the present disclosure as a/the (same) reference RS as specified/defined/determined herein in the present disclosure; in this case,
      a/the index/ID of a/the TCI codepoint comprised in the TCI information could correspond to a/the index/ID of the reference TCI codepoint mapped or mapping to the reference activated TCI state specific or corresponding or associated to the aforementioned reference RS—among the TCI codepoint index(es)/ID(s) mapped/mapping to the activated TCI state(s); in this case, the bitwidth for indicating a/the index/ID of a/the (reference) TCI codepoint could be ┌ log₂S┐, where S is the maximum/total number of TCI codepoint(s) mapped/mapping to the TCI state(s) that can be/are/is activated for/in a given indication/activation instance—e.g., in a/the (enhanced) TCI state(s)/unified TCI state(s) activation/deactivation MAC CE (for instance, when/if S=4, the bitwidth here is 2, and when/if S=8, the bitwidth here is 3); and/or
      a/the index/ID of a/the TCI state comprised in the TCI information could correspond to a/the index/ID of the reference activated TCI state specific or corresponding or associated to the reference RS—among the activated TCI state(s); in this case, the bitwidth for indicating a/the index/ID of a/the (reference activated) TCI state could be ┌ log₂ U┐, where U is the maximum/total number of TCI state(s) that can be/are/is activated for/in a given indication/activation instance—e.g., in a/the (enhanced) TCI state(s)/unified TCI state(s) activation/deactivation MAC CE (for instance, when/if U=4, the bitwidth here is 2, and when/if U=8, the bitwidth here is 3) and/or
      a/the index/ID (e.g., in terms/form of CRI or SSBRI) of the one first current serving NZP CSI-RS resource (for case-i and/or case-ii as specified/defined herein in the present disclosure and/or when/if condition-i as specified/defined herein in the present disclosure is satisfied, achieved or held) or the one first current serving SS/PBCH block (for case-iii and/or case-iv as specified/defined herein in the present disclosure and/or when/if condition-ii as specified/defined herein in the present disclosure is satisfied, achieved or held) as specified/defined herein in the present disclosure could correspond to a/the index/ID of the reference RS (for case-v as specified/defined herein in the present disclosure and/or when/if condition-i and/or condition-ii as specified/defined herein in the present disclosure are/is satisfied, achieved or held), e.g., among the RS(s) hence the corresponding RS ID(s)/index(es) in the newBeamResourceSet,
         for the one first current serving NZP CSI-RS resource or the reference RS (e.g., when/if the reference RS corresponds to a current serving NZP CSI-RS resource), the bitwidth for indicating a/the corresponding resource index/ID (e.g., in terms of CRI) could be ┌ log₂R┐, where: for example, R is the maximum/total number of NZP CSI-RS resource(s) in the corresponding resource set, e.g., newBeamResourceSet; for another example, R is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE; for another example, R is the maximum/total number of NZP CSI-RS resource(s) specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if R=4, the bitwidth here is 2, and when/if R=8, the bitwidth here is 3); and/or
         for the one first current serving SS/PBCH block or the reference RS (e.g., when/if the reference RS corresponds to a current serving SS/PBCH block), the bitwidth for indicating a/the corresponding resource index/ID (e.g., in terms of SSBRI) could be ┌ log₂ T┐, where: for example, T is the maximum/total number of SS/PBCH block(s) in the corresponding resource set, e.g., newBeamResourceSet; for another example, T is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE; for another example, T is the maximum/total number of SS/PBCH block(s) specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if T=4, the bitwidth here is 2, and when/if T=8, the bitwidth here is 3); and/or
      for the one first current serving SS/PBCH block or the reference RS (e.g., when/if the reference RS corresponds to a current serving SS/PBCH block), the TCI information could comprise a/the first (resource) index/ID (e.g., in terms of CRI) of the current serving QCLed RS as specified/defined herein in the present disclosure in the activated TCI state that is QCLed with the one first current serving SS/PBCH block; in this case, the bitwidth for indicating a/the first resource index/ID (e.g., in terms of CRI) could be ┌ log₂V1┐, where: for example, V1 is the maximum/total number of NZP CSI-RS resource(s) in the corresponding resource set, e.g., newBeamResourceSet; for another example, V1 is the maximum/total number of NZP CSI-RS resource(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V1 is the maximum/total number of NZP CSI-RS resource(s) QCLed with the one first current serving SS/PBCH block; for another example, V1 is the maximum/total number of NZP CSI-RS resource(s) QCLed with the one first current serving SS/PBCH block and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V1=4, the bitwidth here is 2, and when/if V1=8, the bitwidth here is 3). The TCI information could additionally comprise a/the second index/ID (e.g., in terms of SSBRI) of the one first current serving SS/PBCH block; in this case, the bitwidth for indicating a/the second resource index/ID (e.g., in terms of SSBRI) could be ┌ log₂V2┐, where: for example, V2 is the maximum/total number of SS/PBCH block(s) in the corresponding resource set, e.g., newBeamResourceSet; for another example, V2 is the maximum/total number of SS/PBCH block(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V2 is the maximum/total number of SS/PBCH block(s) QCLed with the aforementioned current serving QCLed RS in the activated TCI state; for another example, V2 is the maximum/total number of SS/PBCH block(s) QCLed with the aforementioned current serving QCLed RS in the activated TCI state and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V2=4, the bitwidth here is 2, and when/if V2=8, the bitwidth here is 3), wherein the UE could determine or identify value(s) of U, S, R, T, V1 and/or V2 according to or based on (i) fixed value(s) in system specification(s) and/or per RRC (re-)configuration(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling/report, and/or (iii) UE's autonomous determination/selection e.g. subject to their implementations( ), which could be further sent or transmitted or indicated to the network via various UL channels/signals including PUCCH(s), PUSCH(s), PRACH(s), and/or etc., e.g., in part of a CSI/beam report and/or UE's capability signaling(s).

For this design example, when enabledCurrentBeamReport is configured, the UE could report, as defined in Clause 6.3.2.1.2 of [5, [REF 2]], in a/the (same) single reporting instance/CSI report, the absolute L1-RSRP or differential L1-RSRP as specified/defined herein in the present disclosure corresponding to the one first current serving NZP CSI-RS resource, or to the one first current serving SS/PBCH block, or to the reference RS as specified/defined herein in the present disclosure. In addition, when PresenceOfConditionMetIndicator is configured (with or without eventDetectionTimeWindowLength being configured/provided or when eventDetectionTimeWindowLength is configured), the UE could report, as defined in Clause 6.3.2.1.2 of [5, [REF 2]], in a/the (same) single reporting instance/CSI report, one or more condition met indicators each indicating whether a corresponding RS—from the newBeamResourceSet—indicated by a corresponding reported CRI or SSBRI triggers the UEIRI transmission
in one example, e.g., for Case-1 or Case-2 and/or when/if Case-1 or Case-2 is provided or configured or enabled for a UE to determine event instance(s) hence when (or condition(s)) to trigger transmission of a UEIRI according to or following those specified/defined herein in the present disclosure with K=1, a one-bit condition met indicator can be set to ‘1’ indicating that (i) for Case-1, the corresponding RS—from the newBeamResourceSet—indicated by a corresponding reported CRI or SSBRI triggers the UEIRI transmission, or (2) for Case-2, (a/the (same) pair of) the corresponding RS—from the newBeamResourceSet—indicated by a corresponding reported CRI or SSBRI and the one first current serving NZP CSI-RS resource or the one first current serving SS/PBCH block trigger the UEIRI transmission according to or following those specified/defined herein in the present disclosure; otherwise, the one-bit condition met indicator is set to ‘0’;
in another example, e.g., for Case-3 and/or when/if Case-3 is provided or configured or enabled for the UE to determine event instance(s) hence when (or condition(s)) to trigger transmission of a UEIRI according to or following those specified/defined herein in the present disclosure, a one-bit condition met indicator can be set to ‘1’ indicating that the corresponding RS—from the newBeamResourceSet—indicated by a corresponding reported CRI or SSBRI (together/along with the (same) reference RS) triggers the UEIRI transmission according to or following those specified/defined herein in the present disclosure; otherwise, the one-bit condition met indicator is set to ‘0’.
in another example, e.g., with or without eventDetectionTimeWindowLength being configured/provided or only when eventDetectionTimeWindowLength is configured, and/or for Case-1/Case-2 and/or when/if Case-1/Case-2 is provided or configured or enabled for a UE to determine event instance(s) hence when (or condition(s)) to trigger transmission of a UEIRI according to or following those specified/defined herein in the present disclosure with K>1 (for this design example, the UE may not expect to be provided or configured or enabled by or with Case-3 to determine event instance(s) hence when (or condition(s)) to trigger transmission of a UEIRI according to or following those specified/defined herein in the present disclosure), the TCI information could comprise P>1 (here, P is the same as or identical to the defined/specified K herein with K>1) index/ID values respectively corresponding to P>1 first current serving NZP CSI-RS resources as defined/specified/determined herein in the present disclosure, or to P>1 first current serving SS/PBCH blocks as specified/defined/determined herein in the present disclosure, wherein P could have a fixed value, e.g., P=2, in system specification(s)/per RRC (re-)configuration or higher layer configured in the CSI-ReportConfig subject to a corresponding UE's capability or capability signaling—e.g., P=2, 3, 4 or P could be up to nrofReportedRS-UEIBR i.e. P≤nrofReportedRS-UEIBR; in particular, the P>1 index/ID values comprised in the TCI information could respectively correspond to
P>1 indexes/IDs of the (P>1) TCI codepoints—among the TCI codepoint indexes/IDs mapped/mapping to the activated TCI states—mapped/mapping to the activated TCI states each specific or corresponding or associated to one of the P>1 first current serving NZP CSI-RS resources or one of the P>1 first current serving SS/PBCH blocks as specified/defined herein in the present disclosure, wherein the P>1 indexes/IDs of the (P>1) TCI codepoints are ordered in the CSI fields of a/the (same) CSI report from high (or low) CSI field number(s)/index(es) to low (or high) CSI field number(s)/index(es) according to or based on
   values of the P>1 indexes/IDs of the (P>1) TCI codepoints from high to low (or low to high), and/or
   values of the P>1 indexes/IDs of the (P>1) TCI states mapped/mapping to the (P>1) TCI codepoints from high to low (or low to high), and/or
   values of the P>1 indexes/IDs of the (P>1) first current serving NZP CSI-RS resources or the (P>1) first current serving SS/PBCH blocks as specified/defined herein in the present disclosure—corresponding or associated or specific to the (P>1) TCI states mapped/mapping to the (P>1) TCI codepoints—from high to low (or low to high), and/or
   the largest measured L1-RSRPs of the P>1 first current serving NZP CSI-RS resources (of their respective/corresponding TOs) or the P>1 first current serving SS/PBCH blocks (of their respective/corresponding TOs) from high to low (or low to high), and/or
   order of the reported SSBRI(s) or CRI(s) corresponding to the SS/PBCH block(s) or NZP CSI-RS resource(s) determined or selected from the newBeamResourceSet—and therefore order of the corresponding L1-RSRP(s), e.g., from high to low—in the CSI field(s) of a/the (same) CSI report, and/or
   the time (from early/earlier/earliest to late/later/latest or vice versa) when the P>1 first current serving NZP CSI-RS resources or the P>1 first current serving SS/PBCH blocks (hence the corresponding P>1 TCI codepoints/activated TCI states) as specified/defined herein in the present disclosure are determined;
in this case, the bitwidth for indicating each of the P>1 indexes/IDs of the (P>1) TCI codepoint could be ┌ log₂S┐, where S is the maximum/total number of TCI codepoint(s) mapped/mapping to the TCI state(s) that can be/are/is activated for/in a given indication/activation instance—e.g., in a/the (enhanced) TCI state(s)/unified TCI state(s) activation/deactivation MAC CE (for instance, when/if S=4, the bitwidth here is 2, and when/if S=8, the bitwidth here is 3)
P>1 indexes/IDs of the (P>1) TCI states—among the activated TCI states—each specific or corresponding or associated to one of the P>1 first current serving NZP CSI-RS resources or one of the P>1 first current serving SS/PBCH blocks as specified/defined herein in the present disclosure, wherein the P>1 indexes/IDs of the (P>1) TCI states are ordered in the CSI fields of a/the (same) CSI report from high (or low) CSI field number(s)/index(es) to low (or high) CSI field number(s)/index(es) according to or based on
   values of the P>1 indexes/IDs of the (P>1) TCI states from high to low (or low to high), and/or
   values of the P>1 indexes/IDs of the (P>1) TCI codepoints mapped/mapping to the (P>1) TCI states from high to low (or low to high), and/or
   values of the P>1 indexes/IDs of the (P>1) first current serving NZP CSI-RS resources or the (P>1) first current serving SS/PBCH blocks as specified/defined herein in the present disclosure—corresponding or associated or specific to the (P>1) TCI states mapped/mapping to the (P>1) TCI codepoints—from high to low (or low to high), and/or
   the largest measured L1-RSRPs of the P>1 first current serving NZP CSI-RS resources (of their respective/corresponding TOs) or the P>1 first current serving SS/PBCH blocks (of their respective/corresponding TOs) from high to low (or low to high), and/or
   order of the reported SSBRI(s) or CRI(s) corresponding to the SS/PBCH block(s) or NZP CSI-RS resource(s) determined or selected from the newBeamResourceSet—and therefore order of the corresponding L1-RSRP(s), e.g., from high to low—in the CSI field(s) of a/the (same) CSI report, and/or
   the time (from early/earlier/earliest to late/later/latest or vice versa) when the P>1 first current serving NZP CSI-RS resources or the P>1 first current serving SS/PBCH blocks (hence the corresponding P>1 activated TCI states/TCI codepoints) as specified/defined herein in the present disclosure are determined;
in this case, the bitwidth for indicating each of the P>1 indexes/IDs of the (P>1) activated TCI states could be ┌ log₂ U┐, where U is the maximum/total number of TCI state(s) that can be/are/is activated for/in a given indication/activation instance—e.g., in a/the (enhanced) TCI state(s)/unified TCI state(s) activation/deactivation MAC CE (for instance, when/if U=4, the bitwidth here is 2, and when/if U=8, the bitwidth here is 3)
P>1 indexes/IDs (e.g., in terms/form of CRIs or SSBRIs) of the (P>1) first current serving NZP CSI-RS resources (for case-i and/or case-ii as specified/defined herein in the present disclosure and/or when/if condition-i as specified/defined herein in the present disclosure is satisfied, achieved or held) or the (P>1) first current serving SS/PBCH blocks (for case-iii and/or case-iv as specified/defined herein in the present disclosure and/or when/if condition-ii as specified/defined herein in the present disclosure is satisfied, achieved or held) as specified/defined herein in the present disclosure, e.g., among the RS(s) hence the corresponding RS ID(s)/index(es) in the newBeamResourceSet, wherein the P>1 indexes/IDs of the (P>1) first current serving NZP CSI-RS resources or the (P>1) first current serving SS/PBCH blocks as specified/defined herein in the present disclosure are ordered in the CSI fields of a/the (same) CSI report from high (or low) CSI field number(s)/index(es) to low (or high) CSI field number(s)/index(es) according to or based on
   values of the P>1 indexes/IDs of the (P>1) first current serving NZP CSI-RS resources or the (P>1) first current serving SS/PBCH blocks as specified/defined herein in the present disclosure from high to low (or low to high), and/or
   values of the P>1 indexes/IDs of the (P>1) TCI states each corresponding or associated or specific to a first current serving NZP CSI-RS resource or a first current serving SS/PBCH block from high to low (or low to high), and/or
   values of the P>1 indexes/IDs of the (P>1) TCI codepoints mapped/mapping to the (P>1) TCI states each corresponding or associated or specific to a first current serving NZP CSI-RS resource or a first current serving SS/PBCH block from high to low (or low to high), and/or
   the largest measured L1-RSRPs of the P>1 first current serving NZP CSI-RS resources (of their respective/corresponding TOs) or the P>1 first current serving SS/PBCH blocks (of their respective/corresponding TOs) from high to low (or low to high), and/or
   order of the reported SSBRI(s) or CRI(s) corresponding to the SS/PBCH block(s) or NZP CSI-RS resource(s) determined or selected from the newBeamResourceSet—and therefore order of the corresponding L1-RSRP(s), e.g., from high to low—in the CSI field(s) of a/the (same) CSI report, and/or
   the time (from early/earlier/earliest to late/later/latest or vice versa) when the P>1 first current serving NZP CSI-RS resources or the P>1 first current serving SS/PBCH blocks as specified/defined herein in the present disclosure are determined;
in this case,
   for each of the P>1 first current serving NZP CSI-RS resources (and therefore, the corresponding P>1 indexes/IDs), the bitwidth for indicating a/the corresponding resource index/ID (e.g., in terms of CRI) could be ┌ log₂R┐, where: for example, R is the maximum/total number of NZP CSI-RS resource(s) in the corresponding resource set, e.g., newBeamResourceSet; for another example, R is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE; for another example, R is the maximum/total number of NZP CSI-RS resource(s) specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if R=4, the bitwidth here is 2, and when/if R=8, the bitwidth here is 3); and/or
   for each of the P>1 first current serving SS/PBCH blocks (and therefore, the corresponding P>1 indexes/IDs), the bitwidth for indicating a/the corresponding resource index/ID (e.g., in terms of SSBRI) could be ┌ log₂ T┐, where: for example, T is the maximum/total number of SS/PBCH block(s) in the corresponding resource set, e.g., newBeamResourceSet; for another example, T is the maximum/total number of TCI codepoint(s) mapped/mapping to the TCI state(s) or the maximum/total number of TCI state(s) that can be/are/is activated for/in a given indication/activation instance—e.g., in a/the (enhanced) TCI state(s)/unified TCI state(s) activation/deactivation MAC CE; for another example, T is the maximum/total number of SS/PBCH block(s) specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if T=4, the bitwidth here is 2, and when/if T=8, the bitwidth here is 3); and/or
   for a given first current serving SS/PBCH block out of the P>1 first current serving SS/PBCH blocks (and therefore, the corresponding P>1 indexes/IDs), the TCI information could comprise a/the first (resource) index/ID (e.g., in terms of CRI) of the current serving QCLed RS as specified/defined herein in the present disclosure in the activated TCI state that is QCLed with the given first current serving SS/PBCH block; in this case, the bitwidth for indicating a/the first resource index/ID (e.g., in terms of CRI) could be ┌ log 2V1┐, where: for example, V1 is the maximum/total number of NZP CSI-RS resource(s) in the corresponding resource set, e.g., newBeamResourceSet; for another example, V1 is the maximum/total number of NZP CSI-RS resource(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V1 is the maximum/total number of NZP CSI-RS resource(s) QCLed with the given first current serving SS/PBCH block; for another example, V1 is the maximum/total number of NZP CSI-RS resource(s) QCLed with the given first current serving SS/PBCH block and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V1=4, the bitwidth here is 2, and when/if V1=8, the bitwidth here is 3). The TCI information could additionally comprise a/the second index/ID (e.g., in terms of SSBRI) of the given first current serving SS/PBCH block; in this case, the bitwidth for indicating a/the second resource index/ID (e.g., in terms of SSBRI) could be ┌ log₂V2┐, where: for example, V2 is the maximum/total number of SS/PBCH block(s) in the corresponding resource set, e.g., newBeamResourceSet; for another example, V2 is the maximum/total number of SS/PBCH block(s) specific or corresponding to the TCI state(s) that can be/are/is activated for/in a given indication/activation instance—e.g., in a/the (enhanced) TCI state(s)/unified TCI state(s) activation/deactivation MAC CE; for another example, V2 is the maximum/total number of SS/PBCH block(s) QCLed with the aforementioned current serving QCLed RS in the activated TCI state; for another example, V2 is the maximum/total number of SS/PBCH block(s) QCLed with the aforementioned current serving QCLed RS in the activated TCI state and specific or corresponding to the TCI state(s) that can be/are/is activated for/in a given indication/activation instance—e.g., in a/the (enhanced) TCI state(s)/unified TCI state(s) activation/deactivation MAC CE (for these design examples, when/if V2=4, the bitwidth here is 2, and when/if V2=8, the bitwidth here is 3)
wherein the UE could determine or identify value(s) of U, S, R, T, V1 and/or V2 according to or based on (i) fixed value(s) in system specification(s) and/or per RRC (re-)configuration(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling/report, and/or (iii) UE's autonomous determination/selection e.g. subject to their implementations( ), which could be further sent or transmitted or indicated to the network (e.g., the network 130) via various UL channels/signals including PUCCH(s), PUSCH(s), PRACH(s), and/or etc., e.g., in part of a CSI/beam report and/or UE's capability signaling(s), and the UE could determine or identify the P>1 first current serving NZP CSI-RS resources—out of the second current serving NZP CSI-RS resources as specified/defined/determined herein in the present disclosure, or the P>1 first current serving SS/PBCH blocks—out of the second current serving SS/PBCH blocks as specified/defined/determined herein in the present disclosure according to or based on or following: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s);
for example, the P>i first current serving NZP CSI-RS resources could correspond to the second current serving NZP CSI-RS resources as specified/defined/determined herein in the present disclosure, or the P>1 first current serving SS/PBCH blocks could correspond to the second current serving SS/PBCH blocks as specified/defined/determined herein in the present disclosure;
for another example, the P>1 first current serving NZP CSI-RS resources could correspond to the second current serving NZP CSI-RS resources with their respective or corresponding TOs having the P largest measured L1-RSRPs among the second current serving NZP CSI-RS resources as specified/defined/determined herein in the present disclosure, or the P>1 first current serving SS/PBCH blocks could correspond to the second current serving SS/PBCH blocks with their respective or corresponding TOs having the P largest measured L1-RSRPs among the second current serving SS/PBCH blocks as specified/defined/determined herein in the present disclosure;
for another example, the P>1 first current serving NZP CSI-RS resources could correspond to the P second current serving NZP CSI-RS resources among the second current serving NZP CSI-RS resources as specified/defined/determined herein in the present disclosure that are determined early/earlier/earliest (or late/later/latest) in time, or the P>1 first current serving SS/PBCH blocks could correspond to the P second current serving SS/PBCH blocks among the second current serving SS/PBCH blocks as specified/defined/determined herein in the present disclosure that are determined early/earlier/earliest (or late/later/latest) in time.

The UE could determine the value(s) of P>1 according to or based on or following: (i) fixed value(s) in system specification(s) or per RRC (re-)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, e.g., P=nrofReportedRS-UEIBR, and/or (iii) UE's autonomous selection or determination, which could be further sent to the network via/in part of various UL channels/signals and/or CSI/beam report(s) and/or UE's capability signaling(s). For this design example, when enabledCurrentBeamReport is configured, the UE could report, as defined in Clause 6.3.2.1.2 of [5, [REF 2]], in a/the (same) single reporting instance/CSI report the absolute current serving L1-RSRPs or differential current serving L1-RSRPs as specified/defined herein in the present disclosure corresponding to one or more of the P>1 first current serving NZP CSI-RS resources (or one or more of the S>1 second current serving NZP CSI-RS resources), or to one or more of the P>1 first current serving SS/PBCH blocks (or one or more of the S>1 second current serving SS/PBCH blocks) as specified/defined herein in the present disclosure. Here, the absolute/differential current serving L1-RSRPs are ordered in the CSI fields of a/the (same) CSI report from high (or low) CSI field number(s)/index(es) to low (or high) CSI field number(s)/index(es) according to or based on
the order of the index/ID value(s) comprised in the TCI information as specified/defined herein in the present disclosure related to the one or more of the P>1 first current serving NZP CSI-RS resources (or one or more of the S>1 second current serving NZP CSI-RS resources), or to one or more of the P>1 first current serving SS/PBCH blocks (or one or more of the S>1 second current serving SS/PBCH blocks) as specified/defined herein in the present disclosure; and/or
their respective values from high to low (or low to high); and/or
index(es)/ID(s) of the one or more of the P>1 first current serving NZP CSI-RS resources, or one or more of the P>1 first current serving SS/PBCH blocks as specified/defined herein in the present disclosure from high to low (or low to high); and/or
the largest measured L1-RSRP(s) of the one or more the P>1 first current serving NZP CSI-RS resources (of their respective/corresponding TOs), or the one or more of the P>1 first current serving SS/PBCH blocks (of their respective/corresponding TOs) from high to low (or low to high), and/or
order of the reported SSBRI(s) or CRI(s) corresponding to the SS/PBCH block(s) or NZP CSI-RS resource(s) determined or selected from the newBeamResourceSet—and therefore order of the corresponding L1-RSRP(s), e.g., from high to low—in the CSI field(s) of a/the (same) CSI report, and/or
the time (from early/earlier/earliest to late/later/latest or vice versa) when the one or more of the P>1 first current serving NZP CSI-RS resources or the one or more of the P>1 first current serving SS/PBCH blocks as specified/defined herein in the present disclosure are determined.

In addition,
for one example, the one or more of the P>1 first current serving NZP CSI-RS resources (or the one or more of the S>1 second current serving NZP CSI-RS resources) could correspond to the P>1 first current serving NZP CSI-RS resources (or the second current serving NZP CSI-RS resources), or the one or more of the P>1 first current serving SS/PBCH blocks (or one or more of the S>1 second current serving SS/PBCH blocks) could correspond to the P>1 first current serving SS/PBCH blocks (or the S>1 second current serving SS/PBCH blocks);
for another example, the CSI report could comprise, include or contain
   a bitmap with each entry/bit position of the bitmap corresponding to one of the P>1 first current serving NZP CSI-RS resources (or one of the S>1 second current serving NZP CSI-RS resources), or one of the P>1 first current serving SS/PBCH blocks (or one of the S>1 second current serving SS/PBCH blocks); when/if an entry/bit position is set to ‘1’ (or ‘0’), the first current serving NZP CSI-RS resource (or the second current serving NZP CSI-RS resource), or the first current serving SS/PBCH block (or the second current serving SS/PBCH block) corresponding to the entry/bit position could belong or correspond to the one or more of the P>1 first current serving NZP CSI-RS resources (or the one or more of the S>1 second current serving NZP CSI-RS resources), or the one or more of the P>1 first current serving SS/PBCH blocks (or the one or more of the S>1 second current serving SS/PBCH blocks), and/or
   one or more p-bit indicators with p=┌ log₂ P┐; when/if a p-bit indicator indicates a value P′∈{1, . . . P}(or P′∈{1, . . . , S}), the P′-th first current serving NZP CSI-RS resource (or the P′-th second current serving NZP CSI-RS resource), or the P′-th first current serving SS/PBCH block (or the P′-th second current serving SS/PBCH block) could belong or correspond to the one or more of the P>1 first current serving NZP CSI-RS resources (or the one or more of the S>1 second current serving NZP CSI-RS resources), or the one or more of the P>1 first current serving SS/PBCH blocks (or the one or more of the S>1 second current serving SS/PBCH blocks), and/or
   one or more indexes each indicating a value in or belonging to {1, . . . , P}(or {1, . . . , S}); when/if an index indicates a value P′∈{1, . . . , P}(or P′∈{1, . . . , S}), the P′-th first current serving NZP CSI-RS resource (or the P′-th second current serving NZP CSI-RS resource), or the P′-th first current serving SS/PBCH block (or the P′-th second current serving SS/PBCH block) could belong or correspond to the one or more of the P>1 first current serving NZP CSI-RS resources (or the one or more of the S>1 second current serving NZP CSI-RS resources), or the one or more of the P>1 first current serving SS/PBCH blocks (or the one or more of the S>1 second current serving SS/PBCH blocks).

In addition, when PresenceOfConditionMetIndicator is configured (with or without eventDetectionTimeWindowLength being configured/provided or when eventDetectionTimeWindowLength is configured), the UE (e.g., the UE 116) could report, as defined in Clause 6.3.2.1.2 of [5, [REF 2]], in a/the (same) single reporting instance/CSI report, one or more condition met indicators each indicating whether a corresponding RS—from the newBeamResourceSet—indicated by a corresponding reported CRI or SSBRI triggers the UEIRI transmission:
in one example, a condition met indicator is in form of a q-bit indicator (or the bitwidth for a condition met indicator is q) with q=┌ log₂ P┐ (e.g., when/if P=4, q=2); for this design example, e.g., for Case-1 or Case-2 and/or when/if Case-1 or Case-2 is provided or configured or enabled for a UE to determine event instance(s) hence when (or condition(s)) to trigger transmission of a UEIRI according to or following those specified/defined herein in the present disclosure with K>1, when/if a q-bit condition met indicator is set to a value indicating p (e.g., p belongs to {1, . . . , P}), (i) for Case-1, the corresponding RS—from the newBeamResourceSet—indicated by a corresponding reported CRI or SSBRI triggers the UEIRI transmission, or (2) for Case-2, (a/the (same) pair of) the corresponding RS—from the newBeamResourceSet—indicated by a corresponding reported CRI or SSBRI and the p-th first current serving NZP CSI-RS resource or the p-th first current serving SS/PBCH block trigger the UEIRI transmission according to or following those specified/defined herein in the present disclosure;
in another example, a condition met indicator is in form of a q-bit indicator (or the bitwidth for a condition met indicator is q) with q=┌ log₂ P┐+1 (e.g., when/if P=4, q=3); for this design example, e.g., for Case-1 or Case-2 and/or when/if Case-1 or Case-2 is provided or configured or enabled for a UE to determine event instance(s) hence when (or condition(s)) to trigger transmission of a UEIRI according to or following those specified/defined herein in the present disclosure with K>1, when/if the 1-bit LSB (or MSB) of a q-bit condition met indicator is set to ‘1’, the corresponding RS—from the newBeamResourceSet—indicated by a corresponding reported CRI or SSBRI triggers the UEIRI transmission; otherwise, set to ‘0’; furthermore, for a q-bit condition met indicator with its 1-bit LSB (or MSB) set to ‘1’, when/if its (q−1)-bit MSBs (or LSBs) are set to a value indicating p (e.g., p belongs to {1, . . . , P}), (i) for Case-1, the corresponding RS—from the newBeamResourceSet—indicated by a corresponding reported CRI or SSBRI triggers the UEIRI transmission, or (2) for Case-2, (a/the (same) pair of) the corresponding RS—from the newBeamResourceSet—indicated by a corresponding reported CRI or SSBRI and the p-th first current serving NZP CSI-RS resource or the p-th first current serving SS/PBCH block trigger the UEIRI transmission according to or following those specified/defined herein in the present disclosure;
in another example, a condition met indicator is in form of a 1-bit indicator (or the bitwidth for a condition met indicator is 1); for this design example, e.g., for Case-1 or Case-2 and/or when/if Case-1 or Case-2 is provided or configured or enabled for a UE to determine event instance(s) hence when (or condition(s)) to trigger transmission of a UEIRI according to or following those specified/defined herein in the present disclosure with K>1, when/if a 1-bit condition met indicator is set to ‘1’, the corresponding RS—from the newBeamResourceSet—indicated by a corresponding reported CRI or SSBRI triggers the UEIRI transmission; otherwise, set to ‘0’; furthermore, the CSI could additionally comprise, include or contain one or more q′-bit mapping indicators (or the bitwidth for each of the one or more mapping indicators is q′) each associated or corresponding or specific to a RS (hence a corresponding/associated condition met indicator)—from the newBeamResourceSet—indicated by a corresponding reported CRI or SSBRI, wherein q′=┌ log₂ P┐(e.g., when/if P=4, q′=2); furthermore, for a 1-bit condition met indicator set to ‘1’, when/if its corresponding/associated q′-bit mapping indicator is set to a value indicating p′ (e.g., p′ belongs to {1, . . . , P}), (i) for Case-1, the corresponding RS—from the newBeamResourceSet—indicated by a corresponding reported CRI or SSBRI triggers the UEIRI transmission, or (2) for Case-2, (a/the (same) pair of) the corresponding RS—from the newBeamResourceSet—indicated by a corresponding reported CRI or SSBRI and the p′-th first current serving NZP CSI-RS resource or the p′-th first current serving SS/PBCH block trigger the UEIRI transmission according to or following those specified/defined herein in the present disclosure.

In the present disclosure, the UE could determine or identify the order or ordering (e.g., the p-th or p‘-th with p or p’ belonging to {1, . . . , P}) of the P>1 first current serving NZP CSI-RS resources or the P>1 current serving SS/PBCH blocks according to or based on or following,
order or ordering of the P>1 indexes/IDs of the (P>1) TCI codepoints comprised in the TCI information—among the TCI codepoint indexes/IDs mapped/mapping to the activated TCI states—mapped/mapping to the activated TCI states each specific or corresponding or associated to one of the P>1 first current serving NZP CSI-RS resources or one of the P>1 first current serving SS/PBCH blocks as specified/defined herein in the present disclosure in the CSI report, and/or
order or ordering of the P>1 indexes/IDs of the (P>1) TCI states comprised in the TCI information—among the activated TCI states—each specific or corresponding or associated to one of the P>1 first current serving NZP CSI-RS resources or one of the P>1 first current serving SS/PBCH blocks as specified/defined herein in the present disclosure in the CSI report, and/or
order or ordering of the P>1 indexes/IDs (e.g., in terms/form of CRIs or SSBRIs) of the (P>1) first current serving NZP CSI-RS resources (for case-i and/or case-ii as specified/defined herein in the present disclosure and/or when/if condition-i as specified/defined herein in the present disclosure is satisfied, achieved or held) or the (P>1) first current serving SS/PBCH blocks (for case-III and/or case-iv as specified/defined herein in the present disclosure and/or when/if condition-ii as specified/defined herein in the present disclosure is satisfied, achieved or held) as specified/defined herein in the present disclosure in the CSI report.

The bitwidth for CRI, SSBRI, RSRP, differential RSRP, CSI report configuration indicator and condition met indicator are provided in Table 1.

TABLE 1
CRI, SSBRI, RSRP, CapabilityIndex, CSI report configuration
indicator and condition met indicator

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| RSRP | 7 |
| Differential RSRP | 4 |
| CSI report configuration indicator | $⌈ {log}_{2} ( {K}_{s}^{CSI \_ config} ) ⌉$ |
| Condition met indicator | 1 |

NOTE:
${K}_{s}^{CSI - RS} is the number of CSI ‐ RS resources in the corresponding resource$ $set , {K}_{s}^{SSB} is the configured number of SS / PBCH blocks in the corresponding$ resource set for reporting ‘ssb-Index-RSRP’ or ‘ssb-Index-RSRP-Index’,
${K}_{s}^{CSI \_ config} is the number of CSI report configurations associated with a$ same PUCCH resource configured by firstPUCCHIResourceConfig-UEIBR.

The mapping order of CSI fields of one report for UEI reporting for CSI report configuration indicator/CRI/RSRP/condition met indicator, or CSI report configuration indicator/SSBRI/RSRP/condition met indicator is provided in Table 2 herein by taking (only) Table 1 herein for the determination of the bitwidth of a CSI field. The procedure in clause 6.3.2 of [REF 2] described for CSI part 1 is also applicable for one report for UEI reporting for CSI report configuration indicator/CRI/RSRP/condition met indicator, or CSI report configuration indicator/SSBRI/RSRP/condition met indicator.

TABLE 2
Mapping order of CSI fields of one report for CSI report configuration
indicator/CRI/RSRP/Condition met indicator, or CSI report configuration
indicator/SSBRI/RSRP/Condition met indicator

| CSI report number | CSI fields |
|---|---|
| CSI report #n | CSI report configuration indicator as in Table 1, if reported |
| | CRI or SSBRI #1 as in Table 1 |
| | CRI or SSBRI #2 as in Table 1, if reported |
| | CRI or SSBRI #3 as in Table 1, if reported |
| | CRI or SSBRI #4 as in Table 1, if reported |
| | RSRP #1 as in Table 1 |
| | Differential RSRP #2 as in Table 1, if reported |
| | Differential RSRP #3 as in Table 1, if reported |
| | Differential RSRP #4 as in Table 1, if reported |
| | Condition met indicator #1 in Table 1, if reported |
| | Condition met indicator #2 in Table 1, if reported |
| | Condition met indicator #3 in Table 1, if reported |
| | Condition met indicator #4 in Table 1, if reported |
| | RSRP as in Table 1 for the RS in the indicated TCI state or the |
| | SS/PBCH block which is QCLed with the RS in the indicated |
| | TCI state if eventType is set to ‘event1’ and |
| | enabledCurrentBeamReport is configured; |
| | RSRP or differential RSRP as in Table 1 for the RS in the |
| | indicated TCI state or the SS/PBCH block which is QCLed with |
| | the RS in the indicated TCI state if eventType is set to ‘event2’ |
| | and if enabledCurrentBeamReport is configured; |
| | RSRP or differential RSRP as in Table 1 for the RS with the |
| | valueOfQ-th highest L1-RSRP out of RSs among the activated |
| | TCI states or the current serving SS/PBCH block as |
| | specified/defined herein in the present disclosure or the current |
| | serving RS as specified/defined herein in the present disclosure |
| | if eventType is set to ‘event7’ and if enabledCurrentBeamReport |
| | is configured; or RSRP or differential RSRP as in Table 1 for the |
| | K = 1 (first) current serving NZP CSI-RS resource or the K = 1 |
| | (first) current serving SS/PBCH block determined or identified |
| | according to or following those specified/defined herein in the |
| | present disclosure or the reference RS as specified/defined |
| | herein in the present disclosure if eventType is set to ‘event7’ |
| | and if enabledCurrentBeamReport is configured |
| | Zero padding bits Oₚ, if needed |

NOTE:
The CSI report configuration indicator with value i indicates the (i + 1)-th CSI report configuration among the CSI report configurations associated with a same PUCCH resource configured by firstPUCCHResourceConfig-UEIBR, which are ordered in ascending order of CSI-ReportConfigID.
The condition met indicators are reported only when the UE is configured with higher layer parameter PresenceOfConditionMetIndicator. If the RS associated with CRI or SSBRI #j satisfies the condition for transmitting UEIRI as defined in Clause 5.2.1.5.4.1 in [6, [REF 4]] with or without eventDetectionTimeWindowLength being configured/provided or when eventDetectionTimeWindowLength is configured, the value of the condition met indicator #j is set to 1; otherwise set to 0. The condition met indicators could also be determined or identified according to or following those specified/defined herein in the present disclosure.

The number of zero padding bits Oₚ in Table 2 is 0 if there is only one CSI report configuration associated with the PUCCH carrying UEIRI; otherwise Oₚ=Nₘₐₓ−N_{reported}, where:

$${N}_{max} = {max}_{i ∈ S} ( {N}_{i} ) ,$$

where S is the set of CSI report configurations associated with a same PUCCH resource configured by firstPUCCHResourceConfig-UEIBR, and Nᵢ is the payload size of the report for the i-th CSI report configuration, obtained according to Table 2 prior to padding;
Nreported is the payload size of the current report, obtained according to Table 2 prior to padding.

For a UE configured with multiple CSI-ReportConfig with same higher layer parameters eventType and PUCCHResource, the UE expects
the multiple CSI-ReportConfig to be configured in the same CC,
the multiple CSI-ReportConfig to be associated with a same CSI trigger state if reportTransmissionMode is configured as ‘ModeA’, else
the same configuredPUSCHResourceOjModeB if reportTransmissionMode is configured as ‘ModeB’.

The UE reports in a single reporting instance nrojReportedRS-UEIBR CRIs or SSBRIs corresponding to RSs provided by the newBeamResourceSet in a CSI-ReportConfig that satisfies the event. The CSI report includes the corresponding CSI-ReportConfigId and is zero padded to a fixed payload size (when needed), with the fixed payload size given by the maximum payload size among the multiple CSI-ReportConfig.

In one embodiment, the UE could indicate or send or transmit to the network, e.g., in their capability signaling(s), one or more indicators to indicate:
whether or not the UE could support (1) UE initiated CSI reporting for event 2, (2) UE initiated CSI reporting for event 1, and/or (3) UE initiated CSI reporting for event 7; and/or
which one or more of (1) UE initiated CSI reporting for event 2, (2) UE initiated CSI reporting for event 1, and (3) UE initiated CSI reporting for event 7 the UE could support.

For instance, the one or more indicators could be in form/terms of:
a first one-bit indicator specific to UE initiated CSI reporting for event 2, a second one-bit indicator specific to UE initiated CSI reporting for event 2 and a third one-bit indicator specific to UE initiated CSI reporting for event 7; for this case,
   in one example, when/if the first one-bit indicator is set to ‘1’ (or ‘0’), the UE could indicate or send or transmit to the network, e.g., in their capability signaling(s), that they are capable of supporting or they could support the UE initiated CSI reporting for event 2; otherwise, i.e., when/if the first one-bit indicator is set to ‘0’ (or ‘1’), the UE could indicate or send or transmit to the network, e.g., in their capability signaling(s), that they are not capable of supporting or they could not support the UE initiated CSI reporting for event 2
   in another example, when/if the second one-bit indicator is set to ‘1’ (or ‘0’), the UE could indicate or send or transmit to the network, e.g., in their capability signaling(s), that they are capable of supporting or they could support the UE initiated CSI reporting for event 1; otherwise, i.e., when/if the second one-bit indicator is set to ‘0’ (or ‘1’), the UE could indicate or send or transmit to the network, e.g., in their capability signaling(s), that they are not capable of supporting or they could not support the UE initiated CSI reporting for event 1
   in another example, when/if the third one-bit indicator is set to ‘1’ (or ‘0’), the UE could indicate or send or transmit to the network, e.g., in their capability signaling(s), that they are capable of supporting or they could support the UE initiated CSI reporting for event 7; otherwise, i.e., when/if the third one-bit indicator is set to ‘0’ (or ‘1’), the UE could indicate or send or transmit to the network, e.g., in their capability signaling(s), that they are not capable of supporting or they could not support the UE initiated CSI reporting for event 7

Here, the UE may be expected to set at least one of the first one-bit indicator, the second one-bit indicator and the third one-bit indicator as ‘1’(s) or non-zero value(s).
a bitmap with each entry/bit position of/in the bitmap specific or associated or corresponding to (1) UE initiated CSI reporting for event 2, (2) UE initiated CSI reporting for event 1, or (3) UE initiated CSI reporting for event 7
   in one example, the first entry/bit position of/in the bitmap could be specific or associated or corresponding to the UE initiated CSI reporting for event 2; in this case, when/if the first entry/bit position of/in the bitmap is set to ‘1’ (or ‘0’), the UE could indicate or send or transmit to the network, e.g., in their capability signaling(s), that they are capable of supporting or they could support the UE initiated CSI reporting for event 2; otherwise, i.e., when/if the first entry/bit position of/in the bitmap is set to ‘0’ (or ‘1’), the UE could indicate or send or transmit to the network, e.g., in their capability signaling(s), that they are not capable of supporting or they could not support the UE initiated CSI reporting for event 2
   in another example, the second entry/bit position of/in the bitmap could be specific or associated or corresponding to the UE initiated CSI reporting for event 1; in this case, when/if the second entry/bit position of/in the bitmap is set to ‘1’ (or ‘0’), the UE could indicate or send or transmit to the network, e.g., in their capability signaling(s), that they are capable of supporting or they could support the UE initiated CSI reporting for event 1; otherwise, i.e., when/if the second entry/bit position of/in the bitmap is set to ‘0’ (or ‘1’), the UE could indicate or send or transmit to the network, e.g., in their capability signaling(s), that they are not capable of supporting or they could not support the UE initiated CSI reporting for event 1
   in another example, the third entry/bit position of/in the bitmap could be specific or associated or corresponding to the UE initiated CSI reporting for event 7; in this case, when/if the third entry/bit position of/in the bitmap is set to ‘1’ (or ‘0’), the UE could indicate or send or transmit to the network, e.g., in their capability signaling(s), that they are capable of supporting or they could support the UE initiated CSI reporting for event 7; otherwise, i.e., when/if the third entry/bit position of/in the bitmap is set to ‘0’ (or ‘1’), the UE could indicate or send or transmit to the network, e.g., in their capability signaling(s), that they are not capable of supporting or they could not support the UE initiated CSI reporting for event 7.

Here, the UE may be expected to set at least one of the first, second and third entries/bit positions in/of the bitmap as ‘1’(s) or non-zero value(s).

In one embodiment, for a UE supporting the UE-initiated/event-driven CSI/beam reporting as specified/defined herein in the present disclosure, the UE could support one of (1) UE initiated CSI reporting for event 2, (2) UE initiated CSI reporting for event 1, and (3) UE initiated CSI reporting for event 7 (e.g., as basic/default feature(s) for the UE). For example, the UE could support the UE initiated CSI reporting for event 2; in this case, the UE could indicate or send or transmit to the network (e.g., the network 130), e.g., in their capability signaling(s), one or more indicators to indicate:
whether or not the UE could support (a) UE initiated CSI reporting for event 1 and/or (b) UE initiated CSI reporting for event 7; and/or
which one or more of (a) UE initiated CSI reporting for event 1 and (b) UE initiated CSI reporting for event 7 the UE could support.

For instance, the one or more indicators could be in form/terms of:
a first one-bit indicator specific to UE initiated CSI reporting for event 1 and a second one-bit indicator specific to UE initiated CSI reporting for event 7; for this case,
   in one example, when/if the first one-bit indicator is set to ‘1’ (or ‘0’), the UE could indicate or send or transmit to the network, e.g., in their capability signaling(s), that they are capable of supporting or they could support the UE initiated CSI reporting for event 1; otherwise, i.e., when/if the first one-bit indicator is set to ‘0’ (or ‘1’), the UE could indicate or send or transmit to the network, e.g., in their capability signaling(s), that they are not capable of supporting or they could not support the UE initiated CSI reporting for event 1
   in another example, when/if the second one-bit indicator is set to ‘1’ (or ‘0’), the UE could indicate or send or transmit to the network, e.g., in their capability signaling(s), that they are capable of supporting or they could support the UE initiated CSI reporting for event 7; otherwise, i.e., when/if the second one-bit indicator is set to ‘0’ (or ‘1’), the UE could indicate or send or transmit to the network, e.g., in their capability signaling(s), that they are not capable of supporting or they could not support the UE initiated CSI reporting for event 7
a bitmap with each entry/bit position of/in the bitmap specific or associated or corresponding to (a) UE initiated CSI reporting for event 1 or (b) UE initiated CSI reporting for event 7
   in one example, the first entry/bit position of/in the bitmap could be specific or associated or corresponding to the UE initiated CSI reporting for event 1; in this case, when/if the first entry/bit position of/in the bitmap is set to ‘1’ (or ‘0’), the UE could indicate or send or transmit to the network, e.g., in their capability signaling(s), that they are capable of supporting or they could support the UE initiated CSI reporting for event 1; otherwise, i.e., when/if the first entry/bit position of/in the bitmap is set to ‘0’ (or ‘1’), the UE could indicate or send or transmit to the network, e.g., in their capability signaling(s), that they are not capable of supporting or they could not support the UE initiated CSI reporting for event 1
   in another example, the second entry/bit position of/in the bitmap could be specific or associated or corresponding to the UE initiated CSI reporting for event 7; in this case, when/if the second entry/bit position of/in the bitmap is set to ‘1’ (or ‘0’), the UE could indicate or send or transmit to the network, e.g., in their capability signaling(s), that they are capable of supporting or they could support the UE initiated CSI reporting for event 7; otherwise, i.e., when/if the second entry/bit position of/in the bitmap is set to ‘0’ (or ‘1’), the UE could indicate or send or transmit to the network, e.g., in their capability signaling(s), that they are not capable of supporting or they could not support the UE initiated CSI reporting for event 7.

For another example, the UE could support the UE initiated CSI reporting for event 1; in this case, the UE could indicate or send or transmit to the network, e.g., in their capability signaling(s), one or more indicators to indicate:
whether or not the UE could support (a) UE initiated CSI reporting for event 2 and/or (b) UE initiated CSI reporting for event 7; and/or
which one or more of (a) UE initiated CSI reporting for event 2 and (b) UE initiated CSI reporting for event 7 the UE could support,
   according to or following those specified/defined herein in the present disclosure for the case that the UE could support the UE initiated CSI reporting for event 2, and indicate or send or transmit to the network, e.g., in their capability signaling(s), one or more indicators to indicate:
whether or not the UE could support (a) UE initiated CSI reporting for event 1 and/or (b) UE initiated CSI reporting for event 7; and/or
which one or more of (a) UE initiated CSI reporting for event 1 and (b) UE initiated CSI reporting for event 7 the UE could support by replacing “UE initiated CSI reporting for event 1” and “UE initiated CSI reporting for event 2” with “UE initiated CSI reporting for event 2” and “UE initiated CSI reporting for event 1”, respectively. For another example, the UE could support the UE initiated CSI reporting for event 7; in this case, the UE could indicate or send or transmit to the network, e.g., in their capability signaling(s), one or more indicators to indicate:
whether or not the UE could support (a) UE initiated CSI reporting for event 2 and/or (b) UE initiated CSI reporting for event 1; and/or
which one or more of (a) UE initiated CSI reporting for event 2 and (b) UE initiated CSI reporting for event 1 the UE could support,
   according to or following those specified/defined herein in the present disclosure for the case that the UE could support the UE initiated CSI reporting for event 2, and indicate or send or transmit to the network, e.g., in their capability signaling(s), one or more indicators to indicate:
whether or not the UE could support (a) UE initiated CSI reporting for event 1 and/or (b) UE initiated CSI reporting for event 7; and/or
which one or more of (a) UE initiated CSI reporting for event 1 and (b) UE initiated CSI reporting for event 7 the UE could support by replacing “UE initiated CSI reporting for event 7” and “UE initiated CSI reporting for event 2” with “UE initiated CSI reporting for event 2” and “UE initiated CSI reporting for event 7”, respectively.

In one embodiment, for a UE supporting the UE-initiated/event-driven CSI/beam reporting as specified/defined herein in the present disclosure, the UE could support two of (1) UE initiated CSI reporting for event 2, (2) UE initiated CSI reporting for event 1, and (3) UE initiated CSI reporting for event 7 (e.g., as basic/default feature(s) for the UE).
For example, the UE could support the UE initiated CSI reporting for event 2 and event 1; in this case, the UE could indicate or send or transmit to the network, e.g., in their capability signaling(s), one or more indicators to indicate whether or not the UE could support the UE initiated CSI reporting for event 7. For instance, the one or more indicators could be in form/terms of a one-bit indicator specific to the UE initiated CSI reporting for event 7; for this case, when/if the one-bit indicator is set to ‘1’ (or ‘0’), the UE could indicate or send or transmit to the network, e.g., in their capability signaling(s), that they are capable of supporting or they could support the UE initiated CSI reporting for event 7; otherwise, i.e., when/if the one-bit indicator is set to ‘0’ (or ‘1’), the UE could indicate or send or transmit to the network, e.g., in their capability signaling(s), that they are not capable of supporting or they could not support the UE initiated CSI reporting for event 7.
For another example, the UE could support the UE initiated CSI reporting for event 2 and event 7; in this case, the UE could indicate or send or transmit to the network, e.g., in their capability signaling(s), one or more indicators to indicate whether or not the UE could support the UE initiated CSI reporting for event 1 according to or following those specified/defined herein in the present disclosure for the case that the UE could support the UE initiated CSI reporting for event 2 and event 1, and indicate or send or transmit to the network, e.g., in their capability signaling(s), one or more indicators to indicate whether or not the UE could support the UE initiated CSI reporting for event 7 by replacing “UE initiated CSI reporting for event 1” and “UE initiated CSI reporting for event 7” with “UE initiated CSI reporting for event 7” and “UE initiated CSI reporting for event 1”, respectively.
For another example, the UE could support the UE initiated CSI reporting for event 1 and event 7; in this case, the UE could indicate or send or transmit to the network, e.g., in their capability signaling(s), one or more indicators to indicate whether or not the UE could support the UE initiated CSI reporting for event 2 according to or following those specified/defined herein in the present disclosure for the case that the UE could support the UE initiated CSI reporting for event 2 and event 1, and indicate or send or transmit to the network, e.g., in their capability signaling(s), one or more indicators to indicate whether or not the UE could support the UE initiated CSI reporting for event 7 by replacing “UE initiated CSI reporting for event 2” and “UE initiated CSI reporting for event 7” with “UE initiated CSI reporting for event 7” and “UE initiated CSI reporting for event 2”, respectively.

When a UE configured with dl-OrJointTCI-StateL1st or ul-TCI-StateL1st would transmit a PUCCH with positive hybrid automatic repeat request acknowledgement (HARQ-ACK) or a PUSCH with positive HARQ-ACK corresponding to the DCI carrying the TCI State indication and without DL assignment, or corresponding to the PDSCH scheduled by the DCI carrying the TCI State indication, and if second content(s)/component(s)/parameter(s)/signalling(s)/setting(s)/value(s) comprising one or more of first contents/components/parameters/signalings/settings/values listed herein:
the ID number of the TCI state provided by tci-Stateld
the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the SS/PBCH block which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the SRS resource e.g. with the higher layer parameter usage set to ‘beamManagement’ which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the PCI of the SSBs when referenceSignal is configured as SSB, provided by additionalPCI
the ID of the RS (e.g. a CSI-RS or an SS/PBCH block (SSB) or an SRS resource e.g. with the higher layer parameter usage set to ‘beamManagement’) used for PUSCH, PUCCH and SRS path loss estimation, provided by pathlossReferenceRS-Id
the QCL information for the TCI state, provided by qcl-Type1 and/or qcl-Type2
the power control parameter for PUCCH, PUSCH and SRS for the TCI state, provided by ul-PowerControl
the TAG that is associated with the TCI state, provided by tag-Id-ptr
the DL BWP which the CSI-RS is located in or UL BWP where the SRS is located in, provided by bwp-Id
the UE's serving cell in which the referenceSignal is configured, provided by cell and/or servingCellId
the QCL type provided by qcl-Type
   specific or associated or corresponding to the indicated TCI State(s)/in the TCI-State/TCI-UL-State/QCL-Info provided for the indicated TCI State(s) is/are different from corresponding (e.g., having the same RRC parameter(s)/configuration(s)/signalling(s)/name(s)) second content(s)/component(s)/parameter(s)/signaling(s)/setting(s)/value(s) specific or associated or corresponding to the previously indicated one(s) or TCI State(s)/in the TCI-State/TCI-UL-State/QCL-Info provided for the previously indicated one(s) or TCI State(s), the second content(s)/component(s)/parameter(s)/signaling(s)/setting(s)/value(s) as specified/defined herein in the present disclosure specific or associated or corresponding to the indicated TCI-State(s) and/or TCI-UL-State(s)/in the TCI-State/TCI-UL-State/QCL-Info provided for the indicated TCI-State(s) and/or TCI-UL-State(s) should be applied starting from the first slot that is at least beamAppTime symbols after the last symbol of the PUCCH or the PUSCH, and if the UE (e.g., the UE 116) receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. For the indicated TCI state(s) and/or the previously indicated one(s) or TCI state(s), third contents/components/parameters/signalings/settings/values could correspond to or comprise the first contents/components/parameters/signalings/settings/values excluding the second contents/components/parameters/signalings/settings/values. In this case, the third contents/components/parameters/signalings/settings/values specific or associated or corresponding to the previously indicated one(s) or TCI State(s)/in the TCI-State/TCI-UL-State/QCL-Info provided for the previously indicated one(s) or TCI State(s) may not be updated/changed, and the UE could maintain and/or keep and/or apply the third content(s)/component(s)/parameter(s)/signaling(s)/setting(s)/value(s) specific or associated or corresponding to the previously indicated one(s) or TCI State(s)/in the TCI-State/TCI-UL-State/QCL-Info provided for the previously indicated one(s) or TCI State(s) regardless of the aforementioned TCI state(s) indication. The first slot and the beamAppTime symbols are both determined on the active BWP with the smallest subcarrier spacing (SCS) among the BWP(s) from the CCs applying the indicated TCI-State(s) or TCI-UL-State(s) that are active at the end of the PUCCH or the PUSCH carrying the positive HARQ-ACK. For instance, the second content(s)/component(s)/parameter(s)/signalling(s)/setting(s)/value(s) could correspond to or comprise
the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5,
   and the third contents/components/parameters/signallings/settings/values could correspond to or comprise the first contents/components/parameters/signallings/settings/values excluding the second content(s)/component(s)/parameter(s)/signalling(s)/setting(s)/value(s), i.e.,
the ID number of the TCI state provided by tci-Stateld
the SS/PBCH block which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the SRS resource e.g. with the higher layer parameter usage set to ‘beamManagement’ which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the PCI of the SSBs when referenceSignal is configured as SSB, provided by additionalPCI
the ID of the RS (e.g. a CSI-RS or an SS/PBCH block (SSB) or an SRS resource e.g. with the higher layer parameter usage set to ‘beamManagement’) used for PUSCH, PUCCH and SRS path loss estimation, provided by pathlossReferenceRS-Id
the QCL information for the TCI state, provided by qcl-Type1 and/or qcl-Type2
the power control parameter for PUCCH, PUSCH and SRS for the TCI state, provided by ul-PowerControl
the TAG that is associated with the TCI state, provided by tag-Id-ptr
the DL BWP which the CSI-RS is located in or UL BWP where the SRS is located in, provided by bwp-Id
the UE's serving cell in which the referenceSignal is configured, provided by cell and/or servingCellId
the QCL type provided by qcl-Type

In this case, because the RS(s) specific or associated or corresponding to the indicated TCI State(s)/in the TCI-State/TCI-UL-State/QCL-Info provided for the indicated TCI State(s) is/are different from the RS(s)—e.g., in terms/form of their resource ID(s)/index(es)—specific or associated or corresponding to the previously indicated one(s) or TCI State(s)/in the TCI-State/TCI-UL-State/QCL-Info provided for the previously indicated one(s) or TCI State(s), the RS(s) specific or associated or corresponding to the indicated TCI-State(s) and/or TCI-UL-State(s)/in the TCI-State/TCI-UL-State/QCL-Info provided for the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied; furthermore, the UE could maintain and/or keep and/or apply the aforementioned third contents/components/parameters/signalings/settings/values, i.e.,
the ID number of the TCI state provided by tci-Stateld
the SS/PBCH block which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the SRS resource e.g. with the higher layer parameter usage set to ‘beamManagement’ which is QCLed with the RS (e.g., an NZP CSI-RS resource or an SS/PBCH block or an SRS resource e.g. with the higher layer parameter usage set to ‘beamManagement’) in the TCI state, provided by referenceSignal, with which quasi-collocation information is provided as specified in [REF 4] clause 5.1.5
the PCI of the SSBs when referenceSignal is configured as SSB, provided by additionalPCI
the ID of the RS (e.g. a CSI-RS or an SS/PBCH block (SSB) or an SRS resource e.g. with the higher layer parameter usage set to ‘beamManagement’) used for PUSCH, PUCCH and SRS path loss estimation, provided by pathlossReferenceRS-Id
the QCL information for the TCI state, provided by qcl-Type1 and/or qcl-Type2
the power control parameter for PUCCH, PUSCH and SRS for the TCI state, provided by ul-PowerControl
the TAG that is associated with the TCI state, provided by tag-Id-ptr
the DL BWP which the CSI-RS is located in or UL BWP where the SRS is located in, provided by bwp-Id
the UE's serving cell in which the referenceSignal is configured, provided by cell and/or servingCellId
the QCL type provided by qcl-Type
   specific or associated or corresponding to the previously indicated one(s) or TCI State(s)/in the TCI-State/TCI-UL-State/QCL-Info provided for the previously indicated one(s) or TCI State(s) regardless of the aforementioned TCI state(s) indication. That is, when a UE configured with dl-OrJointTCI-StateL1st or ul-TCI-StateL1st would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if a first content/component/parameter/signaling/setting/value as specified/defined herein in the present disclosure specific or associated or corresponding to the indicated TCI State(s)/in the TCI-State/TCI-UL-State/QCL-Info provided for the indicated TCI State(s) is/are different from a corresponding (e.g., having the same RRC parameter/configuration/signalling/name) first content/component/parameter/signaling/setting/value specific or associated or corresponding to the previously indicated one(s) or TCI State(s)/in the TCI-State/TCI-UL-State/QCL-Info provided for the previously indicated one(s) or TCI State(s), the first content/component/parameter/signaling/setting/value as specified/defined herein in the present disclosure specific or associated or corresponding to the indicated TCI-State(s) and/or TCI-UL-State(s)/in the TCI-State/TCI-UL-State/QCL-Info provided for the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. If a first content/component/parameter/signaling/setting/value as specified/defined herein in the present disclosure specific or associated or corresponding to the indicated TCI State(s)/in the TCI-State/TCI-UL-State/QCL-Info provided for the indicated TCI State(s) is the same as or identical to or not changed/updated from a corresponding (e.g., having the same RRC parameter/configuration/signalling/name) first content/component/parameter/signaling/setting/value specific or associated or corresponding to the previously indicated one(s) or TCI State(s)/in the TCI-State/TCI-UL-State/QCL-Info provided for the previously indicated one(s) or TCI State(s), the UE could maintain and/or keep and/or apply the first content/component/parameter/signaling/setting/value specific or associated or corresponding to the previously indicated one(s) or TCI State(s)/in the TCI-State/TCI-UL-State/QCL-Info provided for the previously indicated one(s) or TCI State(s) regardless of the aforementioned TCI state(s) indication. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

When a UE configured with dl-OrJointTCI-StateL1st or ul-TCI-StateL1st would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State(s) is/are different from the previously indicated one(s)—meaning that the (first) content(s)/component(s)/parameter(s)/signaling(s)/setting(s)/value(s) as specified/defined herein in the present disclosure specific or associated or corresponding to the indicated TCI State(s)/in the TCI-State/TCI-UL-State/QCL-Info provided for the indicated TCI-State(s) and/or TCI-UL-State(s) is/are different from the corresponding/respective (first) content(s)/component(s)/parameter(s)/signaling(s)/setting(s)/value(s) as specified/defined herein in the present disclosure specific or associated or corresponding to the previously indicated one(s) or TCI State(s)/in the TCI-State/TCI-UL-State/QCL-Info provided for the previously indicated one(s) or TCI State(s), the indicated TCI-State(s) and/or TCI-UL-State(s) hence the (first) content(s)/component(s)/parameter(s)/signaling(s)/setting(s)/value(s) as specified/defined herein in the present disclosure specific or associated or corresponding to the indicated TCI State(s)/in the TCI-State/TCI-UL-State/QCL-Info provided for the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

When a UE configured with dl-OrJointTCI-StateL1st or ul-TCI-StateL1st would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if (1) the RS(s) in the indicated TCI State(s) is/are different from the RS(s) in the previously indicated one(s), the indicated TCI-State(s) and/or TCI-UL-State(s) hence the RS(s) in the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied, or (2) the SS/PBCH block(s) and/or SRS(s) QCLed with the RS(s) in the indicated TCI State(s) is/are different from the SS/PBCH block(s) and/or SRS(s) QCLed with the RS(s) in the previously indicated one(s), the indicated TCI-State(s) and/or TCI-UL-State(s) hence the SS/PBCH block(s) and/or SRS(s) QCLed with the RS(s) in the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

When a UE is configured with dl-OrJointTCI-StateL1st and is having one indicated TCI-state, and if the UE is configured with unifiedTCI-State Type is set as ‘separate’, and if the UE receives a TCI codepoint mapped with either of {TCI-State, TCI-UL-State}, the UE shall maintain the other {TCI-State, TCI-UL-State} that is not updated by the received TCI codepoint, and
if a first content/component/parameter/signaling/setting/value as specified/defined herein in the present disclosure specific or associated or corresponding to the one of {TCI-State, TCI-UL-State}mapped to the received TCI codepoint is/are different from a corresponding (e.g., having the same RRC parameter/configuration/signalling/name) first content/component/parameter/signaling/setting/value specific or associated or corresponding to the one indicated {TCI-State, TCI-UL-State}, update the first content/component/parameter/signaling/setting/value, e.g., specific or associated or corresponding to the one indicated {TCI-State, TCI-UL-State}, with the corresponding first content/component/parameter/signaling/setting/value as specified/defined herein in the present disclosure specific or associated or corresponding to the one of {TCI-State, TCI-UL-State}mapped to the received TCI codepoint—or equivalently, update the one indicated {TCI-State, TCI-UL-State} with the corresponding first content/component/parameter/signaling/setting/value as specified/defined herein in the present disclosure specific or associated or corresponding to the one of {TCI-State, TCI-UL-State}mapped to the received TCI codepoint;
if a first content/component/parameter/signaling/setting/value as specified/defined herein in the present disclosure specific or associated or corresponding to the one of {TCI-State, TCI-UL-State}mapped to the received TCI codepoint is/are the same as or identical to a corresponding (e.g., having the same RRC parameter/configuration/signalling/name) first content/component/parameter/signaling/setting/value specific or associated or corresponding to the one indicated {TCI-State, TCI-UL-State}, maintain the corresponding first content/component/parameter/signaling/setting/value, e.g., specific or associated or corresponding to the one indicated {TCI-State, TCI-UL-State}, that is not updated/changed—or equivalently, maintain the one indicated {TCI-State, TCI-UL-State} with the corresponding first content/component/parameter/signaling/setting/value as specified/defined herein in the present disclosure that is not updated/changed.

In particular, when a UE is configured with dl-OrJointTCU-StateL1st and is having one indicated TCI-state, and if the UE is configured with unifiedTCI-StateType is set as ‘separate’, and if the UE receives a TCI codepoint mapped with either of {TCI-State, TCI-UL-State}, the UE shall maintain the other {TCI-State, TCI-UL-State} that is not updated by the received TCI codepoint, and
if the RS(s) in the one of {TCI-State, TCI-UL-State}mapped to the received TCI codepoint is/are different from the RS(s) in the one indicated {TCI-State, TCI-UL-State}, update the RS(s), e.g., in the one indicated {TCI-State, TCI-UL-State}, with the RS(s) in the one of {TCI-State, TCI-UL-State}mapped to the received TCI codepoint—or equivalently, update the one indicated {TCI-State, TCI-UL-State} with the RS(s) in the one of {TCI-State, TCI-UL-State}mapped to the received TCI codepoint; and/or
if the SS/PBCH block(s)/SRS resource(s) QCLed with the RS(s) in the one of {TCI-State, TCI-UL-State}mapped to the received TCI codepoint is/are different from the SS/PBCH block(s)/SRS resource(s) QCLed with the RS(s) in the one indicated {TCI-State, TCI-UL-State}—e.g., assuming that the RS(s) in the one of {TCI-State, TCI-UL-State}mapped to the received TCI codepoint is/are the same as or identical to the RS(s) in the one indicated {TCI-State, TCI-UL-State}, update the SS/PBCH block(s)/SRS resource(s) QCLed with the RS(s), e.g., in the one indicated {TCI-State, TCI-UL-State}, with SS/PBCH block(s)/SRS resource(s) QCLed with the RS(s) in the one of {TCI-State, TCI-UL-State}mapped to the received TCI codepoint—or equivalently, update the one indicated {TCI-State, TCI-UL-State} with the SS/PBCH block(s)/SRS resource(s) QCLed with the RS(s) in the one of {TCI-State, TCI-UL-State}mapped to the received TCI codepoint.

When a UE is configured with dl-OrJointTCI-StateL1st and is having one indicated TCI-state, and if the UE is configured with unifiedTCI-State Type is set as ‘separate’, and if the UE receives a TCI codepoint mapped with either of {TCI-State, TCI-UL-State}, the UE shall update the one indicated {TCI-State, TCI-UL-State}—meaning that the (first) content(s)/component(s)/parameter(s)/signaling(s)/setting(s)/value(s) as specified/defined herein in the present disclosure specific or associated or corresponding to one of {TCI-State, TCI-UL-State}mapped to the received TCI codepoint is/are different from the corresponding/respective (first) content(s)/component(s)/parameter(s)/signaling(s)/setting(s)/value(s) as specified/defined herein in the present disclosure specific or associated or corresponding to the one indicated {TCI-State, TCI-UL-State}, and maintain the other {TCI-State, TCI-UL-State} that is not updated by the received TCI codepoint.

When a UE is configured with dl-OrJointTCI-StateL1st and is having two indicated TCI-states, if the UE receives a TCI codepoint mapped with a sub-set of first and second TCI-State(s) and/or a sub-set of first and second TCI-UL-State(s), the UE shall keep the previously indicated first/second TCI-State(s) and/or first/second TCI-UL-State(s) that is/are not updated by the TCI codepoint, and
if a first content/component/parameter/signaling/setting/value as specified/defined herein in the present disclosure specific or associated or corresponding to the first/second TCI-State(s) and/or first/second TCI-UL-State(s) mapped to the received TCI codepoint is/are different from a corresponding (e.g., having the same RRC parameter/configuration/signalling/name) first content/component/parameter/signaling/setting/value specific or associated or corresponding to the previously indicated first/second TCI-State(s) and/or first/second TCI-UL-State(s) corresponding/respective to the first/second TCI-State(s) and/or first/second TCI-UL-State(s) mapped to the received TCI codepoint, update the first content/component/parameter/signaling/setting/value, e.g., specific or associated or corresponding to the previously indicated first/second TCI-State(s) and/or first/second TCI-UL-State(s) corresponding/respective to the first/second TCI-State(s) and/or first/second TCI-UL-State(s) mapped to the received TCI codepoint, with the corresponding first content/component/parameter/signaling/setting/value as specified/defined herein in the present disclosure specific or associated or corresponding to the first/second TCI-State(s) and/or first/second TCI-UL-State(s) mapped to the received TCI codepoint—or equivalently, update the previously indicated first/second TCI-State(s) and/or first/second TCI-UL-State(s) corresponding/respective to the first/second TCI-State(s) and/or first/second TCI-UL-State(s) mapped to the received TCI codepoint with the corresponding first content/component/parameter/signaling/setting/value as specified/defined herein in the present disclosure specific or associated or corresponding to the first/second TCI-State(s) and/or first/second TCI-UL-State(s) mapped to the received TCI codepoint;
if a first content/component/parameter/signaling/setting/value as specified/defined herein in the present disclosure specific or associated or corresponding to the first/second TCI-State(s) and/or first/second TCI-UL-State(s) mapped to the received TCI codepoint is/are the same as or identical to a corresponding (e.g., having the same RRC parameter/configuration/signalling/name) first content/component/parameter/signaling/setting/value specific or associated or corresponding to the previously indicated first/second TCI-State(s) and/or first/second TCI-UL-State(s) corresponding/respective to the first/second TCI-State(s) and/or first/second TCI-UL-State(s) mapped to the received TCI codepoint, maintain the corresponding first content/component/parameter/signaling/setting/value, e.g., specific or associated or corresponding to the previously indicated first/second TCI-State(s) and/or first/second TCI-UL-State(s) corresponding/respective to the first/second TCI-State(s) and/or first/second TCI-UL-State(s) mapped to the received TCI codepoint, that is not updated/changed—or equivalently, maintain the previously indicated first/second TCI-State(s) and/or first/second TCI-UL-State(s) corresponding/respective to the first/second TCI-State(s) and/or first/second TCI-UL-State(s) mapped to the received TCI codepoint with the corresponding first content/component/parameter/signaling/setting/value as specified/defined herein in the present disclosure that is not updated/changed.

In particular, when a UE is configured with dl-OrJointTCI-StateL1st and is having two indicated TCI-states, if the UE receives a TCI codepoint mapped with a sub-set of first and second TCI-State(s) and/or a sub-set of first and second TCI-UL-State(s), the UE shall keep the previously indicated first/second TCI-State(s) and/or first/second TCI-UL-State(s) that is/are not updated by the TCI codepoint, and
if the RS(s) in the first/second TCI-State(s) and/or first/second TCI-UL-State(s) mapped to the received TCI codepoint is/are different from the RS(s) in the previously indicated first/second TCI-State(s) and/or first/second TCI-UL-State(s) corresponding/respective to the first/second TCI-State(s) and/or first/second TCI-UL-State(s) mapped to the received TCI codepoint, update the RS(s), e.g., in the previously indicated first/second TCI-State(s) and/or first/second TCI-UL-State(s) corresponding/respective to the first/second TCI-State(s) and/or first/second TCI-UL-State(s) mapped to the received TCI codepoint, with the RS(s) in the first/second TCI-State(s) and/or first/second TCI-UL-State(s) mapped to the received TCI codepoint—or equivalently, update the previously indicated first/second TCI-State(s) and/or first/second TCI-UL-State(s) corresponding/respective to the first/second TCI-State(s) and/or first/second TCI-UL-State(s) mapped to the received TCI codepoint with the RS(s) in the first/second TCI-State(s) and/or first/second TCI-UL-State(s) mapped to the received TCI codepoint; and/or
if the SS/PBCH block(s)/SRS resource(s) QCLed with the RS(s) in the first/second TCI-State(s) and/or first/second TCI-UL-State(s) mapped to the received TCI codepoint is/are different from the SS/PBCH block(s)/SRS resource(s) QCLed with the RS(s) in the previously indicated first/second TCI-State(s) and/or first/second TCI-UL-State(s) corresponding/respective to the first/second TCI-State(s) and/or first/second TCI-UL-State(s) mapped to the received TCI codepoint—e.g., assuming that the RS(s) in the first/second TCI-State(s) and/or first/second TCI-UL-State(s) mapped to the received TCI codepoint is/are the same as or identical to the RS(s) in the previously indicated first/second TCI-State(s) and/or first/second TCI-UL-State(s) corresponding/respective to the first/second TCI-State(s) and/or first/second TCI-UL-State(s) mapped to the received TCI codepoint, update the SS/PBCH block(s)/SRS resource(s) QCLed with the RS(s), e.g., in the previously indicated first/second TCI-State(s) and/or first/second TCI-UL-State(s) corresponding/respective to the first/second TCI-State(s) and/or first/second TCI-UL-State(s) mapped to the received TCI codepoint, with SS/PBCH block(s)/SRS resource(s) QCLed with the RS(s) in the previously indicated first/second TCI-State(s) and/or first/second TCI-UL-State(s) corresponding/respective to the first/second TCI-State(s) and/or first/second TCI-UL-State(s) mapped to the received TCI codepoint—or equivalently, update the previously indicated first/second TCI-State(s) and/or first/second TCI-UL-State(s) corresponding/respective to the first/second TCI-State(s) and/or first/second TCI-UL-State(s) mapped to the received TCI codepoint with the SS/PBCH block(s)/SRS resource(s) QCLed with the RS(s) in the first/second TCI-State(s) and/or first/second TCI-UL-State(s) mapped to the received TCI codepoint.

When a UE is configured with dl-OrJointTCI-StateL1st and is having two indicated TCI-states, if the UE receives a TCI codepoint mapped with a sub-set of first and second TCI-State(s) and/or a sub-set of first and second TCI-UL-State(s), the UE shall update the first/second TCI-State(s) and/or first/second TCI-UL-State(s) mapped to the received TCI codepoint—meaning that the (first) content(s)/component(s)/parameter(s)/signaling(s)/setting(s)/value(s) as specified/defined herein in the present disclosure specific or associated or corresponding to the first/second TCI-State(s) and/or first/second TCI-UL-State(s) mapped to the received TCI codepoint is/are different from the corresponding/respective (first) content(s)/component(s)/parameter(s)/signaling(s)/setting(s)/value(s) as specified/defined herein in the present disclosure specific or associated or corresponding to the previously indicated first/second TCI-State(s) and/or first/second TCI-UL-State(s) corresponding/respective to the first/second TCI-State(s) and/or first/second TCI-UL-State(s) mapped to the received TCI codepoint, and keep the previously indicated first/second TCI-State(s) and/or first/second TCI-UL-State(s) that is/are not updated by the TCI codepoint.

Throughout the present disclosure, an indicated TCI state provided by TCI-State or UL-TCIState could also be replaced by or referred to as or equivalent to or could correspond to an indicated TCI state provided by CandidateTCI-State or CandidateTCI-UL-State, when/if applicable (e.g., when/if L1/L2 triggered mobility a.k.a. LTM is enabled or configured according to or following those specified herein in the present disclosure); furthermore, a TCI state—e.g., provided by TCI-State or UL-TCIState—indicated by/in a (unified) TCI state(s) activation/deactivation MAC CE command and/or by a TCI codepoint of a TCI field in a beam indication DCI of format 1_1/1_2 with or without DL assignment could also be replaced by or referred to as or equivalent to or could correspond to a TCI state—provided by CandidateTCI-State or CandidateTCI-UL-State—indicated in a LTM Cell Switch Command MAC CE, when/if applicable (e.g., when/if L1/L2 triggered mobility a.k.a. LTM is enabled or configured according to or following those specified herein in the present disclosure).

The second set of candidate/new beam RS(s) or RS resource(s) specified/defined herein in the present disclosure could also be associated, specific or linked to a/the CSI reporting setting provided or configured for the UE-initiated/event-driven beam reporting as specified/defined herein in the present disclosure. Furthermore, the design examples specified/defined/described herein throughout the present disclosure could also be applicable or extended to when a configured or activated or indicated TCI state only has TRS as the QCL RS and/or when only a TRS is provided or indicated or configured as a (QCL) RS in a configured or activated or indicated TCI state.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a RS (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., the network 130) (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s).

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB (e.g., the BS 102) lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. L1kewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Accordingly, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various report formats customized for the UE-initiated/event-driven beam reporting, and specifies different conditions or settings to apply or use different report formats. Means of detecting/declaring different events or combinations of different events, and designs of their corresponding configurations and signaling details are specified in this disclosure as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CRI, SSBRI) and Jᵢ is a beam metric (e.g. L1-RSRP, L1-SINR).
In one example, the content includes CSI-related quantity/quantities. For example, at least one of (RI, PMI, CQI, CRI, LI).
In one example, the content includes TDCP-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
In one example, quantity/quantities comprises a selector/indicator indicating selection of one (or >1) of either
   beam (TCI state) TCI states (e.g. DL TCI state, UL TCI state, or unified (joint) DL/UL TCI state), or
   panel(s) (e.g. UE panels for DL reception or/and UL transmission), or
   antenna(e) (e.g. UE antennae for DL reception or/and UL transmission), or
   antenna port(s) (e.g. UE antenna ports for DL reception or/and UL transmission).
In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE (e.g., the UE 116) is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. MCS, or number of CWs.
For another example, when there is no pre-notification message/trigger associated with a content, i.e., the report-type is (B), the content can be transmitted using UL resource(s) configured (e.g. configured-grant PUSCH), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
In one example, the UE could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format described/specified herein in the present disclosure is presented in FIG. 7A.
In another example, for (3), a first indicator and/or a second indicator could be provided, reported, sent, comprised, included, contained or transmitted in a/the UEI report as specified herein in the present disclosure. For this design example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure. In particular, the first indicator could correspond to a set index/indicator for a serving beam(s) RS set denoted by s̅₀ according to those specified herein in the present disclosure—e.g., the set index/indicator for the serving beam(s) RS set, and therefore, the first indicator, could be ‘0’ (or ‘1’ or ‘2’); optionally or alternatively, the first indicator could correspond to a one-bit indicator (e.g., a one-bit set index/indicator) with ‘0’ (or ‘1’ or ‘2’) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure. Furthermore, the second indicator could correspond to a set index/indicator for a candidate beam(s) RS set denoted by s̅₁ according to those specified herein in the present disclosure—e.g., the set index/indicator for the candidate beam(s) RS set, and therefore, the second indicator, could be ‘1’ (or ‘0’ or ‘2’); optionally or alternatively, the second indicator could correspond to a one-bit indicator (e.g., a one-bit set index/indicator) with ‘1’ (or ‘0’ or ‘2’) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s). In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) such as SSBRI(s)/CRI(s) and/or beam metric(s) such as L1-RSRP(s)/L1-SINR(s) corresponding to the current serving (or candidate) beam(s)—in FIG. 7B, a conceptual example capturing the UEI reporting format according to those specified herein in the present disclosure is provided. Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network (e.g., the network 130) via various UL channels/signals including PUCCH, PUSCH, PRACH, and/or etc.
In another example, for (3), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by s̅₀ according to those specified herein in the present disclosure or a candidate beam(s) RS set denoted by s̅₁ according to those specified herein in the present disclosure—e.g., the indicator (or equivalently, the set index/indicator) could be ‘0’ (or ‘1’ or ‘2’) for the serving beam(s) RS set, and ‘1’ (or ‘0’ or ‘2’) for the candidate beam(s) RS set. For another example, the indicator could correspond to a one-bit indicator with ‘0’ (or ‘1’ or ‘2’) corresponding to/indicating the serving beam(s) RS set and/or information related to current serving beam(s), and ‘1’ (or ‘0’ or ‘2’) corresponding to/indicating the candidate beam(s) RS set and/or information related to candidate beam(s). In this case, when/if an indicator associated/corresponding/specific to a report content/quantity as specified/defined herein in the present disclosure in a UEI report is set to ‘0’ (or ‘1’ or ‘2’), the report content/quantity could be associated/corresponding/specific to the current serving beam(s), and when/if an indicator associated/corresponding/specific to a report content/quantity as specified/defined herein in the present disclosure in a UEI report is set to ‘1’ (or ‘0’ or ‘2’), the report content/quantity could be associated/corresponding/specific to the candidate beam(s).
In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE (e.g., the UE 116) could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

For a first event (denoted by Event-1), wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams.
Component-1f: indicator(s) or bitmap(s) indicating the one or more second current serving beams—e.g., out of the current serving beams or out of the first current serving beam(s).
Component-1g: a number of the one or more first current serving beams in the UEI report(s).
Component-1h: a number of the one or more second current serving beams in the UEI report(s).
Component-1i: indicator(s) indicating occurrence of the first event and/or an event index/ID associated/specific/corresponding to the first event.
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or, the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or, the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-1c in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-1d in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Ns>1. In another example, Ns>1. Furthermore, when/if an/the event-driven or event-triggered (beam) reporting for L1/L2 triggered mobility (LTM) is configured or enabled (e.g., when/if the UE is provided a higher layer RRC signaling/parameter LTM-ConfigLTM-CSI-ResourceConfig/LTM-CSI-ReportConfig and/or ‘event-driven reporting’ in LTM-ConfgLTM-CSI-ResourceConfgLTM-CSI-ReportConfg set to ‘enabled’), the first event or the Event-1 as described/specified herein could be denoted by or referred to as a first LTM event or a LTM Event-1. For the first LTM event or the LTM Event-1, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a second event (denoted by Event-2), wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)—throughout the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams.
Component-2f: indicator(s) or bitmap(s) indicating the one or more second candidate beams—e.g., out of the candidate beams or out of the first candidate beam(s).
Component-2g: a number of the one or more first candidate beams in the UEI report(s).
Component-2h: a number of the one or more second candidate beams in the UEI report(s).
Component-2i: indicator(s) indicating occurrence of the second event and/or an event index/ID associated/specific/corresponding to the second event.
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or, the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y| dBm could be reported in the UEI report as a report content/quantity, and a corresponding one-bit sign indicator indicating either positive or negative of the difference could also be reported in the same UEI report. Or, the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-21: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc>1. Furthermore, when/if an/the event-driven or event-triggered (beam) reporting for L1/L2 triggered mobility (LTM) is configured or enabled (e.g., when/if the UE is provided a higher layer RRC signaling/parameter LTM-ConfigLTM-CSI-ResourceConfigLTM-CSI-ReportConfig and/or ‘event-driven reporting’ in LTM-Confg/LTM-CSI-ResourceConfg/LTM-CSI-ReportConfg set to ‘enabled’), the second event or the Event-2 as described/specified herein could be denoted by or referred to as a second LTM event or a LTM Event-2. For the second LTM event or the LTM Event-2, the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a third event (denoted by Event-3), wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the third event or the Event-3 as described/specified herein could be denoted by or referred to as a third LTM event or a LTM Event-3. For the third LTM event or the LTM Event-3, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), and the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a fourth event (denoted by Event-4), wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or, the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or, the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams.
Component-4h: indicator(s) or bitmap(s) indicating the one or more first candidate beams—e.g., out of the candidate beams.
Component-4i: a number of the one or more first current serving beams in the UEI report(s).
Component-4j: a number of the one or more first candidate beams in the UEI report(s).
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4l for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or, the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C|) specified/defined or obtained in Component-4o and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or, the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s).
Component-4r: indicator(s) or bitmap(s) indicating the one or more second candidate beams—e.g., out of the candidate beams or out of the first candidate beam(s).
Component-4s: a number of the one or more second current serving beams in the UEI report(s).
Component-4t: a number of the one or more second candidate beams in the UEI report(s).
Component-4u: indicator(s) indicating occurrence of the fourth event and/or an event index/ID associated/specific/corresponding to the fourth event.
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-41 in the UEI report(s); e.g., the indicator(s) could be a one-bit indicator with ‘1’ (or ‘0’) indicating presence and ‘0’ (or ‘1’) indicating absence of Component-41 in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-51: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Nc>1 and/or Ns>1. In another example, Nc≥1 and/or Ns≥1. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the fourth event or the Event-4 as described/specified herein could be denoted by or referred to as a fourth LTM event or a LTM Event-4. For the fourth LTM event or the LTM Event-4, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), and the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

Throughout the present disclosure, discussions, descriptions, specifications and etc. related to the first event (Event-1), the second event (Event-2), the third event (Event-3) and the fourth event (Event-4) can be equally applied or extended to the first LTM event (LTM Event-1), the second LTM event (LTM Event-2), the third LTM event (LTM event-3) and the fourth LTM event (LTM event-4), respectively, according to/following those described/specified herein in the present disclosure.

For each (or one or more) of the first, second, third and fourth events, and/or for a UE (e.g., the UE 116) to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstanceDetectionTimer; thirdEventInstanceDetectionTimer or fourthEventInstanceDetectionTimer (higher layer configured respectively for the first, second, third or fourth event—when/if applicable)
      3> increment firstEvent COUNTER, secondEvent COUNTER, thirdEvent COUNTER or fourthEvent COUNTER (higher layer configured respectively for the first, second, third or fourth event—when/if applicable) by 1;
      3> if firstEvent COUNTER>=JfrstEventInstanceMaxCount, secondEvent COUNTER>=secondEventInstanceMaxCount, thirdEvent COUNTER>=thirdEventInstanceMaxCount or fourthEvent COUNTER>=fourthEventInstanceMaxCount (respectively for the first, second, third or fourth event—when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event—when/if applicable:
         4> trigger a UEI (beam) reporting specific to the first, second, third or fourth event—when/if applicable—for this Serving Cell, wherein the report content(s)/quantity(s) in the UEI report(s) is specific to the first, second, third or fourth event—when/if applicable—according to or following those specified herein in the present disclosure.
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable) expires; or
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable), firstEvent COUNTER, secondEvent COUNTER, thirdEvent COUNTER or fourthEvent COUNTER (respectively for the first, second, third or fourth event—when/if applicable), or any of the RSs used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the RS(s) associated with this Serving Cell used for detection/declaration/indication for the first, second, third or fourth event as specified/defined herein in the present disclosure is changed and/or reconfigured by upper layers associated with this Serving Cell:
      3> setfirstEvent COUNTER, secondEvent COUNTER, thirdEvent COUNTER or fourthEvent COUNTER (respectively for the first, second, third or fourth event—when/if applicable) to 0; and/or
      3> stop the ueiReportingTimer, if configured; and/or
      3> consider the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity herein and the corresponding operation(s)/procedure(s) are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events—jointly or simultaneously, the corresponding MAC entity—e.g., for the third and fourth events—could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent COUNTER and/or fourthEvent COUNTER (higher layer configured for the third and/or fourth event(s)—when/if applicable) by 1;
      3> if both thirdEvent COUNTER>=thirdEventInstanceMaxCount and fourthEvent COUNTER>=fourthEventInstanceMaxCount (for the third and fourth events—when/if applicable), wherein the thirdEventInstanceMaxCount and fourthEventInstanceMaxCount are higher layer configured respectively for the third and fourth events—when/if applicable:
         4> trigger a UEI (beam) reporting specific to the third and fourth events for this Serving Cell, wherein the report content(s)/quantity(s) in the UEI report(s) is specific to the third and fourth events—when/if applicable—according to or following those specified herein in the present disclosure.
   2> if the thirdEventInstanceDetectionTimer and/or fourthEventInstanceDetectionTimer (respectively for the third and/or fourth event(s)—when/if applicable) expires; or
   2> if the thirdEventInstanceDetectionTimer and/or fourthEventInstanceDetectionTimer (respectively for the third and/or fourth event(s)—when/if applicable), thirdEvent COUNTER and/or fourthEvent COUNTER (respectively for the third and/or fourth event(s)—when/if applicable), or any of the RSs used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the RS(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent COUNTER and/orfourthEvent COUNTER (respectively for the third and/or fourth event(s)—when/if applicable) to 0; and/or
      3> stop the ueiReportingTimer, if configured; and/or
      3> consider the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) herein and the corresponding operation(s)/procedure(s) could be applied or extended to when/if more than two events could be configured and/or enabled by the network and/or applied or used by the UE for initiating or triggering the UEI reporting.

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-4}, the UE could indicate or send or transmit to the network that they could support or could be capable of supporting the Event-1 and Event-4 in the present disclosure:
{Event-1}
{Event-2}
{Event-3}
{Event-4}
{Event-1, Event-2}
{Event-1, Event-3}
{Event-1, Event-4}
{Event-2, Event-3}
{Event-2, Event-4}
{Event-3, Event-4}
{Event-1, Event-2, Event-3}
{Event-1, Event-2, Event-4}
{Event-1, Event-3, Event-4}
{Event-2, Event-3, Event-4}
{Event-1, Event-2, Event-3, Event-4}

Furthermore, UEs that could or would support the UE-initiated or event-driven reporting should support or indicate their support of one or more of the events—such as Event-4; i.e., the one or more of the events—such as Event-4 in the present disclosure—could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one or more than one) of the events (e.g., Event-1 and/or Event-4) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when/if the eventType is set to ‘Event-i’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-4’ or ‘four’ or ‘4’ or ‘fourth’ or ‘two’ or ‘2’ or ‘second’ or ‘disabled’ (or ‘enabled’) or 0 (or 1), the Event-4 as specified/described herein in the present disclosure is enabled. For another example, when/if the eventType is set to ‘Event-1 and Event-4’ or ‘one and four’ or ‘1 and 4‘ or’first and fourth’ or ‘enabled’ (or ‘disabled’) or 1 (or 0) or ‘00’ (or ‘01’ or ‘10’ or ‘11’), both the Event-1 and Event-4 as specified/defined herein in the present disclosure are enabled. Throughout the present disclosure, discussions, descriptions, specifications and etc. for when one/an event (e.g., Event-1 or Event-4) is enabled (e.g., detection, declaration, triggering and etc. of the event) can be equally applied or extended to when more than one events (e.g., both Event-1 and Event-4) are enabled (e.g., detection, declaration, triggering and etc. of the more than one events).

As specified herein in the present disclosure, to declare an event and to trigger the corresponding (beam) reporting, a UE would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event (e.g., Event-4) and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure. After the UE has declared an event, the UE could trigger or initiate a (beam) reporting following those specified/described herein in the present disclosure, and transmit or send to the network a UEI (beam) report comprising at least one or more report contents/quantities (including resource indicator(s) such as SSBRI(s)/CRI(s) and the corresponding beam metric(s) such as L1-RSRP(s)/L1-SINR(s)) that satisfy/achieve the event condition(s).

As specified herein in the present disclosure, to declare an event and to trigger the corresponding (beam) reporting, a UE would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event (e.g., Event-4) and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure based on or according to or following one or more of:
In one example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. In this design example, a first counting instance (or a corresponding/associated measurement instance as specified/defined herein in the present disclosure) and a second counting instance (or a corresponding/associated measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance
denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance
denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if a/the number of instances of the event—denoted by K_1≥1 out of the total number of instances of the event, i.e., K_1≤K—that have at least one same measurement quantity (denoted by first same measurement quantity(s)) is less than (or greater than) or equal to a threshold (denoted by Kmax) or greater than (or less than) or equal to a threshold (denoted by Kmin), and/or a/the number of instances of the event—denoted by K_2≥1 out of the total number of instances of the event, i.e., K_2≤K—that have at least one same measurement quantity (denoted by second same measurement quantity(s)) is less than (or greater than) or equal to a threshold (denoted by Kmax) or greater than (or less than) or equal to a threshold (denoted by Kmin), and so on, and/or a/the number of instances of the event—denoted by K_k≥1 out of the total number of instances of the event, i.e., K_k≤K—that have at least one same measurement quantity (denoted by k-th same measurement quantity(s)) is less than (or greater than) or equal to a threshold (denoted by Kmax) or greater than (or less than) or equal to a threshold (denoted by Kmin), wherein k∈{1, 2, . . . , Btot} with Btot representing the maximum/total number of unique measurement quantities obtained/identified/determined from the K event instances, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. Two conceptual examples are presented in FIG. 8A and FIG. 8B. In FIG. 8A, the UE could determine or identify three instances of the event (denoted by event instance (EI) #1, EI #2 and EI #3) from four measurement instances (MIs)/counting instances (CIs) in the time window/period/gap/offset, and in FIG. 8B, the UE could determine or identify four instances of the event (denoted by EI #1, EI #2, EI #3 and EI #4) from four MIs/CIs within the time window/period/gap/offset. Among the three determined/identified EIs in FIG. 8A, the two (equal to Kmin=2 in this design example) EI #1 and EI #2 have a/the same measurement quantity—i.e., a new beam RS ID/index 4; hence, according to those specified herein in the present disclosure, the UE could declare the event and initiate/trigger a beam reporting with the new beam RS ID/index 4 as a candidate report quantity/content. Among the four determined/identified EIs in FIG. 8B, the two (equal to Kmin=2 in this design example) EI #1 and EI #4 have a/the same measurement quantity—i.e., a new beam RS ID/index 6, and the two (equal to Kmin=2 in this design example) EI #2 and EI #3 have a/the same measurement quantity—i.e., a new beam RS ID/index 4; hence, according to those specified herein in the present disclosure, the UE could declare the event and initiate/trigger a beam reporting with the new beam RS IDs/indexes 4 and 6 as candidate report quantities/contents.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if there is at least one common/same measurement quantity (e.g., in terms of new beam RS ID(s)/index(es)) among the first, second, . . . , and/or K-th measurement quantities as specified/defined herein in the present disclosure and/or the number of at least one of the common/same measurement quantities—denoted by/referred to as triggering measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or K-th measurement quantities as specified/defined herein in the present disclosure, and/or when/if a/the number of one or more same/common measurement quantities—denoted by/referred to as first same measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), k∈{1, 2, . . . , Btot} with Btot representing the maximum/total number of unique measurement quantities obtained/identified/determined from the K event instances, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as specified/defined herein in the present disclosure, and/or the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine an event instance counter specific/associated to the k-th instance of the event wherein k=1, . . . , K. The UE (e.g., higher layer(s) of the UE) could increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein l∈{1, . . . , K} and l≠k, that has at least one same measurement quantity, denoted by k′-th same measurement quantity(s) wherein k′∈{1, . . . , Btot} with Btot representing the maximum/total number of unique measurement quantities obtained/identified/determined from the K event instances, as that determined or identified for the k-th instance of the event. When/if a/the number of count(s) in at least one event instance counter as specified/defined herein in the present disclosure reaches to the maximum number of count(s)—denoted by Cmax, wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in each of the event instance counter(s) as specified/defined herein in the present disclosure to zero(s) when/if (1) the number of count(s) in the corresponding event instance counter has reached to Cmax, and/or (2) after, e.g., the last symbol/slot/etc. of, the K-th measurement instance or the K-th counting instance or the K-th instance of the event or out of the time window/period/gap/offset as specified/defined herein in the present disclosure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), . . . , the k′-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine an event instance counter specific/associated to the k-th instance of the event wherein k=1, . . . , K, . . . . The UE (e.g., higher layer(s) of the UE) could start a timer specific/associated to the k-th instance of the event and/or increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein l∈{1, . . . , K, . . . } and l≠k, that has at least one same measurement quantity, denoted by k′-th same measurement quantity(s) wherein k′∈{1, . . . , Btot} with Btot representing the maximum/total number of unique measurement quantities obtained/identified/determined from the event instances, as that determined or identified for the k-th instance of the event. When/if a/the number of count(s) in at least one event instance counter as specified/defined herein in the present disclosure reaches to the maximum number of count(s)—denoted by Cmax—before the corresponding timer expires (the corresponding same measurement quantity(s) specific/associated to the at least one event instance counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the event instance counter specific/associated to the k-th instance of the event as specified/defined herein in the present disclosure to zero and/or reset the timer specific/associated to the k-th instance of the event when/if (1) the number of count(s) in the event instance counter specific/associated to the k-th instance of the event has reached to Cmax, and/or (2) the timer specific/associated to the k-th instance of the event has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For a m-th measurement quantity, wherein m=1, 2, . . . , Btot with Btot representing the total/maximum number of unique measurement quantities obtained/identified/determined from the K event instances, the UE could determine or identify a/the number of event instance(s)—denoted by K_m≥1 out of the total number of instances of the event, i.e., K_m≤K—that have at least the m-th measurement quantity. In this case, when/if at least one of K_1, . . . , K_Btot is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, when/if K_k (k∈{1, . . . , Btot}) is less than (or greater than) or equal to a threshold (denoted by Kmax) or greater than (or less than) or equal to a threshold (denoted by Kmin), the k-th measurement quantity as defined/specified herein in the present disclosure could be regarded as one of candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine a measurement quantity counter specific/associated to a m-th measurement quantity, wherein m=1, . . . , Btot with Btot representing the total/maximum number of unique measurement quantities obtained/identified/determined from the K event instances. The UE (e.g., higher layer(s) of the UE) could increase the number of count(s), e.g., in the measurement quantity counter specific/associated to the m-th measurement quantity, by 1, when/if the UE has identified, determined or detected a/the same value of the m-th measurement quantity from any of the K event instances and therefore their corresponding/associated counting/measurement instances. When/if a/the number of count(s) in at least one measurement quantity counter as specified/defined herein in the present disclosure reaches to the maximum number of count(s)—denoted by Cmax (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero when/if (1) the number of count(s) in the measurement quantity counter specific/associated to the m-th measurement quantity has reached to Cmax, and/or (2) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance —corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine a measurement quantity counter specific/associated to a m-th measurement quantity, wherein m=1, 2, . . . , Btot, . . . with Btot representing the total/maximum number of unique measurement quantities obtained/identified/determined from the K event instances. The UE (e.g., higher layer(s) of the UE) could start a timer specific/associated to the m-th measurement quantity and/or increase the number of count(s), e.g., in the measurement quantity counter specific/associated to the m-th measurement quantity, by 1, when/if the UE has identified, determined or detected a/the same value of the m-th measurement quantity from any of the (K) event instances and therefore their corresponding/associated counting/measurement instances. When/if a/the number of count(s) in at least one measurement quantity counter as specified/defined herein in the present disclosure reaches to the maximum number of count(s)—denoted by Cmax—before the corresponding timer expires (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero and/or reset the timer specific/associated to the m-th measurement quantity when/if (1) the number of count(s) in the measurement quantity counter specific/associated to the m-th measurement quantity has reached to Cmax, and/or (2) the timer specific/associated to the m-th measurement quantity has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. One conceptual example characterizing the described/specified design procedures herein is provided in FIG. 8c. As can be seen from FIG. 8c, only the number of counts in the measurement quantity counter specific/associated to the measurement quantity of new beam RS ID/index 4 (denoted by Counter_4 in FIG. 8c) has reached to the maximum number of counts Cmax before the corresponding timer specific/associated to the measurement quantity of new beam RS ID/index 4 (denoted by Timer_4 in FIG. 8c) expires. In this case, the UE could declare the event and initiate/trigger a beam reporting with at least the new beam RS ID/index 4 as a candidate report quantity/content.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE (e.g., the UE 116) has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, wherein the first instance of the event (or the corresponding/associated first counting/measurement instance as specified/defined herein in the present disclosure), the second instance of the event (or the corresponding/associated second counting/measurement instance as specified/defined herein in the present disclosure), . . . , and the K-th instance of the event (or the corresponding/associated K-th measurement/counting instance as specified/defined herein in the present disclosure) could be within a t-th (e.g., t∈{1, . . . , T}) time window/period/gap/offset (e.g., in terms of number of symbols/slots/etc.), wherein the value(s) of T and/or the t-th time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if at least one of the second measurement quantity(s), . . . , at least one of the K-th measurement quantity(s) is identical to or the same as at least one of the first measurement quantity(s)—denoted by/as channel triggering condition(s)—within the t-th time window/period/gap/offset as specified/defined herein in the present disclosure, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s), and K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event—within the t-th time window/period/gap/offset—as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time
e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event—denoted by K_1≥1 out of the total number of instances of the event within the t-th time window/period/gap/offset, i.e., K_1≥Kt—that have at least one same measurement quantity (denoted by first same measurement quantity(s)) is less than (or greater than) or equal to a threshold (denoted by Kmax) or greater than (or less than) or equal to a threshold (denoted by Kmin)—denoted by/referred to as channel triggering condition(s), and/or a/the number of instances of the event—denoted by K_2≥1 out of the total number of instances of the event within the t-th time window/period/gap/offset, i.e., K_2≥Kt—that have at least one same measurement quantity (denoted by second same measurement quantity(s)) is less than (or greater than) or equal to a threshold (denoted by Kmax) or greater than (or less than) or equal to a threshold (denoted by Kmin)—denoted by/referred to as channel triggering condition(s), and so on, and/or a/the number of instances of the event—denoted by K_k≥1 out of the total number of instances of the event within the t-th time window/period/gap/offset, i.e., K_k≥Kt—that have at least one same measurement quantity (denoted by k-th same measurement quantity(s)) is less than (or greater than) or equal to a threshold (denoted by Kmax) or greater than (or less than) or equal to a threshold (denoted by Kmin)—denoted by/referred to as channel triggering condition(s), wherein k∈{1, 2, . . . , Btot,t} with Btot,t representing the maximum/total number of unique measurement quantities obtained/identified/determined from the Kt event instances within the t-th time window/period/gap/offset, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event that have at least one same measurement quantity (denoted by triggering measurement quantity(s)) within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. A conceptual example characterizing the described design procedure(s) herein is presented in FIG. 9. As illustrated in FIG. 9, only within the third time window/period/gap/offset, the number of counts of the instances of the event that have at least one common measurement quantity (e.g., in term of new beam RS ID(s)/index(es)) is equal to Kmin (i.e., 4 in this example). Hence, the UE could declare the event and trigger/initiate a beam reporting after the third time window/period/offset/gap. Note there that there is a time gap/offset t_p between two adjacent time windows/periods/offsets/gaps in time, which can be configured/provided by the network, e.g., via higher layer RRC signaling/parameter (e.g., provided in higher layer parameter(s) such as CSI-ResourceConfig, CSI-ReportConfig, UEI-ReportConfig or UEI-ResourceConfig that provides necessary information/settings for the UEI beam reporting).
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure and/or the number of at least one of the common/same measurement quantities—denoted by/referred to as triggering measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by or referred to as channel trigging condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure, and/or when/if a/the number of one or more same/common measurement quantities—denoted by/referred to as first same measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by/referred to as channel triggering condition(s), k∈{1, 2, . . . , Btot} with Btot representing the maximum/total number of unique measurement quantities obtained/identified/determined from the Kt event instances within the t-th time window/period/gap/offset, and/or when/if the t-th time window/period/gap/offset ends the earliest in time than the other time window(s)/period(s)/gap(s)/offset(s) each having one or more same/common measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of same/common measurement quantity(s) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE (e.g., the UE 116) would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s)—within the t-th time window/period/gap/offset—as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among (all) the measurement quantities within at least one time window/period/offset/gap (e.g., the t-th time window/period/offset/gap), and/or when/if a/the number of at least one of the common/same measurement quantities (denoted by triggering measurement quantity(s)) among (all) the measurement quantities within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of common/same measurement quantity(s) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.

For the (described herein) design examples discussed/specified herein in the present disclosure, when/if a UE is configured/provided by the network, e.g., via higher layer RRC signaling/parameter, a parameter, the parameter could be provided in higher layer parameter(s) such as CSI-ResourceConfig, CSI-ReportConfig, UEI-ReportConfig or UEI-ResourceConfig that provides necessary information/settings for the UEI beam reporting. Furthermore, as specified herein in the present disclosure, for a measurement instance (or a counting instance), the UE could measure or assess one or more measurement RSs (for the current serving beam and/or one or more candidate/new beams as specified/defined herein in the present disclosure), obtain/determine/identify the corresponding measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs, and determine or identify an event instance (if any). In the present disclosure, the UE could identify or determine an instance of an event if the condition(s) of the event is achieved/satisfied; for instance, for the fourth event (Event-4) as specified/defined herein in the present disclosure, the UE could identify or determine an instance of the Event-4 or an Event-4 instance when/if the radio link or beam quality(s)—e.g., in form of (measured) L1-RSRP/L1-SINR value(s)—of one or more (or at least one) candidate/new beams is beyond or greater than the radio link or beam quality(s)—e.g., in form of (measured) L1-RSRP/L1-SINR value(s)—of one or more current serving beams by a threshold/offset value, denoted by threshold-C in the present disclosure.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam—denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set s̅₀ of (periodic) CSI-RS resource configuration indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example-2): a set s̅₀ of SS/PBCH block indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking RS(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet, and/or higher layer parameter(s) UEI-ReportConfig, UEI-ResourceConfig and/or etc. dedicated/configured for the UEI reporting as specified herein in the present disclosure.
(explicit configuration example-B): a set s̅₁ of SS/PBCH block indexes by CandidateBeamRSL1st (e.g., via higher layer RRC signalling(s)/parameter(s) and/or MAC CE command(s) and/or dynamic DCI based LI signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking RS(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network (e.g., the network 130) a/the set s̅₁ of (periodic) CSI-RS resource configuration indexes by CandidateBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource index(es)—could be identified or determined according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-i): a set s̅₂ of (periodic) CSI-RS resource configuration indexes by activationBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-ii): a set s̅₂ of SS/PBCH block indexes by activationBeamRSL1st (e.g., via higher layer RRC signalling(s)/parameter(s) and/or MAC CE command(s) and/or dynamic DCI based LI signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking RS(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSL1st (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking RS (TRS)—e.g., a CSI-RS configured with trs-Info, a CSI-RS configured without repetition or with repetition set to ‘off’, and etc.

Furthermore, the UE (e.g., the UE 116) could identify or determine a subset of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D as the RS(s) or RS resource(s) or RS resource index(es) for the actual measurement for/of one or more candidate/new beams.
In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.
In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g. (1) fixed rule(s) in system specification(s) or per RRC (re)configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.
   For example, the first (or last) L≥1 candidate RS(s) or RS resource(s) or RS resource index(es) or the L≥1 candidate RS(s) or RS resource(s) with the lowest (or highest) resource index(es)—among the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of the K configured/determined candidate RS(s) or RS resource(s) or RS resource index(es) or the half of the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.
   For another example, the even-ordered or even-numbered or even-indexed candidate RS(s) or RS resource(s) or RS resource index(es) or the candidate RS(s) or RS resource(s) with even-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.
   For another example, the odd-ordered or odd-numbered or odd-indexed candidate RS(s) or RS resource(s) or RS resource index(es) or the candidate RS(s) or RS resource(s) with odd-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.
In another example, the UE could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.
In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when/if the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.
In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.

For the described/specified design examples herein, when/if the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D to obtain the actual corresponding measurement result(s) for/of the one or more candidate/new beams. As specified or discussed herein in the present disclosure, a/the UE could indicate or send or transmit to the network, e.g., by/in part of their capability or capability signaling, whether or not they are capable of receiving/detecting/using/applying or support to receive/detect/use/apply the one or more indicators as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; for instance, a/the UE could indicate or send or transmit to the network, e.g., by/in part of their capability or capability signaling, whether or not they are capable of receiving/detecting/using/applying or support to receive/detect/use/apply the one or more indicators provided, contained, indicated, included, comprised or configured in the higher layer parameter TCI-State or TCI-UL-State that configures or provides the indicated TCI state as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. Optionally, when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is greater than or equal to a first threshold/number/value, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, (ii) follow those specified in the implicit determination example-A/B/C/D, and/or (iii) follow other subset based candidate RS(s)/RS resource(s)/RS resource index(es) indication/identification/determination method(s) as discussed or specified herein in the present disclosure, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is less than or equal to the first threshold/number/value, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B to obtain the actual corresponding measurement result(s) for/of the one or more candidate/new beams. In this case, the UE could determine or identify the first threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Alternatively, when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is less than or equal to a second threshold/value/number, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, and/or (ii) follow those specified in the explicit configuration example-A/B, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is greater than or equal to the second threshold/value/number, the UE could assess or evaluate the radio link/beam quality(s), e.g., by measuring the L1-RSRP(s)/L1-SINR(s), of the candidate RS(s) or RS resource(s) or RS resource index(es) determined following those specified/described in the implicit determination example-A, the implicit determination example-B, the implicit determination example-C and/or the implicit determination example-D to obtain the actual corresponding measurement result(s) for/of the one or more candidate/new beams. In this case, the UE could determine or identify the second threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Furthermore, the UE could first determine or identify, e.g., based on or according to (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure. Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/1-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

As described or specified herein in the present disclosure, a RS or RS resource or RS resource index of/for a current serving beam—denoted by a current serving beam RS/RS resource/RS resource index—could be corresponding/associated/mapped to one or more of (or a subset of) candidate RSs or RS resources or RS resource indexes—denoted by candidate candidate/new beam RS(s)/RS resource(s)/RS resource index(es)—used/applied as the RS(s) or RS resource(s) or RS resource index(es) for actual measurement(s) of/for one or more candidate/new beams—denoted by actual candidate/new beam RS(s)/RS resource(s)/RS resource index(es), wherein the current serving beam RS/RS resource/RS resource index and/or the candidate or actual candidate/new beam RS(s)/RS resource(s)/RS resource index(es) could be configured and/or determined according to those specified herein in the present disclosure.
In one example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.
   For example, as described/specified herein in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in the same higher layer parameter(s) TCI-State or TCI-UL-State that provides or configures the indicated TCI state.
   For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure. For this design example, the current serving beam RS/RS resource/RS resource index could be associated/mapped/corresponding to the one or more actual candidate/new beam RSs/RS resources/RS resource indexes.
   For another example, a/the higher layer RRC signaling(s)/parameter(s) and/or MAC CE command(s) and/or dynamic DCI based L1 signaling(s) that provides or configures or indicates one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure—could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes.
   For another example, the UE could be indicated or configured or provided by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure. For this design example, the current serving beam RS/RS resource/RS resource index could be associated/mapped/corresponding to the one or more actual candidate/new beam RSs/RS resources/RS resource indexes—via/by their associations to the one or more indicators as specified/defined herein in the present disclosure.
   For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a single/same set/list of RSs or RS resources or RS resource indexes that comprise, contain, include, provide, configure or indicate both a current serving beam RS/RS resource/RS resource index (e.g., the first entry in the set/list or the entry with the lowest/highest RS index or RS resource index in the set/list) and one or more actual candidate/new beam RSs/RS resources/RS resource indexes (e.g., the remaining or rest of the entries in the set/list other than the first entry or the entry with the lowest/highest RS index or RS resource index). Optionally, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one of the RSs or RS resources or RS resource indexes in the set/list could correspond to the current serving beam RS or RS resource or RS resource index and/or which one or more of the RSs or RS resources or RS resource indexes in the set/list could correspond to the actual candidate/new beam RS(s) or RS resource(s) or RS resource index(es). Alternatively, the UE (e.g., the UE 116) could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS/RS resource/RS resource index in the set/list, and/or identify or determine, according to or based on the second list/set, the actual candidate/new beam RS(s)/RS resource(s)/RS resource index(es) in the set/list. For this design example, the current serving beam RS/RS resource/RS resource index could be associated/mapped/corresponding to the one or more actual candidate/new beam RSs/RS resources/RS resource indexes as defined/specified herein.
   For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, an overall set/list of RSs or RS resources or RS resource indexes that comprise, contain, include, provide, configure or indicate both one or more current serving beam RSs/RS resources/RS resource indexes and one or more actual candidate/new beam RSs/RS resources/RS resource indexes. For this design example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one or more of the RSs or RS resources or RS resource indexes in the overall set/list could correspond to the current serving beam RS(s) or RS resource(s) or RS resource index(es) and/or which one or more of the RSs or RS resources or RS resource indexes in the overall set/list could correspond to the actual candidate/new beam RS(s) or RS resource(s) or RS resource index(es). For instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS(s)/RS resource(s)/RS resource index(es) in the overall set/list, and/or identify or determine, according to or based on the second list/set, the actual candidate/new beam RS(s)/RS resource(s)/RS resource index(es) in the overall set/list. Additionally, for a current serving beam RS/RS resource/RS resource index in the overall set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between the current serving beam RS/RS resource/RS resource index and one or more indicators; similar to those specified/defined herein in the present disclosure, the one or more indicators could point/correspond to or represent or indicate one or more actual candidate/new beam RSs/RS resources/RS resource indexes (i.e., from/among/out of the actual candidate/new beam RSs/RS resources/RS resource indexes in the overall set/list); in this case, the current serving beam RS/RS resource/RS resource index could be associated/mapped/corresponding to the one or more actual candidate/new beam RSs/RS resources/RS resource indexes—via/by their associations to the one or more indicators as specified/defined herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the candidate/actual candidate/new beam RS(s) or RS resource(s) or RS resource index(es) in the second set/list could be associated/mapped/corresponding to the current serving beam RS/RS resource/RS resource index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more candidate/actual candidate/new beam RSs or RS resources or RS resource indexes each comprising one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists (and therefore, the corresponding candidate/actual candidate/new beam RS(s)/RS resource(s)/RS resource index(es) comprised or provided therein) could be associated/mapped/corresponding to the current serving beam RS/RS resource/RS resource index.
In another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.
   For example, as described/specified herein in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in one or more second candidate TCI states whose ID(s), index(es) or related information—such as the one or more indicators used to determine or identify or indicate the one or more second candidate TCI states from or out of one or more first candidate TCI states—could be provided, indicated, configured, comprised, included or contained in the same higher layer parameter(s) TCI-State or TCI-UL-State that provides or configures the indicated TCI state.
   For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).
   For another example, a/the higher layer RRC signaling(s)/parameter(s) and/or MAC CE command(s) and/or dynamic DCI based L1 signaling(s) that provides or configures or indicates one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure—could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).
   For another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—via/by their associations to the one or more indicators as specified/defined herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more first/second candidate TCI states (e.g., in form of their IDs/indexes/etc.) as specified/defined herein in the present disclosure. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the first/second candidate TCI states in the second set/list—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more first/second candidate TCI states (e.g., in form of their IDs/indexes/etc.) as specified/defined herein in the present disclosure each comprising one or more first/second candidate TCI states (e.g., in form of their IDs/indexes/etc.). For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists of first/second TCI state(s)—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.
In another example, the UE could determine or identify, based on or according to, e.g. fixed rule(s) in system specification(s) and/or per RRC (re)configuration, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.
   For example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the set ID/index of a set/list of one or more candidate/actual candidate/new beam RS(s)/RS resource(s)/RS resource index(es), the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of candidate/actual candidate/new beam RSs/RS resources with the lowest (or highest) set ID/index, the current serving beam RS/RS resource with the second lowest (or second highest) RS index or RS resource index or RS resource configuration index could be associated/mapped/corresponding to the set/list of candidate/actual candidate/new beam RSs/RS resources with the second lowest (or second highest) set ID/index, and so on, and the current serving beam RS/RS resource with the highest (or lowest) RS index or RS resource index or RS resource configuration index could be associated/mapped/corresponding to the set/list of candidate/actual candidate/new beam RSs/RS resources with the highest (or lowest) set ID/index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the set ID/index of a set/list of one or more candidate/actual candidate/new beam RS(s)/RS resource(s)/RS resource index(es) are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of candidate/actual candidate/new beam RS(s)/RS resource(s)/RS resource index(es) among the groups in the set/list, the current serving beam RS/RS resource/RS resource index could be associated/mapped/corresponding to the one or more candidate/actual candidate/new beam RSs/RS resources/RS resource indexes in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of candidate/actual candidate/new beam RSs/RS resources with the lowest (or highest) ordering/position among the groups in the set/list, the current serving beam RS/RS resource with the second lowest (or second highest) RS index or RS resource index or RS resource configuration index could be associated/mapped/corresponding to the group of candidate/actual candidate/new beam RSs/RS resources with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of candidate/actual candidate/new beam RSs/RS resources with the highest (or lowest) ordering/position among the groups in the set/list.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) and the ordering/position (e.g., the first, second, etc.) of a group of candidate/actual candidate/new beam RS(s)/RS resource(s)/RS resource index(es) among the groups in the set/list are correlated or related, the current serving beam RS/RS resource/RS resource index could be associated/mapped/corresponding to the one or more candidate/actual candidate/new beam RSs/RS resources/RS resource indexes in the group. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the RS index(es) or RS resource index(es) or RS resource configuration index(es) of one or more candidate/actual candidate/new beam RSs or RS resources, the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the candidate/actual candidate/new beam RSs/RS resources with the lowest (or highest) RS index(es) or RS resource index(es) or RS resource configuration index(es), the current serving beam RS/RS resource with the second lowest (or second highest) RS index or RS resource index or RS resource configuration index could be associated/mapped/corresponding to the candidate/actual candidate/new beam RSs/RS resources with the second lowest (or second highest) RS index(es) or RS resource index(es) or RS resource configuration index(es), and so on, and the current serving beam RS/RS resource with the highest (or lowest) RS index or RS resource index or RS resource configuration index could be associated/mapped/corresponding to the candidate/actual candidate/new beam RSs/RS resources with the highest (or lowest) RS index(es) or RS resource index(es) or RS resource configuration index(es).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the RS index(es) or RS resource index(es) or RS resource configuration index(es) of one or more candidate/actual candidate/new beam RSs or RS resources are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. The UE could first determine or identify the one or more current serving beam RSs/RS resources/RS resource indexes in the set/list, and/or the one or more candidate/actual candidate/new beam RSs/RS resources/RS resource indexes in the set/list according to or following those specified herein in the present disclosure. The UE could then determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the entry(s)/position(s)/ordering(s)—e.g., the first, second, etc.—in the set/list that could carry, convey, contain, include, provide or indicate the one or more current serving beam RSs/RS resources/RS resource indexes could be fixed; alternatively, the RS index(es)/RS resource index(es)/RS resource configuration index(es) in the set/list that could correspond or refer to the one or more current serving beam RSs/RS resources/RS resource indexes could be fixed. In this case, the P 1 entry(s)/position(s)/ordering(s) in the set/list that follow the entry(s)/position(s)/ordering(s) in the set/list that carries, conveys, contains, includes, provides or indicates the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). Alternatively, the P 1 entry(s)/position(s)/ordering(s) in the set/list that follow the RS index(es) or RS resource index(es) or RS resource configuration index(es) in the set/list that corresponds or refers to the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). The value of P could be determined or identified according to: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the first Q1 entry(s)/position(s)/ordering(s) in the set/list could carry, convey, contain, include, provide or indicate the one or more current serving beam RSs/RS resources/RS resource indexes; alternatively, the Q>1 lowest/highest RS index(es)/RS resource index(es)/RS resource configuration index(es) in the set/list could correspond or refer to the one or more current serving beam RSs/RS resources. In this case, the rest of or remaining entry(s)/position(s)/ordering(s) in the set/list could carry, convey, contain, include, provide or indicate the one or more candidate/actual candidate/new beam RSs/RS resources/RS resource indexes, and/or the rest of or remaining RS index(es)/RS resource index(es)/RS resource configuration index(es) in the set/list could correspond or refer to the one or more candidate/actual candidate/new beam RSs or RS resources. The value of Q could be determined or identified according to: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Furthermore, the UE could determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.
In another example, the UE could determine or identify, based on or according to, e.g. fixed rule(s) in system specification(s) and/or per RRC (re)configuration, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.
   For example, the UE could be configured, indicated or provided by the network, e.g., via/by higher layer RRC signaling(s)/parameter(s) and/or MAC CE command(s) and/or dynamic DCI based LI signaling(s) based on or according to a corresponding UE's capability or capability signaling, one or more sets/lists of first/second candidate TCI state(s)—e.g., in form of TCI state ID(s)/index(es)/etc. —as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index has the same value as the set ID/index of a set/list of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the lowest (or highest) set ID/index, the current serving beam RS/RS resource with the second lowest (or second highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated—with the second lowest (or second highest) set ID/index, and so on, and the current serving beam RS/RS resource with the highest (or lowest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the highest (or lowest) set ID/index.
   For another example, the UE could be configured, indicated or provided by the network (e.g., the network 130), e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index and the set ID/index of a set/list of one or more first/second candidate TCI state(s) are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states—e.g., in form of TCI state ID(s)/index(es)/etc. —as defined/specified herein in the present disclosure. The set/list of first/second candidate TCI state(s) as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of first/second candidate TCI state(s) among the groups in the set/list, the current serving beam RS/RS resource/RS resource index could be associated/mapped/corresponding to the candidate/actual candidate/new beam RS(s)/RS resource(s)/RS resource index(es) provided or indicated in/by the first/second candidate TCI state(s) in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the lowest (or highest) ordering/position among the groups in the set/list, the current serving beam RS/RS resource with the second lowest (or second highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the highest (or lowest) ordering/position among the groups in the set/list.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. The set/list of first/second candidate TCI states as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) and the ordering/position (e.g., the first, second, etc.) of a group of first/second candidate TCI states among the groups in the set/list are correlated or related, the current serving beam RS/RS resource/RS resource index could be associated/mapped/corresponding to the candidate/actual candidate/new beam RS(s)/RS resource(s)/RS resource index(es) provided or indicated in/by the first/second candidate TCI states in the group. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index has the same value as the TCI state ID(s)/index(es) of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the first/second candidate TCI state(s) with the lowest (or highest) TCI state ID(s)/index(es)—and therefore the corresponding candidate/actual candidate/new beam RS(s)/RS resource(s)/RS resource index(es) provided or indicated therein, the current serving beam RS/RS resource with the second lowest (or second highest) RS index or RS resource index or RS resource configuration index could be associated/mapped/corresponding to the first/second candidate TCI state(s) with the second lowest (or second highest) TCI state ID(s)/index(es)—and therefore the corresponding candidate/actual candidate/new beam RS(s)/RS resource(s)/RS resource index(es) provided or indicated therein, and so on, and the current serving beam RS/RS resource with the highest (or lowest) RS index or RS resource index or RS resource configuration index could be associated/mapped/corresponding to the first/second candidate TCI state(s) with the highest (or lowest) TCI state ID(s)/index(es)—and therefore the corresponding candidate/actual candidate/new beam RS(s)/RS resource(s)/RS resource index(es) provided or indicated therein.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index and the TCI state ID(s)/index(es) of one or more first/second candidate TCI states are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the described or specified design examples herein, or for the design examples described or specified herein in the present disclosure, a UE (e.g., the UE 116) could first identify or determine a current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined current serving beam RS or RS resource or RS resource configuration. The UE could then identify or determine one or more actual candidate/new beam RSs/RS resources/RS resource indexes that are associated/mapped/corresponding to the determined or identified current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined actual candidate/new beam RS(s) or RS resource(s) or RS resource configuration(s).

Furthermore, the UE could determine or identify one or more candidate or actual candidate/new beam RSs or RS resources or RS resource indexes according to or following those specified herein in the present disclosure. The UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure:
(Case-I) According to or that have the same value(s) of RS index(es) or RS resource index(es) or RS resource configuration index(es) as that of the RS(s) or RS resource(s) or RS resource index(es) or RS resource configuration index(es) provided in/by the TCI state(s) and/or the joint/DL TCI state(s) activated or provided or indicated or contained or included or comprised by/in a (unified) TCI state(s) activation/deactivation MAC CE command.
(Case-II) According to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of the TCI state(s) and/or the joint/DL TCI state(s) activated or provided or indicated or contained or included or comprised by/in the (unified) TCI state(s) activation/deactivation MAC CE command—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
(Case-III) According to or that have the same value(s) of RS index(es) or RS resource index(es) or RS resource configuration index(es) as that of the RS(s) or RS resource(s) or RS resource index(es) or RS resource configuration index(es) provided in/by the TCI state(s) in a list of TCI state(s) higher layer configured or provided to the UE, e.g., the joint/DL TCI state(s) provided or configured in/by DLorJointTCI-State.
(Case-IV) According to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) the TCI state(s) in a list of TCI state(s) higher layer configured or provided to the UE, e.g., the joint/DL TCI state(s) provided or configured in/by DLorJointTCI-State. The one or more of (or the subset of) the TCI state(s) in the list of TCI state(s), e.g., DLorJointTCI-State, higher layer configured or provided to the UE—e.g., among or out of the TCI state(s) in the list of TCI state(s) higher layer configured or provided to the UE, e.g., the joint/DL TCI state(s) provided or configured in/by DLorJointTCI-State—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

The UE could first assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-II.
Under Case-II, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)
e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-I;
Under Case-I, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-IV;
Under Case-IV, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-III;
Under Case-III, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure.

As specified/defined herein in the present disclosure, a UE could (implicitly) determine one or more candidate/actual new beam RSs or RS resources or RS resource configurations
(Case-V) as the RS(s) or RS resource(s) or RS resource index(es) or RS resource configuration index(es) provided in/by the TCI state(s) and/or the joint/DL TCI state(s) activated or provided or indicated or contained or included or comprised by/in a (unified) TCI state(s) activation/deactivation MAC CE command.
(Case-VI) as the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of the TCI state(s) and/or the joint/DL TCI state(s) activated or provided or indicated or contained or included or comprised by/in the (unified) TCI state(s) activation/deactivation MAC CE command—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
(Case-VII) as the RS(s) or RS resource(s) or RS resource index(es) or RS resource configuration index(es) provided in/by the TCI state(s) in a list of TCI state(s) higher layer configured or provided to the UE, e.g., the joint/DL TCI state(s) provided or configured in/by DLorJointTCI-State.
(Case-VIII) as the RS(s) or RS resource(s) or RS resource index(es) or RS resource configuration index(es) provided in/by one or more of (or a subset of) the TCI state(s) in a list of TCI state(s) higher layer configured or provided to the UE, e.g., the joint/DL TCI state(s) provided or configured in/by DLorJointTCI-State. The one or more of (or the subset of) the TCI state(s) in the list of TCI state(s), e.g., DLorJointTCI-State, higher layer configured or provided to the UE—e.g., among or out of the TCI state(s) in the list of TCI state(s) higher layer configured or provided to the UE, e.g., the joint/DL TCI state(s) provided or configured in/by DLorJointTCI-State—could be determined or identified according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based LI signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the UE could first (implicitly) determine one or more candidate/actual new beam RSs or RS resources or RS resource configurations according to or following those described or specified in Case-VI such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.
If the UE could identify or determine a L_min≥1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VI—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following those described or specified in Case-V such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;
If the UE could identify or determine a L_min≥1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-V—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following those described or specified in Case-VIII such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;
If the UE could identify or determine a L_min≥1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VIII—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following those described or specified in Case-VII such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;
If the UE could identify or determine a L_min≥1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VII—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE may not declare detection of or trigger the corresponding event(s).

Throughout the present disclosure and/or for the described/specified design examples herein in the present disclosure, the current serving beam RS(s)/RS resource(s)/RS resource index(es) and the candidate (or actual) candidate/new beam RS(s)/RS resource(s)/RS resource index(es) as specified/defined herein in the present disclosure could be in a/same set/list of RS(s) or RS resource(s) or RS resource index(es), e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling. Optionally, the current serving beam RS(s)/RS resource(s)/RS resource index(es) and the candidate (or actual) candidate/new beam RS(s)/RS resource(s)/RS resource index(es) as specified/defined herein in the present disclosure could be in separate lists/sets of RSs or RS resources or RS resource indexes, e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling.

The candidate or actual candidate/new beam RS(s) or RS resource(s) or RS resource (configuration) index(es) configured, determined or identified according to or following those specified herein in the present disclosure could comprise one or more CSI-RS resources, CSI-RS resource configurations and/or CSI-RS resource configuration indexes that could be QCL'ed (e.g., with QCL-TypeD) with a same SSB/SSB index or different/separate SSBs with different/separate SSB indexes. When/if the candidate or actual candidate/new beam RSs or RS resources or RS resource (configuration) indexes or RS indexes—comprising one or more CSI-RS resources, CSI-RS resource configurations and/or CSI-RS resource configuration indexes—are QCL'ed (e.g., with QCL-TypeD) with different SSBs having different SSB indexes,
In one example (configuration A), the bitwidth of a CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes; denote by the total number as Ns˜s, the bitwidth could be determined or provided or configured as ┌ log₂ N_{csirs}┐ bit(s). For this design example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to a SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to a SSB could be or could correspond to or comprise the SSB index provided by SSB-Index or index of the SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure. The UE could be additionally indicated or provided or configured by the network, e.g., via/by RRC signaling(s)/parameter(s) and/or MAC CE command(s) and/or dynamic DCI based L1 signaling(s) based on or according to a corresponding UE's capability or capability signaling, a/the total number of candidate/actual candidate/new beam RSs/RS resources/RS resource indexes—and therefore the total number of the corresponding one or more CSI-RS resources/CSI-RS resource configurations/CSI-RS resource configuration indexes—that are QCL'ed (e.g., of QCL-TypeD) with each of the SSBs that could be QCL'ed (e.g., of QCL-TypeD) with the candidate/actual candidate/new beam RSs/RS resources/RS resource indexes as specified/defined herein in the present disclosure; note that the total number here could be identical or common for the SSBs or for each of the SSBs.
In another example (configuration-B), for a CSI-RS resource or CSI-RS resource configuration or CSI-RS QCL'ed (e.g., of QCL-TypeD) with a SSB, the bitwidth of the CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes—that could be QCL'ed (e.g., of QCL-TypeD) with the same SSB; for a SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure, denote by the corresponding total number as N_{csirs,k}, the bitwidth could be determined or provided or configured as ┌ log₂ N_{csirs,k}┐ bit(s). For this design example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to a SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to a SSB could be or could correspond to or comprise the SSB index provided by SSB-Index or index of the SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure.

For configuration-A as described/specified herein in the present disclosure, a/the UEI (beam) report could comprise one or more CRIs each corresponding to a candidate/actual candidate/new beam RS or RS resource or RS resource index—hence the corresponding CSI-RS or CSI-RS resource or CSI-RS resource (configuration) index; in this case, the bitwidth of each of the reported CRIs in the UEI beam report could be ┌ log₂ N_{csirs}┐ bit(s). For configuration-B as described/specified herein in the present disclosure, a/the UEI (beam) report could comprise one or more CRIs each corresponding to a candidate/actual candidate/new beam RS or RS resource or RS resource index—hence the corresponding CSI-RS or CSI-RS resource or CSI-RS resource (configuration) index; in this case, the bitwidth of a reported CRI in the UEI beam report could be ┌ log₂ N_{csirs,k}┐ bit(s) when/if the reported CRI corresponds to a candidate/actual candidate/new beam RS or RS resource or RS resource index—hence the corresponding CSI-RS or CSI-RS resource or CSI-RS resource (configuration) index—that is QCL'ed (e.g., of QCL-TypeD) with the SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure; in this case, the (same) UEI (beam) report could also comprise a SSBRI (e.g., SSBRI k)—associated to the reported CRI—corresponding to the SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure.

Optionally, a/the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, one or more Type-A indicators to indicate whether the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes is QCL'ed (e.g., with QCL-TypeD) with a same SSB/SSB index or different/separate SSBs with different/separate SSB indexes. For example, the higher layer RRC signaling(s)/parameter(s) could be or could correspond to the higher layer RRC parameter(s) that provides or configures the candidate or actual candidate/new beam RS(s) or RS resource(s) or RS resource (configuration) index(es)—i.e., the corresponding CSI-RS, CSI-RS resource, CSI-RS resource configuration or CSI-RS resource (configuration) index in this case—TCI state(s) and/or etc. For another example, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. Furthermore, the one or more Type-A indicators could be or could correspond to a one-bit indicator. In this case, when/if the Type-A indicator(s), e.g., the one-bit indicator, is present/configured/enabled and/or set to ‘1’ (or ‘0’) or ‘enabled’ or ‘on’ or ‘differentSSBs’, the UE could determine or identify that the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes could be QCL'ed (e.g., with QCL-TypeD) with different/separate SSBs with different/separate SSB indexes; otherwise, i.e., when/if the Type-A indicator(s), e.g., the one-bit indicator, is absent/not present or configured or enabled, and/or is present/configured/enabled and set to ‘0’ (or ‘1’) or ‘disabled’ or ‘off’ or ‘sameSSB’, the UE could determine or identify that the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes could be QCL'ed (e.g., with QCL-TypeD) with a same SSB/SSB index.

As specified/discussed herein in the present disclosure, a current serving beam RS/RS index/RS resource/RS resource index could be determined according to or as the RS(s), RS resource(s) or RS resource index(es)—e.g., CSI-RS(s), CSI-RS resource(s) or CSI-RS resource configuration index(es) including TRS(s)—provided in an indicated TCI state (e.g., according to or following those specified in the implicit determination example-1 in the present disclosure), and/or determined according to or as the SSB(s) or SSB index(es) that could be QCL'ed (e.g., of QCL-TypeD) with the RS(s), RS resource(s) or RS resource index(es)—e.g., CSI-RS(s), CSI-RS resource(s) or CSI-RS resource configuration index(es) including TRS(s)—provided in an indicated TCI state (e.g., according to or following those specified in the implicit determination example-2 in the present disclosure), and/or according to or as the CSI-RS(s), CSI-RS resource(s) or CSI-RS resource configuration index(es) including TRS(s) provided/configured in the set s̅₀ (e.g., according to or following those specified in the explicit configuration example-1 in the present disclosure), and/or according to or as the SSB(s) or SSB index(es) provided/configured in the set s̅₀ (e.g., according to or following those specified in the explicit configuration example-2 in the present disclosure). The UE could be configured or indicated or provided by the network, e.g., via higher layer RRC signalling(s)/parameter(s) and/or MAC CE command(s) and/or dynamic DCI based L1 signaling(s) based on or according to a corresponding UE's capability or capability signalling, one or more Type-B indicators to indicate whether a/the UE could determine or identify a current serving beam RS/RS index/RS resource/RS resource index according to or as (1) a CSI-RS, CSI-RS resource or CSI-RS resource configuration index including TRS, e.g., according to or following those specified in the implicit determination example-1 and/or the explicit configuration example-1 as described/specified herein in the present disclosure, and/or (2) a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-B indicators could be or could correspond to a one-bit indicator or a multi-bit (e.g., 2-bit) indicator.

In one example, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, as a/the baseline or default setting. For this design example, the UE could be configured or indicated or provided or instructed or informed by the network (e.g., the network 130), e.g., via higher layer RRC signalling(s)/parameter(s) and/or MAC CE command(s) and/or dynamic DCI based L1 signaling(s) based on or according to a corresponding UE's capability or capability signalling, one or more Type-C indicators to indicate to the UE whether the UE would need to determine or identify an additional current serving beam RS/RS index/RS resource/RS resource index—denoted by a second current serving beam RS/RS index/RS resource/RS resource index—according to or as a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-C indicators could be or could correspond to a one-bit indicator or a multi-bit (e.g., 2-bit) indicator. That is,
Regardless of whether the Type-C indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s), a/the UE could determine or identify a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure (specifically, for the explicit configuration example-B, the set s̅₁ of SSBs/SSB indexes as defined/specified herein in the present disclosure is provide or configured or indicated by the network), the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if a/the second threshold Th_ssb as defined/specified herein in the present disclosure is provide or configured or indicated by the network according to or following those described/specified herein in the present disclosure, the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1—correspond to CSI-RS(s) for tracking or tracking RS(s)—e.g., CSI-RS(s) configured with trs-Info, the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure.

That is, a/the UE (e.g., the UE 116) could determine or identify a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and whether or not a/the UE could determine or identify a/the second current serving beam RS/RS index/RS resource/RS resource index—in addition to the first current serving beam RS/RS index/RS resource/RS resource index as specified/defined herein in the present disclosure—according to or as a SSB or SSB index, e.g., according to or following those specified in the implicit determination example-2 and/or the explicit configuration example-2 as described/specified herein in the present disclosure could be based on network's configuration(s)/indication(s) according to a corresponding UE's capability or capability signaling. In this case,
When/if the Type-C indicator(s) as specified/defined herein in the present disclosure is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only CRI(s) and the associated/corresponding beam metric(s) including L1-RSRP(s)/L-SINR(s).
Otherwise, i.e., when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI(s) and their corresponding beam metric(s) including L1-RSRP(s)/L1-SINR(s)
Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

In another example, a/the UE could determine or identify a first current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, as a/the baseline or default setting. For this design example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-D indicators to indicate to the UE whether the UE would need to determine or identify an additional current serving beam RS/RS index/RS resource/RS resource index—denoted by a second current serving beam RS/RS index/RS resource/RS resource index—according to or as a CSI-RS, CSI-RS resource or CSI-RS resource configuration index including TRS, e.g., according to or following those specified in the implicit determination example-1 and/or the explicit configuration example-1 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-D indicators could be or could correspond to a one-bit indicator or a multi-bit (e.g., 2-bit) indicator. That is,
Regardless of whether the Type-D indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-D indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-D indicator(s), a/the UE could determine or identify a/the first current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure (specifically, for the explicit configuration example-A, the set s̅₁ of (periodic) CSI-RS resource configuration indexes as defined/specified herein in the present disclosure is provide or configured or indicated by the networker), the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if a/the first threshold Th_csirs as defined/specified herein in the present disclosure is provide or configured or indicated by the network according to or following those described/specified herein in the present disclosure, the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1—correspond to CSI-RS(s) for beam management—e.g., CSI-RS(s) configured with repetition or with repetition set to ‘on’, the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure.

That is, a/the UE could determine or identify a/the first current serving beam RS/RS index/RS resource/RS resource index according to or as a SSB or SSB index, e.g., according to or following those specified in the implicit determination example-2 and/or the explicit configuration example-2 as described/specified herein in the present disclosure, and whether or not a/the UE could determine or identify a/the second current serving beam RS/RS index/RS resource/RS resource index—in addition to the first current serving beam RS/RS index/RS resource/RS resource index as specified/defined herein in the present disclosure—according to or as a CSI-RS, CSI-RS resource or CSI-RS resource configuration index including TRS, e.g., according to or following those specified in the implicit determination example-1 and/or the explicit configuration example-1 as described/specified herein in the present disclosure could be based on network's configuration(s)/indication(s) according to a corresponding UE's capability or capability signaling. In this case,
When/if the Type-D indicator(s) as specified/defined herein in the present disclosure is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s).
Otherwise, i.e., when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI(s) and their corresponding beam metric(s) including L1-RSRP(s)/L1-SINR(s)
Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

In another example, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and a second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, as a/the baseline or default setting. For this design example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-E indicators to indicate to the UE whether the UE would only need to determine or identify the current serving beam RS/RS index/RS resource/RS resource index according to or as (i) the first current serving beam RS/RS index/RS resource/RS resource index—according to or as a CSI-RS, CSI-RS resource or CSI-RS resource configuration index including TRS, e.g., according to or following those specified in the implicit determination example-1 and/or the explicit configuration example-1 as described/specified herein in the present disclosure, or (ii) the second current serving beam RS/RS index/RS resource/RS resource index—according to or as according to or as a SSB or SSB index, e.g., according to or following those specified in the implicit determination example-2 and/or the explicit configuration example-2 as described/specified herein in the present disclosure; i.e., the Type-E indicator(s) here could indicate to the UE not to determine or identify one of or to determine or identify the current serving beam RS/RS index/RS resource/RS resource index not according to or as one of (i) the first current serving beam RS/RS index/RS resource/RS resource index—according to or as a CSI-RS, CSI-RS resource or CSI-RS resource configuration index including TRS, e.g., according to or following those specified in the implicit determination example-1 and/or the explicit configuration example-1 as described/specified herein in the present disclosure and (ii) the second current serving beam RS/RS index/RS resource/RS resource index—according to or as according to or as a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-E indicators could be or could correspond to a one-bit indicator or a multi-bit (e.g., 2-bit) indicator. That is,
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE would determine or identify two current serving beam RSs/RS indexes/RS resources/RS resource indexes respectively corresponding to the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and the second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure (specifically, for the explicit configuration example-A, the set s̅₁ of (periodic) CSI-RS resource configuration indexes as defined/specified herein in the present disclosure is provide or configured or indicated by the networker), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘0’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), when/if the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure (specifically, for the explicit configuration example-B, the set s̅₁ of SSBs/SSB indexes as defined/specified herein in the present disclosure is provide or configured or indicated by the network), the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if a/the second threshold Th_ssb as defined/specified herein in the present disclosure is provide or configured or indicated by the network according to or following those described/specified herein in the present disclosure, the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘0’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), when/if the second threshold Th_ssb as defined/specified herein in the present disclosure is provide or configured or indicated by the network according to or following those described/specified herein in the present disclosure, the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1—correspond to CSI-RS(s) for beam management—e.g., CSI-RS(s) configured with repetition or with repetition set to ‘on’, the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘0’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1—correspond to CSI-RS(s) for tracking or tracking RS(s)—e.g., CSI-RS(s) configured with trs-Info, the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index.

That is, by default, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and a second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, and whether or not a/the UE could (only) determine or identify the current serving beam RS/RS index/RS resource/RS resource index as (i) a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, or (ii) a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure could be based on network's configuration(s)/indication(s) according to a corresponding UE's capability or capability signaling. In this case,
When/if the Type-E indicator(s) as specified/defined herein in the present disclosure is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), the UE could send or transmit to the network (e.g., the network 130), in a CSI-Report or reporting instance, a UEI beam report comprising only CRI(s) and the associated/corresponding beam metric(s) including L1-RSRP(s)/L1-SINR(s); and/or
When/if the Type-E indicator(s) as specified/defined herein in the present disclosure is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s);
Otherwise, i.e., when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send ortransmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI(s) and their corresponding beam metric(s) including L1-RSRP(s)/L1-SINR(s)

Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

For the report Format-C as described/specified herein in the present disclosure, the UE could also indicate or transmit or send to the network, e.g., by/in part of the (same) UEI beam report, one or more indicators (e.g., a bitmap, one or more 1-bit (flag) indicators, etc.) to indicate which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s). Optionally, which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s) could be determined according to fixed rule(s)/ordering(s) provided in the system specification(s) or per RRC (re)configuration.

In one example (example-I), a/the UE could determine or identify a current serving beam RS/RS index/RS resource/RS resource index according to or as a (periodic) CSI-RS, CSI-RS resource or CSI-RS resource configuration index including TRS, e.g., according to or following those specified in the implicit determination example-1 and/or the explicit configuration example-1 as described/specified herein in the present disclosure, and/or the UE could determine or identify that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure, when/if one or more of the following conditions are achieved or satisfied.
Condition-A: the Type-A indicator(s), e.g., the one-bit indicator, as specified/defined herein in the present disclosure is present/configured/enabled and/or set to ‘1’ (or ‘0’) or ‘enabled’ or ‘on’ or ‘differentSSBs’;
Condition-B: the Type-B indicator(s), e.g., a one-bit, two-bit or multi-bit indicator, as specified/defined herein in the present disclosure is present/configured/enabled and/or set to ‘1’ (or ‘0’) or ‘00’ (or ‘01’, ‘10’ or ‘11’) or ‘enabled’ (or ‘disabled’) or ‘on’ (or ‘off’) or ‘csirsAsCurrentBeam’
Condition-C: the UE (e.g., the UE 116) determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure; specifically, for the explicit configuration example-A, the set s̅₁ of (periodic) CSI-RS resource configuration indexes as defined/specified herein in the present disclosure is provide or configured or indicated by the network
Condition-D0: the set s̅₀ of (periodic) CSI-RS resource configuration indexes as defined/specified herein in the present disclosure (explicit configuration example-1) is provide or configured or indicated by the network
Condition-D1: regardless of whether the Type-C indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s)
Condition-D2: when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network
Condition-D3: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-D4: when/if the Type-E indicator(s) is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s)
Condition-D5: when/if the one or more RSs/RS resources/RS resource indexes provided in/by the indicated TCI state (e.g., of QCL-TypeD)—e.g., as specified in the implicit determination example-1—correspond to CSI-RS(s) for beam management—e.g., CSI-RS(s) configured with repetition or with repetition set to ‘on’

For this design example (i.e., the example-I), the UE could send or transmit to the network a/the UEI beam report, in a reporting instance, comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a current serving beam RS/RS resource/RS resource index or a candidate/actual new beam RS/RS resource/RS resource index in this design example that satisfies the event(s) condition(s) as defined/specified herein in the present disclosure).

In one example (example-II), a/the UE could determine or identify a current serving beam RS/RS index/RS resource/RS resource index according to or as a SSB or SSB index, e.g., according to or following those specified in the implicit determination example-2 and/or the explicit configuration example-2 as described/specified herein in the present disclosure, and/or the UE could determine or identify that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure, when/if one or more of the following conditions are achieved or satisfied.
Condition-E: the Type-A indicator(s), e.g., the one-bit indicator, as specified/defined herein in the present disclosure is absent/not present or configured or enabled, and/or is present/configured/enabled and set to ‘0’ (or ‘1’) or ‘disabled’ or ‘off’ or ‘sameSSB’;
Condition-F: the Type-B indicator(s), e.g., a one-bit, two-bit or multi-bit indicator, as specified/defined herein in the present disclosure is present/configured/enabled and/or set to ‘0’ (or ‘1’) or ‘01’ (or ‘00’, ‘10’ or ‘11’) or ‘disabled’ (or ‘enabled’) or ‘off’ (or ‘on’) or ‘ssbAsCurrentBeam’
Condition-G: the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure; specifically, for the explicit configuration example-B, the set s̅₁ of SSBs/SSB indexes as defined/specified herein in the present disclosure is provide or configured or indicated by the network
Condition-H0: the set s̅₀ of SSBs/SSB indexes as defined/specified herein in the present disclosure (explicit configuration example-2) is provide or configured or indicated by the network
Condition-H1: when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s)
Condition-H2: regardless of whether the Type-D indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s)
Condition-H3: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-H4: when/if the Type-E indicator(s) is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s)
Condition-H5: when/if the one or more RSs/RS resources/RS resource indexes provided in/by the indicated TCI state (e.g., of QCL-TypeD)—e.g., as specified in the implicit determination example-1—correspond to CSI-RS(s) for tracking or tracking RS(s)—e.g., CSI-RS(s) configured with trs-Info

For this design example (i.e., the example-II), the UE could send or transmit to the network a/the UEI beam report, in a reporting instance, comprising one or more SSBRIs—and therefore, the corresponding beam metric(s) including L1-RSRP(s)/L1-SINR(s)—each corresponding to a SSB/SSB index (as a current serving beam RS/RS resource/RS resource index or a candidate/actual new beam RS/RS resource/RS resource index in this design example that satisfies the event(s) condition(s) as defined/specified herein in the present disclosure).

In one example (example-III), a/the UE could determine or identify a first current serving beam RS/RS index/RS resource/RS resource index according to or as a SSB or SSB index, e.g., according to or following those specified in the implicit determination example-2 and/or the explicit configuration example-2 as described/specified herein in the present disclosure, and/or a second current serving beam RS/RS index/RS resource/RS resource index according to or as a (periodic) CSI-RS, CSI-RS resource or CSI-RS resource configuration index including TRS, e.g., according to or following those specified in the implicit determination example-1 and/or the explicit configuration example-1 as described/specified herein in the present disclosure, and/or the UE could determine or identify that one or more of the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure, and/or the UE could determine or identify that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure, when/if one or more of the following conditions are achieved or satisfied.
Condition-Ia: the Type-A indicator(s), e.g., the one-bit indicator, as specified/defined herein in the present disclosure is absent/not present or configured or enabled, and/or is present/configured/enabled and set to ‘0’ (or ‘1’) or ‘disabled’ or ‘off’ or ‘sameSSB’;
Condition-Ib: the Type-A indicator(s), e.g., the one-bit indicator, as specified/defined herein in the present disclosure is present/configured/enabled and/or set to ‘1’ (or ‘0’) or ‘enabled’ or ‘on’ or ‘differentSSBs’;
Condition-Ja: the Type-B indicator(s), e.g., a one-bit, two-bit or multi-bit indicator, as specified/defined herein in the present disclosure is present/configured/enabled and/or set to ‘0’ (or ‘1’) or ‘01’ (or ‘00’, ‘10’ or ‘11’) or ‘disabled’ (or ‘enabled’) or ‘off’ (or ‘on’) or ‘ssbAsCurrentBeam’
Condition-Jb: the Type-B indicator(s), e.g., a one-bit, two-bit or multi-bit indicator, as specified/defined herein in the present disclosure is present/configured/enabled and/or set to ‘1’ (or ‘0’) or ‘00’ (or ‘01’, ‘10’ or ‘11’) or ‘enabled’ (or ‘disabled’) or ‘on’ (or ‘off’) or ‘csirsAsCurrentBeam’
Condition-Jc: the Type-B indicator(s), e.g., a one-bit, two-bit or multi-bit indicator, as specified/defined herein in the present disclosure is absent/not present or configured or enabled, and/or is present/configured/enabled and/or set to ‘10’ or ‘11’ (or ‘00’ or ‘01’) or ‘bothSSBAndCsirsAsCurrentBeam’
Condition-Ka: the UE determines or identifies that one or more of the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure; specifically, for the explicit configuration example-B, the set s̅₁ of SSBs/SSB indexes as defined/specified herein in the present disclosure is provide or configured or indicated by the network
Condition-Kb: the UE determines or identifies that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure; specifically, for the explicit configuration example-A, the set s̅₁ of (periodic) CSI-RS resource configuration indexes as defined/specified herein in the present disclosure is provide or configured or indicated by the network
Condition-La: a set s̅₀ of SSBs/SSB indexes as defined/specified herein in the present disclosure (explicit configuration example-2) is provide or configured or indicated by the network
Condition-Lb: a set s̅₀ of (periodic) CSI-RS resource configuration indexes as defined/specified herein in the present disclosure (explicit configuration example-1) is provide or configured or indicated by the network
Condition-L0: when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s)
Condition-L1: when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network
Condition-L2: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-L3: when/if the one or more RSs/RS resources/RS resource indexes provided in/by the indicated TCI state (e.g., of QCL-TypeD)—e.g., as specified in the implicit determination example-1—correspond to CSI-RS(s) for beam management—e.g., CSI-RS(s) configured with repetition or with repetition set to ‘on’
Condition-L4: when/if the one or more RSs/RS resources/RS resource indexes provided in/by the indicated TCI state (e.g., of QCL-TypeD)—e.g., as specified in the implicit determination example-1—correspond to CSI-RS(s) for tracking or tracking RS(s)—e.g., CSI-RS(s) configured with trs-Info

For this design example, the UE could send or transmit to the network, in a reporting instance, a/the UEI beam report that could comprise
one or more SSBRIs—and therefore, the corresponding beam metric(s) including L1-RSRP(s)/L1-SINR(s)
each corresponding to a SSB/SSB index (as a first current serving beam RS/RS resource/RS resource index or a candidate/actual new beam RS/RS resource/RS resource index in this design example that satisfies the event(s) condition(s) as defined/specified herein in the present disclosure), and/or
one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this design example that satisfies the event(s) condition(s) as defined/specified herein in the present disclosure),
   according to or based on (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Optionally, for this design example, the UE could send or transmit to the network, in a first reporting instance, a/the first UEI beam report comprising one or more SSBRIs—and therefore, the corresponding beam metric(s) including L1-RSRP(s)/L1-SINR(s)—each corresponding to a SSB/SSB index (as a first current serving beam RS/RS resource/RS resource index or a candidate/actual new beam RS/RS resource/RS resource index in this design example that satisfies the event(s) condition(s) as defined/specified herein in the present disclosure). Furthermore, the UE could send or transmit to the network, in a second reporting instance, a/the second UEI beam report comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this design example that satisfies the event(s) condition(s) as defined/specified herein in the present disclosure). In this design example, whether the UE could transmit or send to the network a single UEI beam report (in a single reporting instance) that could comprise resource indicator(s) corresponding to CRI(s) and/or SSBRI(s) or separate UEI beam reports (in separate reporting instances) that could separately comprise resource indicators corresponding to CRI(s) and SSBRI(s) could be based on or according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking RS (TRS)—e.g., a CSI-RS configured with trs-Info, a CSI-RS configured without repetition or with repetition set to ‘off’, and etc.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure; furthermore, the UE could determine or identify the one or more activated beams/TCI states as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network (e.g., the network 130), e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

For an activated TCI state—e.g., a joint/DL TCI state, a UE (e.g., the UE 116) could determine or identify RS(s) or RS resource(s) or RS resource index(es) of/for the activated TCI state—denoted by activation beam RS(s) or RS resource(s) or RS resource index(es)—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set ofNZP CSI-RS resources provided by NZP-CSI-RS-Resource Set (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network such that the higher layer parameter e.g. currentBeamRStype is set to ‘CSI-RS’.

For a given event as specified/defined herein in the present disclosure (e.g., the fourth event), a/the UE could be respectively configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, different (or separate) thresholds or different (or separate) values of a threshold (e.g., threshold-C as defined/specified in the fourth event) for different (or separate) cases of (1) when a current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to or following those specified herein in the present disclosure, and (2) when a current serving beam RS/RS resource/RS resource index is (determined, identified or configured as) a SSB or SSB index and/or the candidate/actual candidate/new beam RS(s)/RS resource(s)/RS resource index(es) is (determined, identified or configured as) SSB(s) or SSB index(es) according to or following those specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. For the fourth event as specified/defined herein in the present disclosure,
In one example, and/or when/if a (second) current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to or following those specified herein in the present disclosure, the UE could be configured by the network a first threshold provided by Th_csirs; in this case, the UE could use or apply Th_csirs as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when/if they both correspond to CSI-RSs/CSI-RS resources/CSI-RS resource configuration indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) CSI-RSs/CSI-RS resources/CSI-RS resource configurations (as the candidate/actual candidate/new beam RS(s)/RS resource(s) in this design example) is beyond or greater than the radio link or beam quality(s)—e.g., by measuring the L1-RSRP(s)/L1-SINR(s)—of one or more CSI-RSs/CSI-RS resources/CSI-RS resource configurations (as the current serving beam RS(s)/RS resource(s) in this design example) by Th_csirs.
In another example, and/or when/if a (first) current serving beam RS/RS resource/RS resource index is (determined, identified or configured as) a SSB/SSB index and/or the candidate/actual candidate/new beam RS(s)/RS resource(s)/RS resource index(es) is (determined, identified or configured as) SSB(s)/SSB index(es) according to or following those specified herein in the present disclosure, the UE could be configured by the network a second threshold provided by Th_ssb; in this case, the UE could use or apply Th_ssb as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when/if they both correspond to SSBs/SSB indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) SSBs (as the candidate/actual candidate/new beam RS(s)/RS resource(s) in this design example) is beyond or greater than the radio link or beam quality(s)—e.g., by measuring the L1-RSRP(s)/L1-SINR(s)—of one or more SSBs (as the current serving beam RS(s)/RS resource(s) in this design example) by Th_ssb.

Here, the values of Th_csirs and Th_ssb could be (or could be configured to be) the same. Alternatively, or optionally, the values of Th_csirs and Th_ssb could be (or could be configured to be) different. In addition, the Th_csirs and Th_ssb could be configured or provided to the UE at the same time or simultaneously (e.g., in a/the same higher layer RRC signaling/parameter), or separately (e.g., in separate higher layer RRC signalings/parameters).
In one example, the threshold Th_csirs could be present and the threshold Th_ssb could be absent; for this case, the UE could assume or expect that Th_ssb=Th_csirs.
In another example, the threshold Th_csirs could be present and the threshold Th_ssb could be absent; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could assume or expect that Th_ssb=Th_csirs+Th_offset.
In another example, the threshold Th_csirs could be absent and the threshold Th_ssb could be present; for this case, the UE could assume or expect that Th_csirs=Th_ssb.
In another example, the threshold Th_csirs could be absent and the threshold Th_ssb could be present; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could assume or expect that Th_csirs=Th_ssb+Th_offset.
In another example, both the thresholds Th_csirs and Th_ssb are present.
In another example, both the thresholds Th_csirs and Th_ssb are present. For this case, the UE could still be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could assume or expect that Th_csirs=Th_ssb±Th_offset and/or Th_ssb=Th_csirs±Th_offset.
In another example, neither of the thresholds Th_csirs and Th_ssb is present.

Throughout the present disclosure, a parameter being present is equivalent to being configured, provided or enabled in the corresponding higher layer RRC signaling(s)/parameter(s) and/or MAC CE command(s) and/or dynamic DCI based L1 signaling(s), and/or a parameter being absent (or not present) is equivalent to not being configured, provided or enabled or being disabled in the corresponding higher layer RRC signaling(s)/parameter(s) and/or MAC CE command(s) and/or dynamic DCI based L1 signaling(s).

A UE could indicate or send or transmit to the network, e.g., as/by/in part of their capability signaling, whether or not they can support (1) a CSI-RS, CSI-RS resource or CSI-RS resource configuration index including TRS as a current serving beam RS/RS resource/RS resource index, e.g., according to or following those specified in the implicit determination example-1 and/or the explicit configuration example-1 as described/specified herein in the present disclosure, and/or (2) a SSB or a SSB index as a current serving beam RS/RS resource/RS resource index, e.g., according to or following those specified in the implicit determination example-2 and/or the explicit configuration example-2 as described/specified herein in the present disclosure. For instance, a/the UE could indicate or send or transmit to the network a capability or capability signaling indicating the type of the RS that they can support as a current serving beam RS/RS resource, wherein the capability or capability signaling could comprise one or more of the following components:
{CSI-RS}
{SSB}
{Both CSI-RS and SSB}
{CSI-RS, SSB}

A UE could indicate or send or transmit to the network, e.g., as/by/in part of their capability signaling, whether or not they can support (1) a CSI-RS, CSI-RS resource or CSI-RS resource configuration index including TRS as a candidate/new beam RS/RS resource/RS resource index, e.g., according to or following those specified in the implicit determination example-A and/or the implicit determination example-C and/or the explicit configuration example-A as described/specified herein in the present disclosure, and/or (2) a SSB or a SSB index as a candidate/new beam RS/RS resource/RS resource index, e.g., according to or following those specified in the implicit determination example-B and/or the implicit determination example-D and/or the explicit configuration example-B as described/specified herein in the present disclosure. For instance, a/the UE could indicate or send or transmit to the network a capability or capability signaling indicating the type of the RS that they can support as a candidate/new beam RS/RS resource, wherein the capability or capability signaling could comprise one or more of the following components:
{CSI-RS}
{SSB}
{Both CSI-RS and SSB}
{CSI-RS, SSB}

The described or specified design examples, options, procedures, signaling alternatives and etc. throughout the present disclosure for the current serving beam RS(s)/RS resource(s)/RS resource index(es) can be extended or equally applied to the candidate/actual candidate/new beam RS(s)/RS resource(s)/RS resource index(es) according to or following those specified herein in the present disclosure.

According to those specified/described herein in the present disclosure, detection or declaration of an event or detection or declaration of an instance of the event—and therefore triggering of a UEI beam report based on or according to detection or declaration of the event and/or transmission of the UEI beam report—could be associated/linked/mapped/corresponding to a TCI state. For instance, as specified/described herein in the present disclosure, detection or declaration of an event could at least involve determining/identifying and/or accessing/measuring (radio/beam quality(s) of) the current serving beam(s) or current serving beam RS(s) and/or candidate beam(s) or candidate beam RS(s), which could be further associated/linked/mapped/corresponding to an indicated TCI state—e.g., the current serving beam RS(s) could have the same value(s) as or could correspond to the RS(s), e.g., a CSI-RS, provided in the indicated TCI state, and/or the current serving beam RS(s) could have the same value(s) as or could correspond to the RS(s), e.g., a SSB, associated to the indicated TCI state (e.g., the SSB could be QCL'ed with the RS(s), e.g., a CSI-RS, provided in the indicated TCI state).

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationld: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used.
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value msl corresponds to 1 ms, value ms2 corresponds to 2 ms, and so on. Ifpn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceld: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfg. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a physical resource block (PRB), a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, ki, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateL1st or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel.
      Component-5i: an ending symbol/slot/etc. for the second UL channel.
      Component-5j: a time duration/length (e.g., in form/terms/number of symbols/slot/etc.), within which the resources could be allocated/indicated for the second UL channel.
      Component-5k: a number of resources allocated/indicated for the second UL channel.
      Component-5l: an uplink (scheduling) grant, e.g., for PUSCH(s).

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network (e.g., the network 130) for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel ki slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateL1st or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel.
   Component-6i: an ending symbol/slot/etc. for resource(s) not used/applicable/available for the second UL channel.
   Component-6j: a time duration/length (e.g., in form/terms/number of symbols/slot/etc.), within which the resources may not be used/applicable/available for the second UL channel.
   Component-6k: a number of resources not used/available/applicable for the second UL channel.
   Component-6l: an uplink (scheduling) grant, e.g., for PUSCH(s), such that the scheduled/granted resource(s) may not be used/available/applicable for the second UL channel.

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1—Component-7 as defined/specified herein in the present disclosure could correspond to or could be realized, specified or implemented as/by one or more new DCI fields in the corresponding (downlink/uplink) DCI format; optionally, one or more of the components including Component-1—Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1—Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1—Component-7 as defined/specified herein in the present disclosure according to network's configuration(s) and/or indication(s) based on the corresponding UE's capability or capability signaling following those specified/described herein in the present disclosure. For example, the UE (e.g., the UE 116) could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-51, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1—Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a cell-radio network temporary identifier (C-RNTI), a UE ID/index, and/or etc.
A UE could transmit or send a PN message/trigger in Step-1; upon detection or reception of the group common DCI in Step-2, the UE could identify or determine the set of components (e.g., one or more of Component-1—Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationld: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used.
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value msl corresponds to 1 ms, value ms2 corresponds to 2 ms, and so on. Ifpn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceld: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfg. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

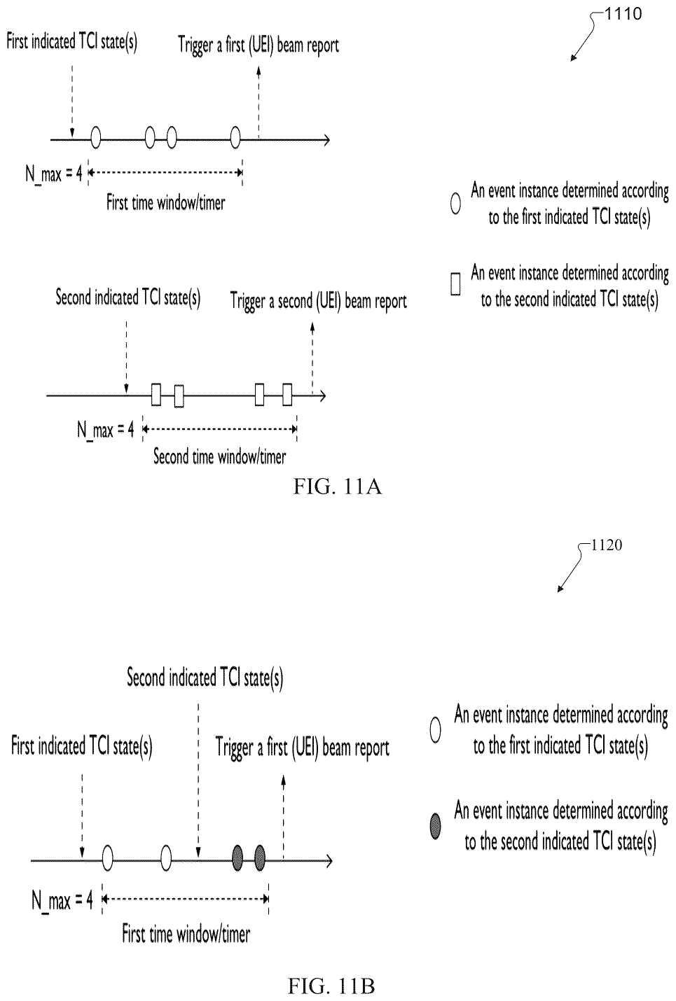

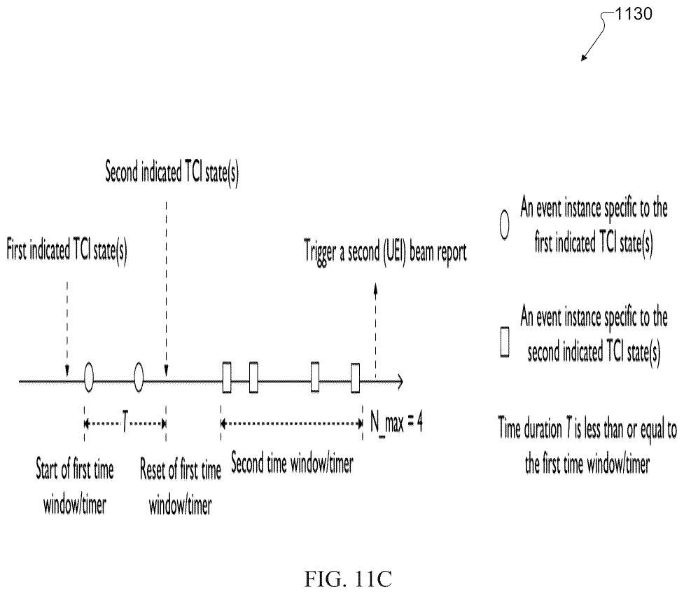

FIGS. 11A, 11B, and 11C illustrate examples of time window(s) 1110, 1120, and 1130, respectively, according to embodiments of the present disclosure. For example, time window(s) 1110, 1120, and 1130, respectively, can be monitored by the UE 116 of FIG. 3. This example is for illustration only and other embodiments can be used without departing from the scope of the present disclosure.

In one embodiment, when/if (i) a UE is determining/identifying and/or assessing/measuring and/or comparing (radio/beam link quality(s) of) at least first current serving beam RS(s) and/or first candidate beam RS(s) associated to one or more first TCI states according to or following those specified herein in the present disclosure, and/or (ii) (higher layer(s) of) the UE has determined or identified or detected or declared a first number of one or more first instances of an event associated/linked/corresponding to the one or more first TCI states according to or following those specified herein in the present disclosure, and/or (iii) the UE has not declared the event according to or based on the first number of the first instance(s) of the event and/or a corresponding timer/time window (e.g., the corresponding timer has not expired yet and/or counting process of event instance(s) is still within the time window) according to or following those specified herein in the present disclosure, and/or (iv) the UE has received from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, and/or the one or more second TCI states, and therefore RS(s) associated to or provided in the one or more second TCI states, have become applicable,
In one example, the UE could keep assessing/measuring and/or comparing (radio/beam link quality(s) of) at least first current serving beam RS(s) and/or first candidate beam RS(s) associated to the one or more first TCI states according to or following those specified herein in the present disclosure, and/or (higher layer(s) of) the UE could keep determining or identifying or detecting or declaring first instance(s) of the event—associated/linked/mapped/corresponding to the first TCI state(s)—in order to declare the event according to or based on (the number/counting of) the first instance(s) of the event and/or a corresponding first timer/time window according to or following those specified herein in the present disclosure. Meanwhile or at the same time, the UE could start determining/identifying and/or assessing/measuring and/or comparing (radio/beam link quality(s) of) at least current serving beam RS(s) and/or candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure in order to declare the event according to or based on (the number/counting of) the second instance(s) of the event and/or a corresponding second timer/time window according to or following those specified herein in the present disclosure. A conceptual example characterizing the aforementioned operation(s) is presented in FIG. 11A. In this case,
   For example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure first in time, the UE could send or transmit to the network the first (UEI) beam report along with necessary indication/request/notification signaling(s); meanwhile, the UE could cancel, terminate, abort or abandon any ongoing process/procedure(s) of detection/declaration/counting of second instance(s) of the event, declaration or detection of the event associated/mapped/linked/corresponding to the second TCI state(s) wherein the declaration or detection of the event here could be based on or according to (the number/counting of) the second instance(s) of the event and/or the corresponding second timer/time window according to or following those specified herein in the present disclosure, triggering of a second (UEI) beam report based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure, and/or transmission of a second (UEI) beam report along with necessary indication/request/notification signaling(s) triggered or initiated based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure.
   For another example, when/if the UE triggers or initiates a second (UEI) beam report according to or based on declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure first in time, the UE could send or transmit to the network the second (UEI) beam report along with necessary indication/request/notification signaling(s); meanwhile, the UE could cancel, terminate, abort or abandon any ongoing process/procedure(s) of detection/declaration/counting of first instance(s) of the event, declaration or detection of the event associated/mapped/linked/corresponding to the first TCI state(s) wherein the declaration or detection of the event here could be based on or according to according to or based on (the number/counting of) the first instance(s) of the event and/or the corresponding first timer/time window according to or following those specified herein in the present disclosure, triggering of a first (UEI) beam report based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure, and/or transmission of a first (UEI) beam report along with necessary indication/request/notification signaling(s) triggered or initiated based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE could send or transmit to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report first in time, the UE could send or transmit to the network the one or more indicators and/or requests and/or notifications, and/or the first (UEI) beam report; meanwhile, the UE could cancel, terminate, abort or abandon any ongoing process/procedure(s) of detection/declaration/counting of second instance(s) of the event, declaration or detection of the event associated/mapped/linked/corresponding to the second TCI state(s) wherein the declaration or detection of the event here could be based on or according to (the number/counting of) the second instance(s) of the event and/or the corresponding second timer/time window according to or following those specified herein in the present disclosure, triggering of a second (UEI) beam report based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure, and/or transmission of a second (UEI) beam report along with necessary indication/request/notification signaling(s) triggered or initiated based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure.
   For another example, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE could send or transmit to the network, e.g., via/in/by most recent (or latest/earlies in time) PUCCH and/or PUSCH resource(s) e.g. periodically configured/provided by the network (e.g., the network 130) via dedicated RRC signaling(s) available for carrying or conveying at least the PN message(s) as specified/defined herein in the present disclosure, one or more indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report first in time, the UE could send or transmit to the network the one or more indicators and/or requests and/or notifications, and/or the second (UEI) beam report; meanwhile, the UE could cancel, terminate, abort or abandon any ongoing process/procedure(s) of detection/declaration/counting of first instance(s) of the event, declaration or detection of the event associated/mapped/linked/corresponding to the first TCI state(s) wherein the declaration or detection of the event here could be based on or according to according to or based on (the number/counting of) the first instance(s) of the event and/or the corresponding first timer/time window according to or following those specified herein in the present disclosure, triggering of a first (UEI) beam report based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure, and/or transmission of a first (UEI) beam report along with necessary indication/request/notification signaling(s) triggered or initiated based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by PUCCH and/or PUSCH resource(s) e.g. periodically configured/provided by the network via dedicated RRC signaling(s) for carrying or conveying at least the PN message(s) as specified/defined herein in the present disclosure, one or more indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, and the UE could receive from the network, e.g., via a DL DCI format (e.g., DCI format(s) 1_0/1_1/1_2) or a UL DCI format (e.g., DCI format(s) 0_0/0_1/0_2), a one-bit indicator (e.g., set to ‘1’ or ‘0’) or an ACK (or NACK) in response to the one or more indicators/requests/notifications and/or UL resource(s) grant, allocation, assignment or scheduling indicator(s) to allocate, assign, schedule or grant UL resource(s) for transmitting the first (UEI) beam report first in time, the UE could send or transmit to the network the first (UEI) beam report; meanwhile, the UE could cancel, terminate, abort or abandon any ongoing process/procedure(s) of detection/declaration/counting of second instance(s) of the event, declaration or detection of the event associated/mapped/linked/corresponding to the second TCI state(s) wherein the declaration or detection of the event here could be based on or according to (the number/counting of) the second instance(s) of the event and/or the corresponding second timer/time window according to or following those specified herein in the present disclosure, triggering of a second (UEI) beam report based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure, and/or transmission of a second (UEI) beam report along with necessary indication/request/notification signaling(s) triggered or initiated based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure.
   For another example, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by PUCCH and/or PUSCH resource(s) e.g. periodically configured/provided by the network via dedicated RRC signaling(s) for carrying or conveying at least the PN message(s) as specified/defined herein in the present disclosure, one or more indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, and the UE could receive from the network, e.g., via a DL DCI format (e.g., DCI format(s) 1_0/1_1/1_2) or a UL DCI format (e.g., DCI format(s) 0_0/0_1/0_2), a one-bit indicator (e.g., set to ‘1’ or ‘0’) or an ACK (or NACK) in response to the one or more indicators/requests/notifications and/or UL resource(s) grant, allocation, assignment or scheduling indicator(s) to allocate, assign, schedule or grant UL resource(s) for transmitting the second (UEI) beam report first in time, the UE could send or transmit to the network the second (UEI) beam report; meanwhile, the UE could cancel, terminate, abort or abandon any ongoing process/procedure(s) of detection/declaration/counting of first instance(s) of the event, declaration or detection of the event associated/mapped/linked/corresponding to the first TCI state(s) wherein the declaration or detection of the event here could be based on or according to according to or based on (the number/counting of) the first instance(s) of the event and/or the corresponding first timer/time window according to or following those specified herein in the present disclosure, triggering of a first (UEI) beam report based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure, and/or transmission of a first (UEI) beam report along with necessary indication/request/notification signaling(s) triggered or initiated based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by PUCCH and/or PUSCH resource(s) e.g. periodically configured/provided by the network via dedicated RRC signaling(s) for carrying or conveying at least the PN message(s) as specified/defined herein in the present disclosure, one or more indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, and/or the UE has received from the network, e.g., via a DL DCI format (e.g., DCI format(s) 1_0/1_1/1_2) or a UL DCI format (e.g., DCI format(s) 0_0/0_1/0_2), a one-bit indicator (e.g., set to ‘1’ or ‘0’) or an ACK (or NACK) in response to the one or more indicators/requests/notifications and/or UL resource(s) grant, allocation, assignment or scheduling indicator(s) to allocate, assign, schedule or grant UL resource(s) for transmitting the first (UEI) beam report, and the UE could send or transmit to the network, e.g., via/in/by most recent (or latest/earlies in time) PUCCH and/or PUSCH resource(s) e.g. periodically configured/provided by the network via dedicated RRC signaling(s) and/or dynamically scheduled/granted/assigned/allocated by the network via DCI(s) available for carrying or conveying at least (UEI) beam report as specified/defined herein in the present disclosure, the first (UEI) beam report first in time, the UE could send or transmit to the network the first (UEI) beam report; meanwhile, the UE could cancel, terminate, abort or abandon any ongoing process/procedure(s) of detection/declaration/counting of second instance(s) of the event, declaration or detection of the event associated/mapped/linked/corresponding to the second TCI state(s) wherein the declaration or detection of the event here could be based on or according to (the number/counting of) the second instance(s) of the event and/or the corresponding second timer/time window according to or following those specified herein in the present disclosure, triggering of a second (UEI) beam report based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure, and/or transmission of a second (UEI) beam report along with necessary indication/request/notification signaling(s) triggered or initiated based on or according to declaration or detection of the event associated/linked/mapped/corresponding to the second TCI state(s) wherein the declaration or detection of the event here could be based on or according to (the number/counting of) the second instance(s) of the event and/or the corresponding second timer/time window according to or following those specified herein in the present disclosure.
   For another example, when/if the UE (e.g., the UE 116) triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by PUCCH and/or PUSCH resource(s) e.g. periodically configured/provided by the network via dedicated RRC signaling(s) for carrying or conveying at least the PN message(s) as specified/defined herein in the present disclosure, one or more indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, and/or the UE has received from the network, e.g., via a DL DCI format (e.g., DCI format(s) 1_0/1_1/1_2) or a UL DCI format (e.g., DCI format(s) 0_0/0_1/0_2), a one-bit indicator (e.g., set to ‘1’ or ‘0’) or an ACK (or NACK) in response to the one or more indicators/requests/notifications and/or UL resource(s) grant, allocation, assignment or scheduling indicator(s) to allocate, assign, schedule or grant UL resource(s) for transmitting the second (UEI) beam report, and the UE could send or transmit to the network, e.g., via/in/by most recent (or latest/earlies in time) PUCCH and/or PUSCH resource(s) e.g. periodically configured/provided by the network via dedicated RRC signaling(s) and/or dynamically scheduled/granted/assigned/allocated by the network via DCI(s) available for carrying or conveying at least (UEI) beam report as specified/defined herein in the present disclosure, the second (UEI) beam report first in time, the UE could send or transmit to the network the second (UEI) beam report; meanwhile, the UE could cancel, terminate, abort or abandon any ongoing process/procedure(s) of detection/declaration/counting of first instance(s) of the event, declaration or detection of the event associated/mapped/linked/corresponding to the first TCI state(s) wherein the declaration or detection of the event here could be based on or according to according to or based on (the number/counting of) the first instance(s) of the event and/or the corresponding first timer/time window according to or following those specified herein in the present disclosure, triggering of a first (UEI) beam report based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure, and/or transmission of a first (UEI) beam report along with necessary indication/request/notification signaling(s) triggered or initiated based on or according to declaration or detection of the event associated/linked/mapped/corresponding to the first TCI state(s) wherein the declaration or detection of the event here could be based on or according to (the number/counting of) the first instance(s) of the event and/or the corresponding first timer/time window according to or following those specified herein in the present disclosure.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, the UE could send or transmit to the network the first (UEI) beam report along with necessary indication/request/notification signaling(s) corresponding to the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, the UE could send or transmit to the network the second (UEI) beam report along with necessary indication/request/notification signaling(s) corresponding to the second (UEI) beam report. The first and second (UEI) beam reports could be separate beam reports, e.g., sent or transmitted in separate (CSI/beam) reporting instances.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, the UE could send or transmit to the network the first (UEI) beam report along with necessary indication/request/notification signaling(s) corresponding to the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, the UE could send or transmit to the network the second (UEI) beam report along with necessary indication/request/notification signaling(s) corresponding to the second (UEI) beam report. The first and second (UEI) beam reports could be in a joint (UEI) beam report, e.g., sent or transmitted in a same (beam/CSI) reporting instance. Furthermore, the joint (UEI) beam report could comprise two parts with (i) the first part or part 1 of the two-part joint (UEI) beam report comprising the first (UEI) beam report, payload size of the second part or part 2 of the two-part joint (UEI) beam report, the number of beams and/or the number of beam metrics corresponding to the beams comprised in the second (UEI) beam report in the second part or part 2 of the two-part joint (UEI) beam report, and/or indicator(s) to indicate presence or absence of the second part or part 2 of the two-part joint (UEI) beam report, and the second part or part 2 of the two-part joint (UEI) beam report comprising the second (UEI) beam report, or (ii) the first part or part 1 of the two-part joint (UEI) beam report comprising the second (UEI) beam report, payload size of the second part or part 2 of the two-part joint (UEI) beam report, the number of beams and/or the number of beam metrics corresponding to the beams comprised in the first (UEI) beam report in the second part or part 2 of the two-part joint (UEI) beam report, and/or indicator(s) to indicate presence or absence of the second part or part 2 of the two-part joint (UEI) beam report, and the second part or part 2 of the two-part joint (UEI) beam report comprising the first (UEI) beam report.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, the UE could send or transmit to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, the UE could send or transmit to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report. For this design example, the first indicator(s)/request(s)/notification(s) as specified/defined herein in the present disclosure could be different or separate (or separately transmitted or sent by the UE) from the second indicator(s)/request(s)/notification(s) as specified/defined herein in the present disclosure. For instance, the UE could transmit or send the first indicator(s)/request(s)/notification(s) in/via/by most recent (or latest/earlies in time) first PUCCH and/or PUSCH resource(s) e.g. periodically configured/provided by the network via first dedicated RRC signaling(s) available for carrying or conveying at least the PN message(s) as specified/defined herein in the present disclosure, and transmit or send the second indicator(s)/request(s)/notification(s) in/via/by most recent (or latest/earlies in time) second PUCCH and/or PUSCH resource(s) e.g. periodically configured/provided by the network via second dedicated RRC signaling(s) available for carrying or conveying at least the PN message(s) as specified/defined herein in the present disclosure, wherein the first PUCCH/PUSCH resource(s) could be different or separate from the second PUCCH/PUSCH resource(s), and/or the first dedicated RRC signaling(s) could be different or separate from the second dedicated RRC signaling(s).
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, the UE could send or transmit to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, the UE could send or transmit to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report. For this design example, in case-1, the first indicator(s)/request(s)/notification(s) as specified/defined herein in the present disclosure and the second indicator(s)/request(s)/notification(s) as specified/defined herein in the present disclosure could correspond to a same or identical indicator(s)/request(s)/notification(s) denoted by global indicator(s)/request(s)/notification(s). For instance, for case-1, the UE could transmit or send the global indicator(s)/request(s)/notification(s) in/via/by most recent (or latest/earlies in time) first PUCCH and/or PUSCH resource(s) e.g. periodically configured/provided by the network via first dedicated RRC signaling(s) available for carrying or conveying at least the PN message(s) as specified/defined herein in the present disclosure, and transmit or send the global indicator(s)/request(s)/notification(s) in/via/by most recent (or latest/earlies in time) second PUCCH and/or PUSCH resource(s) e.g. periodically configured/provided by the network via second dedicated RRC signaling(s) available for carrying or conveying at least the PN message(s) as specified/defined herein in the present disclosure, wherein the first PUCCH/PUSCH resource(s) could be the same as or identical to the second PUCCH/PUSCH resource(s), and/or the first dedicated RRC signaling(s) could be the same as or identical to the second dedicated RRC signaling(s). Alternatively, in case-2, the first indicator(s)/request(s)/notification(s) as specified/defined herein in the present disclosure could be different or separate from the second indicator(s)/request(s)/notification(s) as specified/defined herein in the present disclosure; in this case (i.e., case-2), the UE could transmit or send the first indicator(s)/request(s)/notification(s) in/via/by most recent (or latest/earlies in time) first PUCCH and/or PUSCH resource(s) e.g. periodically configured/provided by the network via first dedicated RRC signaling(s) available for carrying or conveying at least the PN message(s) as specified/defined herein in the present disclosure, and transmit or send the second indicator(s)/request(s)/notification(s) in/via/by most recent (or latest/earlies in time) second PUCCH and/or PUSCH resource(s) e.g. periodically configured/provided by the network via second dedicated RRC signaling(s) available for carrying or conveying at least the PN message(s) as specified/defined herein in the present disclosure, wherein the first PUCCH/PUSCH resource(s) could be the same as or identical to the second PUCCH/PUSCH resource(s), and/or the first dedicated RRC signaling(s) could be the same as or identical to the second dedicated RRC signaling(s). The UE could determine or identify case-1 and/or case-2 as specified/defined herein in the present disclosure to use/apply/follow based on or according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, UE could receive from the network, in/via/by a first response channel, e.g., via a first DCI format including a DL DCI format (e.g., DCI format(s) 1_0/1_1/1_2) or a UL DCI format (e.g., DCI format(s) 0_0/0_1/0_2), one or more first response indicators including a one-bit indicator (e.g., set to ‘1’ or ‘0’) or an ACK (or NACK) in response to the one or more first indicators/requests/notifications and/or UL resource(s) grant, allocation, assignment or scheduling indicator(s) to allocate, assign, schedule or grant UL resource(s) for transmitting the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, UE could receive from the network, via/in/by a second response channel, e.g., via a second DCI format including a DL DCI format (e.g., DCI format(s) 1_0/1_1/1_2) or a UL DCI format (e.g., DCI format(s) 0_0/0_1/0_2), one or more second response indicators including a one-bit indicator (e.g., set to ‘1’ or ‘0’) or an ACK (or NACK) in response to the one or more second indicators/requests/notifications and/or UL resource(s) grant, allocation, assignment or scheduling indicator(s) to allocate, assign, schedule or grant UL resource(s) for transmitting the second (UEI) beam report. For this design example, the first response channel including the first DCI format could be different or separate from the second response channel including the second DCI format—i.e., the UE could receive the first and second response channels/DCI formats separately in time and/or frequency (e.g., via/in/on different or separate PDCCH candidates, CORESETs and/or search space sets), and/or the first response indicator(s) could be different or separate from the second response indicator(s).
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, UE could receive from the network, in/via/by a first response channel, e.g., via a first DCI format including a DL DCI format (e.g., DCI format(s) 1_0/1_1/1_2) or a UL DCI format (e.g., DCI format(s) 0_0/0_1/0_2), one or more first response indicators including a one-bit indicator (e.g., set to ‘1’ or ‘0’) or an ACK (or NACK) in response to the one or more first indicators/requests/notifications and/or UL resource(s) grant, allocation, assignment or scheduling indicator(s) to allocate, assign, schedule or grant UL resource(s) for transmitting the first (UEI) beam report; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, UE could receive from the network, via/in/by a second response channel, e.g., via a second DCI format including a DL DCI format (e.g., DCI format(s) 1_0/1_1/1_2) or a UL DCI format (e.g., DCI format(s) 0_0/0_1/0_2), one or more second response indicators including a one-bit indicator (e.g., set to ‘1’ or ‘0’) or an ACK (or NACK) in response to the one or more second indicators/requests/notifications and/or UL resource(s) grant, allocation, assignment or scheduling indicator(s) to allocate, assign, schedule or grant UL resource(s) for transmitting the second (UEI) beam report. For this design example, in case-i, the first response channel including the first DCI format could be the same as or identical to the second response channel including the second DCI format (denoted by a global response channel/DCI format)—i.e., the UE could receive the first and second response channels/DCI formats in the same/identical time and/or frequency resource(s) (e.g., via/in/on the same or identical PDCCH candidate(s), CORESET(s) and/or search space set(s)), and/or the first response indicator(s) could be the same or identical the second response indicator(s)—denoted by global response indicator(s). For instance, for case-i, the UE could receive from the network, in the global response channel, e.g., via the global DCI format, one or more global response indicators including a one-bit indicator (e.g., set to ‘1’ or ‘0’) or an ACK (or NACK) in response to the one or more first and/or second indicators/requests/notifications and/or UL resource(s) grant, allocation, assignment or scheduling indicator(s) to allocate, assign, schedule or grant UL resource(s) for transmitting the first and/or second (UEI) beam report(s). Alternatively, in case-ii, the first response indicator(s) could be different or separate from the second response indicator(s); in this case (i.e., case-ii), UE could receive from the network, in the global response channel, e.g., via the global DCI format, the one or more first response indicators including a one-bit indicator (e.g., set to ‘1’ or ‘0’) or an ACK (or NACK) in response to the one or more first indicators/requests/notifications and/or UL resource(s) grant, allocation, assignment or scheduling indicator(s) to allocate, assign, schedule or grant UL resource(s) for transmitting the first (UEI) beam report, and the one or more second response indicators including a one-bit indicator (e.g., set to ‘1’ or ‘0’) or an ACK (or NACK) in response to the one or more second indicators/requests/notifications and/or UL resource(s) grant, allocation, assignment or scheduling indicator(s) to allocate, assign, schedule or grant UL resource(s) for transmitting the second (UEI) beam report. The UE could determine or identify case-i and/or case-ii as specified/defined herein in the present disclosure to use/apply/follow based on or according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, and/or the UE has received from the network, in/via/by a first response channel, e.g., via a first DCI format including a DL DCI format (e.g., DCI format(s) 1_0/1_1/1_2) or a UL DCI format (e.g., DCI format(s) 0_0/0_1/0_2), one or more first response indicators including a one-bit indicator (e.g., set to ‘1’ or ‘0’) or an ACK (or NACK) in response to the one or more first indicators/requests/notifications and/or UL resource(s) grant, allocation, assignment or scheduling indicator(s) to allocate, assign, schedule or grant UL resource(s) for transmitting the first (UEI) beam report, the UE could send or transmit to the network, in/via/by one or more first beam report UL resources in one or more first beam report channels, the first (UEI) beam report, wherein the first beam report UL channel(s) could correspond to PUCCH(s) and/or PUSCH(s) and the first beam report UL resource(s) could correspond to the most recent (or latest/earlies in time) PUCCH and/or PUSCH resource(s) e.g. periodically configured/provided by the network via dedicated RRC signaling(s) and/or dynamically scheduled/granted/assigned/allocated by the network via DCI(s) available for carrying or conveying at least the first (UEI) beam report as specified/defined herein in the present disclosure; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, and/or the UE has receive from the network, via/in/by a second response channel, e.g., via a second DCI format including a DL DCI format (e.g., DCI format(s) 1_0/1_1/1_2) or a UL DCI format (e.g., DCI format(s) 0_0/0_1/0_2), one or more second response indicators including a one-bit indicator (e.g., set to ‘1’ or ‘0’) or an ACK (or NACK) in response to the one or more second indicators/requests/notifications and/or UL resource(s) grant, allocation, assignment or scheduling indicator(s) to allocate, assign, schedule or grant UL resource(s) for transmitting the second (UEI) beam report, the UE could send or transmit to the network, in/via/by one or more second beam report UL resources in one or more second beam report channels, the second (UEI) beam report, wherein the second beam report UL channel(s) could correspond to PUCCH(s) and/or PUSCH(s) and the second beam report UL resource(s) could correspond to the most recent (or latest/earlies in time) PUCCH and/or PUSCH resource(s) e.g. periodically configured/provided by the network (e.g., the network 130) via dedicated RRC signaling(s) and/or dynamically scheduled/granted/assigned/allocated by the network via DCI(s) available for carrying or conveying at least the second (UEI) beam report as specified/defined herein in the present disclosure. For this design example, the first and second (UEI) beam reports could be separate beam reports, e.g., sent or transmitted in separate (CSI/beam) reporting instances. Furthermore, the first beam report UL channel(s) could be different or separate from the second beam report UL channel(s), and/or the first beam report UL resource(s) could be different or separate from the second beam report UL resource(s)—e.g., the first and second beam report UL channels could be of different channel types (a channel type could be a PUCCH or a PUSCH), and the first and second beam report UL resources could be different PUCCH and/or PUSCH resources according to or following those specified herein in the present disclosure.
   For another example, when/if the UE triggers or initiates a first (UEI) beam report according to or based on declaration or detection of the event associated/linked/mapped/corresponding to the first TCI state(s), wherein the declaration or detection of the event here could be based on or according to (the number/counting of) the first instance(s) of the event and/or the corresponding first timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more first indicators and/or requests and/or notifications to indicate to or notify the network transmission of the first (UEI) beam report and/or request the network to allocate, assign, schedule or grant UL resource(s) including PUCCH and/or PUSCH resource(s) for transmitting the first (UEI) beam report, and/or the UE has received from the network, in/via/by a first response channel, e.g., via a first DCI format including a DL DCI format (e.g., DCI format(s) 1_0/1_1/1_2) or a UL DCI format (e.g., DCI format(s) 0_0/0_1/0_2), one or more first response indicators including a one-bit indicator (e.g., set to ‘1’ or ‘0’) or an ACK (or NACK) in response to the one or more first indicators/requests/notifications and/or UL resource(s) grant, allocation, assignment or scheduling indicator(s) to allocate, assign, schedule or grant UL resource(s) for transmitting the first (UEI) beam report, the UE could send or transmit to the network, in/via/by one or more first beam report UL resources in one or more first beam report UL channels, the first (UEI) beam report, wherein the first beam report UL channel(s) could correspond to PUCCH(s) and/or PUSCH(s) and the first beam report UL resource(s) could correspond to the most recent (or latest/earlies in time) PUCCH and/or PUSCH resource(s) e.g. periodically configured/provided by the network via dedicated RRC signaling(s) and/or dynamically scheduled/granted/assigned/allocated by the network via DCI(s) available for carrying or conveying at least the first (UEI) beam report as specified/defined herein in the present disclosure; meanwhile, when/if the UE triggers or initiates a second (UEI) beam report according to or based on declaration or detection of the event associated/linked/mapped/corresponding to the second TCI state(s), wherein the declaration or detection of the event here could be based on or according to (the number/counting of) the second instance(s) of the event and/or the corresponding second timer/time window according to or following those specified herein in the present disclosure, and the UE has sent or transmitted to the network, e.g., via/in/by most recent (or latest/earlies in time) PUCCH and/or PUSCH resource(s) e.g. periodically configured/provided by the network via dedicated RRC signaling(s) available for carrying or conveying at least the PN message(s) as specified/defined herein in the present disclosure, one or more second indicators and/or requests and/or notifications to indicate to or notify the network transmission of the second (UEI) beam report and/or request the network to allocate, assign, schedule or grant UL resource(s) including PUCCH and/or PUSCH resource(s) for transmitting the second (UEI) beam report, and/or the UE has receive from the network, via/in/by a second response channel, e.g., via a second DCI format including a DL DCI format (e.g., DCI format(s) 1_0/1_1/1_2) or a UL DCI format (e.g., DCI format(s) 0_0/0_1/0_2), one or more second response indicators including a one-bit indicator (e.g., set to ‘1’ or ‘0’) or an ACK (or NACK) in response to the one or more second indicators/requests/notifications and/or UL resource(s) grant, allocation, assignment or scheduling indicator(s) to allocate, assign, schedule or grant UL resource(s) for transmitting the second (UEI) beam report, the UE could send or transmit to the network, in/via/by one or more second beam report UL resources in one or more second beam report UL channels, the second (UEI) beam report, wherein the second beam report UL channel(s) could correspond to PUCCH(s) and/or PUSCH(s) and the second beam report UL resource(s) could correspond to the most recent (or latest/earlies in time) PUCCH and/or PUSCH resource(s) e.g. periodically configured/provided by the network via dedicated RRC signaling(s) and/or dynamically scheduled/granted/assigned/allocated by the network via DCI(s) available for carrying or conveying at least the second (UEI) beam report as specified/defined herein in the present disclosure. For this design example, in case-A, the first and second (UEI) beam reports could be in a joint (UEI) beam report, e.g., sent or transmitted in a same (beam/CSI) reporting instance. Furthermore, the joint (UEI) beam report could comprise two parts with (i) the first part or part 1 of the two-part joint (UEI) beam report comprising the first (UEI) beam report, payload size of the second part or part 2 of the two-part joint (UEI) beam report, the number of beams and/or the number of beam metrics corresponding to the beams comprised in the second (UEI) beam report in the second part or part 2 of the two-part joint (UEI) beam report, and/or indicator(s) to indicate presence or absence of the second part or part 2 of the two-part joint (UEI) beam report, and the second part or part 2 of the two-part joint (UEI) beam report comprising the second (UEI) beam report, or (ii) the first part or part 1 of the two-part joint (UEI) beam report comprising the second (UEI) beam report, payload size of the second part or part 2 of the two-part joint (UEI) beam report, the number of beams and/or the number of beam metrics corresponding to the beams comprised in the first (UEI) beam report in the second part or part 2 of the two-part joint (UEI) beam report, and/or indicator(s) to indicate presence or absence of the second part or part 2 of the two-part joint (UEI) beam report, and the second part or part 2 of the two-part joint (UEI) beam report comprising the first (UEI) beam report. Alternatively, in case-B, the first and second (UEI) beam reports could be separate beam reports, e.g., sent or transmitted in separate (CSI/beam) reporting instances. Furthermore, the first beam report UL channel(s) could be the same as or identical to the second beam report UL channel(s)—e.g., the first and second beam report UL channels could correspond to same global beam report UL channel(s) of PUCCH(s) and/or PUSCH(s), and/or the first beam report UL resource(s) could be the same as or identical to the second beam report UL resource(s)—e.g., the first and second beam report UL resources could be the same/identical PUCCH and/or PUSCH resources denoted by global beam report UL resource(s) according to or following those specified herein in the present disclosure. For instance, for case-a, the UE could send or transmit to the network, in/via/by one or more global beam report UL resources in one or more global beam report UL channels, the joint (UEI) beam report. Optionally, for case-b, the UE could send or transmit to the network, in/via/by one or more global beam report UL resources in one or more global beam report UL channels, the separate first and second (UEI) beam reports. The UE could determine or identify case-a and/or case-b as specified/defined herein in the present disclosure to use/apply/follow based on or according to: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

According to those specified herein in the present disclosure, for this design example, (higher layer(s) of) the UE could separately maintain or track two separate counters—denoted by a first counter and a second counter—respectively associated, specific, linked, mapped or corresponding to the first TCI state(s) and the second TCI state(s) to count the number of the first instance(s) of the event and the number of the second instance(s) of the event. In addition, (higher layer(s) of) the UE could also separately maintain or track two separate timers/time windows—denoted by a first timer/time window and a second timer/time window—respectively associated, specific, linked, mapped or corresponding to the first TCI state(s) and the second TCI state(s). As specified/defined herein in the present disclosure, declaration or detection of an event specific/associated/corresponding to the first (or second) TCI state(s) according to or based on (the number/counting of) the first (or second) instance(s) of the event and/or a corresponding first (or second) timer/time window could be based on that the maximum number/counting of the first (or second) instance(s) of the event could be achieved before the first (or second) timer expires and/or within the first (or second) time window.
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. For this design example, when/if the first number of the first instance(s) of the event—associated or specific or corresponding to the first TCI state(s)—is N_1 (i.e., the number/count of the event instance(s), e.g., in a counter, is N_1) which is still less or smaller than (or equal to) the maximum number of event instance(s) N_max, and the first timer is still running (i.e., the first timer is not expired) or the event instance(s) counting process herein is still within the first time window, the UE could stop determining/identifying and/or assessing/measuring and/or comparing (radio/beam link quality(s) of) at least first current serving beam RS(s) and/or first candidate beam RS(s) associated to the one or more first TCI states according to or following those specified herein in the present disclosure, and/or (higher layer(s) of) the UE could stop determining or identifying or detecting or declaring first instance(s) of the event associated/linked/corresponding to the one or more first TCI states according to or following those specified herein in the present disclosure; in this case, when/if the UE has detected or declared a second instance of the event—associated or specific or corresponding to the second TCI state(s), (higher layer(s) of) the UE could increment the number/count of the event instance(s), e.g., in a/the counter, by one—e.g., when/if the UE has detected or declared a second instance of the event for the first time, wherein the second instance of the event could be determined/identified in association/specific to the second TCI state(s) according to or following those specified herein in the present disclosure, (higher layer(s) of) the UE (e.g., the UE 116) could increment the current number/count of the event instance(s) which is N_1, e.g., in a/the counter, by one to N_1+1; and, when/if the number/count of the event instance(s), e.g., in a/the counter, (at least) reaches to the maximum number of N_max (or greater than or equal to N_max) before the first timer expires (or the event instance(s) counting process is still within the first time window), the UE could trigger or initiate a first (UEI) beam report according to or based on declaration or detection of the event. A conceptual example characterizing the aforementioned operation(s) is presented in FIG. 111B.
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. For this design example, when/if the first number of the first instance(s) of the event—associated or specific or corresponding to the first TCI state(s)—is N_1 (i.e., the number/count of the event instance(s), e.g., in a counter, is N_1) which is still less or smaller than (or equal to) the maximum number of event instance(s) N_max, and the first timer is still running (i.e., the first timer is not expired) or the event instance(s) counting process herein is still within the first time window, the UE could stop determining/identifying and/or assessing/measuring and/or comparing (radio/beam link quality(s) of) at least first current serving beam RS(s) and/or first candidate beam RS(s) associated to the one or more first TCI states according to or following those specified herein in the present disclosure, and/or (higher layer(s) of) the UE could stop determining or identifying or detecting or declaring first instance(s) of the event associated/linked/corresponding to the one or more first TCI states according to or following those specified herein in the present disclosure, and/or (higher layer(s) of) the UE could reset the (current) number/count of the event instance(s), e.g., in a/the counter, to zero, and/or (higher layer(s) of) the UE could reset the first timer (e.g., to zero) and/or stop the first time window. In this case, when/if the UE has detected or declared a second instance of the event—associated or specific or corresponding to the second TCI state(s), (higher layer(s) of) the UE could increment the number/count of the event instance(s), e.g., in a/the counter, by one—e.g., when/if the UE has detected or declared a second instance of the event for the first time, wherein the second instance of the event could be determined/identified in association/specific to the second TCI state(s) according to or following those specified herein in the present disclosure, (higher layer(s) of) the UE could increment the current number/count of the event instance(s) which is 0, e.g., in a/the counter, by one to 1, and start the second timer/time window; and, when/if the number/count of the event instance(s), e.g., in a/the counter, (at least) reaches to the maximum number of N_max (or becomes greater than or equal to N_max) before the second timer expires (or the event instance(s) counting process is still within the second time window), the UE could trigger or initiate a second (UEI) beam report according to or based on declaration or detection of the event. A conceptual example characterizing the aforementioned operation(s) is provided in FIG. 11C.

According to or following those specified herein in present disclosure, (higher layer(s) of) a UE could detect or determine or declare an event (or one or more events) and trigger a transmission of a UEI beam report (UEI-BR)—e.g., at least a transmission of a PN message/trigger via/in/on one or more PUCCH resources of the first UL channel as in Step-1 for both operation Mode A and Mode B as specified/defined herein in the present disclosure—when/if (higher layer(s) of) the UE has determined or identified that the conditions of the event(s) have been satisfied or achieved, and/or detected or declared necessary (or enough) instance(s) of/for the event(s) based on or according to the evaluation(s)/assessment(s) or evaluation/assessment results of the event(s) according to or following those specified herein in the present disclosure.

The design examples/procedures and the corresponding UE's behaviors/assumptions and/or network's signaling(s)—e.g., higher layer RRC signaling(s)/parameter(s) and/or MAC CE command(s) and/or dynamic DCI based L1 signaling(s) based on or according to a corresponding UE's capability or capability signaling—described/specified throughout the present disclosure could be for or based on a single configuration, wherein the configuration could be a CSI reporting setting provided by CSI-ReportConfig/UEI-ReportConfig providing or configuring necessary information and/or setting(s)—e.g., enabling/configuring/providing the triggering event(s) and/or type(s) of the triggering event(s)—for the UEI beam reporting. Alternatively, the design examples/procedures and the corresponding UE's behaviors/assumptions and/or network's signaling(s)—e.g., higher layer RRC signaling(s)/parameter(s) and/or MAC CE command(s) and/or dynamic DCI based L1 signaling(s) based on or according to a corresponding UE's capability or capability signaling—described/specified throughout the present disclosure could be for or based on multiple (i.e., more than 1) configurations, wherein each of the configuration could be a CSI reporting setting provided by CSI-ReportConfig/UEI-ReportConfig providing or configuring necessary information and/or setting(s)—e.g., enabling/configuring/providing the triggering event(s) and/or type(s) of the triggering event(s)—for the UEI beam reporting.

According to those specified/defined herein in the present disclosure, (higher layer(s) of) a UE could detect, declare or determine an event (or one or more events if configured/provided/enabled simultaneously or at the same time) based on or according to first evaluation or assessment result(s) of the event (or the one or more events)—denoted by first condition(s) of detecting, declaring or determining the event. In addition, (higher layer(s) of) the UE could detect, declare or determine the (same) event (or the (same) one or more events if configured/provided/enabled simultaneously or at the same time) based on or according to second evaluation or assessment result(s) of the (same) event (or the (same) one or more events)—denoted by second condition(s) of detecting or declaring or determining the event. In this case, when/if the first evaluation or assessment result(s) and the second evaluation or assessment result(s) are different according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one different candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could all be different or could be all different;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate (sets of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate current serving beam RSs/RS resources (e.g., determined or identified according to or based on different indicated TCI states) according to or following those specified herein in the present disclosure;
at least one of the condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
All of the condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with different thresholds according to or following those specified herein in the present disclosure, the first condition(s) of detecting, declaring or determining the event could be considered as different or separate from the second condition(s) of detecting, declaring or determining the event. Otherwise, i.e., when/if the first evaluation or assessment result(s) and the second evaluation or assessment result(s) are according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one same or identical candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could all be the same or identical or could be all the same or identical;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing the same/identical (set of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing a same/identical current serving beam RS/RS resource (e.g., determined or identified according to or based on a same/identical indicated TCI state) according to or following those specified herein in the present disclosure;
at least one of the condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
All of the condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with a same/identical threshold according to or following those specified herein in the present disclosure, the first condition(s) of detecting, declaring or determining the event could be considered as same as or identical to the second condition(s) of detecting, declaring or determining the event.

For the operation Mode A, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). In this case, after (higher layer(s) of) the UE has detected and/or declared the event (e.g., the fourth event or Event-4) for triggering and/or requesting UL resource(s) for a transmission of a first (UEI) beam report, and before the UE could send a PN message/trigger via first UL channel(s) in Step-1 according to or following those specified herein in the present disclosure to trigger and/or request UL resource(s) for the transmission of the first (UEI) beam report, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable before the UE could send a PN message/trigger via the first UL channel(s) in Step-1 to trigger and/or request UL resource(s) for the transmission of the first (UEI) beam report.
In one example, (higher layer(s) of) the UE could start a prohibit timer after the UE has detected and/or declared the event according to the indicated first TCI state(s) following or according to those specified or defined herein in the present disclosure. Before the prohibit timer expires, and/or before (e.g., the first or last symbol/slot/etc.) the UE could send a PN message/trigger via the first UL channel(s) in Step-1 according to or following those specified herein in the present disclosure to trigger and/or request UL resource(s) for the transmission of the first (UEI) beam report,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or request UL resource(s) for transmitting a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, but the UE would not (or is not expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, and the UE could (or is expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report, but the UE would not (or is not expected to) transmit or send, in/over/on/using the allocated, scheduled, granted, assigned or indicated UL resource(s) for the second UL channel(s), a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure.
   For example, (higher layer(s) of) the UE could cancel transmission of the PN message/trigger via first UL channel(s) in Step-1 for triggering and/or requesting UL resource(s) for the transmission of the first (UEI) beam report.
   For another example, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report X symbol(s)/slot(s)/etc. earlier in time than or prior to or before (the first symbol/slot/etc. of) transmission of the PN message/trigger via first UL channel(s) in Step-I for triggering and/or requesting UL resource(s) for the transmission of the first (UEI) beam report, and/or when/if the UE could transmit a PN message/trigger via first UL channel(s) in Step-I for triggering and/or requesting UL resource(s) for the transmission of the second (UEI) beam report X symbol(s)/slot(s)/etc. earlier in time or prior to or before (the first symbol/slot/etc. of) transmission of the PN message/trigger via first UL channel(s) in Step-1 for triggering and/or requesting UL resource(s) for the transmission of the first (UEI) beam report, (higher layer(s) of) the UE could cancel transmission of the PN message/trigger via first UL channel(s) in Step-1 for triggering and/or requesting UL resource(s) for the transmission of the first (UEI) beam report. For this design example, the UE could determine or identify the X value(s) according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based LI signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could still transmit the PN message/trigger via first UL channel(s) in Step-1 for triggering and/or requesting UL resource(s) for the transmission of the first (UEI) beam report. In this case, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report X symbol(s)/slot(s)/etc. earlier in time than or prior to or before (the first symbol/slot/etc. of) transmission of the PN message/trigger via first UL channel(s) in Step-1 for triggering and/or requesting UL resource(s) for the transmission of the first (UEI) beam report, wherein the UE could determine or identify the X value(s) according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based LI signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), the UE could transmit a/the (same) PN message/trigger via first UL channel(s) in Step-1 for triggering and/or requesting UL resource(s) for the transmission of both the first and second (UEI) beam reports. For instance, the PN message/trigger could be a one-bit indicator with ‘1’ (or positive) indicating that the PN message/trigger via first UL channel(s) in Step-1 is to trigger and/or request UL resource(s) for the transmission of both of the first and second (UEI) beam reports, and ‘0’ (or negative) indicating that the PN message/trigger via first UL channel(s) in Step-1 could be to trigger and/or request UL resource(s) for the transmission of the first (or second) UEI beam report. Optionally, the PN message/trigger could be a two-bit indicator with ‘00’ (or ‘01’ or ‘10’ or ‘11’) indicating that the PN message/trigger via first UL channel(s) in Step-1 is to trigger and/or request UL resource(s) for the transmission of both of the first and second (UEI) beam reports, ‘01’ (or ‘00’ or ‘10’ or ‘11’) indicating thatthe PN message/trigger via first UL channel(s) in Step-1 could be to trigger and/or request UL resource(s) for the transmission of the first UEI beam report, and ‘10’ (or ‘00’ or ‘01’ or ‘11’) indicating that the PN message/trigger via first UL channel(s) in Step-1 could be to trigger and/or request UL resource(s) for the transmission of the second UEI beam report. For this design example, a/the (same) PN message/trigger—e.g., to trigger and/or request UL resource(s) for the transmission of both of the first and second UEI beam reports—could be sent or transmitted on/over/in the most recent/available UL resource(s) provided or configured for the first UL channel(s) in Step-1 according to or following those specified herein in the present disclosure.
   For another example, the UE could still transmit a first PN message/trigger via first UL channel(s) in Step-1 for triggering and/or requesting UL resource(s) for the transmission of the first (UEI) beam report. In this case, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report, the UE could transmit a second PN message/trigger via first UL channel(s) in Step-1 for triggering and/or requesting UL resource(s) for the transmission of the second (UEI) beam report. For this design example, the first PN message/trigger and the second PN message/trigger could be respectively or separately sent or transmitted on/over/in first UL resource(s) and second UL resource(s) provided or configured for the first UL channel(s) in Step-1 according to or following those specified herein in the present disclosure. For this design example, the first UL resource(s) could correspond to the most recent/available UL resource(s) in time
provided or configured for the first UL channel(s) in Step-1—associated/specific to the first PN message/trigger, and the second UL resource(s) could correspond to the most recent/available UL resource(s) in time—provided or configured for the first UL channel(s) in Step-1—associated/specific to the second PN message/trigger. Optionally, the first UL resource(s) could correspond to the most recent/available UL resource(s) in time—among the UL resource(s) provided or configured for the first UL channel(s) in Step-1 according to or following those specified herein in the present disclosure, or the second UL resource(s) could correspond to the most recent/available UL resource(s) in time—among the UL resource(s) provided or configured for the first UL channel(s) in Step-1 according to or following those specified herein in the present disclosure. Alternatively, the PN message/trigger could be a one-bit indicator with ‘1’ (or positive) indicating that the PN message/trigger via first UL channel(s) in Step-1 is to trigger and/or request UL resource(s) for the transmission of the first (UEI) beam report—i.e., it corresponds to the first PN message/trigger, and ‘0’ (or negative) indicating that the PN message/trigger via first UL channel(s) in Step-1 could be to trigger and/or request UL resource(s) for the transmission of the second UEI beam report—i.e., it corresponds to the second PN message/trigger.

For the operation Mode A, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). Furthermore, after (higher layer(s) of) the UE has detected and/or declared the event (e.g., the fourth event or Event-4) for triggering and/or requesting UL resource(s) for a transmission of a first (UEI) beam report, the UE could send a PN message/trigger via first UL channel(s) in Step-1 according to or following those specified herein in the present disclosure to trigger and/or request UL resource(s) for the transmission of the first (UEI) beam report. In this case, after the UE has sent the PN message/trigger via first UL channel(s) in Step-1 according to or following those specified herein in the present disclosure to trigger and/or request UL resource(s) for the transmission of the first (UEI) beam report, and before the UE could receive from the network (e.g., the network 130) a (downlink/uplink) DCI in response to the PN message/trigger in Step-2 as specified/defined herein in the present disclosure, e.g., within a time window starting from the first or last symbol/slot/etc. of the transmission of the PN message/trigger, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable before the UE could receive from the network the (downlink/uplink) DCI as in Step-2 in response to the PN message/trigger according to or following those specified herein in the present disclosure.
In one example, (higher layer(s) of) the UE could start a prohibit timer after (e.g., the first or last symbol/slot/etc.) the UE has sent the PN message/trigger via first UL channel(s) in Step-1 according to or following those specified herein in the present disclosure to trigger and/or request UL resource(s) for the transmission of the first (UEI) beam report. Before the prohibit timer expires, and/or before (e.g., the first or last symbol/slot/etc.) the UE could receive, monitor and/or detect the (downlink/uplink) DCI as in Step-2 in response to the PN message/trigger in the corresponding CORESET(s) according to or following those specified/defined herein in the present disclosure (e.g., within the aforementioned time window starting from the first or last symbol/slot/etc. of the transmission of the PN message/trigger),
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or request UL resource(s) for transmitting a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, but the UE would not (or is not expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, and the UE could (or is expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report, but the UE would not (or is not expected to) transmit or send, in/over/on/using the allocated, scheduled, granted, assigned or indicated UL resource(s) for the second UL channel(s), a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure.
   For example, (higher layer(s) of) the UE could cancel transmission of the first (UEI) beam report. Optionally, the UE could send or transmit to the network, e.g., via one or more UL resources provided or configured for the first UL channel(s) in Step-1 as specified/defined herein in the present disclosure, one or more indicators to indicate the cancellation of transmission of the first (UEI) beam report. In this case, the UE may not expect to receive from the network a (downlink/uplink) DCI in response to the PN message/trigger in Step-2 as specified/defined herein in the present disclosure, e.g., within a time window starting from the first or last symbol/slot/etc. of the transmission of the PN message/trigger, and/or the UE may not expect to receive from the network a (downlink/uplink) DCI in response to the PN message/trigger in Step-2 as specified/defined herein in the present disclosure, e.g., within a time window starting from the first or last symbol/slot/etc. of the transmission of the one or more indicators. The UE could determine or identify value(s) of the time window according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, (higher layer(s) of) the UE could cancel transmission of the first (UEI) beam report. In this case, the UE could still receive from the network a (downlink/uplink) DCI in response to the PN message/trigger in Step-2 as specified/defined herein in the present disclosure, e.g., within a time window starting from the first or last symbol/slot/etc. of the transmission of the PN message/trigger as in Step-1, but the UE would not transmit or send the first (UEI) beam report using/over/in/by/on the UL resource(s) including PUSCH resource(s) granted or scheduled or assigned or allocated by the (downlink/uplink) DCI for transmitting the first (UEI) beam report.

For the aforementioned design examples, (higher layer(s) of) the UE could cancel transmission of the first (UEI) beam report according to or based on one or more of:
when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report X0 symbol(s)/slot(s)/etc. earlier in time than or prior to or before (the first symbol/slot/etc. of) detection, reception and/or monitoring of the (downlink/uplink) DCI (in Step-2) in response to the PN message/trigger transmitted/sent via first UL channel(s) in Step-1 for triggering and/or requesting UL resource(s) for the transmission of the first (UEI) beam report;
   when/if the UE could transmit a PN message/trigger via first UL channel(s) in Step-1 for triggering and/or requesting UL resource(s) for the transmission of the second (UEI) beam report X1 symbol(s)/slot(s)/etc. earlier in time or prior to or before (the first symbol/slot/etc. of) detection, reception and/or monitoring of the (downlink/uplink) DCI in the corresponding CORESET(s)—in Step-2—in response to the PN message/trigger transmitted/sent via first UL channel(s) in Step-1 for triggering and/or requesting UL resource(s) for the transmission of the first (UEI) beam report;
   when/if the UE could receive, detect and/or monitor a (downlink/uplink) DCI (in the corresponding CORESET(s) as in Step-2) in response to the PN message/trigger transmitted/sent via first UL channel(s) in Step-1 for triggering and/or requesting UL resource(s) for the transmission of the second (UEI) beam report X2 symbol(s)/slot(s)/etc. earlier in time or prior to or before (the first symbol/slot/etc. of) detection, reception and/or monitoring of the (downlink/uplink) DCI in the corresponding CORESET(s)—in Step-2—in response to the PN message/trigger transmitted/sent via first UL channel(s) in Step-1 for triggering and/or requesting UL resource(s) for the transmission of the first (UEI) beam report—in this case, the UE could expect to receive from the network the (downlink/uplink) DCI, as in Step-2, in response to the PN message/trigger transmitted or sent in Step-1 for triggering and/or requesting UL resource(s) for the transmission of the second (UEI) beam report as specified/defined herein in the present disclosure, e.g., within a time window starting from the first or last symbol/slot/etc. of the transmission of the PN message/trigger.

The UE could determine or identify the value(s) of X0, XI, X2 and/or the aforementioned time window according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
For another example, the UE (e.g., the UE 116) could still expect to receive from the network a first (downlink/uplink) DCI in Step-2 in response to the (first) PN message/trigger transmitted/sent via first UL channel(s) in Step-I for triggering and/or requesting UL resource(s) for the transmission of the first (UEI) beam report as specified/defined herein in the present disclosure, e.g., within a time window starting from the first or last symbol/slot/etc. of the transmission of the (first) PN message/trigger. In this case, the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report, and the UE could have transmitted or sent another PN message/trigger—denoted by a second PN message/trigger—via first UL channel(s) in Step-1 for triggering and/or requesting UL resource(s) for the transmission of the second (UEI) beam report. For this design example, the UE could also expect to receive from the network a second (downlink/uplink) DCI in Step-2 in response to the second PN message/trigger transmitted/sent via first UL channel(s) in Step-1 for triggering and/or requesting UL resource(s) for the transmission of the second (UEI) beam report as specified/defined herein in the present disclosure, e.g., within a time window starting from the first or last symbol/slot/etc. of the transmission of the second PN message/trigger. According to or following those specified herein in the present disclosure, the first (downlink/uplink) DCI and the second (downlink/uplink) DCI could respectively indicate UL resources e.g. PUSCH resources to carry the first and second (UEI) beam reports. Here, the first (downlink/uplink) DCI and the second (downlink/uplink) DCI could be the same or identical (i.e., the first DCI and the second DCI could correspond to a/the same DCI denoted by a reference (downlink/uplink) DCI), which could be detected, received and/or monitored in the same PDCCH candidate(s)/search space(s)/search space set(s)/CORESET(s), e.g., when/if one or more of the following conditions are achieved and/or satisfied:
the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for the transmission of the second (UEI) beam report Y0 symbol(s)/slot(s)/etc. earlier in time than or prior to or before (the first symbol/slot/etc. of) detection, reception and/or monitoring of the first (downlink/uplink) DCI (in Step-2) in response to the first PN message/trigger transmitted/sent via first UL channel(s) in Step-I for triggering and/or requesting UL resource(s) for the transmission of the first (UEI) beam report;
the UE could transmit the second PN message/trigger via first UL channel(s) in Step-1 for triggering and/or requesting UL resource(s) for the transmission of the second (UEI) beam report Y1 symbol(s)/slot(s)/etc. earlier in time or prior to or before (the first symbol/slot/etc. of) detection, reception and/or monitoring of the first (downlink/uplink) DCI in the corresponding CORESET(s)—in Step-2—in response to the first PN message/trigger transmitted/sent via first UL channel(s) in Step-1 for triggering and/or requesting UL resource(s) for the transmission of the first (UEI) beam report

The UE could determine or identify the value(s) of Y0 and/or Y1 according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). In this case, a (downlink/uplink) DCI format, e.g., DCI format 0_1/0_2/0_3 in Step-2, could indicate or comprise a one-bit indicator with ‘1’ (or ‘0’) indicating that when/if this (downlink/uplink) DCI format is received in Step-2, it is in response to both the first and second PN messages/triggers transmitted/sent via first UL channel(s) in Step-1 for triggering and/or requesting UL resource(s) for the transmission(s) of the first and second (UEI) beam reports—in this case, this (downlink/uplink) DCI format could correspond to the reference (downlink/uplink) DCI format as specified/defined herein in the present disclosure which could grant, schedule, assign or allocate UL resource(s) for carrying the first and second (UEI) beam reports, and ‘0’ (or ‘1’) indicating that when/if this (downlink/uplink) DCI format is received in Step-2, it is in response to the first (or second) PN message/trigger transmitted/sent via first UL channel(s) in Step-1 for triggering and/or requesting UL resource(s) for the transmission(s) of the first (or second) (UEI) beam report—in this case, this (downlink/uplink) DCI format could correspond to the first (or second) (downlink/uplink) DCI format as specified/defined herein in the present disclosure which could grant, schedule, assign or allocate UL resource(s) for carrying the first (or second) (UEI) beam reports. Optionally, a (downlink/uplink) DCI format, e.g., DCI format 0_1/0_2/0_3 in Step-2, could indicate or comprise a two-bit indicator with ‘00’ (or ‘01’ or ‘10’ or ‘11’) indicating that when/if this (downlink/uplink) DCI format is received in Step-2, it is in response to both the first and second PN messages/triggers transmitted/sent via first UL channel(s) in Step-1 for triggering and/or requesting UL resource(s) for the transmission(s) of the first and second (UEI) beam reports—in this case, this (downlink/uplink) DCI format could correspond to the reference (downlink/uplink) DCI format as specified/defined herein in the present disclosure which could grant, schedule, assign or allocate UL resource(s) for carrying the first and second (UEI) beam report, ‘01’ (or ‘00’ or ‘10’ or ‘11’) indicating that when/if this (downlink/uplink) DCI format is received in Step-2, it is in response to the first PN message/trigger transmitted/sent via first UL channel(s) in Step-1 for triggering and/or requesting UL resource(s) for the transmission of the first (UEI) beam report—in this case, this (downlink/uplink) DCI format could correspond to the first (downlink/uplink) DCI format as specified/defined herein in the present disclosure which could grant, schedule, assign or allocate UL resource(s) for carrying the first (UEI) beam report, and ‘10’ (or ‘00’ or ‘01’ or ‘11’) indicating that when/if this (downlink/uplink) DCI format is received in Step-2, it is in response to the second PN message/trigger transmitted/sent via first UL channel(s) in Step-1 for triggering and/or requesting UL resource(s) for the transmission of the second (UEI) beam report—in this case, this (downlink/uplink) DCI format could correspond to the second (downlink/uplink) DCI format as specified/defined herein in the present disclosure which could grant, schedule, assign or allocate UL resource(s) for carrying the second (UEI) beam report. The one-bit indicator and/or the two-bit indicator as specified/defined herein in the present disclosure could be indicated or provided by dedicated and/or new DCI field(s) in the corresponding DCI format(s), and/or repurposed via one or more codepoints of one or more existing DCI fields in the corresponding DCI format(s).
For another example, the UE could still expect to receive from the network a first (downlink/uplink) DCI in Step-2 in response to the (first) PN message/trigger transmitted/sent via first UL channel(s) in Step-1 for triggering and/or requesting UL resource(s) for the transmission of the first (UEI) beam report as specified/defined herein in the present disclosure, e.g., within a time window starting from the first or last symbol/slot/etc. of the transmission of the (first) PN message/trigger. In this case, the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report, and the UE could have transmitted or sent another PN message/trigger—denoted by a second PN message/trigger—via first UL channel(s) in Step-1 for triggering and/or requesting UL resource(s) for the transmission of the second (UEI) beam report. For this design example, the UE could also expect to receive from the network a second (downlink/uplink) DCI in Step-2 in response to the second PN message/trigger transmitted/sent via first UL channel(s) in Step-1 for triggering and/or requesting UL resource(s) for the transmission of the second (UEI) beam report as specified/defined herein in the present disclosure, e.g., within a time window starting from the first or last symbol/slot/etc. of the transmission of the second PN message/trigger. According to or following those specified herein in the present disclosure, the first (downlink/uplink) DCI and the second (downlink/uplink) DCI could respectively indicate UL resources e.g. PUSCH resources to carry the first and second (UEI) beam reports. Here, the first (downlink/uplink) DCI and the second (downlink/uplink) DCI could be separate or different DCIs, which could be detected, received and/or monitored in separate or different PDCCH candidate(s)/search space(s)/search space set(s)/CORESET(s) on separate or different time and/or frequency domain resources, e.g., when/if one or more of the following conditions are achieved and/or satisfied:
   the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for the transmission of the second (UEI) beam report Y0 symbol(s)/slot(s)/etc. earlier in time than or prior to or before (the first symbol/slot/etc. of) detection, reception and/or monitoring of the first (downlink/uplink) DCI (in Step-2) in response to the first PN message/trigger transmitted/sent via first UL channel(s) in Step-1 for triggering and/or requesting UL resource(s) for the transmission of the first (UEI) beam report;
   the UE could transmit the second PN message/trigger via first UL channel(s) in Step-1 for triggering and/or requesting UL resource(s) for the transmission of the second (UEI) beam report Y1 symbol(s)/slot(s)/etc. earlier in time or prior to or before (the first symbol/slot/etc. of) detection, reception and/or monitoring of the first (downlink/uplink) DCI in the corresponding CORESET(s)
   in Step-2—in response to the first PN message/trigger transmitted/sent via first UL channel(s) in Step-1 for triggering and/or requesting UL resource(s) for the transmission of the first (UEI) beam report

The UE could determine or identify the value(s) of Y0 and/or Y1 according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). In this case, a (downlink/uplink) DCI format, e.g., DCI format 0_1/0_2/0_3 in Step-2, could indicate or comprise a one-bit indicator with ‘1’ (or ‘0’) indicating that when/if this (downlink/uplink) DCI format is received in Step-2, it is in response to the first PN message/trigger transmitted/sent via first UL channel(s) in Step-1 for triggering and/or requesting UL resource(s) for the transmission(s) of the first (UEI) beam report—in this case, this (downlink/uplink) DCI format could correspond to the first (downlink/uplink) DCI format as specified/defined herein in the present disclosure which could grant, schedule, assign or allocate UL resource(s) for carrying the first (UEI) beam report, and ‘0’ (or ‘1’) indicating that when/if this (downlink/uplink) DCI format is received in Step-2, it is in response to the second PN message/trigger transmitted/sent via first UL channel(s) in Step-1 for triggering and/or requesting UL resource(s) for the transmission(s) of the second (UEI) beam report—in this case, this (downlink/uplink) DCI format could correspond to the second (downlink/uplink) DCI format as specified/defined herein in the present disclosure which could grant, schedule, assign or allocate UL resource(s) for carrying the second (UEI) beam report. The one-bit indicator as specified/defined herein in the present disclosure could be indicated or provided by dedicated and/or new DCI field(s) in the corresponding DCI format(s), and/or repurposed via one or more codepoints of one or more existing DCI fields in the corresponding DCI format(s). Alternatively, the UE could expect that the first (downlink/uplink) DCI is received, detected or monitored earlier (or later) in time than the second (downlink/uplink) DCI, and/or the first (downlink/uplink) DCI is received, detected or monitored in PDCCH candidate(s)/search space(s)/search space set(s)/CORESET(s) with lower (or higher) ID(s)/index(es) than that of PDCCH candidate(s)/search space(s)/search space set(s)/CORESET(s), in which the second (downlink/uplink) DCI is received, detected or monitored. For instance, when/if the UE has transmitted the first PN message/trigger according to or following those specified herein in the present disclosure earlier (or later) in time than the transmission of the second PN message/trigger, the UE could expect that the first (downlink/uplink) DCI is received, detected or monitored earlier (or later) in time than the second (downlink/uplink) DCI, and/or the first (downlink/uplink) DCI is received, detected or monitored in PDCCH candidate(s)/search space(s)/search space set(s)/CORESET(s) with lower (or higher) ID(s)/index(es) than that of PDCCH candidate(s)/search space(s)/search space set(s)/CORESET(s), in which the second (downlink/uplink) DCI is received, detected or monitored. Optionally, when/if the first PN message/trigger is associated/linked/mapped to a CSI report setting provided by CSI-ReportConfig/UEI-ReportConfig with a lower (or higher) reportConfigId than that (reportConfigId) of the CSI report setting provided by CSI-Report/UEI-ReportConfig associated/linked/mapped to the second PN message/trigger, the UE could expect that the first (downlink/uplink) DCI is received, detected or monitored earlier (or later) in time than the second (downlink/uplink) DCI, and/or the first (downlink/uplink) DCI is received, detected or monitored in PDCCH candidate(s)/search space(s)/search space set(s)/CORESET(s) with lower (or higher) ID(s)/index(es) than that of PDCCH candidate(s)/search space(s)/search space set(s)/CORESET(s), in which the second (downlink/uplink) DCI is received, detected or monitored, wherein the UE could determine or identify the aforementioned association(s)/linkage(s)/mapping(s) according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the operation Mode A, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). Furthermore, after (higher layer(s) of) the UE has detected and/or declared the event (e.g., the fourth event or Event-4) for triggering and/or requesting UL resource(s) for a transmission of a first (UEI) beam report, the UE could send a PN message/trigger via first UL channel(s) in Step-1 according to or following those specified herein in the present disclosure to trigger and/or request UL resource(s) for the transmission of the first (UEI) beam report. In this case, after the UE has sent the PN message/trigger via first UL channel(s) in Step-1 according to or following those specified herein in the present disclosure to trigger and/or request UL resource(s) for the transmission of the first (UEI) beam report, the UE could receive from the network a (downlink/uplink) DCI in response to the PN message/trigger in Step-2 as specified/defined herein in the present disclosure, e.g., within a time window starting from the first or last symbol/slot/etc. of the transmission of the PN message/trigger, to indicate, grant, schedule, assign and/or allocate first UL resource(s) including PUSCH resource(s) for second UL channel(s) as in Step-3 to carry the first (UEI) beam report. After the UE has received from the network the (downlink/uplink) DCI in response to the PN message/trigger for triggering and/or requesting first UL resource(s) for the transmission of the first (UEI) beam report, and before the UE could actually transmit the first (UEI) beam report using/in/over/on the first UL resource(s) for the second UL channel(s) as in Step-3, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable before the UE could transmit the first UEI beam report according to or following those specified herein in the present disclosure.
In one example, (higher layer(s) of) the UE could start a prohibit timer after (e.g., the first or last symbol/slot/etc.) the UE has received, monitored and/or detected the (downlink/uplink) DCI as in Step-2 in response to the PN message/trigger in the corresponding CORESET(s) according to or following those specified/defined herein in the present disclosure. Before the prohibit timer expires, and/or before (e.g., the first or last symbol/slot/etc.) the UE could transmit the first (UEI) beam report using/via/in/over/on the scheduled, indicated, allocated, assigned, granted first UL resource(s) for the second UL channel(s) as in Step-3,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or request UL resource(s) for transmitting a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, but the UE would not (or is not expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, and the UE could (or is expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report, but the UE would not (or is not expected to) transmit or send, in/over/on/using the allocated, scheduled, granted, assigned or indicated UL resource(s) for the second UL channel(s), a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. For example, (higher layer(s) of) the UE could cancel transmission of the first (UEI) beam report. Optionally, the UE could send or transmit to the network, e.g., via one or more UL resources provided or configured for the first UL channel(s) in Step-1 as specified/defined herein in the present disclosure, one or more indicators to indicate the cancellation of transmission of the first (UEI) beam report. In this case, the UE may not use and/or apply the indicated, scheduled, granted, allocated or assigned first UL resource(s) for the second UL channel(s) to transmit, send or carry the first (UEI) beam report according to or following those specified herein in the present disclosure (as in Step-3). Additionally, (higher layer(s) of) the UE could cancel transmission of the first (UEI) beam report according to or based on one or more of:
   when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report Z0 symbol(s)/slot(s)/etc. earlier in time than or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3;
   when/if the UE could transmit a PN message/trigger via first UL channel(s) in Step-1 for triggering and/or requesting UL resource(s) for the transmission of the second (UEI) beam report Z1 symbol(s)/slot(s)/etc. earlier in time or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3;
   when/if the UE could receive, detect and/or monitor a (downlink/uplink) DCI (in the corresponding CORESET(s) as in Step-2) in response to the PN message/trigger transmitted/sent via first UL channel(s) in Step-1 for triggering and/or requesting UL resource(s) for the transmission of the second (UEI) beam report Z2 symbol(s)/slot(s)/etc. earlier in time or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3; in this case, the UE could expect to receive from the network the (downlink/uplink) DCI, as in Step-2, in response to the PN message/trigger transmitted or sent in Step-1 for triggering and/or requesting UL resource(s) for the transmission of the second (UEI) beam report as specified/defined herein in the present disclosure, e.g., within a time window starting from the first or last symbol/slot/etc. of the transmission of the PN message/trigger;
   when/if the UE could transmit the second (UEI) beam report using/over/in/on second UL resource(s)—assigned, allocated, scheduled, indicated or granted by/in the (downlink/uplink) DCI as in Step-2 in response to the PN message/trigger for triggering and/or requesting UL resource(s) for the transmission of the second (UEI) beam report—Z3 symbol(s)/slot(s)/etc. earlier in time or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3.

The UE could determine or identify the value(s) of Z0, Z1, Z2, Z3 and/or the aforementioned time window according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
For another example, the UE could still expect to transmit the first (UEI) beam report using/in/over/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for the second UL channel(s) as in Step-3. In this case, the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report, and the UE could have transmitted or sent another PN message/trigger via first UL channel(s) in Step-1 for triggering and/or requesting UL resource(s) for the transmission of the second (UEI) beam report. In this case, the UE could have also received from the network a (downlink/uplink) DCI in Step-2 in response to the PN message/trigger transmitted/sent via first UL channel(s) in Step-1 for triggering and/or requesting UL resource(s) for the transmission of the second (UEI) beam report as specified/defined herein in the present disclosure, e.g., within a time window starting from the first or last symbol/slot/etc. of the transmission of the PN message/trigger. For this design example, the UE could also expect to transmit the second (UEI) beam report using/in/over/on the second UL resource(s)—assigned, allocated, scheduled, indicated or granted by/in the (downlink/uplink) DCI in response to the PN message/trigger for triggering and/or requesting UL resource(s) for the transmission of the second (UEI) beam report—for the second UL channel(s) as in Step-3. Here, the UE could report, in a single reporting instance/a joint (UEI) beam report, report quantity(s) of the first (UEI) beam report and the second (UEI) beam report, and/or the UE could report, in two separate/different reporting instances/CSI reports/beam reports, report quantity(s) of the first (UEI) beam report and the second (UEI) beam report respectively, e.g., when/if one or more of the following conditions are achieved and/or satisfied:
   the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or requesting UL resource(s) for a transmission of a second (UEI) beam report Z0′ symbol(s)/slot(s)/etc. earlier in time than or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3;
   the UE could transmit a PN message/trigger via first UL channel(s) in Step-1 for triggering and/or requesting UL resource(s) for the transmission of the second (UEI) beam report Z1′ symbol(s)/slot(s)/etc. earlier in time or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3;
   the UE could receive, detect and/or monitor a (downlink/uplink) DCI (in the corresponding CORESET(s) as in Step-2) in response to the PN message/trigger transmitted/sent via first UL channel(s) in Step-1 for triggering and/or requesting UL resource(s) for the transmission of the second (UEI) beam report Z2′ symbol(s)/slot(s)/etc. earlier in time or prior to or before (the first symbol/slot/etc. of) the transmission the first (UEI) beam report using/over/in/on the first UL resource(s)—assigned, allocated, scheduled, indicated or granted by/in the (downlink/uplink) DCI in response to the PN message/trigger for triggering and/or requesting UL resource(s) for the transmission of the first (UEI) beam report—for/of the second UL channel(s) as in Step-3; in this case, the UE could expect to receive from the network (e.g., the network 130) the (downlink/uplink) DCI, as in Step-2, in response to the PN message/trigger transmitted or sent in Step-1 for triggering and/or requesting UL resource(s) for the transmission of the second (UEI) beam report as specified/defined herein in the present disclosure, e.g., within a time window starting from the first or last symbol/slot/etc. of the transmission of the PN message/trigger.

The UE could determine or identify the value(s) of Z0′, Z1′ and/or Z2′ according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the operation Mode A, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). Furthermore, after (higher layer(s) of) the UE has detected and/or declared the event (e.g., the fourth event or Event-4) for triggering and/or requesting UL resource(s) for a transmission of a first (UEI) beam report, the UE could send a PN message/trigger via first UL channel(s) in Step-1 according to or following those specified herein in the present disclosure to trigger and/or request UL resource(s) for the transmission of the first (UEI) beam report. In this case, after the UE has sent the PN message/trigger via first UL channel(s) in Step-1 according to or following those specified herein in the present disclosure to trigger and/or request UL resource(s) for the transmission of the first (UEI) beam report, the UE could receive from the network a (downlink/uplink) DCI in response to the PN message/trigger in Step-2 as specified/defined herein in the present disclosure, e.g., within a time window starting from the first or last symbol/slot/etc. of the transmission of the PN message/trigger, to indicate, grant, schedule, assign and/or allocate first UL resource(s) including PUSCH resource(s) for second UL channel(s) as in Step-3 to carry the first (UEI) beam report. After the UE has received from the network the (downlink/uplink) DCI in response to the PN message/trigger for triggering and/or requesting first UL resource(s) for the transmission of the first (UEI) beam report, the UE could transmit the first (UEI) beam report using/in/over/on the first UL resource(s) for the second UL channel(s) as in Step-3. After the UE has transmitted the first (UEI) beam report via/using/in/over/on the dynamically assigned, allocated, scheduled or granted first UL resource(s) of the second UL channel(s) as in Step-3, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable.
In one example, (higher layer(s) of) the UE could start a prohibit timer after (e.g., the first or last symbol/slot/etc.) the UE has transmitted or sent the first (UEI) beam report using/via/in/over/on the scheduled, indicated, allocated, assigned, granted first UL resource(s) for the second UL channel(s) as in Step-3. Before the prohibit timer expires,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or request UL resource(s) for transmitting a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, but the UE would not (or is not expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or request UL resource(s) for transmitting a/the second (UEI) beam report, and the UE could (or is expected to) receive from the network a/the (downlink/uplink) DCI in response to the PN trigger/message for triggering and/or requesting UL resource(s) for the transmission of the second (UEI) beam report, wherein the (downlink/uplink) DCI could provide, indicate, schedule, grant, allocate or assign UL resource(s) for transmitting the second (UEI) beam report, but the UE would not (or is not expected to) transmit or send, in/over/on/using the allocated, scheduled, granted, assigned or indicated UL resource(s) for the second UL channel(s), a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. When/if the UE has detected and/or declared the event (e.g., the fourth event or Event-4) for triggering and/or requesting UL resource(s) for a transmission of a second (UEI) beam report (i.e., associated/linked/corresponding to the one or more second TCI states), the UE could follow those/steps specified in the operation Mode A to trigger, initiate and/or transmit the second (UEI) beam report: in particular, the UE could send a PN message/trigger via first UL channel(s) in Step-1 according to or following those specified herein in the present disclosure to trigger and/or request UL resource(s) for the transmission of the second (UEI) beam report; after the UE has sent the PN message/trigger via first UL channel(s) in Step-1 according to or following those specified herein in the present disclosure to trigger and/or request UL resource(s) for the transmission of the second (UEI) beam report, the UE could receive from the network a (downlink/uplink) DCI in response to the PN message/trigger in Step-2 as specified/defined herein in the present disclosure, e.g., within a time window starting from the first or last symbol/slot/etc. of the transmission of the PN message/trigger, to indicate, grant, schedule, assign and/or allocate UL resource(s) including PUSCH resource(s) for second UL channel(s) as in Step-3 to carry the second (UEI) beam report. After the UE has received from the network the (downlink/uplink) DCI in response to the PN message/trigger for triggering and/or requesting UL resource(s) for the transmission of the second (UEI) beam report, the UE could transmit the second (UEI) beam report using/in/over/on the UL resource(s) for the second UL channel(s) as in Step-3.

For the operation Mode B, according to those specified herein in the present disclosure, the UE (e.g., the UE 116) could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). In this case, after (higher layer(s) of) the UE has detected and/or declared the event (e.g., the fourth event or Event-4) for triggering and/or notifying a transmission of a first (UEI) beam report, and before the UE could send a PN message/trigger via first UL channel(s) in Step-1 according to or following those specified herein in the present disclosure to trigger and/or notify the transmission of the first (UEI) beam report, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable before the UE could send a PN message/trigger via the first UL channel(s) in Step-1 to trigger and/or notify the transmission of the first (UEI) beam report.
In one example, (higher layer(s) of) the UE could start a prohibit timer after the UE has detected and/or declared the event according to the indicated first TCI state(s) following or according to those specified or defined herein in the present disclosure. Before the prohibit timer expires, and/or before (e.g., the first or last symbol/slot/etc.) the UE could send a PN message/trigger via the first UL channel(s) in Step-1 according to or following those specified herein in the present disclosure to trigger and/or notify the transmission of the first (UEI) beam report,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or notify transmission of a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or notify transmission of a/the second (UEI) beam report, but the UE would not (or is not expected to) transmit or send, in/over/on/using the pre-configured UL resource(s) for the second UL channel(s) as in Step-2, a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure.
   For example, (higher layer(s) of) the UE could cancel transmission of the PN message/trigger via first UL channel(s) in Step-1 for triggering and/or notifying the transmission of the first (UEI) beam report.
   For another example, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying transmission of a second (UEI) beam report X symbol(s)/slot(s)/etc. earlier in time than or prior to or before (the first symbol/slot/etc. of) transmission of the PN message/trigger via first UL channel(s) in Step-1 for triggering and/or notifying the transmission of the first (UEI) beam report, and/or when/if the UE could transmit a PN message/trigger via first UL channel(s) in Step-1 for triggering and/or notifying the transmission of the second (UEI) beam report X symbol(s)/slot(s)/etc. earlier in time or prior to or before (the first symbol/slot/etc. of) transmission of the PN message/trigger via first UL channel(s) in Step-1 for triggering and/or notifying the transmission of the first (UEI) beam report, (higher layer(s) of) the UE could cancel transmission of the PN message/trigger via first UL channel(s) in Step-1 for triggering and/or notifying the transmission of the first (UEI) beam report. For this design example, the UE could determine or identify the X value(s) according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could still transmit the PN message/trigger via first UL channel(s) in Step-1 for triggering and/or notifying the transmission of the first (UEI) beam report. In this case, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying a transmission of a second (UEI) beam report X symbol(s)/slot(s)/etc. earlier in time than or prior to or before (the first symbol/slot/etc. of) transmission of the PN message/trigger via first UL channel(s) in Step-1 for triggering and/or notifying the transmission of the first (UEI) beam report, wherein the UE could determine or identify the X value(s) according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), the UE could transmit a/the (same) PN message/trigger via first UL channel(s) in Step-1 for triggering and/or notifying the transmission of both the first and second (UEI) beam reports. For instance, the PN message/trigger could be a one-bit indicator with ‘1’ (or positive) indicating that the PN message/trigger via first UL channel(s) in Step-1 is to trigger and/or notify the transmission of both of the first and second (UEI) beam reports, and ‘0’ (or negative) indicating that the PN message/trigger via first UL channel(s) in Step-1 could be to trigger and/or notify the transmission of the first (or second) UEI beam report. Optionally, the PN message/trigger could be a two-bit indicator with ‘00’ (or ‘01’ or ‘10’ or ‘11’) indicating that the PN message/trigger via first UL channel(s) in Step-1 is to trigger and/or notify the transmission of both of the first and second (UEI) beam reports, ‘01’ (or ‘00’ or ‘10’ or ‘11’) indicating thatthe PN message/trigger via first UL channel(s) in Step-1 could be to trigger and/or notify the transmission of the first UEI beam report, and ‘10’ (or ‘00’ or ‘01’ or ‘11’) indicating that the PN message/trigger via first UL channel(s) in Step-1 could be to trigger and/or notify the transmission of the second UEI beam report. For this design example, a/the (same) PN message/trigger—e.g., to trigger and/or notify the transmission of both of the first and second UEI beam reports—could be sent or transmitted on/over/in the most recent/available UL resource(s) provided or configured for the first UL channel(s) in Step-1 according to or following those specified herein in the present disclosure.
   For another example, the UE could still transmit a first PN message/trigger via first UL channel(s) in Step-1 for triggering and/or notifying the transmission of the first (UEI) beam report. In this case, when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying a transmission of a second (UEI) beam report, the UE could transmit a second PN message/trigger via first UL channel(s) in Step-1 for triggering and/or notifying the transmission of the second (UEI) beam report. For this design example, the first PN message/trigger and the second PN message/trigger could be respectively or separately sent or transmitted on/over/in first UL resource(s) and second UL resource(s) provided or configured for the first UL channel(s) in Step-I according to or following those specified herein in the present disclosure. For this design example, the first UL resource(s) could correspond to the most recent/available UL resource(s) in time—provided or configured for the first UL channel(s) in Step-I—associated/specific to the first PN message/trigger, and the second UL resource(s) could correspond to the most recent/available UL resource(s) in time—provided or configured for the first UL channel(s) in Step-1—associated/specific to the second PN message/trigger. Optionally, the first UL resource(s) could correspond to the most recent/available UL resource(s) in time—among the UL resource(s) provided or configured for the first UL channel(s) in Step-I according to or following those specified herein in the present disclosure, or the second UL resource(s) could correspond to the most recent/available UL resource(s) in time—among the UL resource(s) provided or configured for the first UL channel(s) in Step-1 according to or following those specified herein in the present disclosure. Alternatively, the PN message/trigger could be a one-bit indicator with ‘1’ (or positive) indicating that the PN message/trigger via first UL channel(s) in Step-I is to trigger and/or notify the transmission of the first (UEI) beam report—i.e., it corresponds to the first PN message/trigger, and ‘0’ (or negative) indicating that the PN message/trigger via first UL channel(s) in Step-1 could be to trigger and/or notify the transmission of the second UEI beam report—i.e., it corresponds to the second PN message/trigger.

For the operation Mode B, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). Furthermore, after (higher layer(s) of) the UE has detected and/or declared the event (e.g., the fourth event or Event-4) for triggering and/or notifying a transmission of a first (UEI) beam report, the UE could send a PN message/trigger via first UL resource(s)/occasion(s) of first UL channel(s) in Step-I according to or following those specified herein in the present disclosure to trigger and/or notify the transmission of the first (UEI) beam report. In this case, after the UE has sent the PN message/trigger via the first UL resource(s)/occasion(s) of first UL channel(s) in Step-I according to or following those specified herein in the present disclosure to trigger and/or notify the transmission of the first (UEI) beam report, and before the UE could actually transmit the first (UEI) beam report using/in/over/on pre-configured first UL resource(s)/occasion(s) of second UL channel(s) as in Step-2, wherein the first UL resource(s)/occasion(s) of the second UL channel(s) in Step-2 could be associated/corresponding/mapped/linked to the first UL resource(s)/occasion(s) of the first UL channel(s) in Step-1 wherein the UE could determine and/or identify the aforementioned association/correspondence/mapping/linkage according to or based on (i) fixed rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable before the UE could transmit the first UEI beam report according to or following those specified herein in the present disclosure.
In one example, (higher layer(s) of) the UE could start a prohibit timer after (e.g., the first or last symbol/slot/etc.) the UE has sent the PN message/trigger via the first UL resource(s)/occasion(s) of first UL channel(s) in Step-1 according to or following those specified herein in the present disclosure to trigger and/or notify the transmission of the first (UEI) beam report. Before the prohibit timer expires, and/or before (e.g., the first or last symbol/slot/etc.) the UE could transmit the first (UEI) beam report using/via/in/over/on the pre-configured first UL resource(s)/occasion(s) of the second UL channel(s) as in Step-2 according to or following those specified/defined herein in the present disclosure,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or notify transmission of a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or notify transmission of a/the second (UEI) beam report, but the UE would not (or is not expected to) transmit or send, in/over/on/using the pre-configured UL resource(s) for the second UL channel(s) as in Step-2, a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. For example, (higher layer(s) of) the UE could cancel transmission of the first (UEI) beam report. Optionally, the UE could send or transmit to the network, e.g., via one or more UL resources provided or configured for the first UL channel(s) in Step-1 as specified/defined herein in the present disclosure, one or more indicators to indicate the cancellation of transmission of the first (UEI) beam report. In this case, the UE may not use and/or apply the pre-configured first UL resource(s)/occasion(s) of the second UL channel(s) as in Step-2 to transmit, send or carry the first (UEI) beam report according to or following those specified herein in the present disclosure (as in Step-2). Additionally, (higher layer(s) of) the UE could cancel transmission of the first (UEI) beam report according to or based on one or more of:
   when/if the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying a transmission of a second (UEI) beam report Z0 symbol(s)/slot(s)/etc. earlier in time than or prior to or before (the first symbol/slot/etc. of) the transmission the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2;
   when/if the UE could transmit a PN message/trigger via first UL channel(s) in Step-1 for triggering and/or notifying the transmission of the second (UEI) beam report Z1 symbol(s)/slot(s)/etc. earlier in time or prior to or before (the first symbol/slot/etc. of) the transmission the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2;
   when/if the UE could transmit the second (UEI) beam report using/over/in/on pre-configured second UL resource(s)/occasion(s)—associated/linked/mapped/corresponding to second UL resource(s)/occasion(s) of the first UL channel(s) as in Step-1 to transmit and/or send the PN message/trigger for triggering and/or notifying the transmission of the second (UEI) beam report—for/of the second UL channel(s) as in Step-2 Z2 symbol(s)/slot(s)/etc. earlier in time or prior to or before (the first symbol/slot/etc. of) the transmission the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2.

The UE could determine or identify the value(s) of Z0, Z1 and/or Z2 according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
For another example, the UE could still expect to transmit the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2. In this case, the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying a transmission of a second (UEI) beam report, and the UE could have transmitted or sent another PN message/trigger via second UL resource(s)/occasion(s) of first UL channel(s) in Step-1 for triggering and/or notifying the transmission of the second (UEI) beam report. In this case, the UE could also expect to transmit the second (UEI) beam report using/over/in/on the pre-configured second UL resource(s)/occasion(s)—associated/linked/mapped/corresponding to the second UL resource(s)/occasion(s) of the first UL channel(s) as in Step-1 to transmit and/or send the PN message/trigger for triggering and/or notifying the transmission of the second (UEI) beam report—for/of the second UL channel(s) as in Step-2. Here, the UE could report, in a single reporting instance/a joint (UEI) beam report, report quantity(s) of the first (UEI) beam report and the second (UEI) beam report, and/or the UE could report, in two separate/different reporting instances/CSI reports/beam reports, report quantity(s) of the first (UEI) beam report and the second (UEI) beam report respectively, e.g., when/if one or more of the following conditions are achieved and/or satisfied:
   the UE could detect and/or declare the event (e.g., the fourth event or Event-4) according to the indicated second (joint/DL) TCI state(s) following or according to those specified or defined herein in the present disclosure—e.g., at least the current serving beam RS(s) or RS resource(s) for evaluating, assessing or detecting at least one instance of the event could be associated/specific to the indicated second TCI state(s)—for triggering and/or notifying a transmission of a second (UEI) beam report Z0′ symbol(s)/slot(s)/etc. earlier in time than or prior to or before (the first symbol/slot/etc. of) the transmission the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2;
   the UE could transmit a PN message/trigger via first UL channel(s) in Step-1 for triggering and/or notifying the transmission of the second (UEI) beam report Z1′ symbol(s)/slot(s)/etc. earlier in time or prior to or before (the first symbol/slot/etc. of) the transmission the first (UEI) beam report using/over/in/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—for/of the second UL channel(s) as in Step-2.

The UE could determine or identify the value(s) of Z0′ and/or Z1′ according to or based on: (i) fixed rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the operation Mode B, according to those specified herein in the present disclosure, the UE could detect and/or declare the event (e.g., the fourth event or Event-4) according to one or more indicated first (joint/DL) TCI states following or according to those specified or defined herein in the present disclosure—e.g., at least the current serving beam RS(s) or RS resource(s) for evaluating, assessing or detecting at least one instance of the event could be associated/specific to the indicated first TCI state(s). Furthermore, after (higher layer(s) of) the UE has detected and/or declared the event (e.g., the fourth event or Event-4) for triggering and/or notifying a transmission of a first (UEI) beam report, the UE could send a PN message/trigger via first UL resource(s)/occasion(s) of first UL channel(s) in Step-1 according to or following those specified herein in the present disclosure to trigger and/or notify the transmission of the first (UEI) beam report. In this case, after the UE has sent the PN message/trigger via the first UL resource(s)/occasion(s) of first UL channel(s) in Step-1 according to or following those specified herein in the present disclosure to trigger and/or notify the transmission of the first (UEI) beam report, the UE could transmit the first (UEI) beam report using/in/over/on pre-configured first UL resource(s)/occasion(s) of second UL channel(s) as in Step-2, wherein the first UL resource(s)/occasion(s) of the second UL channel(s) in Step-2 could be associated/corresponding/mapped/linked to the first UL resource(s)/occasion(s) of the first UL channel(s) in Step-1 wherein the UE could determine and/or identify the aforementioned association/correspondence/mapping/linkage according to or based on (i) fixed rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network (e.g., the network 130) via/in part of various UL channels/signals and/or CSI/beam report(s) and/or UE's capability signaling(s). After the UE has transmitted the first (UEI) beam report using/in/over/on pre-configured first UL resource(s)/occasion(s) of second UL channel(s) as in Step-2, the UE could receive from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable.
In one example, (higher layer(s) of) the UE could start a prohibit timer after (e.g., the first or last symbol/slot/etc.) the UE has transmitted or sent the first (UEI) beam report using/in/over/on the pre-configured first UL resource(s)/occasion(s)—associated/linked/mapped/corresponding to the first UL resource(s)/occasion(s) of the first UL channel(s) as in Step-1 to transmit and/or send the PN message/trigger for triggering and/or notifying the transmission of the first (UEI) beam report—of/for the second UL channel(s) as in Step-2. Before the prohibit timer expires,
   For example, the UE would not (or is not expected to) perform any event(s) or event instance(s) evaluation, assessment, detection and/or declaration according to the indicated second TCI state(s).
   For another example, the UE could (or is expected to) perform event(s) or event instance(s) evaluation, assessment, detection and/or declaration according to the indicated second TCI state(s) following those specified herein in the present disclosure, but the UE would not (or is not expected to) transmit or send any PN trigger(s)/message(s) via the first UL channel(s) as in Step-1 to trigger and/or notify transmission of a/the second (UEI) beam report.
   For another example, the UE could (or is expected to) perform event(s) or event instance(s) evaluation, assessment, detection and/or declaration according to the indicated second TCI state(s) following those specified herein in the present disclosure, and the UE could (or is expected to) transmit or send a/the PN trigger/message via the first UL channel(s) as in Step-1 to trigger and/or notify transmission of a/the second (UEI) beam report, but the UE would not (or is not expected to) transmit or send, in/over/on/using the pre-configured UL resource(s) for the second UL channel(s) as in Step-2, a/the second (UEI) beam report.

For this design example, the UE could determine or identify value(s) of the prohibit timer according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could start determining/identifying and/or assessing/measuring and/or comparing (radio/beam link quality(s) of) at least second current serving beam RS(s) and/or second candidate beam RS(s) associated to the one or more second TCI states according to or following those specified herein in the present disclosure, and/or (higher layer(s) of) the UE could start determining or identifying or detecting or declaring second instance(s) of the event associated/linked/corresponding to the one or more second TCI states according to or following those specified herein in the present disclosure. When/if the UE has detected and/or declared the event (e.g., the fourth event or Event-4) for triggering and/or notifying a transmission of a second (UEI) beam report (i.e., associated/linked/corresponding to the one or more second TCI states), the UE could follow those/steps specified in the operation Mode B to trigger, initiate and/or transmit the second (UEI) beam report: in particular, the UE could send a PN message/trigger via second UL resource(s)/occasion(s) of first UL channel(s) in Step-1 according to or following those specified herein in the present disclosure to trigger and/or notify the transmission of the second (UEI) beam report. In this case, after the UE has sent the PN message/trigger via the second UL resource(s)/occasion(s) of first UL channel(s) in Step-1 according to or following those specified herein in the present disclosure to trigger and/or notify the transmission of the second (UEI) beam report, the UE could transmit the second (UEI) beam report using/in/over/on pre-configured second UL resource(s)/occasion(s) of second UL channel(s) as in Step-2, wherein the second UL resource(s)/occasion(s) of the second UL channel(s) in Step-2 could be associated/corresponding/mapped/linked to the second UL resource(s)/occasion(s) of the first UL channel(s) in Step-1 wherein the UE could determine and/or identify the aforementioned association/correspondence/mapping/linkage according to or based on (i) fixed rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For both operation Mode A and Mode B, after the UE has sent to the network, e.g., in/via/through the dynamic grant PUSCH resource(s) of the second UL channel as in Step-3 (Mode A) or the configured grant PUSCH resource(s) (e.g. Type1 CG PUSCH resource(s)) of the second UL channel as in Step-2 (Mode B), a first UEI beam report determined or obtained according to or based on the first condition(s) of detecting, declaring or determining the event as specified/defined herein in the present disclosure, the UE could expect to receive from the network, within a time window e.g. starting from the first (or last) symbol/slot/etc. among the slot(s)/symbol(s)/etc. of the PUSCH resource(s) of the second UL channel that carries or conveys the first UEI beam report, a network's response to the transmission of the first UEI beam report, wherein the network's response could be in form(s) of one or more of:
Response-1: a beam indication DCI (e.g., DCI format 1_1/1_2 with or without DL assignment) or a PDCCH reception with a beam indication DCI (e.g., DCI format 1_1/1_2 with or without DL assignment) and/or a (unified) TCI state(s) activation/deactivation MAC CE command providing or comprising or indicating a TCI state update
Response-2: a (unified) TCI state(s) activation/deactivation MAC CE command providing or comprising or activating one or more TCI states
Response-3: a (downlink/uplink) DCI (e.g., of DCI format(s) 0_1/0_2/0_3) or a PDCCH reception with a (downlink/uplink) DCI (e.g., of DCI format(s) 0_1/0_2/0_3) providing or comprising or indicating an UL grant/assignment e.g. to grant/allocate/assign/schedule PUSCH resource(s) for transmitting or sending a (UEI) beam report; in this case, the (downlink/uplink) DCI here could have the same form and/or design and/or functionalities and/or functionalities of the codepoint(s) as the (downlink/uplink) DCI in Step-2 (of Mode A) in response to the transmission of the PN message/trigger in Step-1. For Mode A, the (downlink/uplink) DCI here could schedule the PUSCH resource(s)/PUSCH transmission(s) with same HARQ process number(s) as for the transmission(s) of the PUSCH resource(s)—e.g., the DG PUSCH(s)—of the second UL channel as in Step-3 that carries or conveys the UEI beam report and/or having a toggled NDI field value, and for Mode B, the (downlink/uplink) DCI here could schedule the PUSCH resource(s)/PUSCH transmission(s) with same HARQ process number(s) as for the transmission(s) of the PUSCH resource(s)—e.g., the Type1 CG PUSCH(s)—of the second UL channel as in Step-2 that carries or conveys the UEI beam report and/or having a toggled NDI field value.

The UE could determine or identify the value(s) of the aforementioned time window according to or based on: fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Alternatively, after the UE has sent to the network, e.g., in/via/through the dynamic grant PUSCH resource(s) of the second UL channel of Step-3 (Mode A) or the configured grant PUSCH resource(s) (e.g. Type1 CG PUSCH resource(s)) of the second UL channel as in Step-2 (Mode B), the first UEI beam report determined or obtained according to or based on the first condition(s) of detecting, declaring or determining the event as specified/defined herein in the present disclosure, (higher layer(s) of) the UE could start a timer e.g. starting from the first (or last) symbol/slot/etc. among the slot(s)/symbol(s)/etc. of the PUSCH resource(s) of the second UL channel that carries or conveys the first UEI beam report, and the UE could expect to receive from the network, before the timer expires, a network's response to the transmission of the first UEI beam report, wherein the network's response could be in form(s) of one or more of Response-1, Response-2 and Response-3. The UE could determine or identify the value(s)/parameter(s)/length(s)/duration(s) of the aforementioned timer according to or based on: fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
After the UE has sent or transmitted the first UEI beam report, when/if there is no valid or available measurement occasion(s) for evaluating, assessing, detecting, determining or declaring instance(s) of the event(s) or the event(s) according to or following those specified herein in the present disclosure, and/or the UE could not obtain or determine or identify any condition(s) of detecting, declaring or determining the event as specified/defined herein in the present disclosure, and/or the UE could not obtain or determine or identify any evaluation or assessment result(s) of the event before or prior to when the UE could receive any network's response(s) to the transmission of the first UEI beam report e.g. within the time window or before the timer expires, upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report on the one or more PUSCH resources.
After the UE (e.g., the UE 116) has sent or transmitted the first UEI beam report, when/if there is valid or available measurement occasion(s) for evaluating, assessing, detecting, determining or declaring instance(s) of the event(s) or the event(s) according to or following those specified herein in the present disclosure, and/or (higher layer(s)) of the UE could have obtained, determined or identified the second condition(s) of detecting, declaring or determining the event as specified/defined herein in the present disclosure with the measurement result(s)—e.g., measured L1-RSRP(s)/L1-SINR(s)—obtained or determined or identified from at least the aforementioned valid or available measurement occasion(s) which may comprise the latest measurement occasion(s) in time before or prior to the UE could receive any network's response(s) to the transmission of the first UEI beam report e.g. within the time window or before the timer expires,
   when/if the second condition(s) of detecting, declaring or determining the event as specified/defined herein in the present disclosure is the same as or identical to the first condition(s) of detecting, declaring or determining the event as specified/defined herein in the present disclosure, upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report on the one or more PUSCH resources.
   In another example, when/if the second condition(s) of detecting, declaring or determining the event as specified/defined herein in the present disclosure is different or separate from the first condition(s) of detecting, declaring or determining the event as specified/defined herein in the present disclosure, the UE could repeat or (re-)start the procedure(s) as specified/defined in Step-1, Step-2 and Step-3 of the operation Mode A, or Step-1 and Step-2 of the operation Mode B (either operation Mode A or Mode B could be higher layer configured/enabled). In this case, even upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE may not send the (same) first UEI beam report or one or more of the report quantity(s) including SSBRI(s)/CRI(s) and/or L1-RSRP(s)/L1-SINR(s) of/for the first UEI beam report on the one or more PUSCH resources.
   In another example, when/if the second condition(s) of detecting, declaring or determining the event as specified/defined herein in the present disclosure is different or separate from the first condition(s) of detecting, declaring or determining the event as specified/defined herein in the present disclosure, upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE may not send the (same) first UEI beam report or one or more of the report quantity(s) including SSBRI(s)/CRI(s) and/or L1-RSRP(s)/L1-SINR(s) of/for the first UEI beam report on the one or more PUSCH resources.
   In another example, when/if the second condition(s) of detecting, declaring or determining the event as specified/defined herein in the present disclosure is different or separate from the first condition(s) of detecting, declaring or determining the event as specified/defined herein in the present disclosure, upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could still send the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report on the one or more PUSCH resources.
   In another example, the UE could determine or identify or obtain a second UEI beam report according to or based on the second condition(s) of detecting or determining the event following those specified herein in the present disclosure; when/if the second condition(s) of detecting, declaring or determining the event as specified/defined herein in the present disclosure is different or separate from the first condition(s) of detecting, declaring or determining the event as specified/defined herein in the present disclosure—i.e., the second UEI beam report could be different or separate from the first UEI beam report such that they could comprise different or separate report quantities including resource indicator(s) SSBRI(s)/CRI(s) and/or beam metric(s) including L1-RSRP(s)/L1-SINR(s), upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send the second UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the second UEI beam report on the one or more PUSCH resources. In this case, the UE may not send the (same) first UEI beam report or one or more of the report quantity(s) including SSBRI(s)/CRI(s) and/or L1-RSRP(s)/L1-SINR(s) of/for the first UEI beam report on the (same) one or more PUSCH resources.
   In another example, the UE could determine or identify or obtain a second UEI beam report according to or based on the second condition(s) of detecting or determining the event following those specified herein in the present disclosure; when/if the second condition(s) of detecting, declaring or determining the event as specified/defined herein in the present disclosure is different or separate from the first condition(s) of detecting, declaring or determining the event as specified/defined herein in the present disclosure—i.e., the second UEI beam report could be different or separate from the first UEI beam report such that they could comprise different or separate report quantities including resource indicator(s) SSBRI(s)/CRI(s) and/or beam metric(s) including L1-RSRP(s)/L1-SINR(s), upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send the second UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the second UEI beam report on the one or more PUSCH resources. In this case, the UE could also send the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report on the (same) one or more PUSCH resources. For this design example, the UE could send or transmit, in a single (CSI) reporting instance or CSI report (using/via/in/on the (same) one or more PUSCH resources), (one or more of) the report quantity(s)/content(s) of the first UEI beam port and (one or more of) the report quantity(s)/content(s) of the second UEI beam report.
      For example, (the one or more of) the report quantity(s)/content(s) of the first (or second) UEI beam report could be conveyed or carried by/in a number N_0 of CSI field(s) e.g. the first N_0 CSI field(s) or the CSI field(s) with the N_0 lowest/highest index(es)/ID(s)/ordering(s)—e.g., among the CSI field(s) or the CSI field(s) that carries or conveys the report quantity(s)/content(s) of the first and second UEI beam reports in the (CSI) reporting instance or CSI report, and the first N_1 CSI field(s) or the CSI field(s) with the N_1 lowest/highest index(es)/ID(s)/ordering(s)—e.g., among the CSI field(s) except/excluding the aforementioned N_0 CSI field(s) or the CSI field(s) except/excluding the aforementioned N_0 CSI field(s) that carries or conveys the report quantity(s)/content(s) of the first and second UEI beam reports in the (CSI) reporting instance or CSI report—following (e.g., in terms of their ordinal positions/orderings/indexes/IDs etc. from low to high or high to low) the aforementioned N_0 CSI field(s) could convey or carry (the one or more of) the report quantity(s)/content(s) of the second (or first) UEI beam report—i.e., (the one or more of) the report quantity(s)/content(s) of the second (or first) UEI beam report could be conveyed or carried by/in a number N_1 of CSI field(s). The UE could determine or identity the value(s) of N_0 and/or N_1 according to or based on: (i) fixed value(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
      For another example, the UE could transmit or send or include or provide or comprise, in the (CSI) reporting instance or CSI report, one or more indicators to indicate which of the report quantity(s)/content(s) in the (CSI) reporting instance or CSI report corresponding/belonging to the first UEI beam report, and/or which of the report quantity(s)/content(s) in the (CSI) reporting instance or CSI report corresponding/belonging to the second UEI beam report.
      For another example, the (CSI) reporting instance/CSI report could comprise one or more (one-bit) indicators each associated/corresponding/specific to a report quantity, e.g., a SSBRI/CRI or a L1-RSRP/L1-SINR, and/or each of the reported report quantity(s) in the (CSI) reporting instance/CSI report could be associated/corresponding/specific to a (one-bit) indicator; in this case, when/if a (one-bit) indicator is set to ‘1’ (or ‘0’), the report quantity associated/corresponding/specific to the (one-bit) indicator could correspond or belong to the first UEI beam report; otherwise, i.e., when/if a (one-bit) indicator is set to ‘0’ (or ‘1’), the report quantity associated/corresponding/specific to the (one-bit) indicator could correspond or belong to the second UEI beam report. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
      For another example, the (CSI) reporting instance/CSI report could comprise one or more (one-bit) indicators each associated/corresponding/specific to a report quantity, e.g., a SSBRI/CRI or a L1-RSRP/L1-SINR, of/for the first UEI beam report; i.e., when/if a (one-bit) indicator is present and set to a valid value e.g. ‘1’ or ‘0’, the report quantity associated/corresponding/specific to the (one-bit) indicator could correspond or belong to the first UEI beam report. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
      For another example, the (CSI) reporting instance/CSI report could comprise one or more (one-bit) indicators each associated/corresponding/specific to a report quantity, e.g., a SSBRI/CRI or a L1-RSRP/L1-SINR, of/for the second UEI beam report; i.e., when/if a (one-bit) indicator is present and set to a valid value e.g. ‘1’ or ‘0’, the report quantity associated/corresponding/specific to the (one-bit) indicator could correspond or belong to the second UEI beam report. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
      For another example, the (CSI) reporting instance/CSI report could comprise one or more indicators each associated/corresponding/specific to a report quantity, e.g., a SSBRI/CRI or a L1-RSRP/L1-SINR, of/for the first UEI beam report; i.e., when/if a (one-bit) indicator is present and set to a valid value e.g. ‘1’ or ‘0’, the report quantity associated/corresponding/specific to the indicator—e.g., when/if the index/order/position of a first CSI field in the (CSI) reporting instance/CSI report that carries/conveys the (one-bit) indicator is k, the index/order/position of a second CSI field in the (CSI) reporting instance/CSI report that carries/conveys the report quantity is k+1 or k−1 (i.e., the second CSI field could follow the first CSI field (e.g., in order or in index or in ordinal position) in the (CSI) reporting instance/CSI report or vice versa)—could correspond or belong to the first UEI beam report.
      For another example, the (CSI) reporting instance/CSI report could comprise one or more indicators each associated/corresponding/specific to a report quantity, e.g., a SSBRI/CRI or a L1-RSRP/L1-SINR, of/for the second UEI beam report; i.e., when/if a (one-bit) indicator is present and set to a valid value e.g. ‘1’ or ‘0’, the report quantity associated/corresponding/specific to the indicator—e.g., when/if the index/order/position of a first CSI field in the (CSI) reporting instance/CSI report that carries/conveys the (one-bit) indicator is k, the index/order/position of a second CSI field in the (CSI) reporting instance/CSI report that carries/conveys the report quantity is k+1 or k−1 (i.e., the second CSI field could follow the first CSI field (e.g., in order or in index or in ordinal position) in the (CSI) reporting instance/CSI report or vice versa)—could correspond or belong to the second UEI beam report.
      For another example, the (CSI) reporting instance/CSI report could comprise one or more indicators each associated/corresponding/specific to one or more (e.g., NO defined or determined based on or according the previous example(s)) report quantities, e.g., one or more SSBRIs/CRIs and/or one or more L1-RSRPs/L1-SINRs, of/for the first UEI beam report; i.e., when/if a (one-bit) indicator is present and set to a valid value e.g. ‘1’ or ‘0’, the report quantity(s) associated/corresponding/specific to the indicator—e.g., one or more second CSI fields in the (CSI) reporting instance/CSI report that carry/convey the NO report quantity(s) could follow (e.g., in order or in index or in ordinal position) a first CSI field that carries or conveys the (one-bit) indicator in the (CSI) reporting instance/CSI report or vice versa—could correspond or belong to the first UEI beam report.
      For another example, the (CSI) reporting instance/CSI report could comprise one or more indicators each associated/corresponding/specific to one or more (e.g., N1 defined or determined based on or according the previous example(s)) report quantities, e.g., one or more SSBRIs/CRIs and/or one or more L1-RSRPs/L1-SINRs, of/for the second UEI beam report; i.e., when/if a (one-bit) indicator is present and set to a valid value e.g. ‘1’ or ‘0’, the report quantity(s) associated/corresponding/specific to the indicator—e.g., one or more second CSI fields in the (CSI) reporting instance/CSI report that carry/convey the N1 report quantity(s) could follow (e.g., in order or in index or in ordinal position) a first CSI field that carries or conveys the (one-bit) indicator in the (CSI) reporting instance/CSI report or vice versa—could correspond or belong to the second UEI beam report.
      For another example, the (CSI) reporting instance/CSI report could comprise one or more indicators each having a bitwidth of ┌ log₂(Nₜ)┐ and/or one or more indexes, wherein Nₜ=N_0+N_1 (N_0 and/or N_1 are defined/determined in the previous design example(s)), or Nₜ could correspond to the total number of CSI field(s) in the reporting instance/CSI report, or Nₜ could correspond to the total number of CSI field(s) that carries or conveys the report quantity(s)/content(s) of the first and second UEI beam reports in the (CSI) reporting instance or CSI report; in this case, when/if an indicator/index indicates a value nₜ less than or equal to NO, the nₜ-th report quantity—among the report quantities/content(s) of/for the first and second UEI beam reports in the (CSI) reporting instance/CSI report—could correspond or belong to the first UEI beam report; and, when/if an indicator/index indicates a value nₜ greater than N0, the (nₜ−N_0)-th report quantity—among the report quantities/content(s) of/for the first and second UEI beam reports in the (CSI) reporting instance/CSI report—could correspond or belong to the second UEI beam report.
      For another example, the (CSI) reporting instance/CSI report could comprise one or more indicators each having a bitwidth of ┌ log₂(Nₜ)┐ and/or one or more indexes, wherein Nₜ=N_0+N_1 (N_0 and/or N_1 are defined/determined in the previous design example(s)), or Nₜ could correspond to the total number of CSI field(s) in the reporting instance/CSI report, or Nₜ could correspond to the total number of CSI field(s) that carries or conveys the report quantity(s)/content(s) of the first and second UEI beam reports in the (CSI) reporting instance or CSI report; in this case, when/if an indicator/index indicates a value nₜ, the nₜ-th report quantity—among the report quantities/content(s) of/for the first and second UEI beam reports in the (CSI) reporting instance/CSI report—could correspond or belong to the first UEI beam report.
      For another example, the (CSI) reporting instance/CSI report could comprise one or more indicators each having a bitwidth of ┌ log₂(Nₜ)┐ and/or one or more indexes, wherein Nₜ=N_0+N_1 (N_0 and/or N_1 are defined/determined in the previous design example(s)), or Nₜ could correspond to the total number of CSI field(s) in the reporting instance/CSI report, or Nₜ could correspond to the total number of CSI field(s) that carries or conveys the report quantity(s)/content(s) of the first and second UEI beam reports in the (CSI) reporting instance or CSI report; in this case, when/if an indicator/index indicates a value nₜ, the nₜ-th report quantity—among the report quantities/content(s) of/for the first and second UEI beam reports in the (CSI) reporting instance/CSI report—could correspond or belong to the second UEI beam report.

In this case, the UE could determine or identify which of the report/reporting formats as described/specified in the aforementioned design examples to follow or use or apply for transmitting or sending the first and/or second UEI beam report(s) according to or based on: (i) fixed value(s)/rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
In another example, the UE could determine or identify or obtain a second UEI beam report according to or based on the second condition(s) of detecting or determining the event following those specified herein in the present disclosure; when/if the second condition(s) of detecting, declaring or determining the event as specified/defined herein in the present disclosure is different or separate from the first condition(s) of detecting, declaring or determining the event as specified/defined herein in the present disclosure—i.e., the second UEI beam report could be different or separate from the first UEI beam report such that they could comprise different or separate report quantities including resource indicator(s) SSBRI(s)/CRI(s) and/or beam metric(s) including L1-RSRP(s)/L1-SINR(s), upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send, on the one or more PUSCH resources, (a) the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report, and/or (b) the second UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the second UEI beam report based on or according to their (first and second UEI beam reports) priority indexes or priority values from high to low (or low to high). For instance, in this case, the second UEI beam report (and therefore, the corresponding report quantity(s) including SSBRI(s)/CRI(s) and/or L1-RSRP(s)/L1-SINR(s) provided or comprised therein) could have a higher (or lower) priority—with a higher/lower priority index or priority value—than the first UEI beam report (and therefore, the corresponding report quantity(s) including SSBRI(s)/CRI(s) and/or L1-RSRP(s)/L1-SINR(s) provided or comprised therein) for the (UEI) beam reporting on the PUSCH resource(s).
   For another example, the UE could determine or identify or obtain a second UEI beam report according to or based on the second condition(s) of detecting or determining the event following those specified herein in the present disclosure; when/if the second condition(s) of detecting, declaring or determining the event as specified/defined herein in the present disclosure is different or separate from the first condition(s) of detecting, declaring or determining the event as specified/defined herein in the present disclosure—i.e., the second UEI beam report could be different or separate from the first UEI beam report such that they could comprise different or separate report quantities including resource indicator(s) SSBRI(s)/CRI(s) and/or beam metric(s) including L1-RSRP(s)/L1-SINR(s), upon or when or after the UE has received the network's response in form of Reponse-3 e.g. within the time window or before the timer expires that indicates, grants, allocates, assigns or schedules one or more PUSCH resources for transmitting or sending a (UEI) beam report, after a scheduling offset (higher layer configured) and/or when/if the one or more PUSCH resources have become valid/available/applicable, the UE could send the second UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the second UEI beam report on the one or more PUSCH resources. In this case, the UE could also send the (same) first UEI beam report (and therefore, the corresponding report quantity(s) including SSBRI(s)/CRI(s) and/or L1-RSRP(s)/L1-SINR(s) provided or comprised therein) or one or more of the report quantity(s) including SSBRI(s)/CRI(s) and/or L1-RSRP(s)/L1-SINR(s) of/for the first UEI beam report on the (same) one or more PUSCH resources. For this design example, the UE could send or transmit, in a first single (CSI) reporting instance or CSI report (using/via/in/on a first subset of the one or more PUSCH resources), (one or more of) the report quantity(s)/content(s) of the first UEI beam port, and the UE could send or transmit, in a second single (CSI) reporting instance or CSI report (using/via/in/on a second subset of the one or more PUSCH resources), (one or more of) the report quantity(s)/content(s) of the second UEI beam port. In this case, the first (CSI) reporting instance/CSI report could be different or separate from the second (CSI) reporting instance/CSI report, and/or the first subset of the one or more PUSCH resources could be different or separate from the second subset of the one or more PUSCH resources.
      For example, the first (CSI) reporting instance/CSI report could comprise a first report index/ID, and the second (CSI) reporting instance/CSI report could comprise a second report index/ID. For instance, the first report index/ID value could be lower/smaller (or higher/larger) than the second report index/ID value. Alternatively, the first report index/ID value could be 0 (or 1), and the second report index/ID value could be 1 (or 0). Optionally, the first report index/ID value could be from a set of one or more values configured/provided for the first (CSI) reporting instance/CSI report (hence, the first UEI beam report), and the second report index/ID value could be from a set of one or more values configured/provided for the second (CSI) reporting instance/CSI report (hence, the second UEI beam report).
      For another example, the first (CSI) reporting instance/CSI report could comprise a first report index/ID, and the second (CSI) reporting instance/CSI report could comprise a second report index/ID. For this design example, the UE could determine or identify the first (or second) report index/ID based on or according to: (i) fixed value(s)/rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
      For another example, the UE could identify or determine the first (or second) subset of the one or more PUSCH resources to transmit or send the first (or second) UEI beam report based on or according to: (i) fixed value(s)/rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network (e.g., the network 130) via/in part of various UL channels/signals and/or CSI/beam report(s) and/or UE's capability signaling(s). For instance, the first subset of the one or more PUSCH resources could have smaller/lower (or larger/higher) resource/resource configuration IDs than the second subset of the one or more PUSCH resources. Alternatively, the first subset of the one or more PUSCH resources could occur or become valid/available/application for transmission earlier (or later) in time than the second subset of the one or more PUSCH resources. Optionally, the first subset of the one or more PUSCH resources could correspond to the first (or second) half of the one or more PUSCH resources (e.g., in terms/form of their time/frequency domain positions, resource/resource configuration IDs, and etc.), and the second subset of the one or more PUSCH resources could correspond to the second (or first) half of the one or more PUSCH resources (e.g., in terms/form of their time/frequency domain positions, resource/resource configuration IDs, and etc.).

The first report index/ID could be associated/linked/mapped to the second report index/ID. The UE could determine or identify the association, linkage or mapping between the first report index/ID and the second report index/ID according to or based on: (i) fixed value(s)/rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Furthermore, the UE could determine or identify which of the report/reporting formats as described/specified in the aforementioned design examples to follow or use or apply for transmitting or sending the first and/or second UEI beam report(s) according to or based on: (i) fixed value(s)/rule(s) in system specification(s) or per RRC (re)configuration, (ii) network's configuration(s)/indication(s) via higher layer RRC signaling(s)/parameter(s)—e.g., in/by higher layer parameter(s) CSI-ReportConfig and/or UEI-ReportConfig that provides or configures necessary setting(s)/information for the UE-initiated beam reporting—and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

Throughout the present disclosure, a report quantity (reported) in a UEI beam report or a (CSI) reporting instance or a CSI report could be equivalent to or correspond to or could be the same as/identical to a CSI field in the corresponding (CSI) reporting instance or CSI report that carries the report quantity, or vice versa. That is, for the design examples specified/defined herein in the present disclosure, a report quantity (reported) in a UEI beam report or a (CSI) reporting instance or a CSI report and a CSI field in the corresponding (CSI) reporting instance or CSI report that carries or conveys the report quantity can be used in an exchangeable manner/fashion. Furthermore, for the described/specified design examples herein/procedures, when/if the UE could determine or identify or obtain a second UEI beam report according to or based on the second condition(s) of detecting or determining the event following those specified herein in the present disclosure, the first condition(s) of detecting or determining the event following those specified herein in the present disclosure could still be valid—i.e., the first UEI beam report obtained, identified or determined based on or according to the first condition(s) of detecting or determining the event following those specified herein in the present disclosure could still be valid.

For the design examples specified herein in the present disclosure for the operation Mode A, detecting, declaring and/or determining a/the event according to the indicated first TCI state(s) following or according to those specified or defined herein in the present disclosure could be referred to as or equivalent to detecting, declaring and/or determining the event according to or based on the first condition(s) of detecting, declaring or determining the event as specified/described herein in the present disclosure or vice versa, and detecting, declaring and/or determining a/the event according to the indicated second TCI state(s) following or according to those specified or defined herein in the present disclosure could be referred to as or equivalent to detecting, declaring and/or determining the event according to or based on the second condition(s) of detecting, declaring or determining the event as specified/described herein in the present disclosure or vice versa. According to or following those specified herein in the present disclosure, the first condition(s) of detecting, declaring or determining the event could be same as or identical to the second condition(s) of detecting, declaring or determining the event; or alternatively, the first condition(s) of detecting, declaring or determining the event could be different or separate from the second condition(s) of detecting, declaring or determining the event.

For the design examples specified herein in the present disclosure for the operation Mode B, detecting, declaring and/or determining a/the event according to the indicated first TCI state(s) following or according to those specified or defined herein in the present disclosure could be referred to as or equivalent to detecting, declaring and/or determining the event according to or based on the first condition(s) of detecting, declaring or determining the event as specified/described herein in the present disclosure or vice versa, and detecting, declaring and/or determining a/the event according to the indicated second TCI state(s) following or according to those specified or defined herein in the present disclosure could be referred to as or equivalent to detecting, declaring and/or determining the event according to or based on the second condition(s) of detecting, declaring or determining the event as specified/described herein in the present disclosure or vice versa. According to or following those specified herein in the present disclosure, the first condition(s) of detecting, declaring or determining the event could be same as or identical to the second condition(s) of detecting, declaring or determining the event; or, the first condition(s) of detecting, declaring or determining the event could be different or separate from the second condition(s) of detecting, declaring or determining the event.

Throughout the present disclosure, the first UL resource(s)/occasion(s) of/for the first UL channel(s) that carries or conveys the (first) PN message/trigger as in Step-1 for both Mode A and Mode B according to or following those specified herein in the present disclosure could be identical or the same as the second UL resource(s)/occasion(s) of/for the first UL channel(s) that carries or conveys the (second) PN message/trigger as in Step-1 for both Mode A and Mode B according to or following those specified herein in the present disclosure. In addition, the first UL resource(s)/occasion(s) of/for the second UL channel(s) that carries or conveys the first (UEI) beam report as in Step-3 for Mode A and Step-2 in Mode B according to or following those specified herein in the present disclosure could be identical or the same as the second UL resource(s)/occasion(s) of/for the second UL channel(s) that carries or conveys the second (UEI) beam report as in Step-3 for Mode A and Step-2 in Mode B according to or following those specified herein in the present disclosure.

The UEI beam reporting procedure(s)—along with the corresponding UE's operation(s)/assumption(s)/behaviors and the associated network's configuration(s) and/or indication(s)—as specified/defined herein throughout the present disclosure assuming that the UE receives from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable, could be (equally) extended or applied to the case when the UE receives from the network, e.g., via higher layer RRC signaling(s)/parameter(s) and/or MAC CE command(s) and/or dynamic DCI based L1 signaling(s) based on or according to a corresponding UE's capability or capability signaling, one or more indicators (and/or one or more RSs, RS resources, RS indexes, RS resource configuration indexes, and/or etc.) to update, sub-select and/or replace one or more of the candidate/new beam RS(s), RS resource(s), RS index(es) and/or RS resource configuration index(es), e.g., for event(s)/event instance(s) evaluation, assessment, detection and/or declaration according to or following those specified herein in the present disclosure. Optionally, the UEI beam reporting procedure(s)—along with the corresponding UE's operation(s)/assumption(s)/behaviors and the associated network's configuration(s) and/or indication(s)—as specified/defined herein throughout the present disclosure assuming that the UE receives from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable, could be (equally) extended or applied to the case when the UE receives from the network a (unified) TCI state(s) activation/deactivation MAC CE command, and/or when the TCI state(s) activated by/in the (unified) TCI state(s) activation/deactivation MAC CE command has become applicable. In addition, the UEI beam reporting procedure(s)—along with the corresponding UE's operation(s)/assumption(s)/behaviors and the associated network's configuration(s) and/or indication(s)—as specified/defined herein throughout the present disclosure assuming that the UE receives from the network, e.g., in a beam indication MAC CE/DCI (e.g., via a TCI codepoint of a TCI field in DCI format(s) 1_1/1_2 with or without DL assignment and/or cell switch MAC CE command), one or more second TCI states, wherein the one or more second TCI states, and therefore RS(s) associated to or provided in the one or more second TCI states, could have also become applicable, could be (equally) extended or applied to the case when the UE receives from the network a DCI (e.g., DCI format 0_1/0_2/0_3) indicating an UL grant and/or a CSI request field with a non-zero value, wherein the DCI and therefore the UL grant/CSI request field indicated therein have become application (e.g., after an up to 3 slots scheduling offset higher layer configured by the network). Throughout the present disclosure, an indicated TCI state (and therefore, the corresponding RS(s) or RS index(es) or RS resource(s) or RS resource configuration index(es) associated to or provided in the indicated TCI state)—e.g., the one or more second TCI states as specified/defined herein in the present disclosure—has become applicable can be understood as:
In one example (beam application time A), when/if the TCI state is indicated by a TCI codepoint of a TCI field in a beam indication DCI (e.g., DCI format(s) 1_1/1_2 with or without DL assignment), when the UE (e.g., the UE 116) would transmit a PUCCH with positive HARQ-ACK or a PUSCH with positive HARQ-ACK corresponding to the DCI carrying the indicated TCI state and without DL assignment, or corresponding to the PDSCH scheduled by the DCI carrying the indicated TCI state, and if the indicated TCI state is different from the previously indicated one, the indicated TCI state should be applied starting from the first slot that is at least beamAppTime symbols after the last symbol of the PUCCH or the PUSCH. The first slot and the beamAppTime symbols are both determined on the active BWP with the smallest SCS among the BWP(s) from the CCs applying the indicated TCI state that are active at the end of the PUCCH or the PUSCH carrying the positive HARQ-ACK.
In another example (beam application time B), when/if the TCI state is indicated/activated in/by a (unified) TCI state(s) activation/deactivation MAC CE command,
   when/if the indicated/activated TCI state is known, upon receiving the PDSCH carrying the (unified) TCI state(s) activation/deactivation MAC CE command in slot n, the indicated/activated TCI state could become applicable at the first slot that is after slot

$$n + {T}_{HARQ} + 3 {N}_{slot}^{subframe , μ} + {TO}_{k}^{*} ( {T}_{first - SSB} + {T}_{SSB - proc} ) / NR slot length$$

when/if the indicated/activated TCI state is unknown, upon receiving the PDSCH carrying the (unified) TCI state(s) activation/deactivation MAC CE command in slot n, the indicated/activated TCI state could become applicable the first slot that is after slot

$$n + {T}_{HARQ} + 3 {N}_{slot}^{subframe , μ} + {TO}_{k}^{*} ( {T}_{first - SSB} + {T}_{SSB - proc} ) / NR slot length$$

where

$${T}_{HAR} , {N}_{slot}^{subframe , μ} , {TO}_{k} , {T}_{first - SSB} , {T}_{SSB - proc}$$

and/or etc. are defined in [8, TS 38.133].
In another example (beam application time C), when/if the TCI state is indicated in/by a cell switch command (MAC CE), the UE could apply the indicated TCI state no later than T_{LTM-RRC-processing}+T_{LTM-processing}+T_{first-RS}+T_{RS-proc}+3 msec after the last symbol of a PUCCH or PUSCH with HARQ-ACK information for the PDSCH providing the cell switching MAC CE command, where T_{LTM-RRC-processing}, T_{LTM-processing}, T_{first-RS} and T_{RS-proc} are defined in [10, TS 38.133]. For RACH-based LTM cell switch [19, TS 38.300], the UE applies the indicated TCI state for receptions on the candidate cell, and applies a spatial domain filter corresponding to the indicated TCI state for transmissions on the candidate cell, that are after the completion of the random access procedure associated with the PRACH transmission on the candidate cell and before a new TCI state is indicated for the candidate cell or before a new (indicated) TCI state for the candidate cell becomes/has become applicable (e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure) or before a new TCI state (indicated) for the candidate cell is applied or becomes/has become applicable (e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure) or before a new TCI state is indicated and/or applied (or becomes/has become applicable)—e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure—for the candidate cell. For RACH-less LTM cell switch [19, TS 38.300], the UE applies the indicated TCI state receptions on the candidate cell and applies a spatial domain filter corresponding to the indicated TCI state for transmissions on the candidate cell before a new TCI state is indicated for the candidate cell or before a new (indicated) TCI state for the candidate becomes/has become applicable (e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure), or before a new TCI state (indicated) for the candidate cell is applied or becomes/has become applicable (e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure) or before a new TCI state is indicated and/or applied (or becomes/has become applicable)—e.g., according to or based on the beam application time A—when/if the new TCI state is indicated by/in a beam indication DCI, and/or beam application time B—when/if the new TCI state is indicated/activated by/in a (unified) TCI state(s) activation/deactivation MAC CE, as specified/defined herein in the present disclosure—for the candidate cell. Here, the indicated TCI state could be provided by CandidateTCI-State or CandidateTCI-UL-State or TCI-State or UL-TCIState.

According to those specified herein in the present disclosure, when/if one or more measurement RSs or RS resources associated/specific to an indicated TCI state—e.g., (1) the one or more measurement RSs or RS resources could be the QCL RS(s) or RS resource(s) provided in/by the indicated TCI state, i.e., index(es)/ID(s) of the one or more measurement RSs or RS resources could have the same value(s) as the index(es)/ID(s) of the RS(s) or RS resource(s) provided in higher layer parameter(s) TCI-State and/or UL-TCIState that provides or configures the indicated TCI state, and/or (2) the one or more RSs or RS resources could be QCL'ed (e.g., with typeD) with the RS(s) or RS resource(s) provided in/by the indicated TCI state—are used/applied/measured for evaluating, assessing, detecting or declaring an event or instance(s) of the event according to or following those specified herein in the present disclosure (e.g., the one or more measurement RSs or RS resources could comprise current serving beam RS(s)/RS resource(s) and/or candidate/new beam RS(s)/RS resource(s)), it could be understood that the event or instance(s) of the event or the evaluation, assessment, detection and/or declaration of the event/instance(s) of the event could be associated/specific to the indicated TCI state.

According to or following those specified herein in the present disclosure, when/if (higher layer(s) of) the UE has detected and/or declared a first event (e.g., the fourth event or Event-4) associated/specific to the first indicated TCI state(s) earlier (or later) in time than or before (or after) the detection and/or declaration of a second event (e.g., the fourth event or Event-4) associated/specific to the second indicated TCI state(s),
For both Mode A and Mode B, the UE could transmit the first PN message/trigger—e.g., using/over/on/in the most recent available UL resource(s)/occasion(s) denoted by first UL resource(s)/occasion(s) e.g. periodic PUCCH resource(s) of/for the first UL channel(s) as in Step-1—earlier (or later) in time than or before (or after) the transmission of the second PN message/trigger—e.g., using/over/on/in the most recent available UL resource(s)/occasion(s) denoted by second UL resource(s)/occasion(s) e.g. periodic PUCCH resource(s) of/for the first UL channel(s) as in Step-1, wherein the first and second PN messages/triggers could be respectively associated/specific to/for the first and second events here, and (the first/last symbol/slot/etc. of) the first UL resource(s)/occasion(s) of/for the first UL channel(s) as in Step-1 could occur earlier (or later) in time than or before (or after) the (first/last symbol/slot/etc. of the) second UL resource(s)/occasion(s) of/for the first UL channel(s) as in Step-1. Furthermore, the UE could transmit the first PN message/trigger in a form (e.g., one-bit and/or two-bit indicator(s)) to indicate triggering of the first event here, and/or request UL resource(s) for a transmission of a first (UEI) beam report (for Mode A) or notify the transmission of the first (UEI) beam report (for Mode B) according to or following those specified herein in the present disclosure, and/or the UE could transmit the second PN message/trigger in a form (e.g., one-bit and/or two-bit indicator(s)) to indicate triggering of the second event here, and/or request UL resource(s) for a transmission of a second (UEI) beam report (for Mode A) or notify the transmission of the second (UEI) beam report (for Mode B) according to or following those specified herein in the present disclosure. Alternatively, the first PN message/trigger associated/specific to/for the first event here could be associated/linked/mapped to a CSI report setting provided by CSI-ReportConfig/UEI-ReportConfig with a lower (or higher) reportConfigId than that (reportConfigId) of the CSI report setting provided by CSI-Report/UEI-ReportConfig associated/linked/mapped to the second PN message/trigger associated/specific to/for the second event here. Optionally, the first PN message/trigger could be the same as or identical to the second PN message/trigger, which could be transmitted—e.g., using/over/on/in the (same) most recent available UL resource(s)/occasion(s) e.g. periodic PUCCH resource(s) of/for the first UL channel(s) as in Step-1, i.e., the first UL resource(s)/occasion(s) of/for the first UL channel(s) could be the same as or identical to the second UL resource(s)/occasion(s) of/for the first UL channel(s) as specified/defined herein in the present disclosure.
For Mode A, when/if the UE has transmitted the first PN message/trigger according to or following those specified herein in the present disclosure earlier (or later) in time than the transmission of the second PN message/trigger, the UE could expect that the first (downlink/uplink) DCI is received, detected or monitored earlier (or later) in time than the second (downlink/uplink) DCI, and/or the first (downlink/uplink) DCI is received, detected or monitored in PDCCH candidate(s)/search space(s)/search space set(s)/CORESET(s) with lower (or higher) ID(s)/index(es) than that of PDCCH candidate(s)/search space(s)/search space set(s)/CORESET(s), in which the second (downlink/uplink) DCI is received, detected or monitored. Optionally, when/if the first PN message/trigger is associated/linked/mapped to a CSI report setting provided by CSI-ReportConfig/UEI-ReportConfig with a lower (or higher) reportConfigId than that (reportConfigId) of the CSI report setting provided by CSI-Report/UEI-ReportConfig associated/linked/mapped to the second PN message/trigger, the UE could expect that the first (downlink/uplink) DCI is received, detected or monitored earlier (or later) in time than the second (downlink/uplink) DCI, and/or the first (downlink/uplink) DCI is received, detected or monitored in PDCCH candidate(s)/search space(s)/search space set(s)/CORESET(s) with lower (or higher) ID(s)/index(es) than that of PDCCH candidate(s)/search space(s)/search space set(s)/CORESET(s), in which the second (downlink/uplink) DCI is received, detected or monitored, wherein the UE could determine or identify the aforementioned association(s)/linkage(s)/mapping(s) according to or based on: (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Optionally, the first (downlink/uplink) DCI and the second (downlink/uplink) DCI could be the same or identical (i.e., the first DCI and the second DCI could correspond to a/the same DCI denoted by a reference (downlink/uplink) DCI), which could be detected, received and/or monitored in the same PDCCH candidate(s)/search space(s)/search space set(s)/CORESET(s).
For both Mode A and Mode B, the UE could transmit the first UEI beam report—e.g., using/over/on/in the most recent available UL resource(s)/occasion(s) denoted by first UL resource(s)/occasion(s) e.g. DG/CG PUSCH resource(s) of/for the second UL channel(s) as in Step-3 (for Mode A) or Step-2 (for Mode B)—earlier (or later) in time than or before (or after) the transmission of the second UEI beam report—e.g., using/over/on/in the most recent available UL resource(s)/occasion(s) denoted by second UL resource(s)/occasion(s) e.g. DG/CG PUSCH resource(s) of/for the second UL channel(s) as in Step-3 (for Mode A) or Step-2 (for Mode B), wherein the first and second UEI beam reports could be respectively associated/specific to/for the first and second events here, and (the first/last symbol/slot/etc. of) the first UL resource(s)/occasion(s) of/for the second UL channel(s) as in Step-3 (for Mode A) or Step-2 (for Mode B) could occur earlier (or later) in time than or before (or after) the (first/last symbol/slot/etc. of the) second UL resource(s)/occasion(s) of/for the second UL channel(s) as in Step-3 (for Mode A) or Step-2 (for Mode B). In this case, the UE could report, in two separate/different reporting instances/CSI reports/beam reports, report quantity(s) of the first (UEI) beam report and the second (UEI) beam report respectively. Optionally, the UE could report, in a single reporting instance/a joint (UEI) beam report, report quantity(s) of the first (UEI) beam report and the second (UEI) beam report; in this case, the first UL resource(s)/occasion(s) of/for the second UL channel(s) as in Step-3 (for Mode A) or Step-2 (for Mode B) could be the same as or identical to the second UL resource(s)/occasion(s) of/for the second UL channel(s) as in Step-3 (for Mode A) or Step-2 (for Mode B).

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.

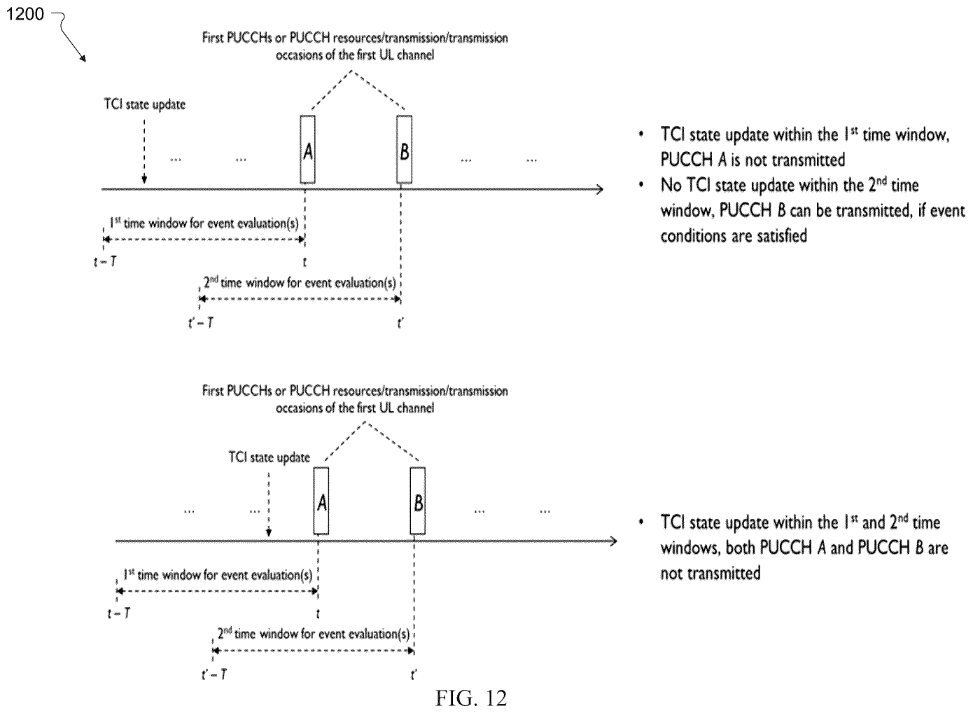

FIG. 12 illustrates an example of determining time window 1200 for event evaluation(s) for UEI beam reporting according to embodiments of the present disclosure. For example, determining time window 1200 can be followed by any of the UEs 111-116 of FIG. 1, such as the UE 114. This example is for illustration only and other embodiments can be used without departing from the scope of the present disclosure.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. One conceptual example of the described design example/procedure herein is presented in FIG. 12.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network (e.g., the network 130) according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure, and/or when/if one or more of the following conditions are achieved or satisfied:
The UE (e.g., the UE 116) does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:

for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE does not receive a (unified) TCI state(s) activation/deactivation MAC CE within the first time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE does not receive any form/format of a beam failure recover response (BFRR) within the first time window
The UE or higher layer(s) of the UE does not start (or starts) a prohibit timer as defined/specified herein in the present disclosure within the first time window, and/or the prohibit timer expires (or does not expire) within the first time window
For Mode-A/Mode-B, the UE does not receive a DCI in Step-2 in response to the transmission of the PN message/trigger in Step-1 within the first time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE does not receive triggering of aperiodic or semi-persistent CSI measurement and/or reporting (e.g., via a CSI request field in a triggering DCI) within the first time window
The UE does not receive activation of semi-persistent CSI measurement and/or reporting (e.g., via SP CSI measurement and/or reporting activation MAC CE(s)) within the first time window;
   and for another example, when/if one or more of the following conditions are achieved or satisfied:
The UE receives a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE receives a (unified) TCI state(s) activation/deactivation MAC CE within the first time window
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE receives a beam failure recover response (BFRR) within the first time window
The UE or higher layer(s) of the UE starts (or does not start) a prohibit timer as defined/specified herein in the present disclosure within the first time window, and/or the prohibit timer does not expire (or expires) within the first time window
For Mode-A/Mode-B, the UE receives a DCI in Step-2 in response to the transmission of the PN message/trigger in Step-1 within the first time window
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE receives triggering of aperiodic or semi-persistent CSI measurement and/or reporting (e.g., via a CSI request field in a triggering DCI) within the first time window
The UE receives activation of semi-persistent CSI measurement and/or reporting (e.g., via SP CSI measurement and/or reporting activation MAC CE(s)) within the first time window,
   the UE could determine or identify or declare an/the event when/if the number/counting of event instance(s) within a second time window starting from time t−T−T_proc−t_offset (e.g., in form of a slot or a symbol, i.e., slot or symbol t−T−T_proc−t_offset or the (t−T−T_proc−t_offset)-th slot or symbol) and ending at time t−T_proc−t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the second time window
The UE (e.g., the UE 116) receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window
The UE does not receive a (unified) TCI state(s) activation/deactivation MAC CE within the second time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure
The UE does not receive any form/format of a beam failure recover response (BFRR) within the second time window
The UE or higher layer(s) of the UE does not start (or starts) a prohibit timer as defined/specified herein in the present disclosure within the second time window, and/or the prohibit timer expires (or does not expire) within the second time window
For Mode-A/Mode-B, the UE does not receive a DCI in Step-2 in response to the transmission of the PN message/trigger in Step-1 within the second time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the second time window
The UE does not receive triggering of aperiodic or semi-persistent CSI measurement and/or reporting (e.g., via a CSI request field in a triggering DCI) within the second time window
The UE does not receive activation of semi-persistent CSI measurement and/or reporting (e.g., via SP CSI measurement and/or reporting activation MAC CE(s)) within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. For example, candidate value(s) of t_offset could be {1, 2, . . . , 10, 20, 40, . . . }slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc−k×t_offset and ending at time t−T_proc—k×t_offset according to or following those specified herein in the present disclosure, the UE could transmit or trigger or initiate a transmission of the PN message/trigger over/on/via/in the PUCCH resource or transmission or transmission occasion of the first UL channel at time t, and/or
When/if the UE could determine or identify or declare an/the event within a k-th time window starting from time t−T−T_proc—k×t_offset and ending at time t−T_proc—k×t_offset according to or following those specified herein in the present disclosure, the UE may not check or evaluate or assess whether the UE could determine or identify or declare an/the event within a (k+1)-th or (k−1)-th time window starting from time t−T−T_proc—(k+1)×t_offset and ending at time t−T_proc—(k+1)×t_offset according to or following those specified herein in the present disclosure, and/or
When/if the UE could not determine or identify or declare an/the event within a k-th time window starting from time t−T−T_proc—k×t_offset and ending at time t−T_proc—k×t_offset according to or following those specified herein in the present disclosure, the UE could further check or evaluate or assess whether the UE could determine or identify or declare an/the event within a (k+1)-th or (k−1)-th time window starting from time t−T−T_proc—(k+1)×t_offset and ending at time t−T_proc—(k+1)×t_offset according to or following those specified herein in the present disclosure.

In this case, k∈{0, . . . , Kmax}, wherein the UE could determine or identify vaue(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc—(Kmax+1)×t_offset of the Kmax-th time window could be no earlier than t—2×T−T_proc, and/or the ending time t−T_proc—(Kmax+1)×t_offset of the Kmax-th time window could be no earlier than t−T−T_proc.
In another example, the ending time t−T_proc—(Kmax+1)×t_offset of the Kmax-th time window could be no earlier than t−T_pucch—T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset.

In another example, when/if a UE has determined or identified or declared an event instance wherein:
for Event-1, the event instance could be associated/specific to at least one (same) new/candidate beam RS/RS resource according to or following those specified herein in the present disclosure
for Event-2, the event instance could be associated/specific to the current beam RS/RS resource according to or following those specified herein in the present disclosure
for Event-3, the event instance could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du—T_proc (e.g., in form of a slot or a symbol, i.e., slot or symbol t−T_du—T_proc or the (t−T_du—T_proc)-th slot or symbol) and ending at time t−Tproc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrences) according to or following those specified or described herein in the present disclosure within the aforementioned time duration associated/specific/corresponding to the PUCCH resource or transmission or transmission occasion at time t—for instance,
the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
   and/or when/if one or more of the following conditions are achieved or satisfied:
The UE does not receive a TCI state update within the time duration
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration
The UE does not receive a (unified) TCI state(s) activation/deactivation MAC CE within the time duration
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure
The UE does not receive any form/format of a beam failure recover response (BFRR) within the time duration
The UE or higher layer(s) of the UE does not start (or starts) a prohibit timer as defined/specified herein in the present disclosure within the time duration, and/or the prohibit timer expires (or does not expire) within the time duration
For Mode-A/Mode-B, the UE does not receive a DCI in Step-2 in response to the transmission of the PN message/trigger in Step-1 within the time duration
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time duration
The UE does not receive triggering of aperiodic or semi-persistent CSI measurement and/or reporting (e.g., via a CSI request field in a triggering DCI) within the time duration
The UE does not receive activation of semi-persistent CSI measurement and/or reporting (e.g., via SP CSI measurement and/or reporting activation MAC CE(s)) within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. Here, the UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure.
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure.
For another example, T_du could correspond to or higher layer configured as min{periodicity of a first MO, periodicity of a second MO}.
For another example, T_du could correspond to or higher layer configured as max{periodicity of a first MO, periodicity of a second MO}.
For another example, T_du could correspond to or higher layer configured as max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel—associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this design example, the time window(s) associated/specific to the event instance(s) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure could correspond to or could be sliding time window(s) as specified/defined herein in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure,
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window/duration
The UE receives a (unified) TCI state(s) activation/deactivation MAC CE within the time window/duration
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure
The UE receives a beam failure recover response (BFRR) within the time window/duration
The UE or higher layer(s) of the UE starts (or does not start) a prohibit timer as defined/specified herein in the present disclosure within the time window/duration, and/or the prohibit timer does not expire (or expires) within the time window/duration
For Mode-A/Mode-B, the UE receives a DCI in Step-2 in response to the transmission of the PN message/trigger in Step-1 within the time window/duration
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration
The UE receives activation of semi-persistent CSI measurement and/or reporting (e.g., via SP CSI measurement and/or reporting activation MAC CE(s)) within the time window/duration, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

For the described or specified design examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   the periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling

For the described or specified design examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s))
   the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1
before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s)) to zero, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In one example, for one or more RSs or RS resources each corresponding to one or more of: (1) a (same) new/candidate beam RS/RS resource (e.g., for Event-1 or Event-3), (2) the current beam RS/RS resource (e.g., for Event-2), (3) (a pair of) a (same) new/candidate beam RS/RS resource and a (same) activation beam RS/RS resource (or equivalently, a (same) activated beam/TCI state)—e.g., for Event-3, the MAC entity of/for a UE (e.g., the UE 116) could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2 and/or Event-3 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance) associated/specific to the one or more RSs or RS resources determined or identified according to or following those specified herein in the present disclosure has been received from lower layers:
      3> start or restart an EventInstanceDetectionTimer (higher layer configured for the event—when/if applicable), e.g., associated/specific to the one or more RSs or RS resources;
      3> increment an EventInstanceCounter (higher layer configured for the event—when/if applicable), e.g., associated/specific to the one or more RSs or RS resources by 1;
      3> if EventInstanceCounter>=EventInstanceMaxCount (higher layer configured for the event—when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du−T_proc (e.g., in form of a slot or a symbol, i.e., slot or symbol t−T_du−T_proc or the (t−T_du−T_proc)-th slot or symbol) and ending at time t−T_proc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du−T_proc (e.g., in form of a slot or a symbol, i.e., slot or symbol t−T_du−T_proc or the (t−T_du−T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventInstanceDetectionTimer, e.g., associated/specific to the one or more RSs or RS resources, expires
      the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure—used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based L1 signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      3> set EventInstanceCounter, e.g., associated/specific to the one or more RSs or RS resources, to 0.

The one or more RSs or RS resources could belong to or could be a subset of or one(s) of the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:
the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C—could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)).

A UE or higher layer(s) of a UE could start a prohibit timer (duration, length and/or etc. of the prohibit timer and/or how/when the prohibit timer would expire could be higher layer configured)
after the last symbol/slot/etc. of transmitting a PN message/trigger on/over/in a PUCCH resource or a PUCCH transmission/transmission occasion of the first UL channel of Mode A and/or Mode B and/or Mode C, and/or
after the last symbol/slot/etc. of receiving the UL grant DCI in Step-2 of Mode A and/or Mode C, and/or
after the last symbol/slot/etc. of when the UL grant DCI received in Step-2 of Mode A and/or Mode C has become applicable, and/or
after the last symbol/slot/etc. of transmitting a beam report on/over/in (DG and/or CG e.g. Type1 CG) PUSCH resource(s) of the second UL channel of Mode A and/or Mode B and/or Mode C.

When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
in one example, the UE or higher layer(s) of the UE could continue performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
   for another example, when/if the UE or higher layer(s) of the UE starts the prohibit timer, the UE or higher layer(s) of the UE could or may reset the number/counting of the event instance(s), e.g., to zero;
   for another example, when/if or after the prohibit timer expires, the UE or higher layer(s) of the UE could or may reset the number/counting of the event instance(s), e.g., to zero;
in another example, the UE or higher layer(s) of the UE could stop performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE could or may reset the number/counting of the event instance(s), e.g., to zero;
   for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations—between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′−t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

Throughout the present disclosure, and according to or following those specified herein in the present disclosure, a/the first (indicated) TCI state or the first (indicated) TCI state(s) could correspond to or could be equivalent to or could be replaced by/with a first network's response (NWR) or first NWR(s), and a/the second (indicated) TCI state or the second (indicated) TCI state(s) could correspond to or could be equivalent to or could be replaced by/with a second network's response (NWR) or second NWR(s), wherein or whereas a/the first or second NWR could be in form of:
a TCI state update indicated by a TCI codepoint of a (unified) TCI state(s) activation/deactivation MAC CE or a/the TCI field of a beam indication DCI (e.g., of DCI format 1_1/1_2 with or without DL assignment)
a TCI state update indicated by a TCI codepoint of a (unified) TCI state(s) activation/deactivation MAC CE or a/the TCI field of a beam indication DCI (e.g., of DCI format 1_1/1_2 with or without DL assignment), and the (measured) current beam RS/RS resource associated/specific to or determined/identified based on or according to the TCI state update or updated TCI state according to or following those specified herein in the present disclosure is updated/changed in contrast to or different from the previous one
a reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
a (unified) TCI state(s) activation/deactivation MAC CE
a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure
a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
a beam failure recovery response (BFRR)
a DCI in Step-2 in response to the transmission of the PN message/trigger in Step-I (Mode A/C)
a reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
a triggering of aperiodic or semi-persistent CSI measurement and/or reporting (e.g., via a CSI request field in a triggering DCI)
an activation of semi-persistent CSI measurement and/or reporting (e.g., via SP CSI measurement and/or reporting activation MAC CE(s))

Here, a BFRR can be defined or specified or determined according to one or more of:
In one example, after or upon declaration and/or detection of a beam failure for a/the PCell and/or PSCell, a UE could transmit a PRACH—e.g., based on a configuration for PRACH transmission provided by PRACH-ResourceDedicatedBFR—in slot n and according to antenna port quasi co-location parameters associated with periodic CSI-RS resource configuration or with SS/PBCH block (SSB) associated with a new beam RS index q_new provided by higher layer(s) of the UE, wherein transmission of the PRACH here could be denoted/represented by or referred to as transmission of a link failure recovery indication (LFRI). In this case, after transmitting the LFRI (for the PCell and/or PSCell), the UE could monitor PDCCH in a search space set provided by recoverySearchSpaceld for detection of a DCI format with cyclic redundancy check (CRC) scrambled by C-RNTI or MCS-C-RNTI—denoted/represented by or referred to as detection or reception of a beam failure recovery response (BFRR)—starting from slot n+4+2^{μ}·k_{mac}, where μ is the SCS configuration for the PRACH transmission and k_{mac} is a number of slots provided by k_{mac} or k_{mac}=0 if k_{mac} is not provided, within a window configured by BeamFailureRecoveryConfig. Furthermore, after 28 symbols from a last symbol of a first PDCCH reception in a search space set provided by recoverySearchSpaceld where the UE detects a DCI format with CRC scrambled by C-RNTI or MCS-C-RNTI, the UE could (re)set/determine spatial domain filter(s) for transmitting various UL channel(s)/signal(s) including PUCCH, PUSCH and/or SRS same as that/those used for transmitting a/the last PRACH (transmission), and/or the UE could (re)set/determine spatial domain filter(s) for receiving various DL channel(s)/signal(s) including PDCCH, PDSCH and/or CSI-RS according to the identified or determined new beam RS index q_new.
In another example, after or upon declaration and/or detection of a beam failure for a/the PCell and/or PSCell, a UE could transmit a BFR MAC CE provided in Msg3 or MsgA of contention based random access procedure—denoted/represented by or referred to as transmission of a LFRI. In this case, after transmitting the LFRI (for the PCell and/or PSCell), and after 28 symbols from the last symbol of the PDCCH reception that determines the completion of the contention based random access procedure—denoted/represented by or referred to as detection or reception of a BFRR in this case, the UE (e.g., the UE 116) could (re)set/determine spatial domain filter(s) for transmitting various UL channel(s)/signal(s) including PUCCH, PUSCH and/or SRS same as that/those used for transmitting a/the last PRACH (transmission), and/or the UE could (re)set/determine spatial domain filter(s) for receiving various DL channel(s)/signal(s) including PDCCH, PDSCH and/or CSI-RS according to the identified or determined new beam RS index q_new.
In another example, after or upon declaration and/or detection of a beam failure for a/the PCell and/or PSCell and/or SCell, a UE could transmit a PUCCH with a link recovery request (LRR)—denoted/represented by or referred to as transmission of a LFRI; in this case, the UE could be provided or configured by the network, e.g., via higher layer RRC signalling(s)/parameter(s), a configuration for PUCCH transmission with a/the LRR. The UE could provide, in a PUSCH MAC CE—denoted/represented by or referred to as transmission of a link failure recovery report (LFRR), information related to the identified or determined new beam RS index q_new. After 28 symbols from a last symbol of a PDCCH reception with a DCI format scheduling a PUSCH transmission with a same HARQ process number as for the transmission of the PUSCH MAC CE (hence, the LFRR) and having a toggled NDI field value—denoted/represented by or referred to as detection or reception of a BFRR in this case, the UE could (re)set/determine spatial domain filter(s) for receiving various DL channel(s)/signal(s) including PDCCH, PDSCH and/or CSI-RS and/or transmitting various UL channel(s)/signal(s) including PUCCH, PUSCH and/or SRS according to the identified or determined new beam RS index q_new.

Furthermore, throughout the present disclosure, declaration or detection or determination of an event associated/mapped/linked/corresponding to the first (indicated) TCI state(s) and/or the second (indicated) TCI state(s) could be equivalent to or same as or can be replaced with/by declaration or detection or determination of the event associated/mapped/linked/corresponding to the first NWR(s) and/or the second NWR(s) wherein the declaration or detection or determination of the event here could be based on or according to (the number/counting of) the (first and/or second) instance(s) of the event and/or the corresponding (first and/or second) timer(s)/time window(s) according to or following those specified herein in the present disclosure. For instance, when/if declaration or detection or determination of an event is associated/mapped/linked/corresponding to a first (or second) NWR, at least determination or configuration or indication or measurement or reception of the measurement RS(s)/RS resource(s) for declaring or detecting or determining the event or event instance(s) according to or following those specified herein in the present disclosure could be based on/according to or associated or corresponding or linked to the first (or second) NWR. In addition, throughout the present disclosure, a/the first UEI (beam) report(s) associated/mapped/linked/corresponding to or determined according to/based on the first (indicated) TCI state(s) could be equivalent to or same as or can be replaced with/by a/the first UEI (beam) report(s) associated/mapped/linked/corresponding to or determined according to/based on the first NWR(s), and a/the second UEI (beam) report(s) associated/mapped/linked/corresponding to or determined according to/based on the second (indicated) TCI state(s) could also be equivalent to or same as or can be replaced with/by a/the second UEI (beam) report(s) associated/mapped/linked/corresponding to or determined according to/based on the second NWR(s). For instance, content(s)/report quantity(s) of the first UEI (beam) report(s) could be determined according to or based on the first NWR(s)—e.g., content(s)/report quantity(s) of the first UEI (beam) report(s) could be determined according to or based on at least the measurement RS(s)/RS resource(s) used/applied to declare or detect or determine the event or event instance(s) according to or following those specified herein in the present disclosure based on/according to or associated or corresponding or linked to the first NWR(s), and content(s)/report quantity(s) of the second UEI (beam) report(s) could be determined according to or based on the second NWR(s)—e.g., content(s)/report quantity(s) of the second UEI (beam) report(s) could be determined according to or based on at least the measurement RS(s)/RS resource(s) used/applied to declare or detect or determine the event or event instance(s) according to or following those specified herein in the present disclosure based on/according to or associated or corresponding or linked to the second NWR(s).

Throughout the present disclosure, a PN message/trigger as specified/defined herein in the present disclosure (e.g., in both Mode A and Mode B) could be associated to one or more CSI reporting settings each provided by CSI-ReportConfig or UEI-ReportConfig. The UE could determine or identify the association according to or based on: fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For instance, a/the first PN message/trigger as specified/defined herein in the present disclosure could be associated to a first CSI reporting setting provided by CSI-ReportConfig (with a first reportConfigId), and a/the second PN message/trigger as specified/defined herein in the present disclosure could be associated to a second CSI reporting setting provided by CSI-ReportConfig (with a second reportConfigId), wherein the first reportConfigId could be identical to/the same as or different/separate from the second reportConfigId. In this case, the UE could determine or identify UL resource(s)/occasion(s) for transmitting a/the first (UEI) beam report triggered or indicated by the first PN message/trigger according to or following those specified herein in the present disclosure based on or according to the information and/or setting(s) and/or parameter(s) provided or configured in the first CSI reporting setting, and/or the UE could determine or identify UL resource(s)/occasion(s) for transmitting a/the second (UEI) beam report triggered or indicated by the second PN message/trigger according to or following those specified herein in the present disclosure based on or according to the information and/or setting(s) and/or parameter(s) provided or configured in the second CSI reporting setting.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a RS (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). An UL resource can be referred to as or is equivalent to an UL occasion or an UL transmission occasion, and an UL occasion can be referred to as or is equivalent to an UL resource or an UL transmission occasion.

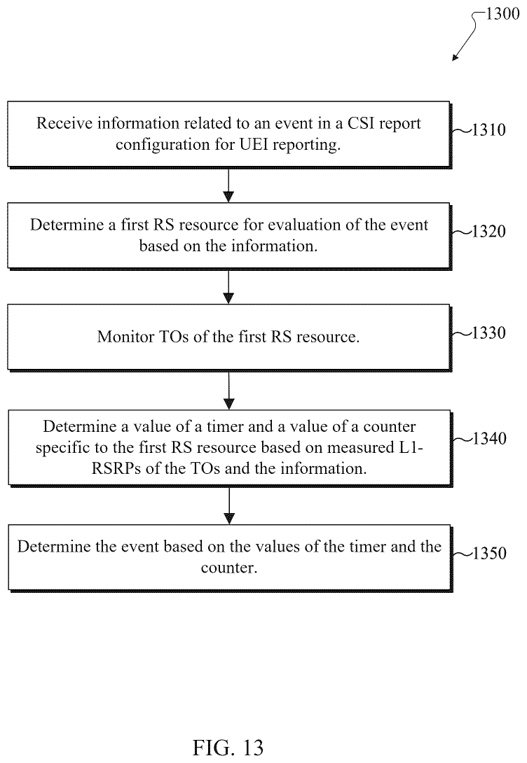

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE receiving information related to an event in a CSI report configuration for UEI reporting (1310). For example, in 1310, the information includes a threshold, a time window length and a number of event instance count. The UE then determines a first RS resource for evaluation of the event based on the information (1320). The UE then monitors TOs of the first RS resource (1330).

The UE then determines a value of a timer and a value of a counter specific to the first RS resource based on measured L1-RSRPs of the TOs and the information (1340). In various embodiments, the UE receives a TCI state and determines the value of the counter based on the TCI state. In various embodiments, the value of the counter is set to zero, when a RS in the TCI state is updated when the first RS signal is from a NZP-CSI-RS-ResourceSet configured with repetition or when a SS/PBCH block quasi co-located with the RS in the TCI state is updated when the first RS signal is from a CSI-SSB-ResourceSet. The UE then determines the event based on the values of the timer and the counter (1350).

In various embodiments, the UE receives one or more TCI states activated in a TCI states activation or deactivation MAC CE command and determines, based on the information and the one or more TCI states, a second RS resource specific to a TCI state for evaluation of the event. The information comprises a value Q. In some examples, the second RS resource has a Q-th highest measured L1-RSRP among all RS resources specific to the one or more TCI states, and the second RS resource corresponds to a RS in the TCI state, or a SS/PBCH block quasi co-located with the RS in the TCI state. In some examples, when a measured L1-RSRP of a TO of the first RS resource is greater than a measured L1-RSRP of a TO of the second RS resource by the threshold, the UE starts the timer from a value equal to the time window length when the timer is not running or determines an instance of the event and increment the value of the counter by one when the timer is running. For example, when the value of the counter is greater than or equal to the number of event instance count, the UE determines the event and transmits a UEI report comprising an absolute L1-RSRP value for the second RS resource.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive, in a channel state information (CSI) report configuration for UE-initiated (UEI) reporting, information related to an event; and
a processor operably coupled with the transceiver, the processor configured to determine, based on the information, a first reference signal (RS) resource for evaluation of the event,
wherein the transceiver is further configured to monitor transmission occasions (TOs) of the first RS resource,
wherein the processor is further configured to:
determine, based on measured layer-1 reference signal received powers (L1-RSRPs) of the TOs and the information, a value of a timer and a value of a counter specific to the first RS resource; and
determine the event based on the values of the timer and the counter, and
wherein the information includes a threshold, a time window length, and a number of event instance count.

2. The UE of claim 1, wherein:
the transceiver is further configured to receive a transmission configuration indication (TCI) state; and
the processor is further configured to determine the value of the counter based on the TCI state.

3. The UE of claim 2, wherein the value of the counter is set to zero:
when a RS in the TCI state is updated when the first RS signal is from a NZP-CSI-RS-ResourceSet configured with repetition, or
when a synchronization signal/physical broadcast channel (SS/PBCH) block quasi co-located with the RS in the TCI state is updated when the first RS signal is from a CSI-SSB-ResourceSet.

4. The UE of claim 1, wherein:
the transceiver is further configured to receive one or more transmission configuration indication (TCI) states activated in a TCI states activation or deactivation medium access control (MAC) control element (CE) command,
the processor is further configured to determine, based on the information and the one or more TCI states, a second RS resource specific to a TCI state for evaluation of the event, and
the information comprises a value Q.

5. The UE of claim 4, wherein:
the second RS resource has a Q-th highest measured L1-RSRP among all RS resources specific to the one or more TCI states, and
the second RS resource corresponds to:
a RS in the TCI state, or
a synchronization signal/physical broadcast channel (SS/PBCH) block quasi co-located with the RS in the TCI state.

6. The UE of claim 4, wherein, when a measured L1-RSRP of a TO of the first RS resource is greater than a measured L1-RSRP of a TO of the second RS resource by the threshold, the processor is further configured to:
start the timer from a value equal to the time window length when the timer is not running, or
determine an instance of the event and increment the value of the counter by one when the timer is running.

7. The UE of claim 4, wherein when the value of the counter is greater than or equal to the number of event instance count:
the processor is further configured to determine the event; and
the transceiver is further configured to transmit a UEI report comprising an absolute L1-RSRP value for the second RS resource.

8. A base station (BS), comprising:
a processor; and
a transceiver operably coupled with the processor, the transceiver configured to:
transmit, in a channel state information (CSI) report configuration for UE-initiated (UEI) reporting, information related to an event, wherein the information indicates a first reference signal (RS) resource for evaluation of the event, and
transmit in one or more transmission occasions (TOs) of the first RS resource,
wherein the event is based on a value of a timer and a value of a counter specific to the first RS resource,
wherein the values of the timer and the counter are based on layer-1 reference signal received powers (L1-RSRPs) of the TOs of the first RS resource, and
wherein the information includes a threshold, a time window length, and a number of event instance count.

9. The BS of claim 8, wherein:
the transceiver is further configured to transmit a transmission configuration indication (TCI) state; and
the value of the counter is based on the TCI state.

10. The BS of claim 9, wherein the value of the counter is set to zero:
when a RS in the TCI state is updated when the first RS signal is from a NZP-CSI-RS-ResourceSet configured with repetition, or
when a synchronization signal/physical broadcast channel (SS/PBCH) block quasi co-located with the RS in the TCI state is updated when the first RS signal is from a CSI-SSB-ResourceSet.

11. The BS of claim 8, wherein:
the transceiver is further configured to transmit one or more transmission configuration indication (TCI) states activated in a TCI states activation or deactivation medium access control (MAC) control element (CE) command;
a second RS resource specific to a TCI state for evaluation of the event is based on the one or more TCI states, and
the information comprises a value Q.

12. The BS of claim 11, wherein:
the second RS resource has a Q-th highest measured L1-RSRP among all RS resources specific to the one or more TCI states, and
the second RS resource corresponds to:
a RS in the TCI state, or
a synchronization signal/physical broadcast channel (SS/PBCH) block quasi co-located with the RS in the TCI state.

13. The BS of claim 11, wherein, when a L1-RSRP of a TO of the first RS resource is greater than a L1-RSRP of a TO of the second RS resource by the threshold:
the timer is started from a value equal to the time window length when the timer is not running, or
an instance of the event is determined and the value of the counter is incremented by one when the timer is running.

14. The BS of claim 11, wherein:
the event is determined when the value of the counter is greater than or equal to the number of event instance count; and
the transceiver is further configured to receive a UEI report comprising an absolute L1-RSRP value for the second RS resource.

15. A method performed by a user equipment (UE), the method comprising:
receiving, in a channel state information (CSI) report configuration for UE-initiated (UEI) reporting, information related to an event;
determining, based on the information, a first reference signal (RS) resource for evaluation of the event;
monitoring transmission occasions (TOs) of the first RS resource;
determining, based on measured layer-1 reference signal received powers (L1-RSRPs) of the TOs and the information, a value of a timer and a value of a counter specific to the first RS resource; and
determining the event based on the values of the timer and the counter,
wherein the information includes a threshold, a time window length and a number of event instance count.

16. The method of claim 15, further comprising:
receiving a transmission configuration indication (TCI) state,
wherein determining the value of the counter further comprises determining the value of the counter based on the TCI state.

17. The method of claim 16, wherein the value of the counter is set to zero:
when a RS in the TCI state is updated when the first RS signal is from a NZP-CSI-RS-ResourceSet configured with repetition, or
when a synchronization signal/physical broadcast channel (SS/PBCH) block quasi co-located with the RS in the TCI state is updated when the first RS signal is from a CSI-SSB-ResourceSet.

18. The method of claim 15, further comprising:
receiving one or more transmission configuration indication (TCI) states activated in a TCI states activation or deactivation medium access control (MAC) control element (CE) command; and
determining, based on the information and the one or more TCI states, a second RS resource specific to a TCI state for evaluation of the event,
wherein the information comprises a value Q.

19. The method of claim 18, wherein:
the second RS resource has a Q-th highest measured L1-RSRP among all RS resources specific to the one or more TCI states, and
the second RS resource corresponds to:
a RS in the TCI state, or
a synchronization signal/physical broadcast channel (SS/PBCH) block quasi co-located with the RS in the TCI state.

20. The method of claim 18, further comprising, when a measured L1-RSRP of a TO of the first RS resource is greater than a measured L1-RSRP of a TO of the second RS resource by the threshold:
starting the timer from a value equal to the time window length when the timer is not running, or
determining an instance of the event and incrementing the value of the counter by one when the timer is running.
